(19) United States
(12) Patent Application Publication
(10) Pub. No.: US 2003/0104344 A1
(43) Pub. Date: Jun. 5, 2003

(54) Structured observation system for early literacy assessment

(76) Inventors: Paula H. Sable, Newburport, MA (US); Sharon J. Houle, Barrington, NH (US); Neal M. Kingston, Greenland, NH (US)

Correspondence Address: MAINE & ASMUS, 100 MAIN STREET, P O BOX 3445, NASHUA, NH, 03061-3445, US

(21) Appl. No.: 10/308,738

(22) Filed: Dec. 3, 2002

Related U.S. Application Data
(60) Provisional application No. 60/338,744, filed on Dec. 3, 2001.

(51) Int. Cl. G09B 17/00

(52) U.S. Cl. 434/178

(57) ABSTRACT

Embodiments of the present invention provide a developmentally appropriate, individualized early literacy assessment that is research-based, assesses pre-literacy and early literacy concepts and skills across all pertinent components, can be customized to address specific state curriculum standards and benchmarks, and provides a process for collecting and aggregating data.

### RELATED APPLICATIONS

This application claims the benefit of U.S. Provisional Application No. 60/338,744, filed Dec. 3, 2001. This application is herein incorporated in its entirety by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates to educational assessment tools, and more particularly, to a comprehensive system for the assessment of a literacy development in a child.

### BACKGROUND OF THE INVENTION

There are two traditional methods for the assessment of the reading ability of young children: group administered tests and individually administered informal reading inventories.

The group-administered tradition involves giving a group of children paper-and-pencil tasks to which they respond. Several key features of such examinations follow.

These examinations are designed to be highly efficient to administer and score. Most of these examinations are multiple-choice in format. The administration format is not supportive of testing some of the skills underlying the development of reading. They typically stress norm-referenced interpretations, how students compare to each other rather than how do they compare to an absolute standard. To support curricular and instructional decisions of educators, they provide aggregated data. They are supported by strong statistical underpinnings, using classical and/or modem test theory to analyze field test data.

Students are expected to respond to all items. Since most young children are not accustomed to this type of testing, they often misunderstand directions or lose their place when filling in answer sheets. Thus, they do not provide reliable diagnostic information.

Individually administered informal reading inventories were developed from research on the development of reading skills in instructional settings. One of the most widely used tools for reading assessment has been the informal reading inventory. Since 1942, when Patsy Killgallon and Emmett Betts first devised the concept, the use of a set of graded reading passages administered to students individually has been applied consistently in elementary schools. Subsequent research has helped to refine the reliability and validity of the initial measures, but the general format has remained the same. This is largely due to the ease of administration and the wealth of information that can be gathered within a short period of time. The general format consists of graded word lists and short, graded reading selections. Student performance on the inventories has been measured using miscue analysis systems and running records.

One of the problems associated with most informal reading inventories is that they are not developed to assess very early emergent literacy skills. In the early 1970s, Marie Clay's Concepts About Print Test made its way to the United States and has been widely used to evaluate young children's conceptual understanding of the practice we call reading. However, Clay's assessment does not address phonemic awareness or a child's understanding of word analysis.

They can be inefficient to administer, requiring a teacher or aid to spend time individually with each student; this can be ameliorated somewhat by tailoring the portions of the inventory to administer to each individual student.

Tests are administered individually and require the child to respond by actually performing such tasks as identifying letters, reading passages, and responding to questions asked by the examiner. As the names suggest, some are more informal than others, and some are carefully calibrated tests. The greatest drawback of this model is the amount of time it takes to administer. Because this model is time-consuming, it is frequently reserved for assessment of children who may not be making adequate progress in learning to read.

By allowing teachers to focus and probe student performance on those tasks most salient for the current instructional level of that student, these tests can be truly diagnostic.

These two traditions have existed in tandem for more than 40 years. The methodology of the invention, for the first time, combines these traditions creating a stronger more useful instrument for assessing reading in young children.

The market provides numerous assessment instruments designed to evaluate children's early literacy skills. Most include a set of subtests that address various components of early literacy; few address the entire range of pre-reading and early reading components. Few are structured developmentally or meet all the professional and federal guidelines for testing young children. Virtually none provide a means for a state educational agency to aggregate data for individual students, schools, and districts.

Few commercially available assessment tools included all of the components of early reading and those that did, did not provide a means for aggregating data.

An assessment instrument that addresses all of the components of early literacy development (print awareness, phonemic/phonological awareness, letter/alphabet knowledge, sight word recognition, phonics/word attack/structural analysis, reading fluency, and reading and listening comprehension), does so within a developmental framework, and provides a means for large-scale data collection appears to be unavailable.

What is needed, therefore, are techniques and instruments for assessing the development of literacy in children that are research-based, meet all the professional and federal guidelines for testing young children, and provide a means for a client to aggregate data for individual students, and individual classrooms, schools and school districts within a given jurisdiction.

### BRIEF SUMMARY OF THE INVENTION

Embodiments of the present invention provide a developmentally appropriate, individualized early literacy assessment that is research-based, assesses pre-literacy and early literacy concepts and skills across all pertinent components, can be customized to address specific state curriculum standards and benchmarks, and provides a process for collecting and aggregating data.

One embodiment of the present invention provides a system for assessing early literacy development in children, the system being formulated by the method comprising: gathering and reviewing early reading standards from a plurality of states and national professional organizations and scientifically based research related to developmental stages involved in acquiring reading skills; determining subtests required for a comprehensive diagnostic early reading assessment covering the early reading standards and the scientifically based research related to developmental stages; comparing existing early reading instruments to the comprehensive diagnostic early reading assessment; developing subtests using standard psychometric practice; developing a blueprint for each the subtest; and developing at least one form of the assessment, including items for all subtests and supporting materials.

Another embodiment of the present invention provides a method for administering an assessment of early literacy development in a student, the method comprising: obtaining assessment documents, including at least one form containing instructions and items for all subtests in the assessment, an answer document, and supporting materials; noting extent of prior reading skills of the student and selecting one or more subtests to be administered; instructing the student, and verifying the student's understanding of instructions; presenting the subtest to the student and recording the student's responses and reaction to each item of the subtest in the answer document; and submitting the answer document for scoring.

Yet another embodiment of the present invention provides a method for processing an assessment of early literacy development in students, the method comprising: confirming analytical and reporting tasks with a client; collecting and logging a plurality of answer documents; creating at least one file containing raw score data and student demographic data; analyzing the file using scientifically based research relating to developmental skills required for reading to diagnose student strengths and/or weaknesses in reading development; preparing reports including results obtained from the step of analyzing and recommendations for the amelioration of developmental deficits; and communicating the reports to the client.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a flow chart illustrating a method of designing an assessment in accordance with one embodiment of the present invention.

FIG. 2 is a flow chart illustrating a method of administering an assessment in accordance with one embodiment of the present invention.

FIG. 3 is a flow chart illustrating a method of processing and using the results of an assessment in accordance with one embodiment of the present invention.

FIG. 4 is a Quick Guide For Test Examiners in accordance with one embodiment of the present invention.

FIG. 5 is an English language storybook for use in an assessment in accordance with one embodiment of the present invention (6 pages).

FIG. 6 is a Spanish language storybook for use in an assessment in accordance with one embodiment of the present invention (5 pages).

FIG. 7 is a student progress record book for use in an assessment in accordance with one embodiment of the present invention (56 pages).

FIG. 8 is a Spanish Language Structured Observation System Notebook for use in an assessment in accordance with one embodiment of the present invention (65 pages).

FIG. 9 is a reading assessment score form for use in an assessment in accordance with one embodiment of the present invention (2 pages).

FIG. 10 is a Reading Assessment Profile Form for use in an assessment in accordance with one embodiment of the present invention (2 pages).

FIG. 11 is a flow chart illustrating the development of an assessment in accordance with one embodiment of the present invention.

FIG. 12 is an English Language Structured Observation System Notebook for use in an assessment in accordance with one embodiment of the present invention (69 pages).

FIG. 13 is a Student Progress Record Book for use in an assessment in accordance with one embodiment of the present invention (52 pages).

FIG. 14 is a District and School Test Coordinator Manual for use in an assessment in accordance with one embodiment of the present invention (12 pages).

### DETAILED DESCRIPTION

One embodiment of the present invention is designed to be developmental in nature. That is, children are assessed on only those literacy components that relate to their stage of reading development. The assessment builds developmentally, from preliterate through the early stages of learning to read.

From Jeanne Chall's classic study, Learning to Read: The Great Debate (1967), to the recent report of the National Research Council (Snow, Burns, & Griffin, 1998), ample evidence points to the fact that an understanding of the systematic structure of words and language contributes significantly to the development of reading ability. Thus, assessment of phonemic awareness, phonics, and structural analysis skills are important parts of reading assessment in the primary grades. Each subtest component of the system will address a specific component of literacy development.

One embodiment of the present invention will provide three forms of the SOS subtest component will allow for appropriate test-retest over time. Subtest components will include: Print awareness; Phonemic awareness; Letter recognition/alphabet knowledge; Phonics/structural analysis; Sight vocabulary development; Listening comprehension, including Global text comprehension, Vocabulary knowledge, and Grammar and text structure; and Reading comprehension, including, Global text comprehension, Vocabulary knowledge, Grammar and text structure, Fluency development, and Word analysis skills.

One embodiment of the present invention will be designed so that its components may be administered independently and as needed. However, performance on some subtests may be necessary to indicate a starting point for other subtests (e.g., performance on the sight vocabulary subtest should guide teachers to begin the reading comprehension subtest at an appropriate level). Additionally, teachers' use of each subtest would be guided primarily by a Reading Assessment Outline provided for each appropriate grade level.

The stage model presented here was introduced by Jeanne Chall in 1983 forms the theoretical environment of one embodiment of the present invention. Chall's work builds upon the earlier work of Jean Piaget, William Gray, Arthur Gates, and Benjamin Bloom, among others. It has been widely accepted and applied in instructional and assessment procedures. A synopsis of the early stages and their relation to the present invention follows.

Stage 0 begins at birth and generally continues through kindergarten for most individuals. At this stage, children are introduced to language, both informal and formal. Children develop functional use of syntax and vocabulary. Through exposure to pleasant experiences (being read to, singing nursery rhymes, etc.) children become aware that the squiggles on pages are a form of talk written down. They begin to experiment with language in many ways, chanting nonsense syllables, making up silly rhymes, and pretending to read. This latter activity is most apparent in children who have had ample exposure to reading from others; by kindergarten, they can be observed looking at books and telling the story through the pictures. When favorite books have been read to these children often, they appear to be reading when, in actuality, they have memorized the stories they so enjoy. These children usually show interest in letters and sounds and can often recognize a few familiar words and logos. Without this early familiarity, one cannot understand what this abstract process, reading, is all about. To attempt formal reading instruction without this familiarity generally results in failure, as the learner has no sense of the goal.

The point of assessment of children who are not yet reading is to determine which elements of the concept of reading have been acquired. By understanding the degree to which the concept of reading has been developed, a teacher can provide this vital background knowledge to facilitate the move toward the next stage, where formal instruction begins. Assessment measures of one embodiment of the present invention that address this level include: Print awareness, Phonemic awareness, Letter recognition/alphabet sequence knowledge, Sight vocabulary development (to a limited degree), Listening comprehension (which may encompass several other measures)

Stage 1 often begins in kindergarten and usually continues through most of first grade. Children at this point understand that reading is another way to convey meaning. They know what letters are and know that these letters are associated with sounds and that bunches of letters together form words. Up to this point, a child may have experimented with “reading” a story by retelling it while turning pages or looking at the pictures of an unfamiliar story and trying to tell its story by looking at the pictures. Around this time, children begin to realize that there is actually a system, a right way to put letters together to form words and, ultimately stories or messages. Children begin to want to be able to “do it right,” i.e., use the code that readers use. This provides the impetus for learning to read and at this point, children are ready to begin formal reading instruction. The greatest task to be achieved is the cracking of the code. Children already know that reading is supposed to make sense; they can comprehend stories that are read to them. They primarily need to know how to recognize words and understand how letters and words function to make that meaning. So, while teachers, parents, and others continue to read to children and share word play, the primary skill to be acquired is decoding, which must, of course, be incorporated into the larger, more complex skill of “reading.”

Assessment of this stage is broad. It encompasses some of the pre-reading elements and extends into a range of word-level skills while still focusing on the ultimate goal of comprehension. However, since readers at this stage have not yet acquired sufficient skill to read substantial text, comprehension continues to be assessed (and developed) primarily via listening activities. Assessment measures of one embodiment of the present invention that address stage 1 learning include: Letter recognition/letter sequence (alphabetic principle), Phonics/structural analysis, Sight vocabulary development (with some attention to fluency), and Listening comprehension (if reading comprehension is attempted, it is limited in scope).

Often by the end of first grade and usually in second grade, children have developed to Stage 2, with sufficient decoding knowledge to begin to solidify this knowledge. The primary task is to become so proficient with word level skills that words are instantly recognizable in print and the child reads “fluently.” This means that these beginning skills are reaching the point where the learner no longer needs to puzzle out the sounds in a word to pronounce, or “read” it. As fluency develops, children can read longer text independently and can begin to rely more on reading than listening for comprehension. This is generally accomplished by lots of practice; reading of “predictable” text (sometimes called repetitive text because lines are often repeated, as in rhymes), text with familiar structure, and text with familiar topics. Familiarity is an important part of the process at this point; this is what keeps learners focused and able to expend most of their cognitive energy on refining the decoding process without losing the meaning of the text. Subtle shifts begin to occur that move learners toward consolidation of these initial skills.

Assessment of Stage 2 learners is quite similar to assessment at Stage 1, but with a greater emphasis on fluency. In addition, assessment can now effectively include measures of reading comprehension that take on a more defining role. Assessment measures of one embodiment of the present invention that are appropriate for this stage include: Phonics/structural analysis, Sight vocabulary development, Listening comprehension, and Reading comprehension that includes a fluency measure.

Stage 3A learners have acquired sufficient reading skills to begin to apply them in more sophisticated ways to expand their reading comprehension proficiency. While comprehension continued to develop in the earlier stages, most cognitive energy was devoted to learning how to read and perfecting those skills. While learning will continue to embrace more complex word level skills, more attention can be devoted to reading more complex forms of text and to developing a broad range of strategies for using reading to gain, analyze, synthesize and evaluate knowledge and concepts. On average, learners reach this stage during third grade; Chall further describes the refinement of these comprehension skills in subsequent stages. This is a process that continues into adulthood.

When children reach Stage 3A, they become increasingly capable of demonstrating comprehension through silent reading measures. Thus, more traditional measures of reading comprehension, which can present learners with a broader variety of text structure, become more reliable and efficient ways to measure reading development. In particular, reading measures that include opportunities for open-ended response may be particularly effective. A traditional silent reading comprehension assessment test used to test level 3 A should include these components: A variety of reading passages, including literary (fiction and poetry), informational, and practical; A combination of high-quality test items that include multiple choice items and open-response items that address; Vocabulary knowledge; Reading strategies; Structural analysis skills; Grammar and text structure; Global text comprehension across various levels of thinking skill; A measure of fluency; and a Traditional Reading Comprehension Test

Since examinations of technical reports of standardized tests indicate that traditional large-group, paper-and-pencil reading assessment models do not yield reliable results for many emergent readers, the assessment components of the SOS are most appropriate as the primary reading comprehension measures for kindergartners, first graders, and many second graders. By second grade, some children have advanced to stage 3A and by third grade, most children's reading skills are at this level. At this point, a more summative form of reading assessment is generally a more effective and efficient means of measuring reading proficiency.

As students develop a modicum of fluency and automaticity, they are able to read independently for sustained periods. While this typically occurs in grades 2-3, not all children will be ready for such an assessment by the end of grade two. For those children whose reading performance indicates appropriate achievement a traditional assessment format can be used.

By third grade, most students who are achieving reading skills at normal developmental rates would be ready to make the transition to a traditional reading comprehension test. However, for students who have clearly not attained this level of achievement, requiring participation in such a test would be self-defeating and in conflict with guidelines for assessment set forth by professional organizations. For these children, a joint decision made by parents and teachers may justify continued use of the appropriate components.

One embodiment of the present invention includes seven subtests that are presented and used in a developmental progression. Each subtest includes a substantial number of tasks that address all key elements of that reading component. It is comprehensive within and across subtests.

One embodiment of the present invention is comprised of the following documents: at least one SOS Notebook per test examiner containing test examiner's instructions and student performance pages; at least one storybook per test examiner; at least one Student Progress Record Book per student; at least one scannable answer sheet or Score Form per student documenting pretest and post-test subtest scores; at least one Profile Form per student; at least one Quick Guide for Test Examiners per test examiner including activity checklist to aid test examiners during test administration; at least one Reading Checklist per student including an optional checklist of reading skills not assessed in the SOS but to be observed throughout the school year by test examiners; at least one District and School Test Coordinator's Manual per district, or per school providing detailed instructions regarding scheduling, administration, test security, and shipping information; and a plurality of student, school, district, and state-level report shells.

Student Progress Record Books are workbooks used for a particular student that are maintained on a student kindergarten through at least 3^{rd} grade.

Profile Forms are non-scannable form documenting pretest and post-test subtest scores are maintained on a student kindergarten through at least 3^{rd} grade.

One embodiment of the present invention provides a developmental structure of the assessment and the data collection process.

One embodiment of the present invention combines (1) a multiple-component, individually administered, reading assessment program, method, and system for grades K-3, with (2) a system and method of collecting, aggregating, analyzing, and reporting results. PTR has psychometric rigor and is solidly grounded in scientifically based reading research. Therefore, it can be used for screening, diagnostic, and accountability purposes. The results can be used to inform instruction. Designed for classroom teachers, PTR is efficient, as each subtest takes only a few minutes to administer. It includes unique features to determine whether a child understands the nature of a task before it is undertaken. The assessment can be adapted for multiple languages, with the subtests reflecting the distinct characteristics of each language.

One embodiment of the present invention provides comprehensive coverage of all developmental skills and components critical to early reading, and reflects performance expectations that are common in many state standards. Separate subtests, which can be administered individually or in developmentally appropriate clusters, address each component. Only the appropriate subtests for a child's point of development need to be administered. The subtests include print awareness, phonemic awareness, letter knowledge, vocabulary knowledge, listening comprehension, phonics and structural analysis, word recognition, and reading comprehension and fluency. Reading research supports the choice of tasks selected for each subtest. One embodiment addresses the inadequacies of existing instruments, particularly in such areas as phonemic awareness, vocabulary, and comprehension.

One embodiment of the present invention provides guidance in analyzing a child's performance across subtests. It provides rubrics for common reading profiles that indicate specific levels of development and/or instructional needs based on the results. These profiles also help explain a child's reading achievement to parents. An accompanying guide explains, in non-technical language, what the components of reading are, why they are important, how they are assessed, and what the scores mean. It also suggests activities parents might implement at home. The guide makes distinctions between the important components in each language.

The results of properly administered assessments, according to one embodiment of the present invention, are designed to be valid, whether used individually or aggregated across classes, schools, districts, and states. The invention includes a system and method of aggregating, analyzing, and reporting the results of the assessment. The assessment forms are designed to permit electronic aggregation, analysis, and reporting of results, although manual means may also be employed.

Often, specific patterns of reading behavior can be seen across subtest scores. A well-trained reading diagnostician can interpret these patterns and make instructional recommendations based on them. Most classroom teachers do not have the extensive training of reading diagnosticians. However, since a number of patterns of performance are fairly typical at certain stages of reading development, one embodiment of the present invention includes these. By presenting several common patterns or profiles, classroom teachers can begin to use these as templates to determine the instructional needs of their students. Thus, indirectly, classroom teachers will learn to analyze subtest results and see relationships among the subtest scores. Alternatively school districts may be provided with in-depth training for their teachers in the use of these profiles.

One embodiment of the present invention provides a system for assessing early literacy development in children, the system being formulated by the method comprising: gathering and reviewing content and achievement standards from a plurality of states with regard to early reading; reviewing scientifically based research related to the developmental stages involved in acquiring reading skills; identifying and reviewing existing early reading instruments to determine the extent to which they assess students in relation to state reading standards and reflect the results of scientifically based research into all the developmental stages involved in learning to read; determining the core components/subtests required for a comprehensive diagnostic early reading assessment covering both state standards and all the development skills; considering practical factors related to classroom operation; applying standard psychometric practice to the design of all the subtests in the assessment and development of specific items to ensure the validity of the results; determining the areas to be covered by each such subtest; developing a schematic for each such subtest; determining that each such subtest will be individually administered; and developing at least one form of the assessment, including items for all subtests and supporting materials.

Another embodiment of the present invention provides a method for administering an assessment of early literacy development in a student, the method comprising: confirming assessment objectives with a client; obtaining assessment documents, including at least one form containing instructions and items for all subtests in the assessment, an answer document, and supporting materials; noting extent of prior reading skills of said student; selecting one or more subtests to be administered; instructing the student; verifying the student's understanding of instructions; presenting subtest items to the student; noting the student's responses to each item in the answer document; annotating the assessment booklet with information relating to the student's performance on and responses to the subtest; submitting the answer document for scoring; and retaining the assessment booklet in a secure location.

Yet another embodiment of the present invention provides a method for the processing of an assessment of early literacy development in children, the method comprising: confirming analytical and reporting tasks with a client; collecting and logging a plurality of answer documents; scanning the answer documents; creating a data file of raw scores; creating a data file of student demographics; merging the data file of raw scored with the data file of student demographics; checking the merged files for errors; submitting the merged files for analysis; compiling scientifically based research relating to student weaknesses in developmental skills required for reading; preparing reports from results obtained from the analysis; preparing guidelines for instructional change keyed to the results; providing instruction to educators regarding how to use the results to understand student strengths and weaknesses in developmental skills required for learning how to read, and to use that understanding to inform instruction; and communicating the reports to the client.

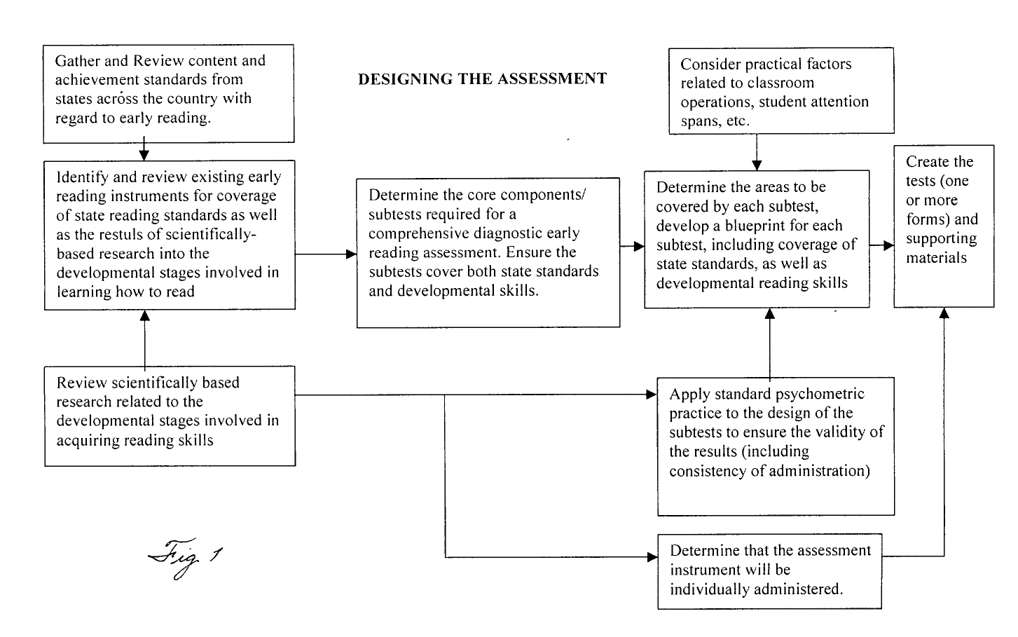

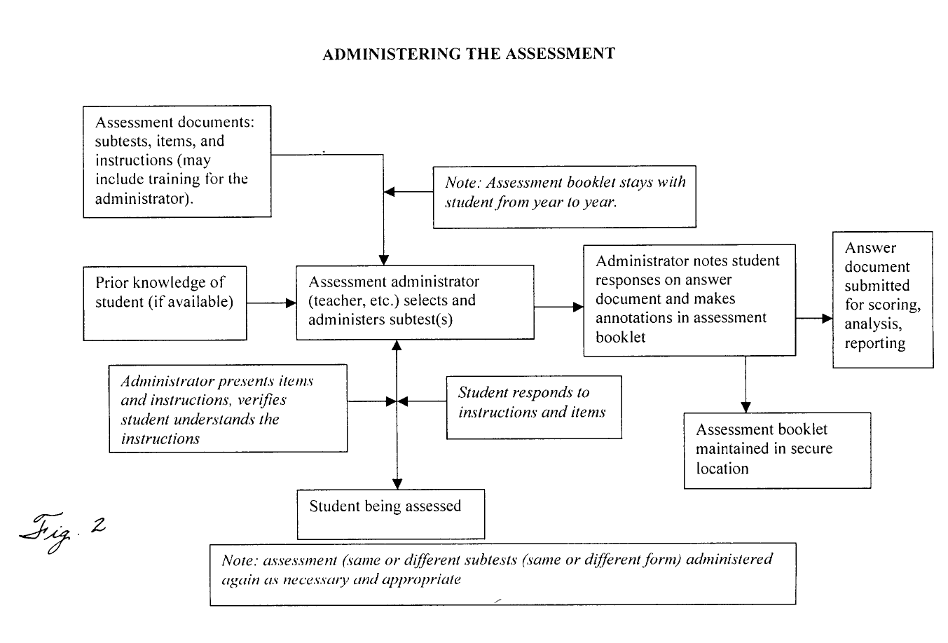

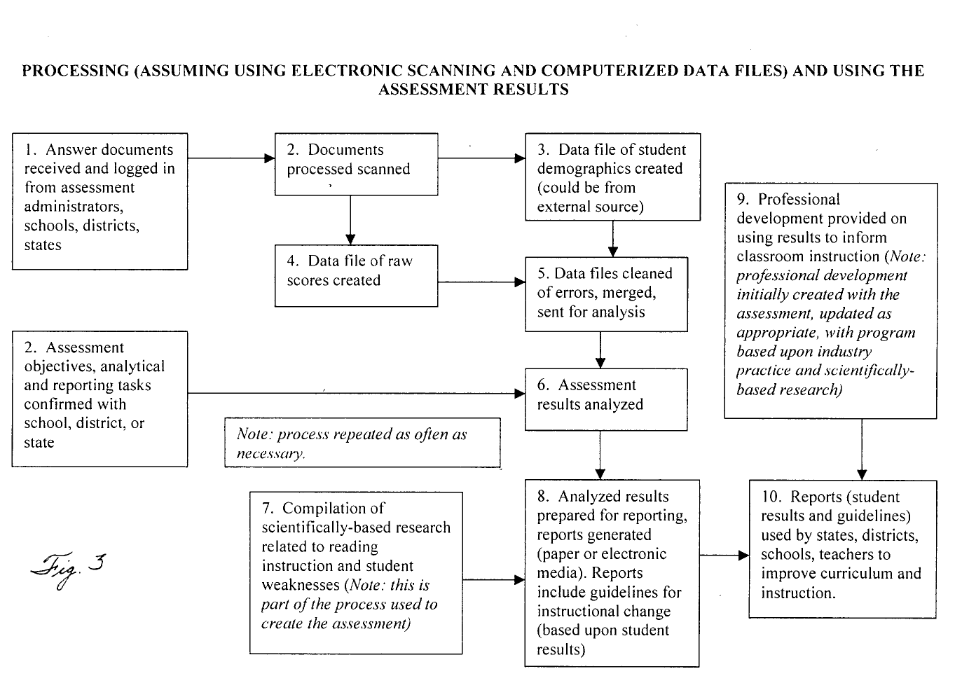

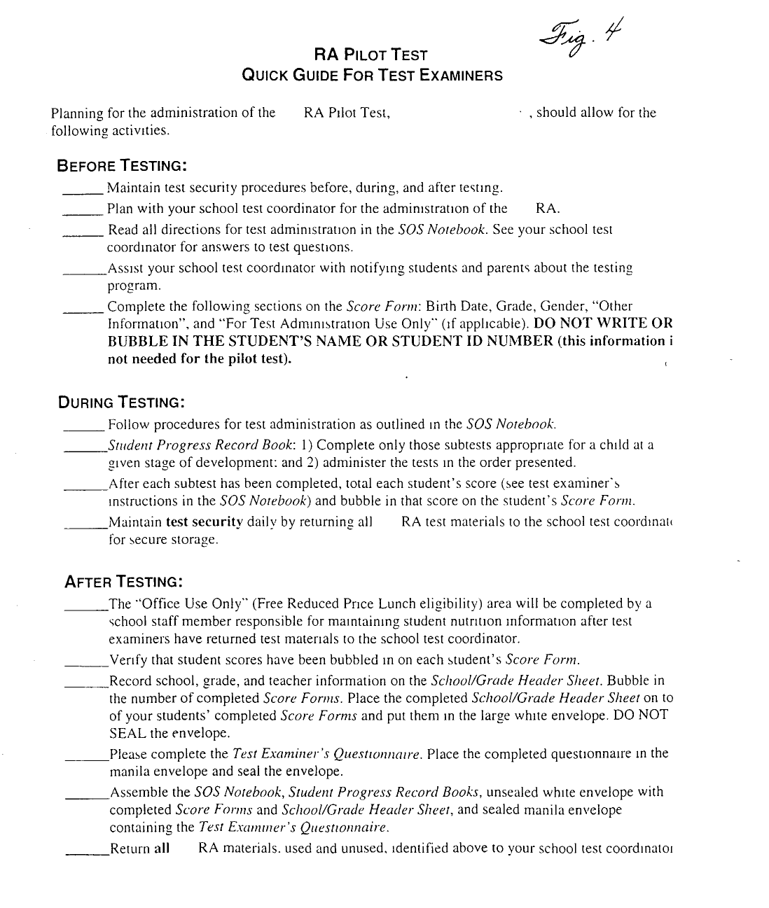

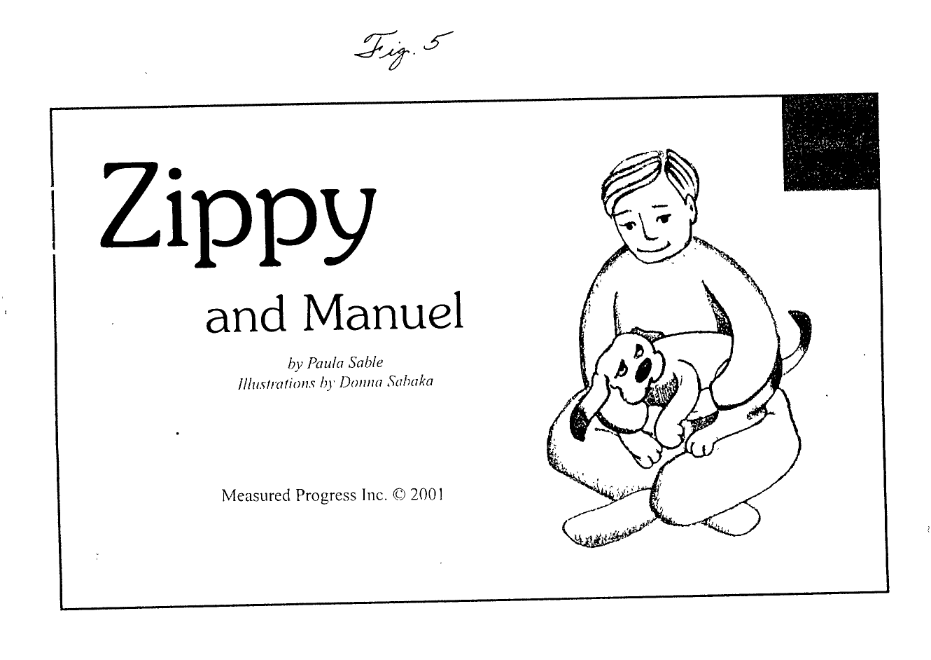

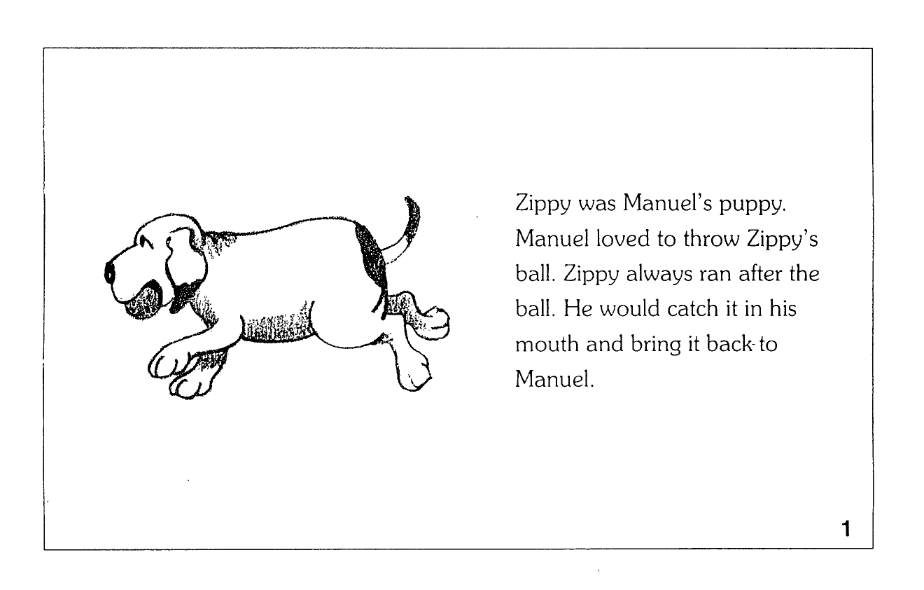

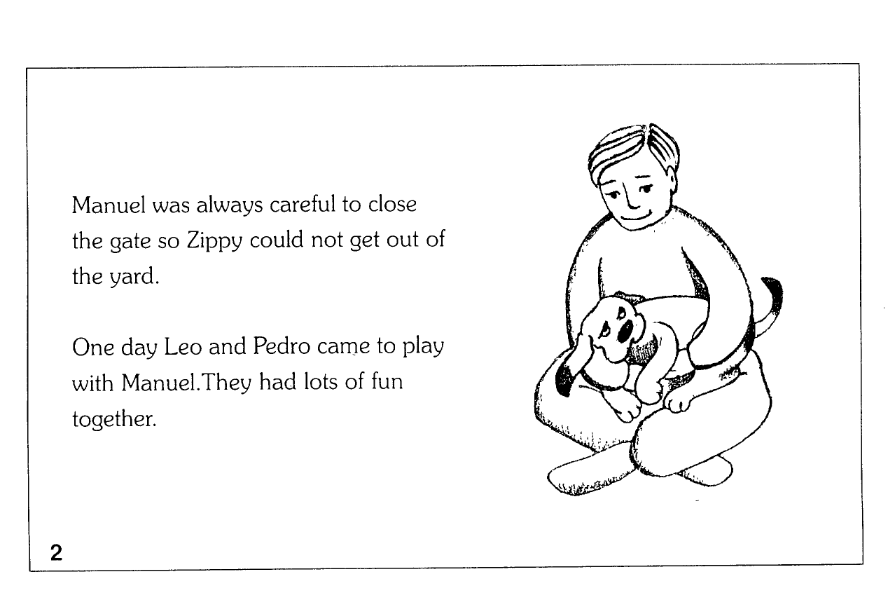

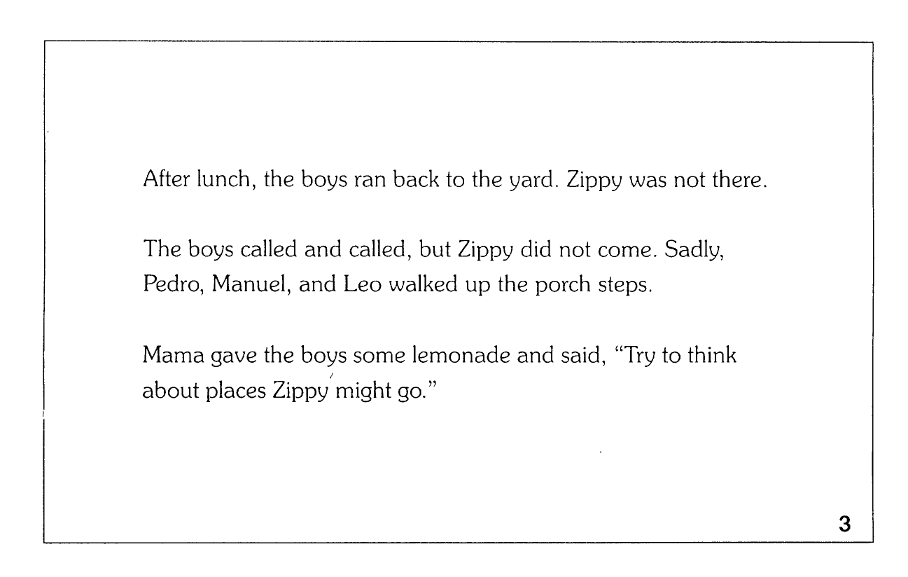

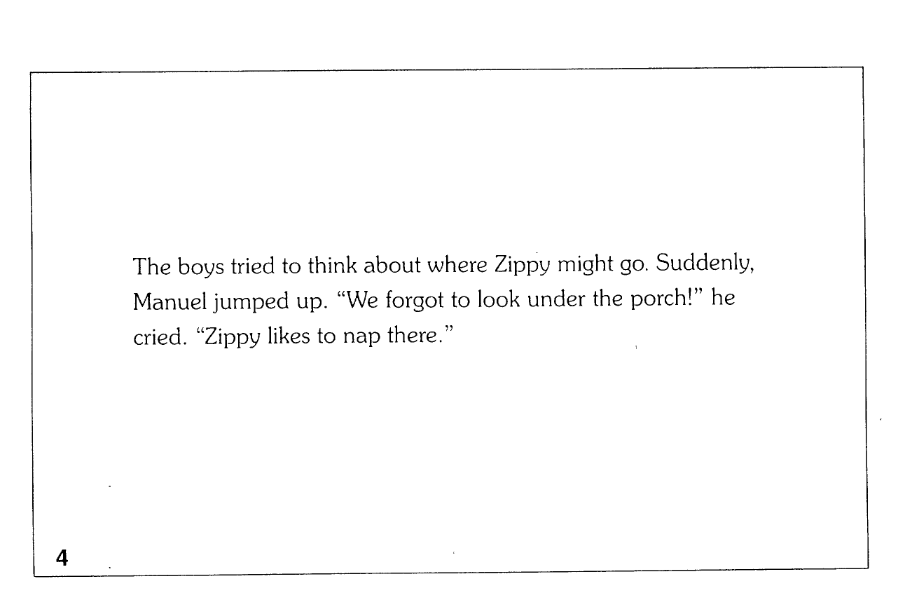

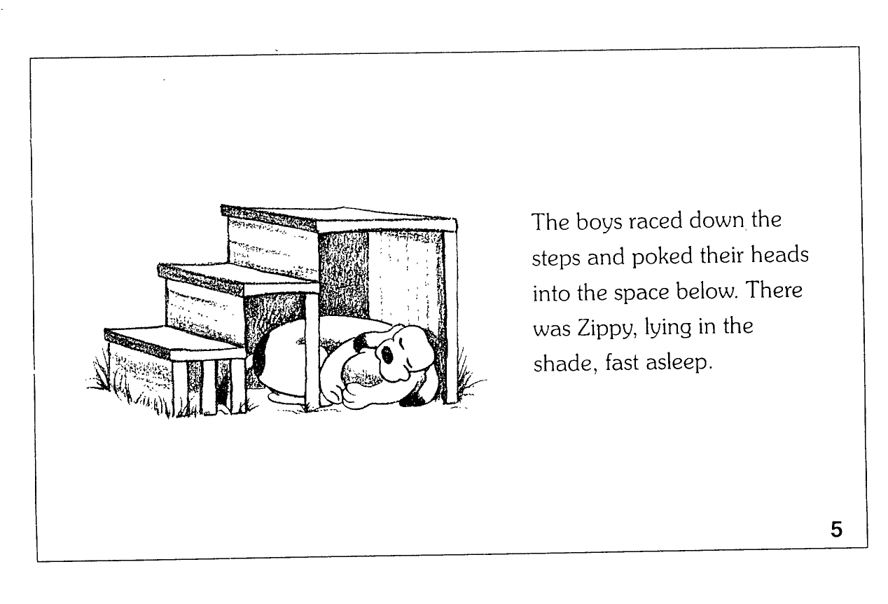

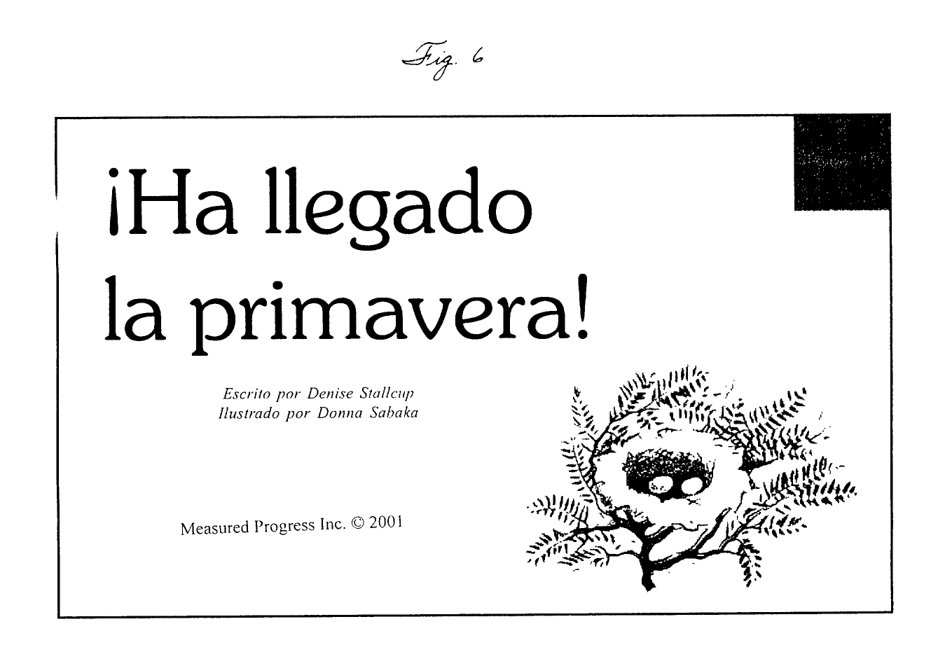

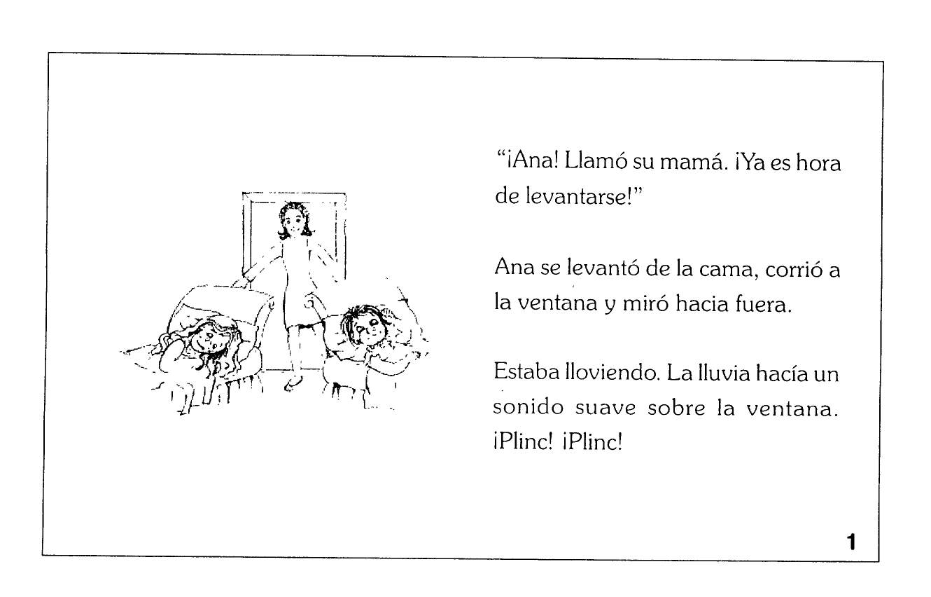

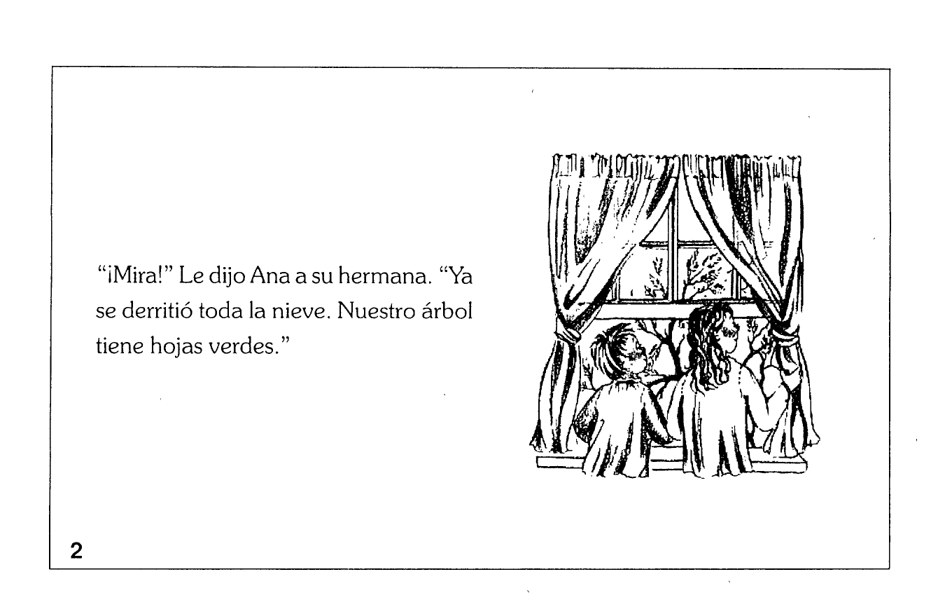

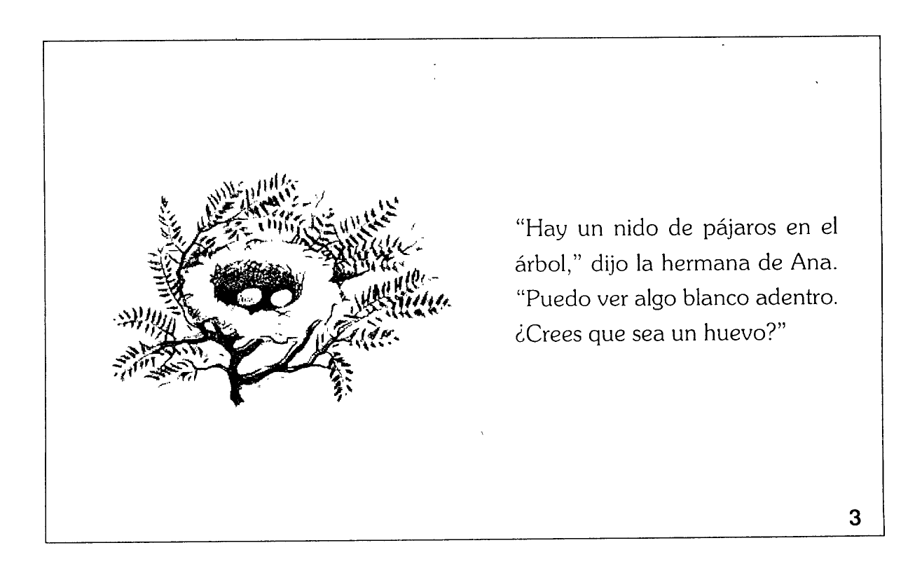

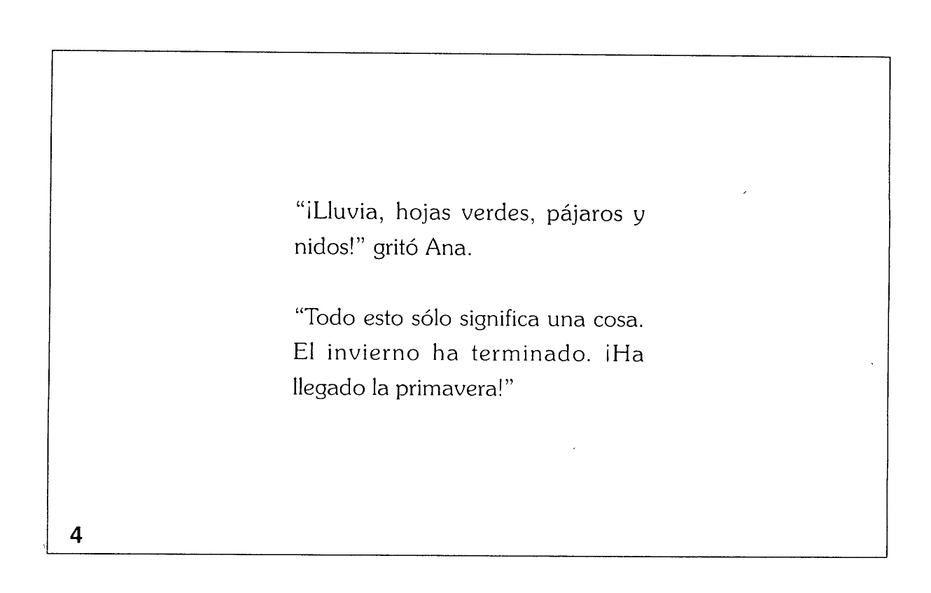

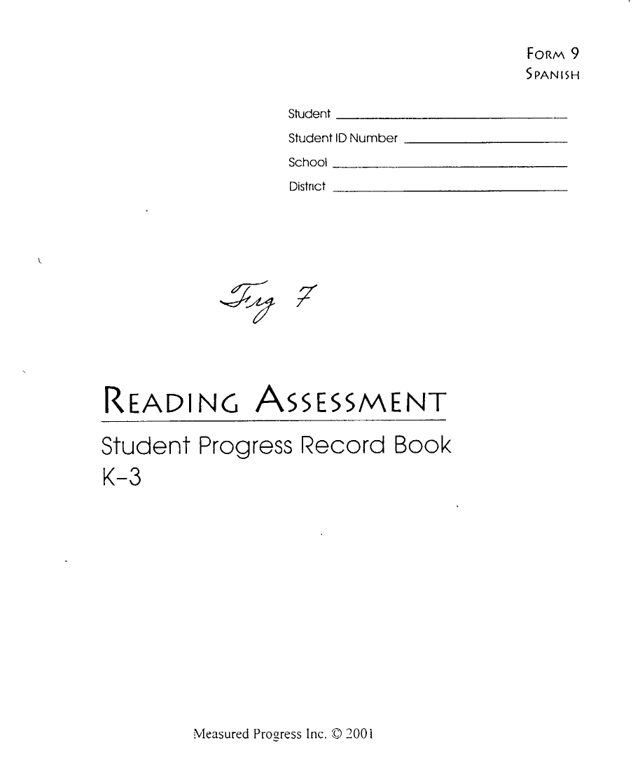

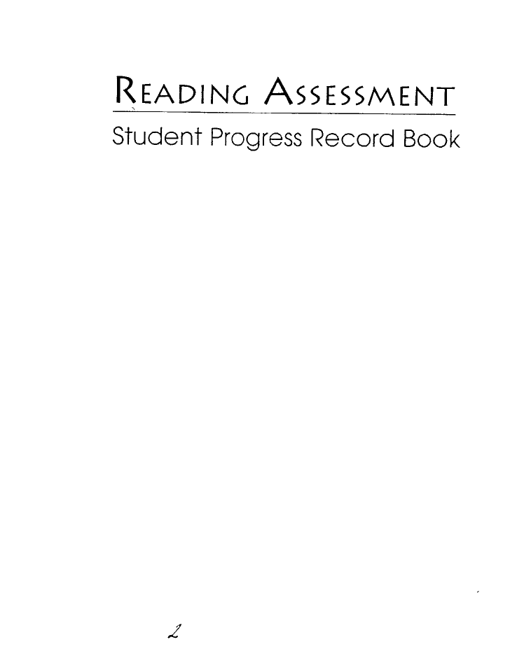

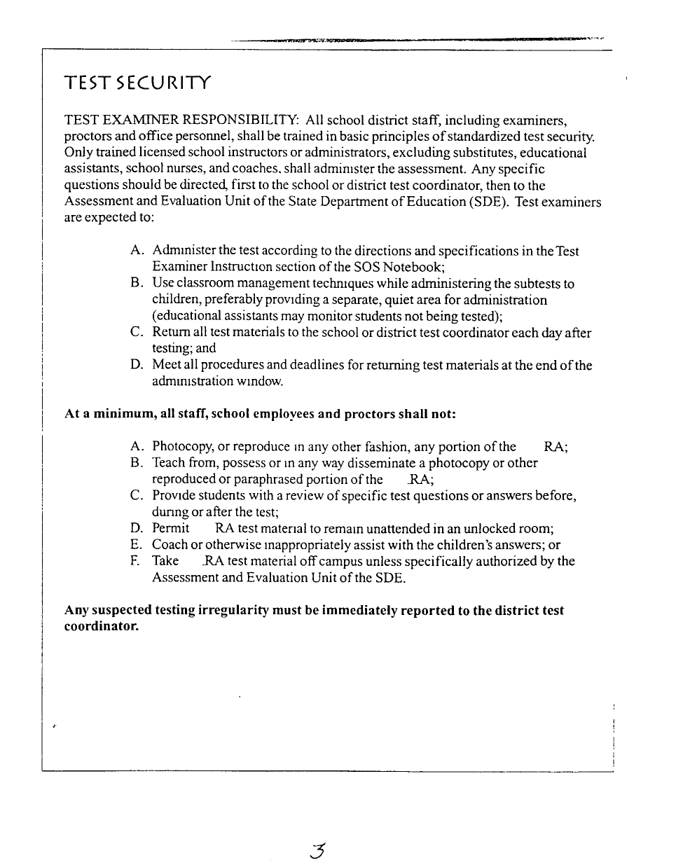

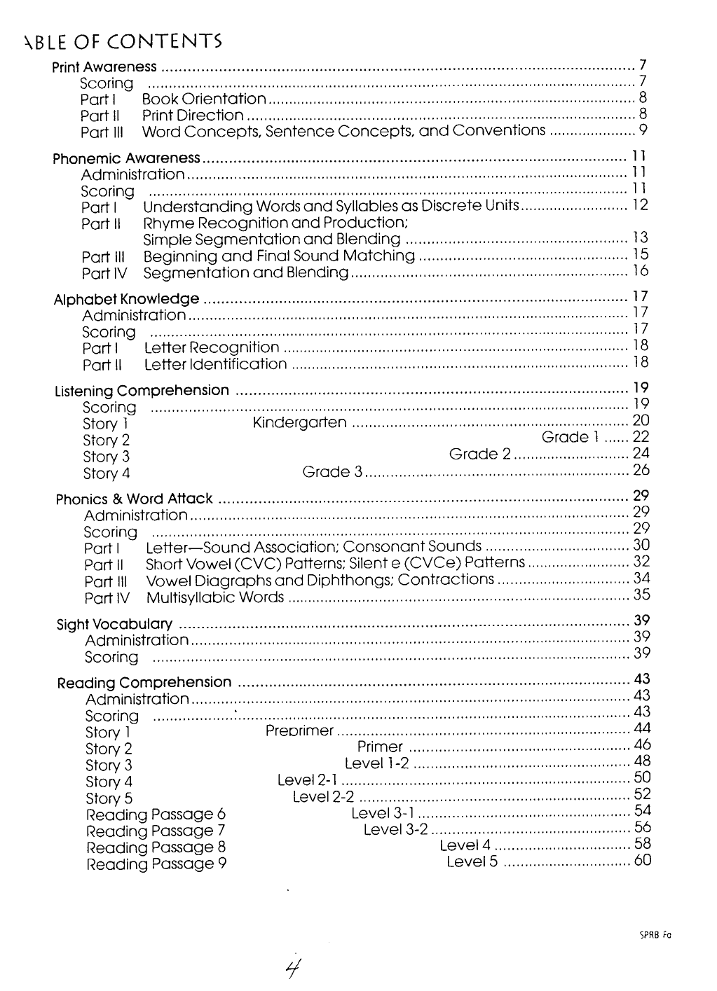

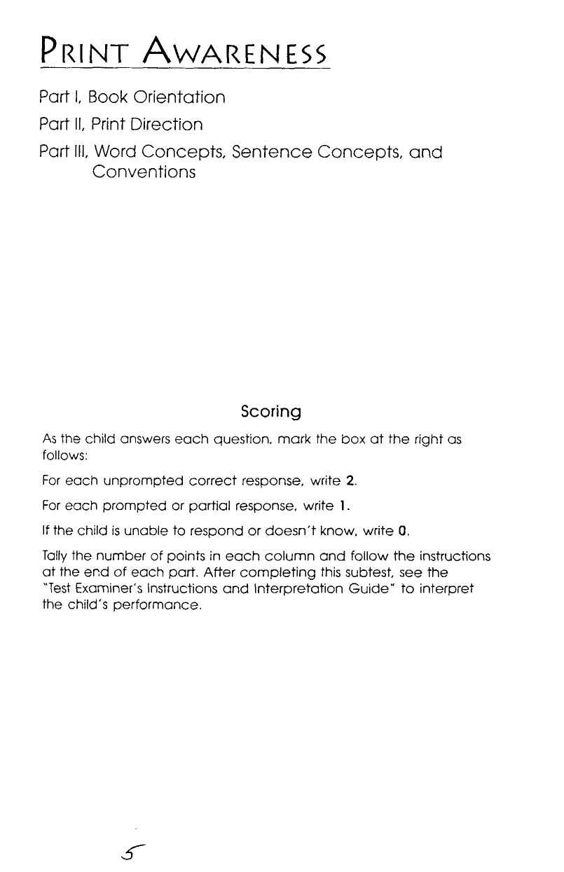

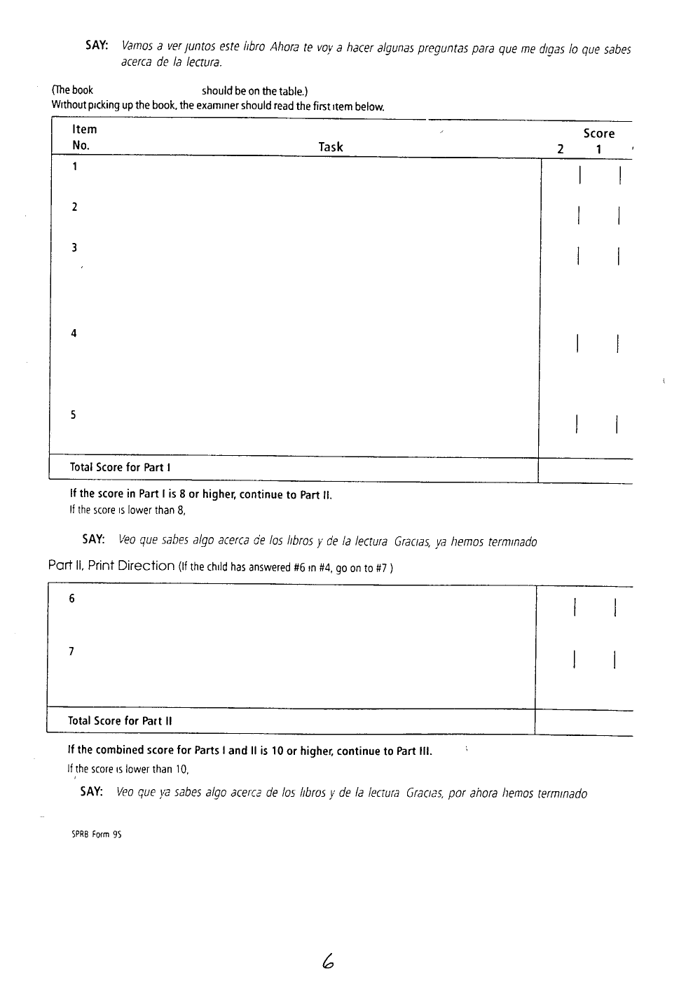

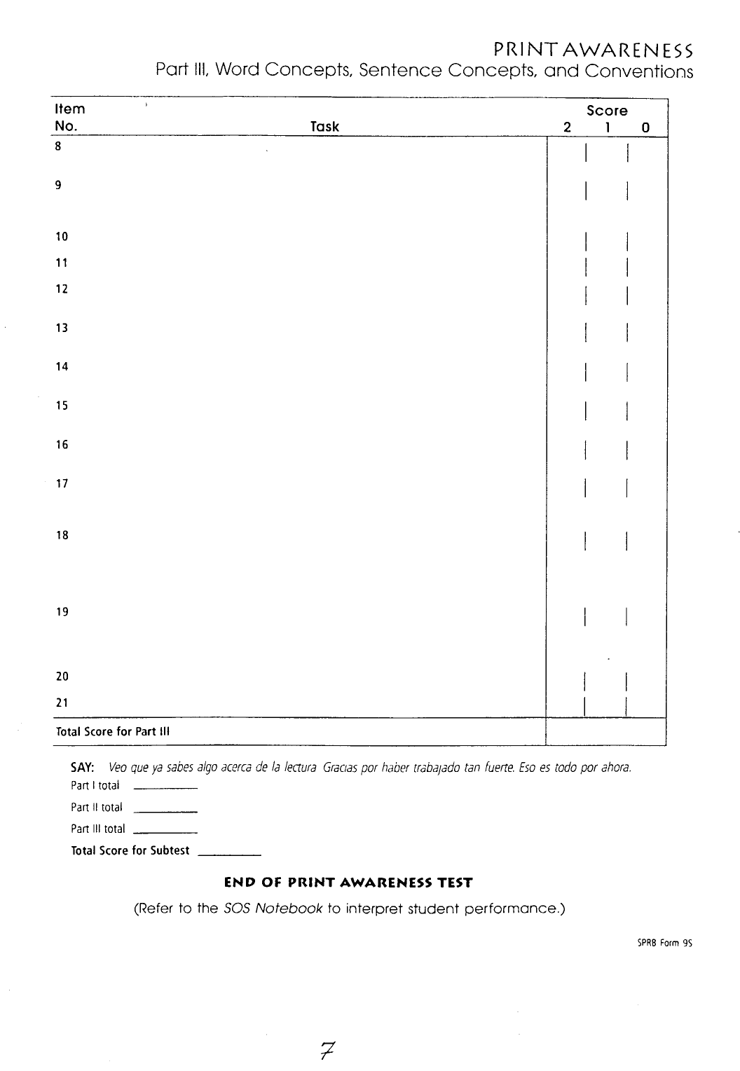

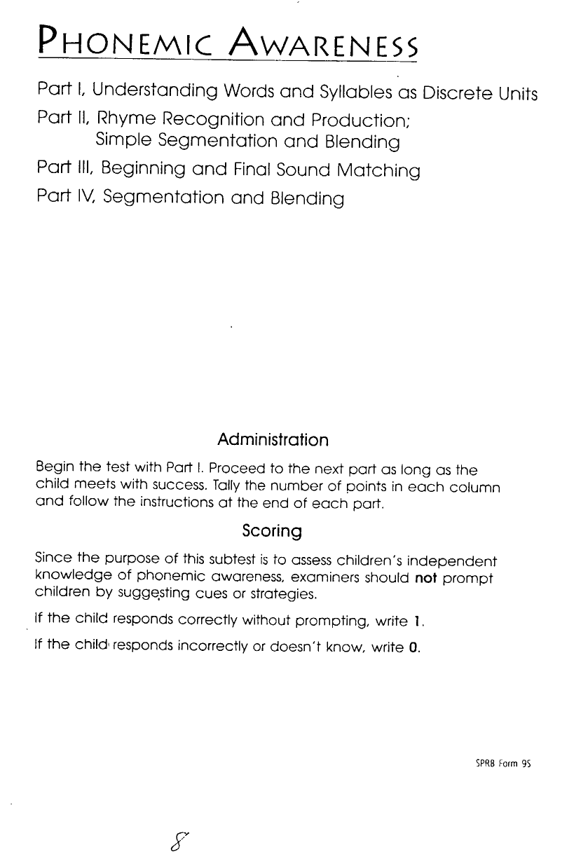

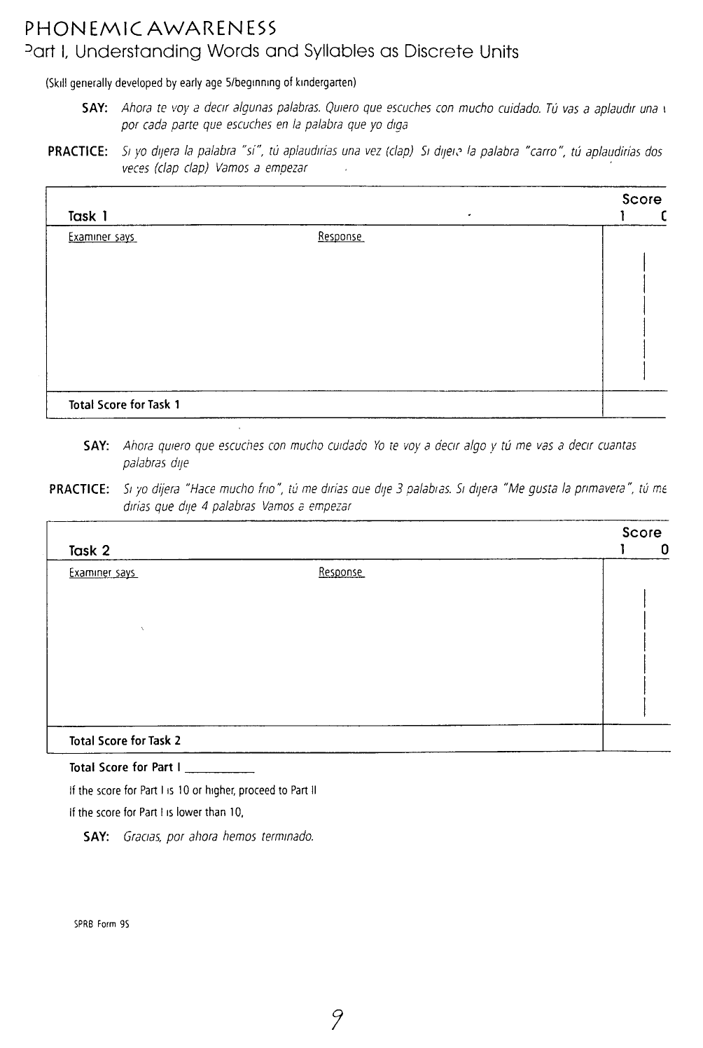

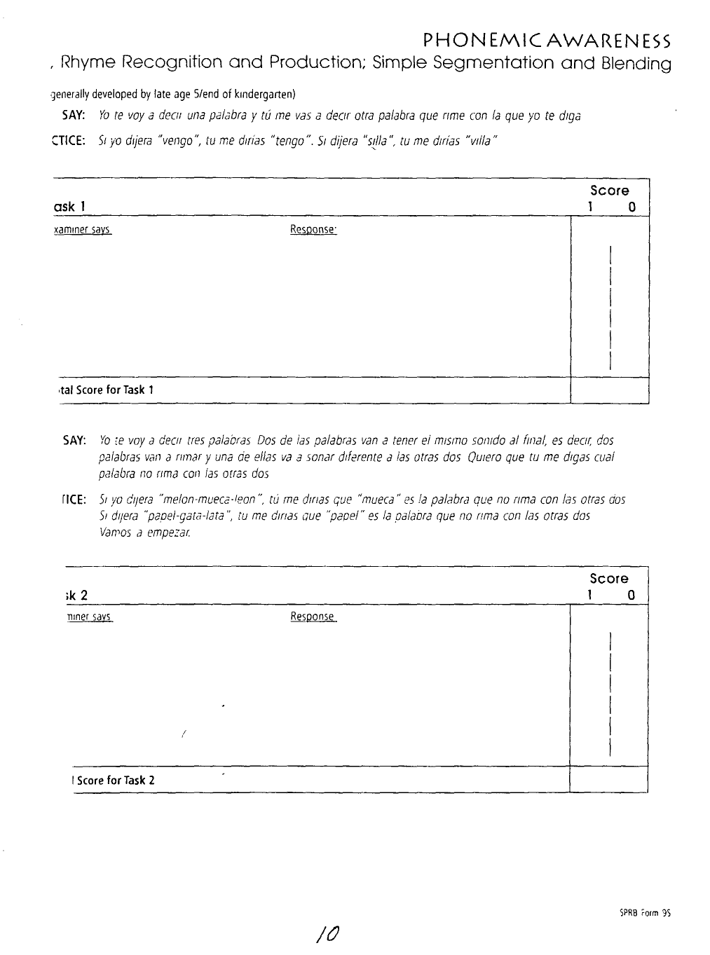

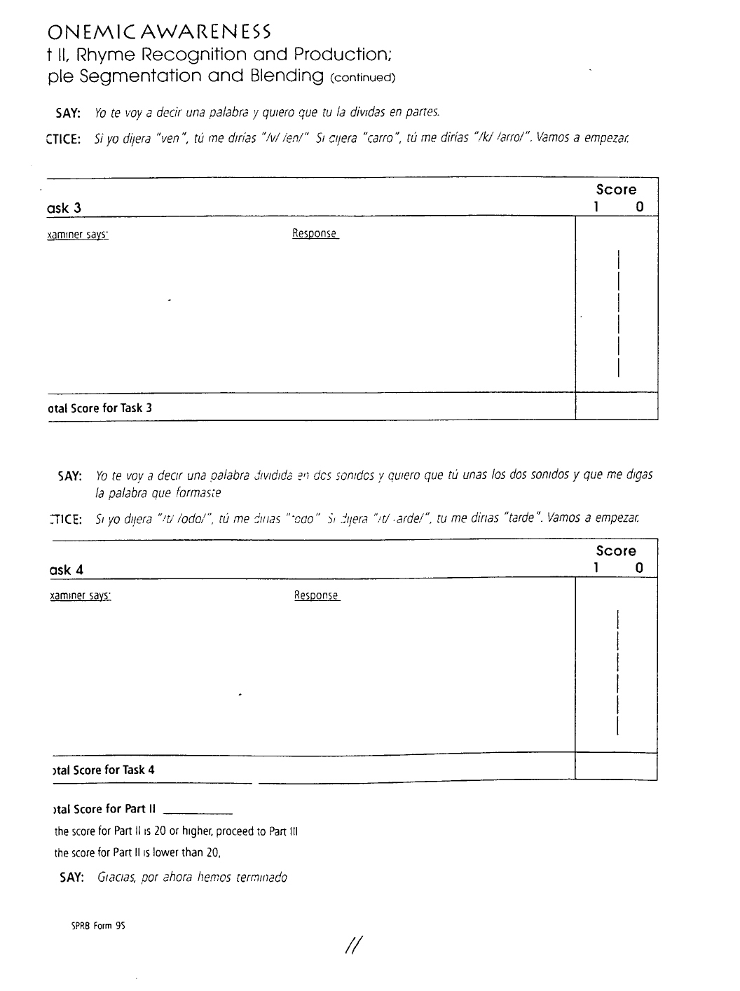

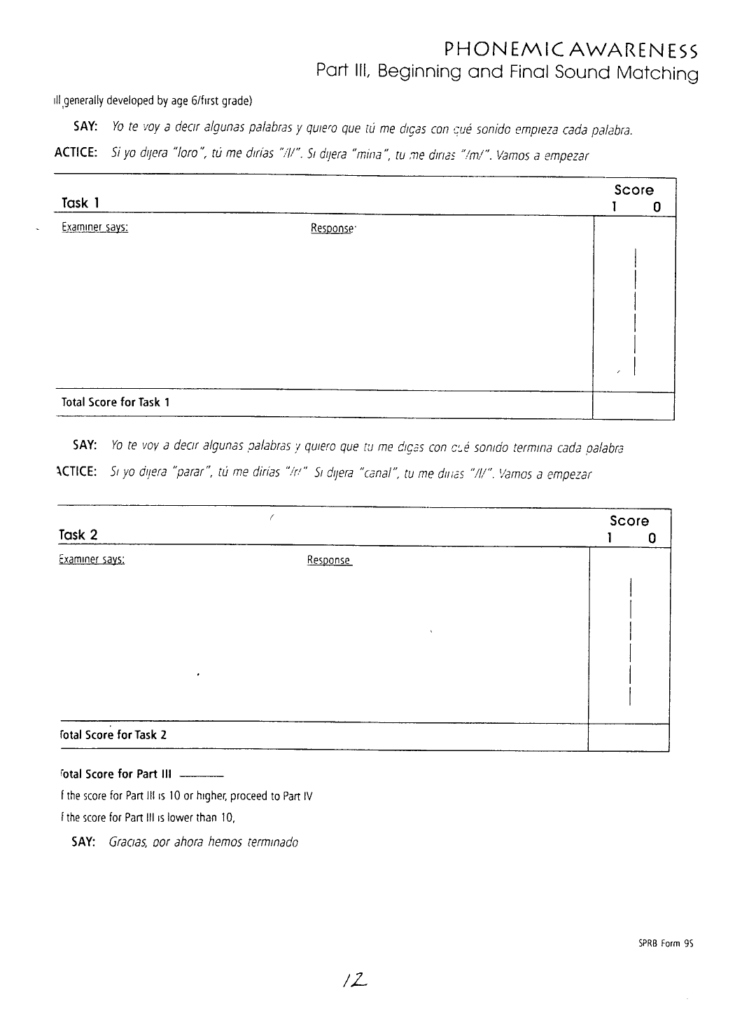

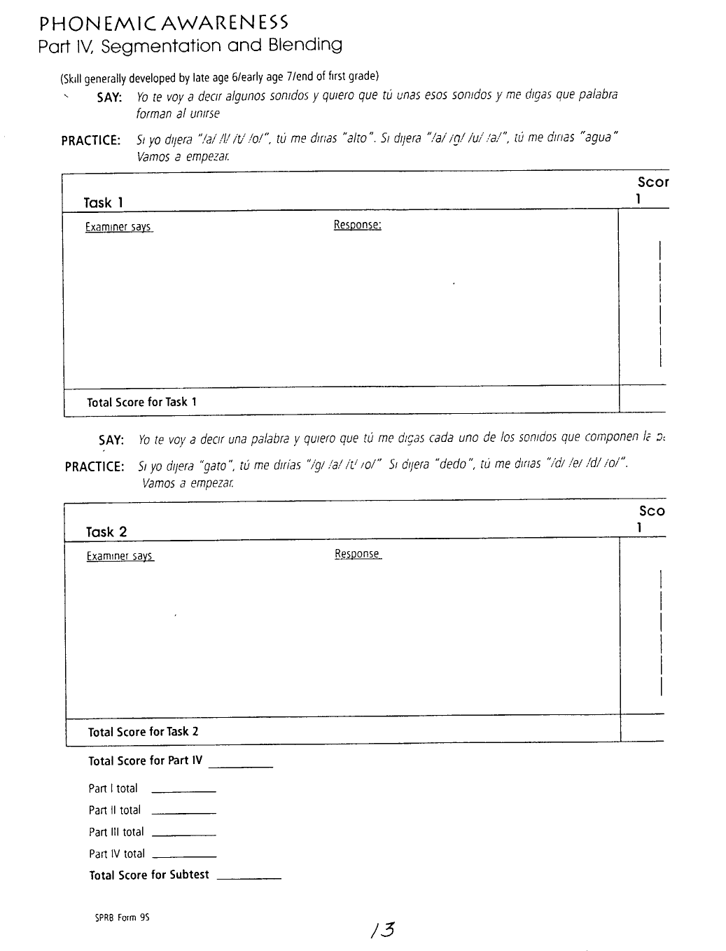

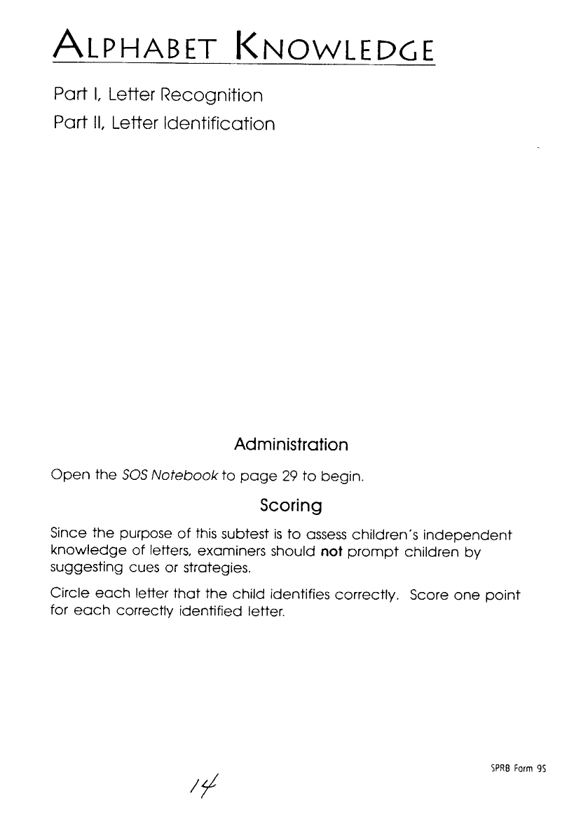

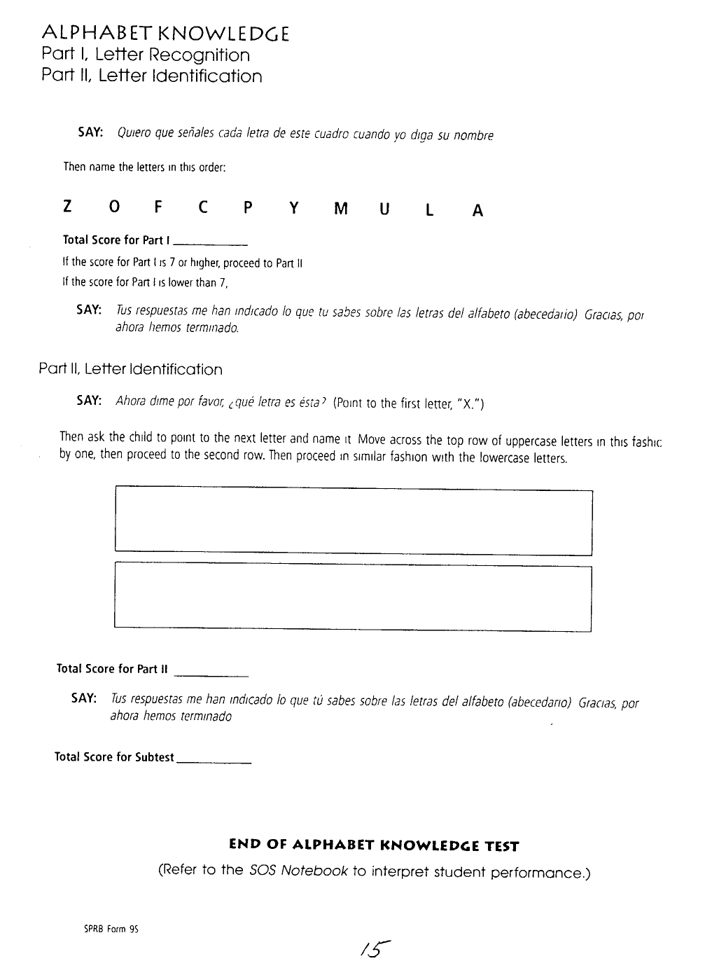

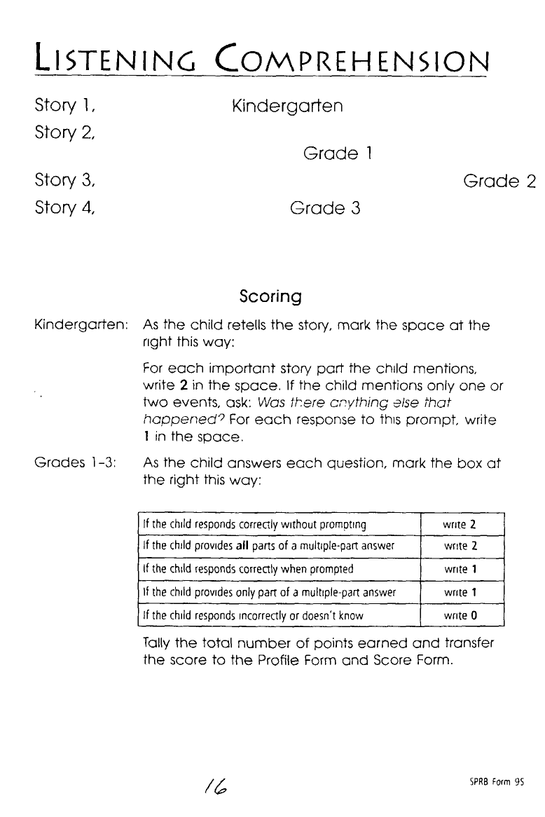

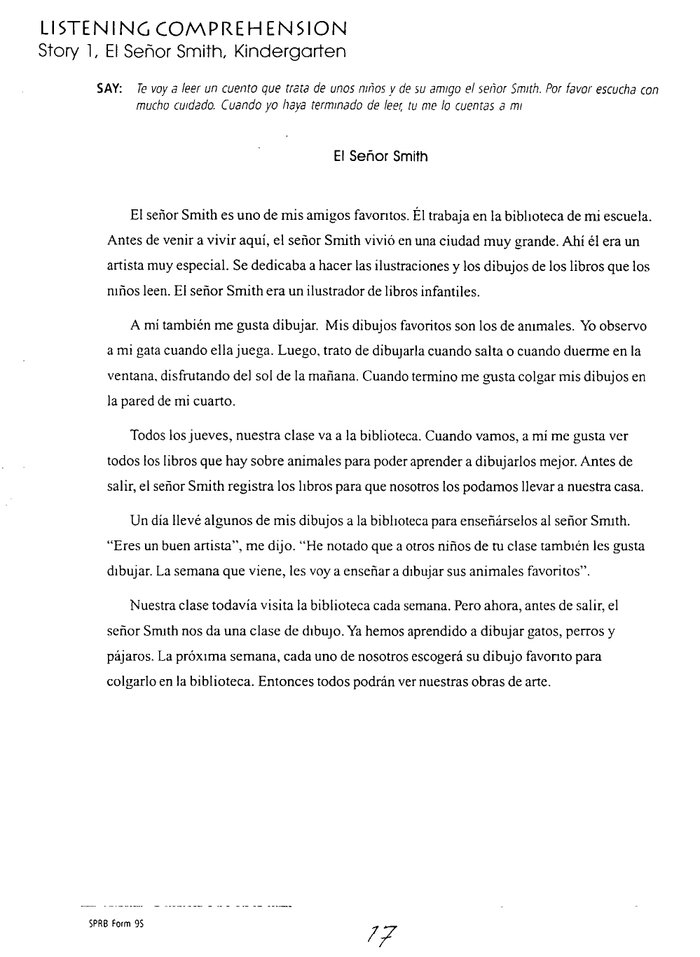

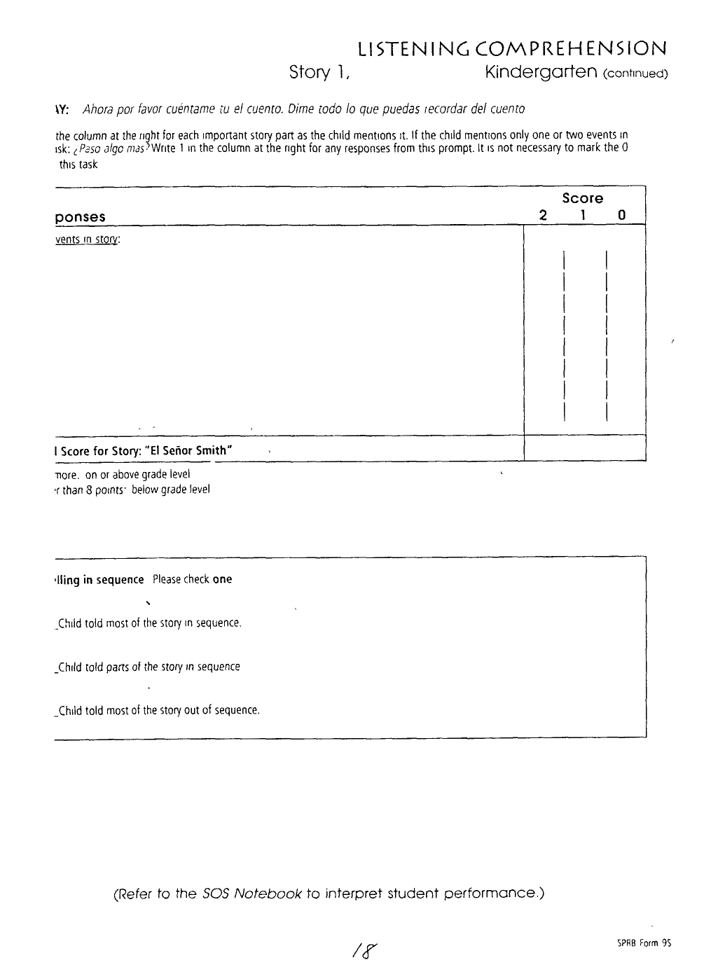

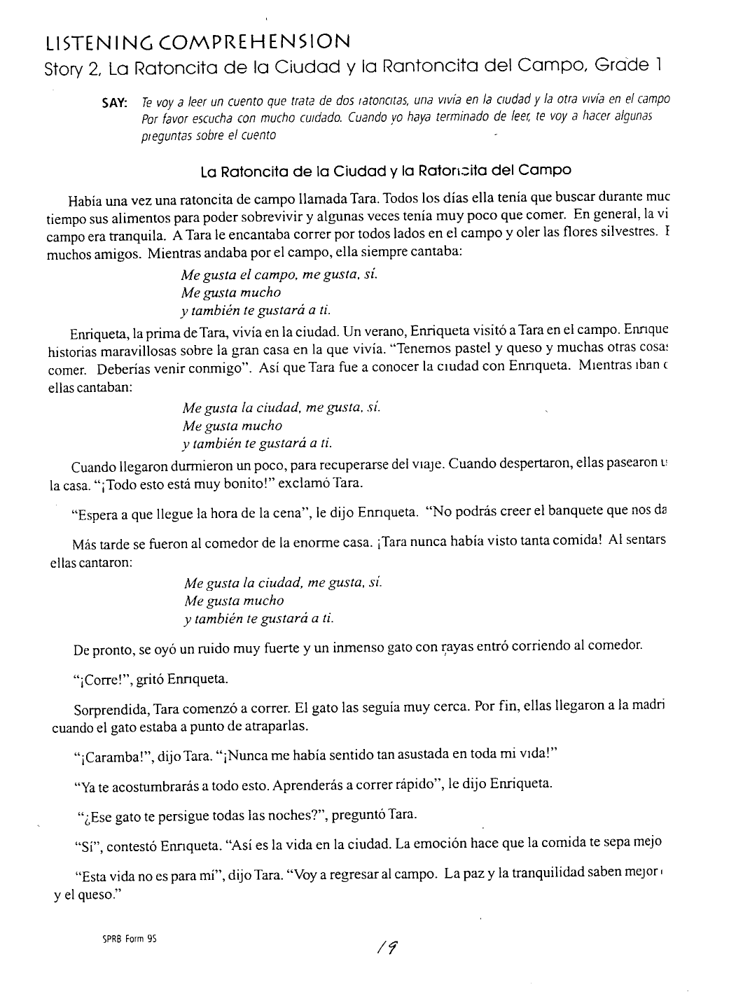

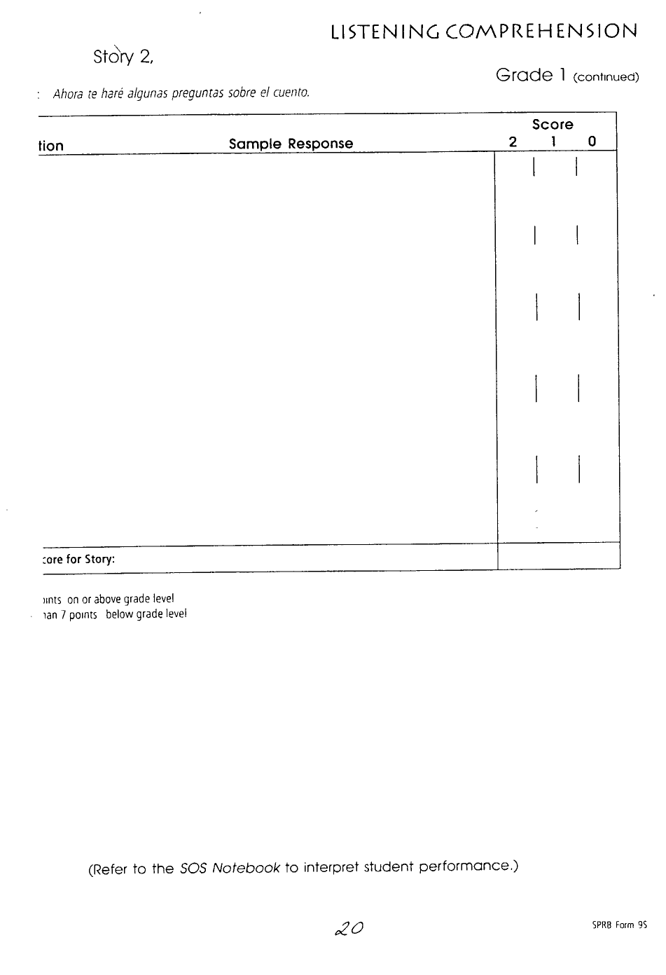

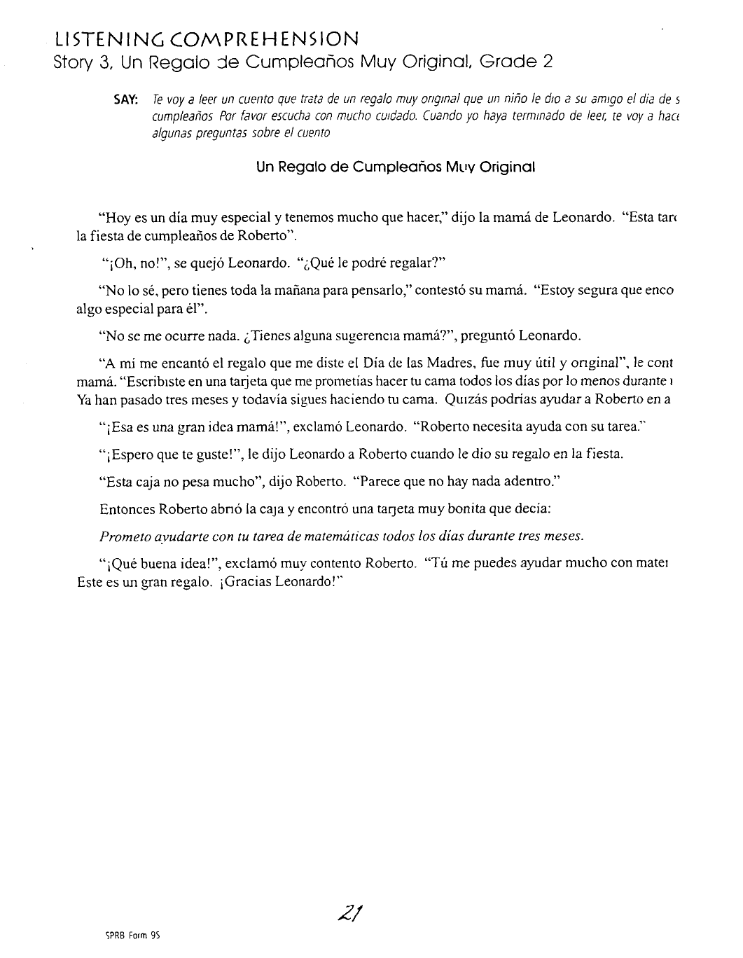

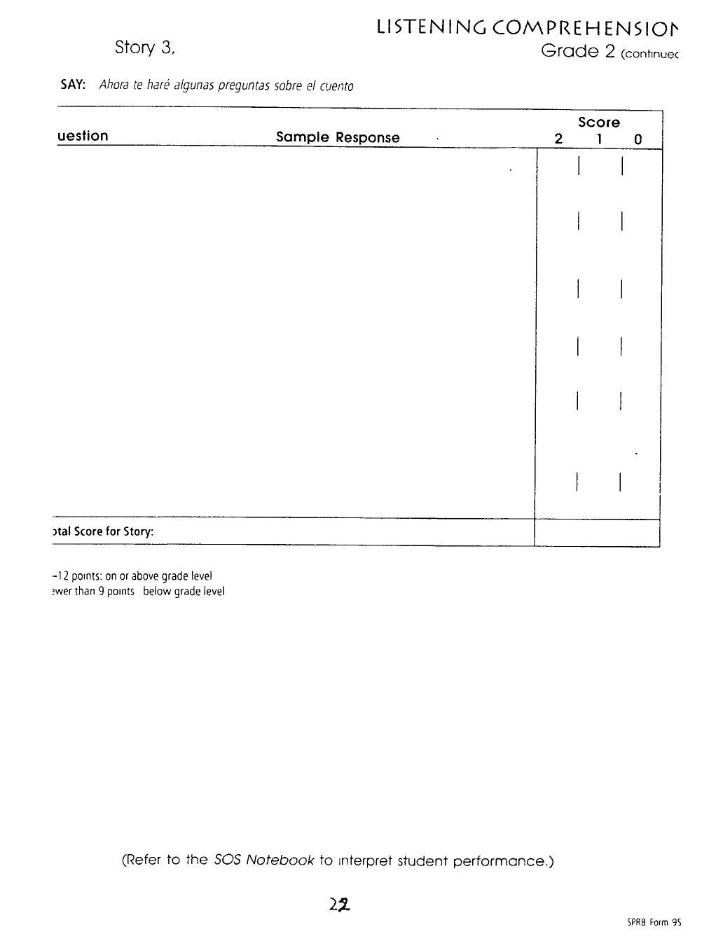

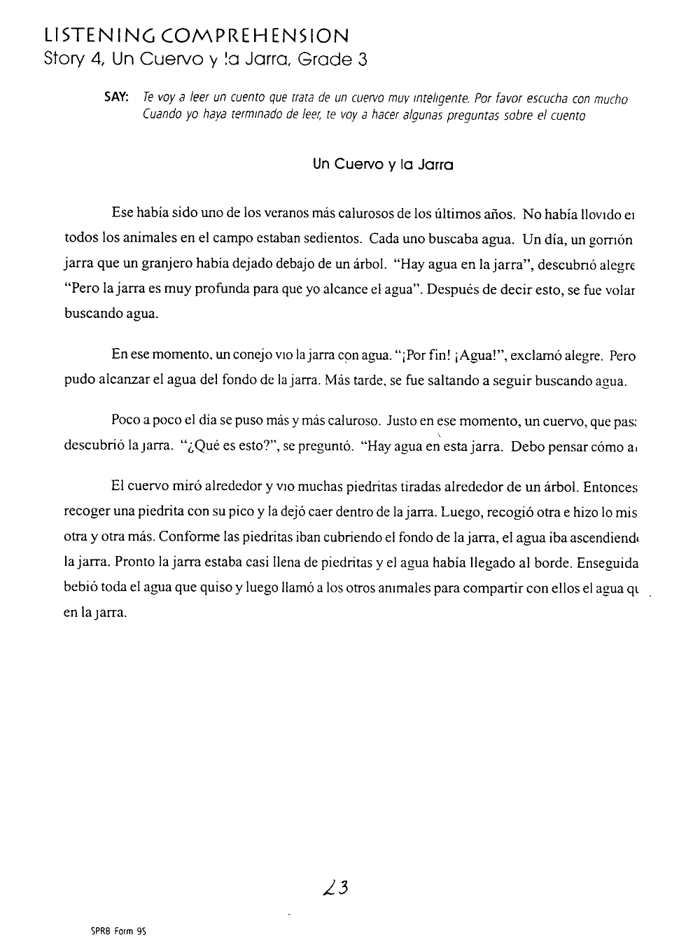

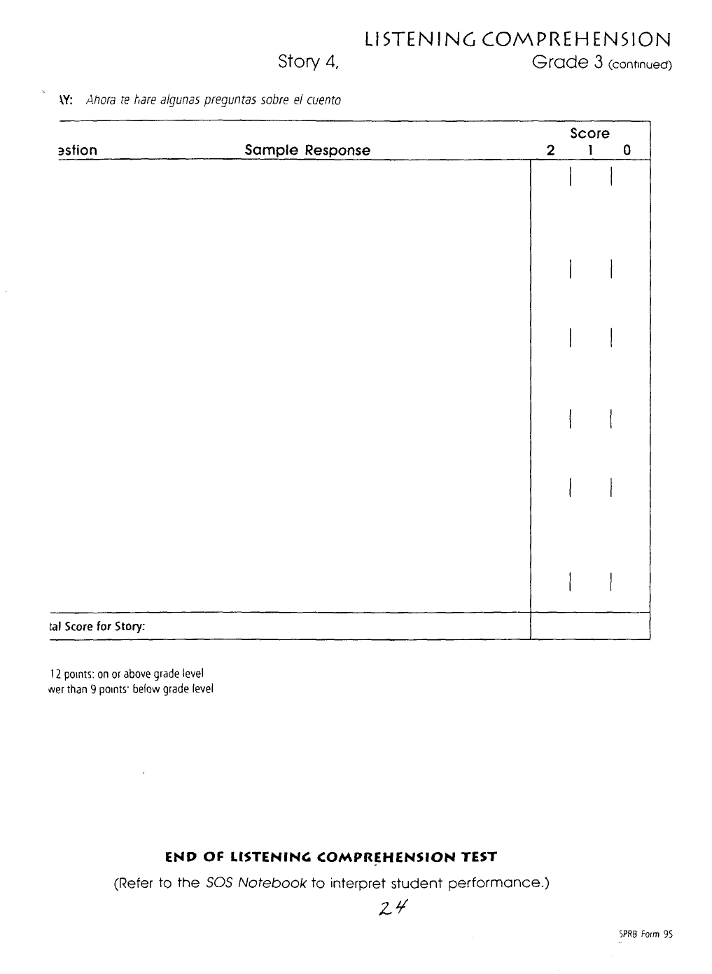

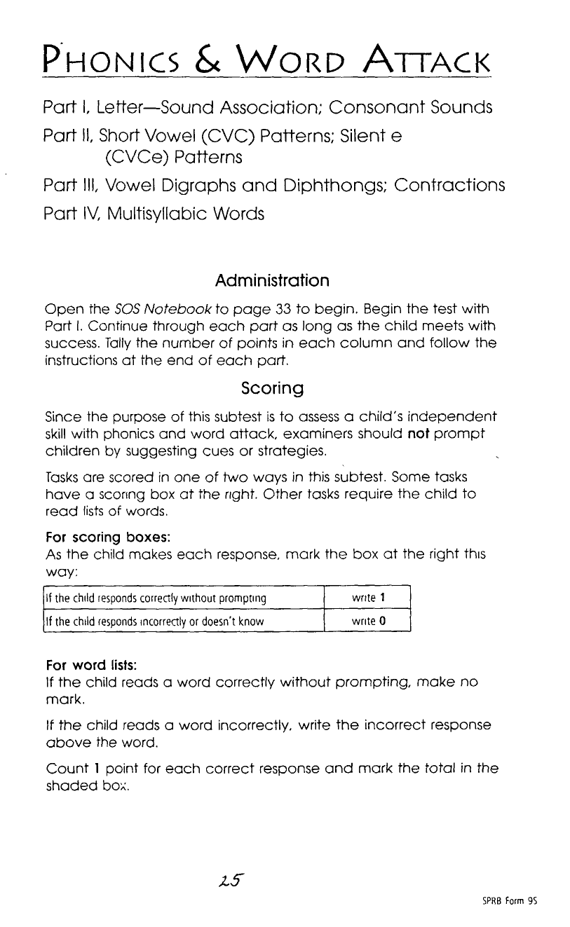

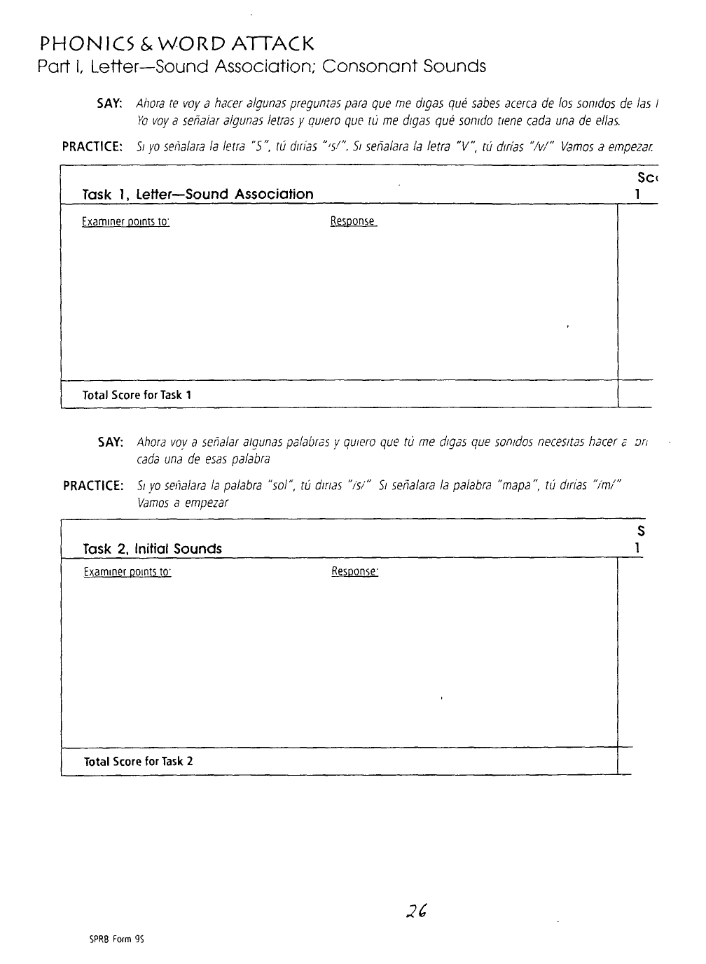

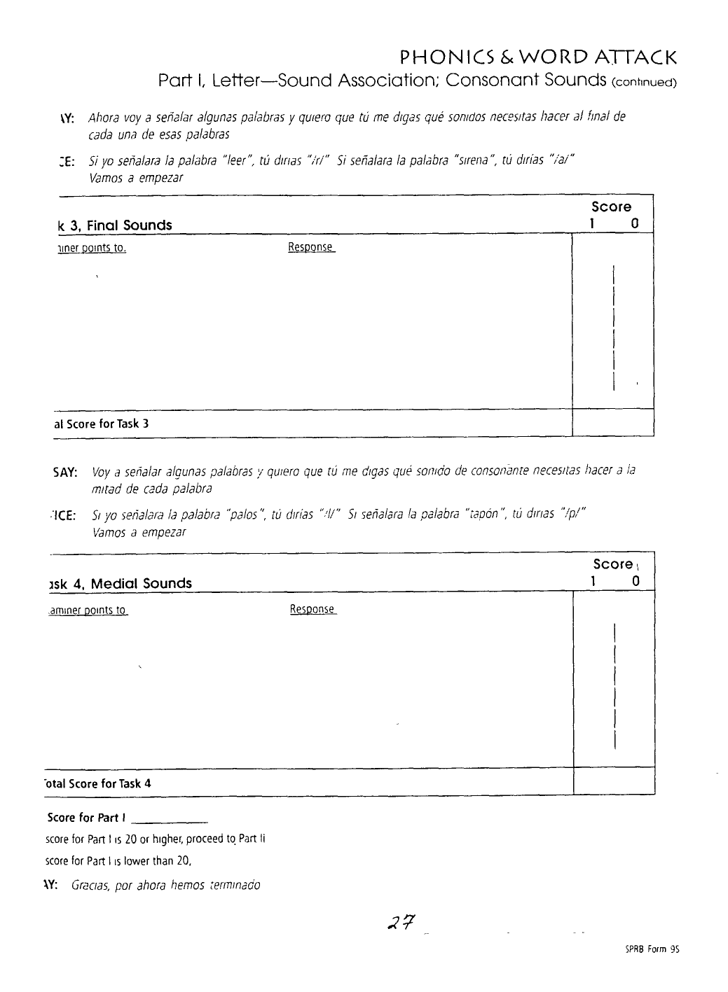

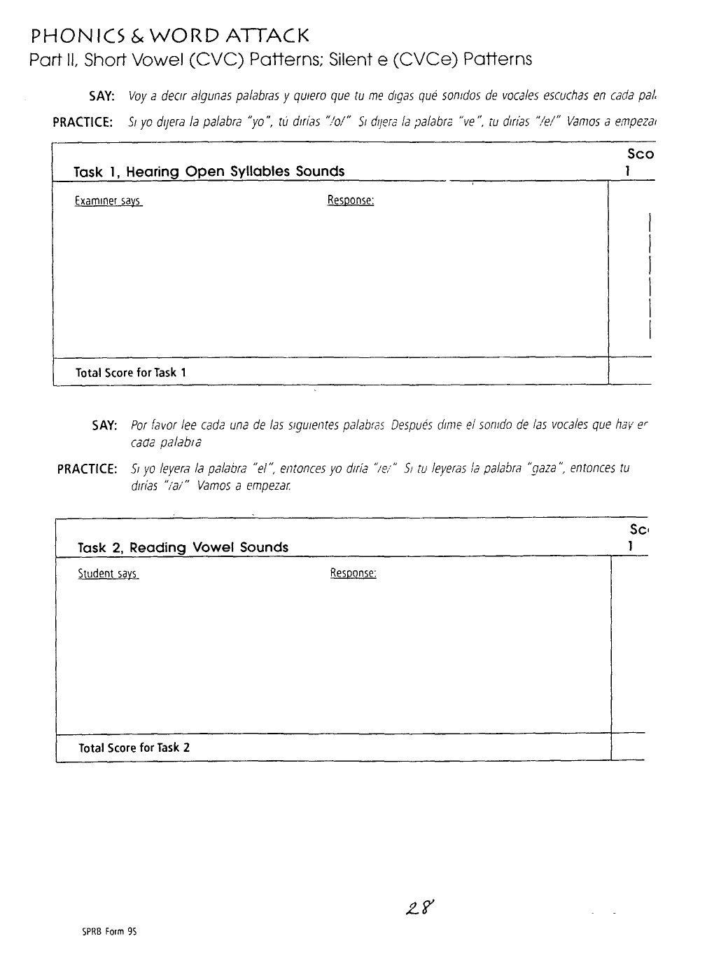

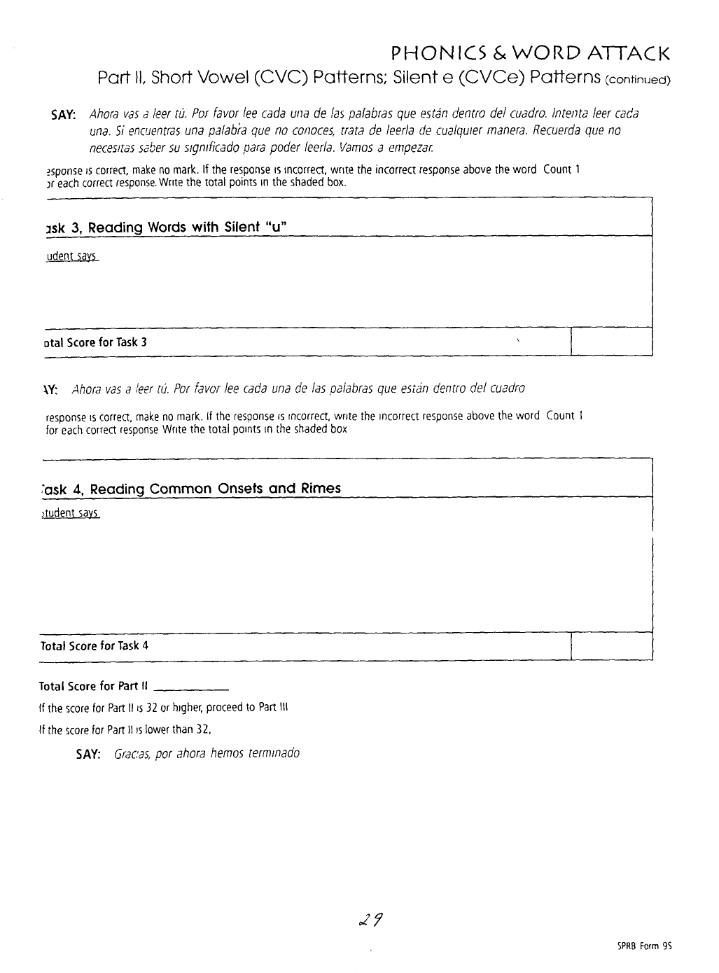

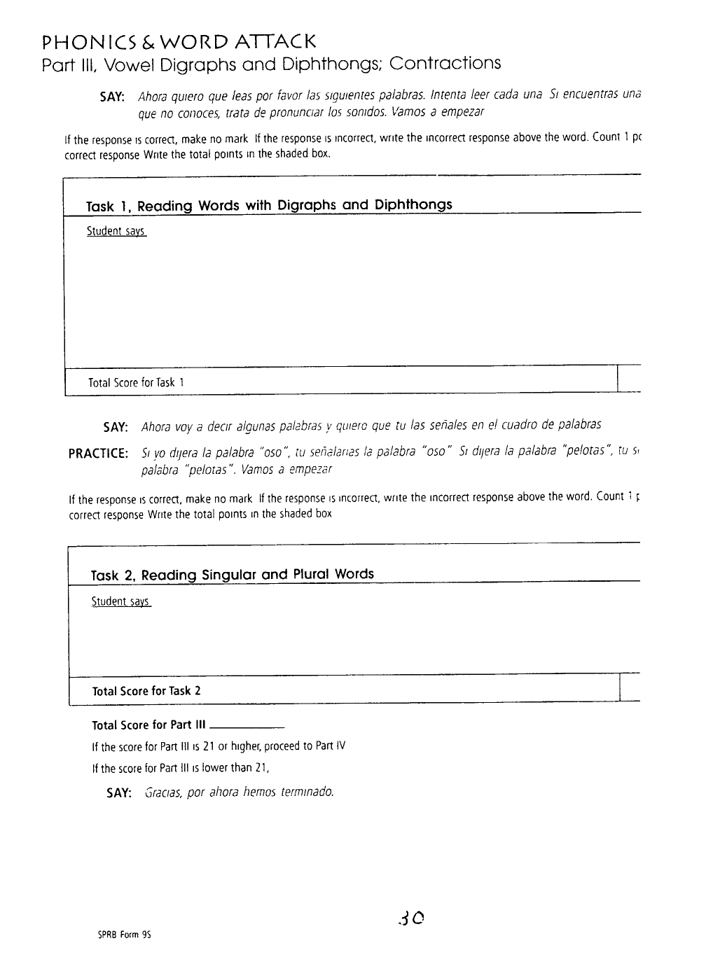

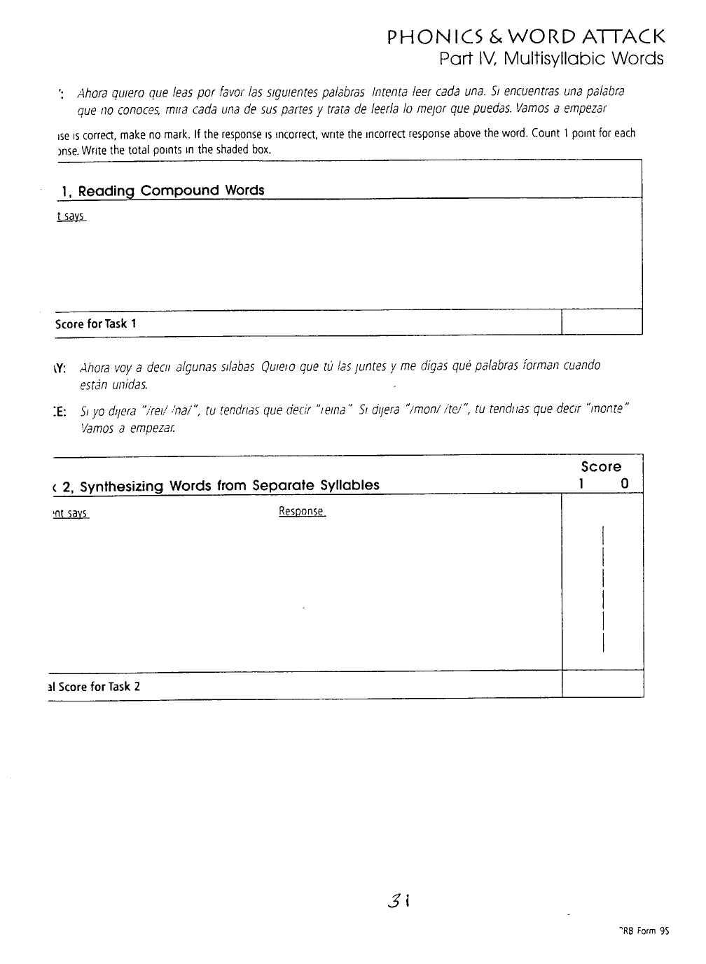

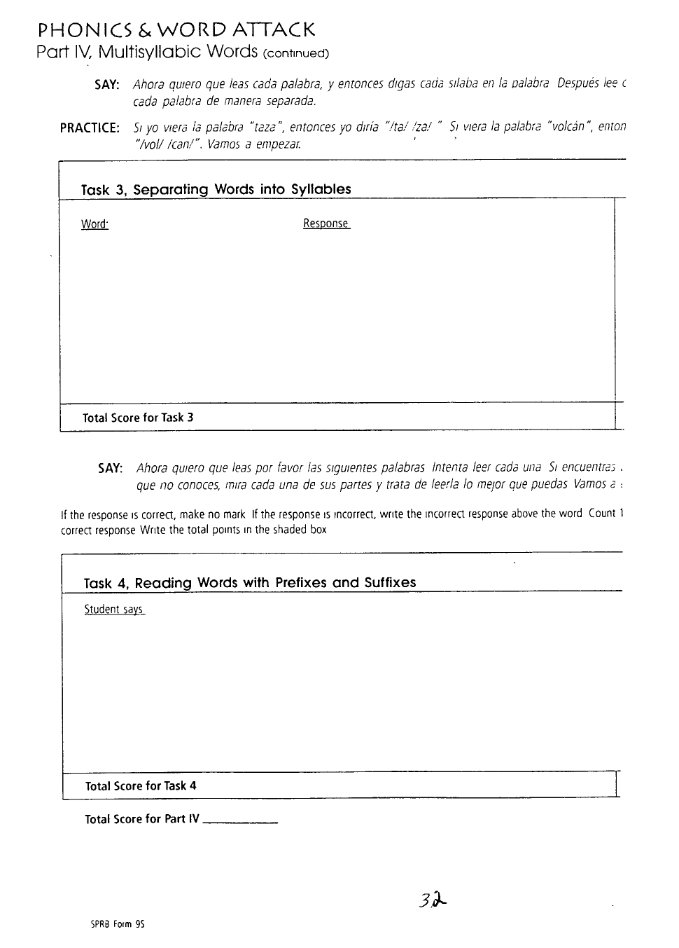

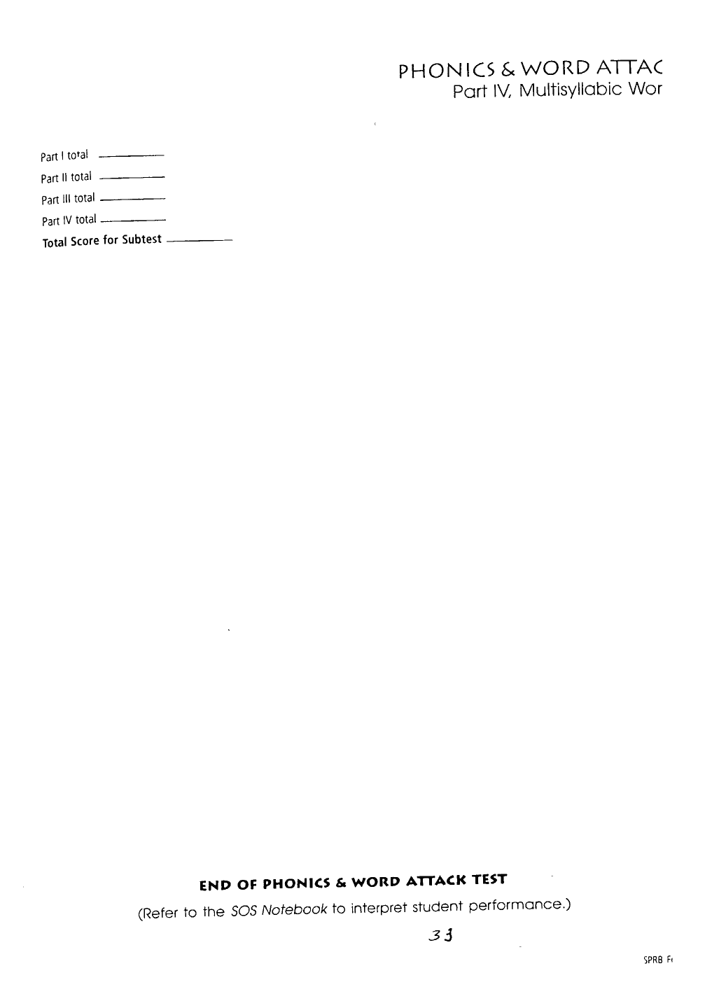

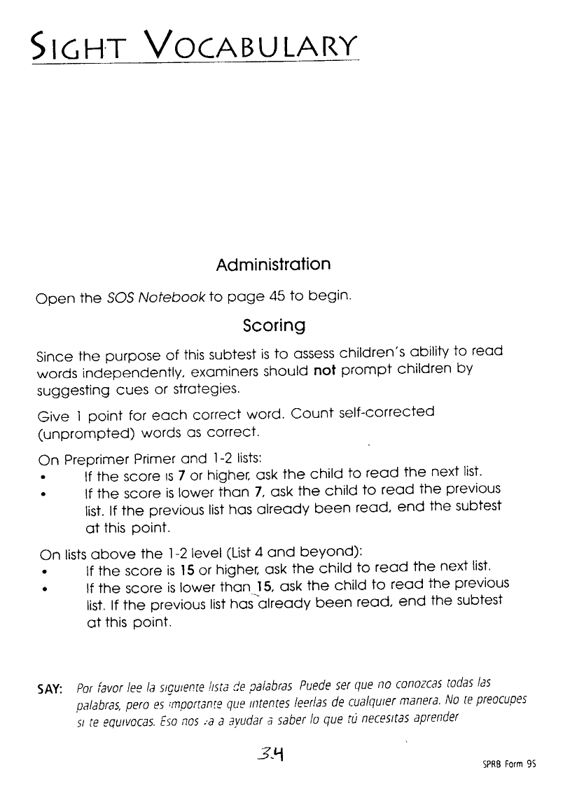

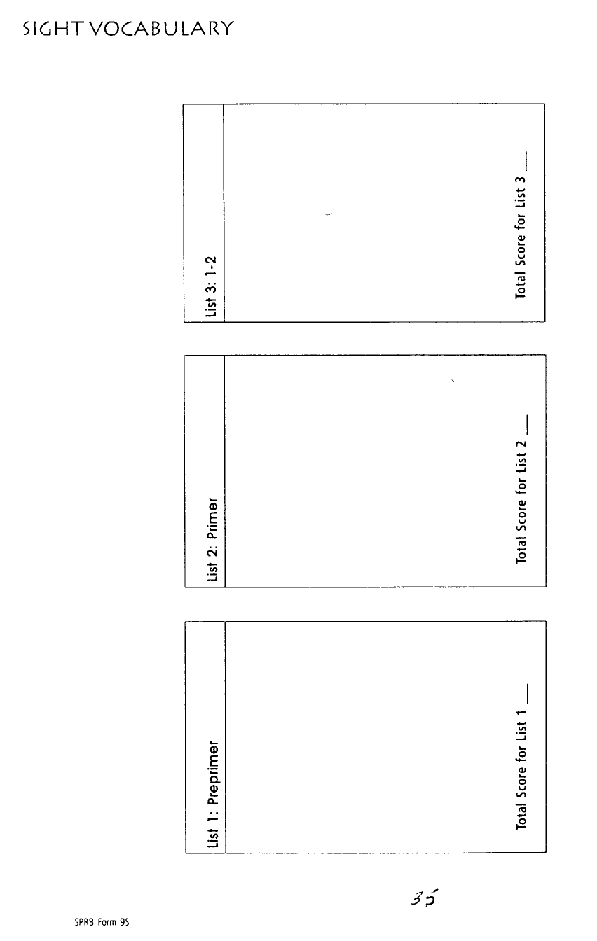

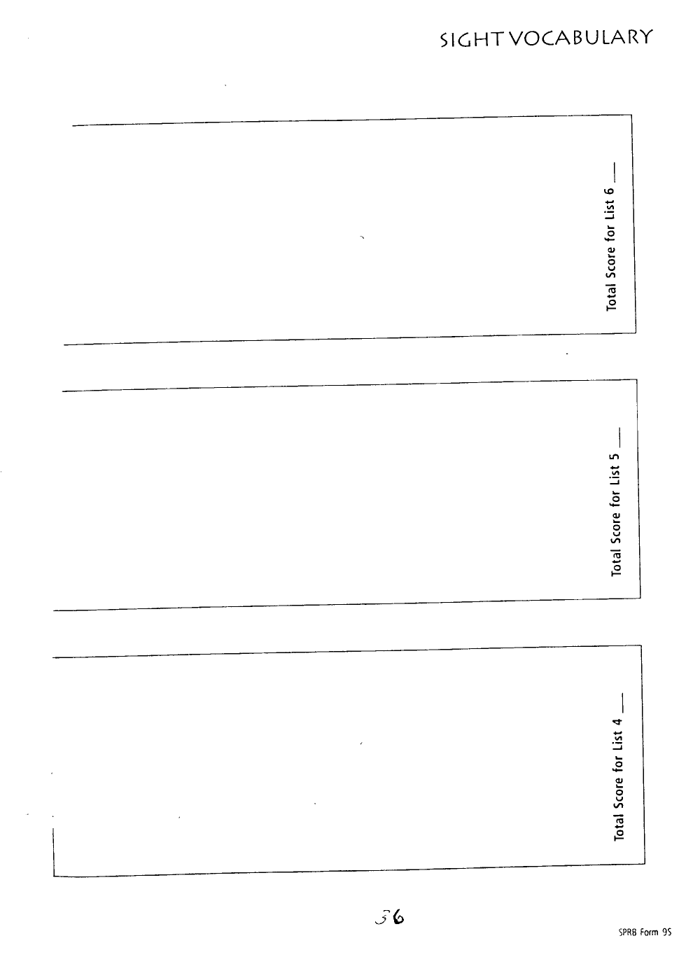

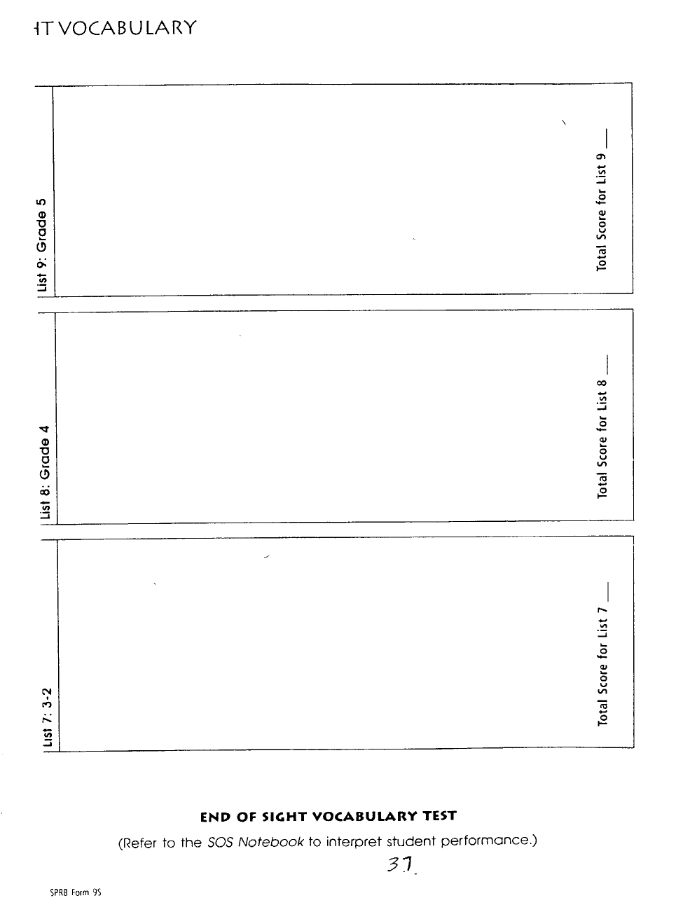

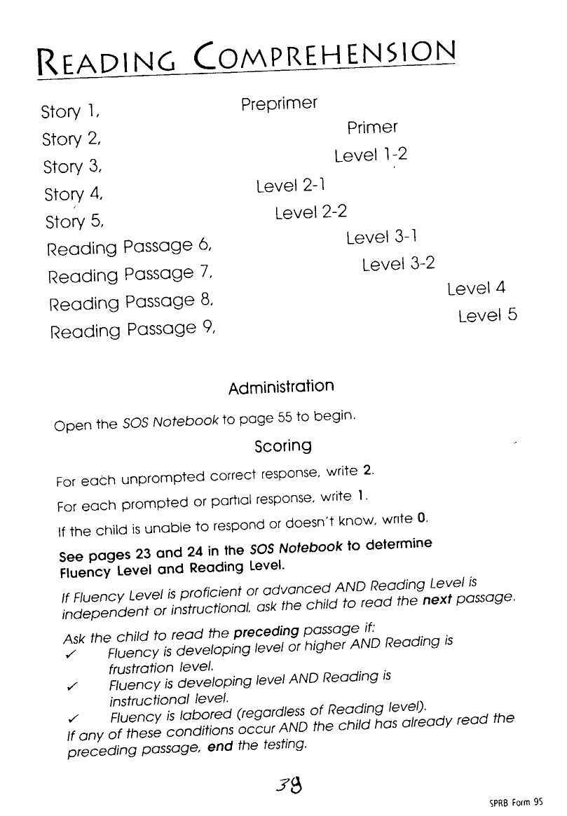

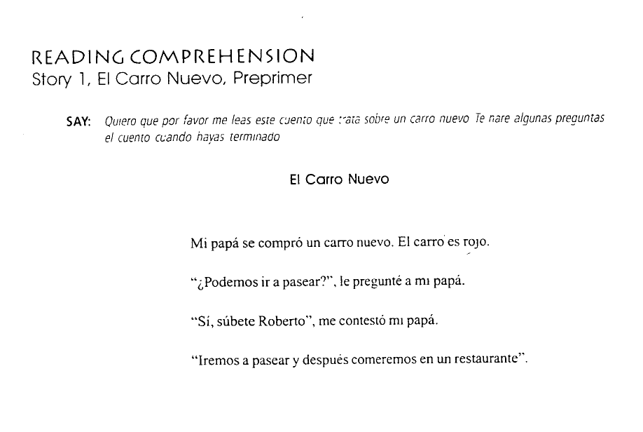

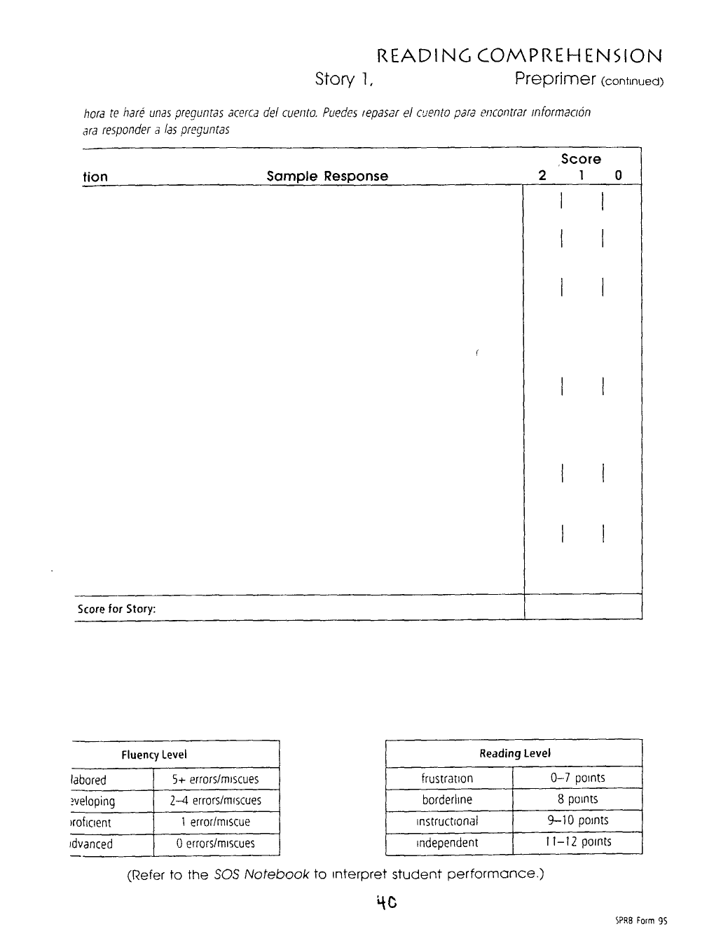

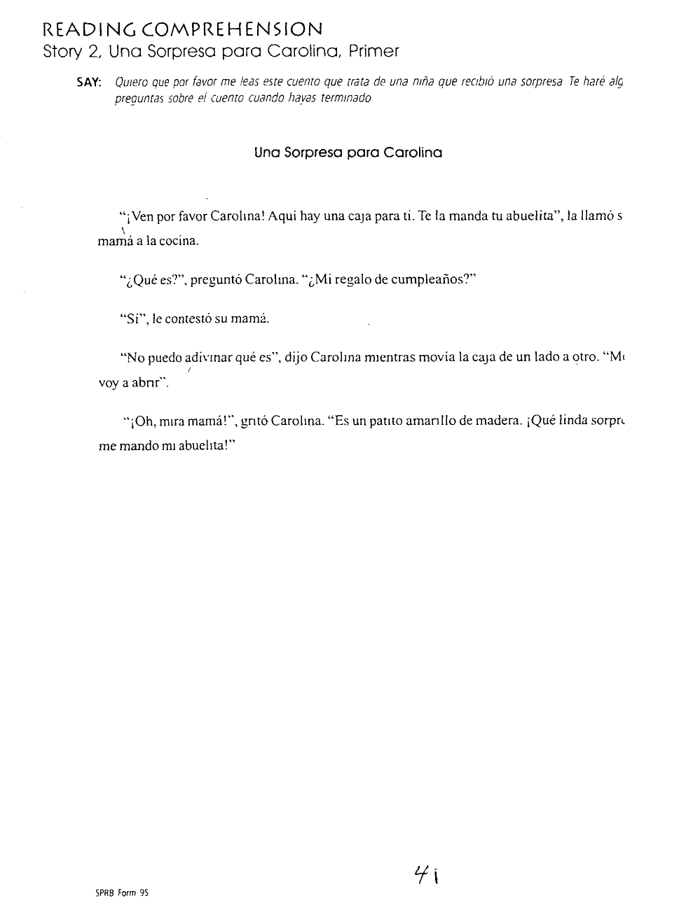

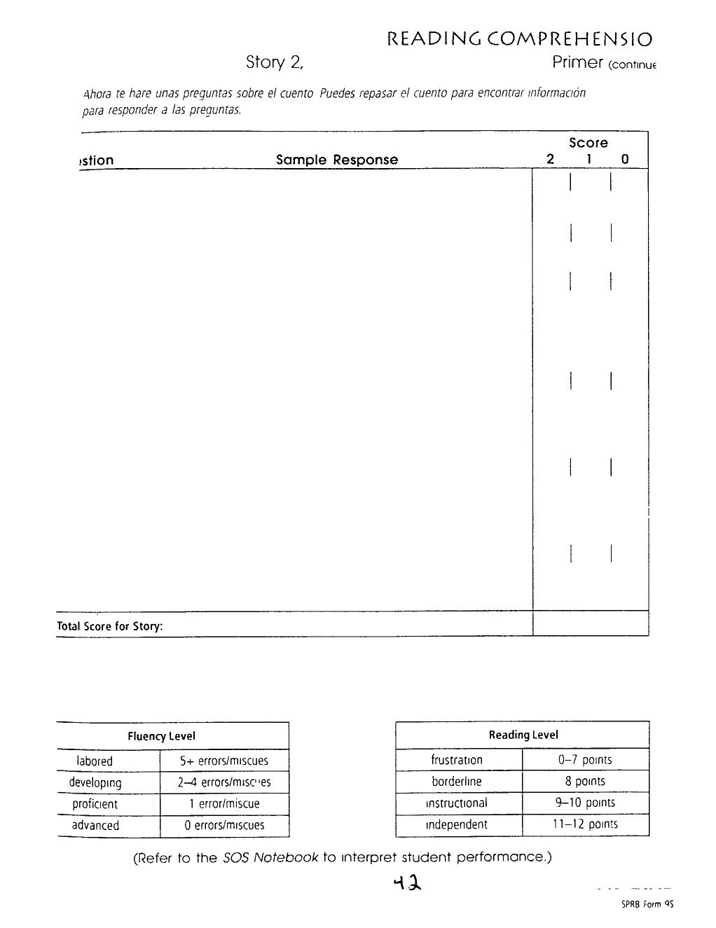

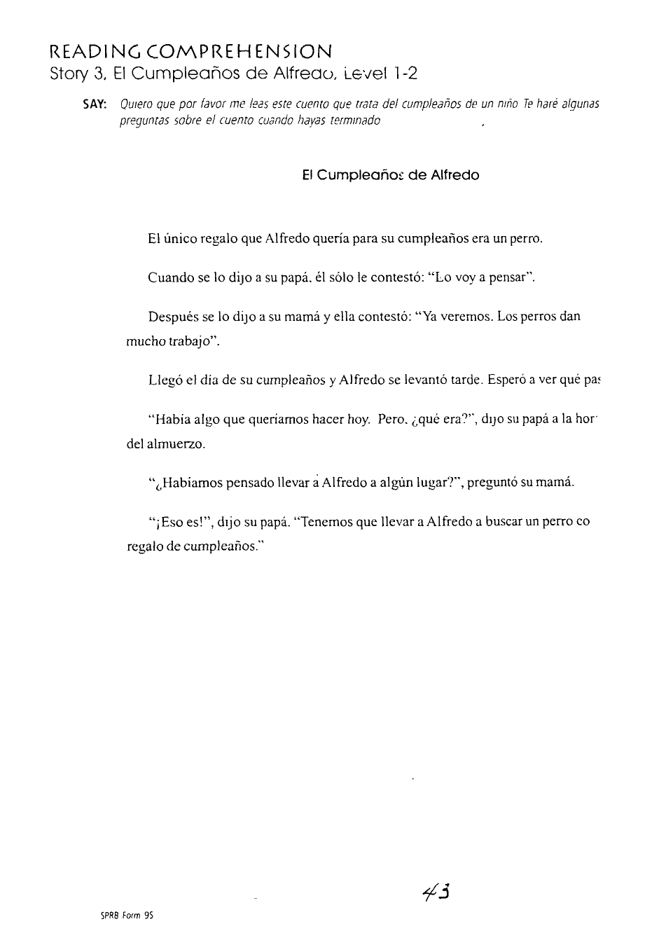

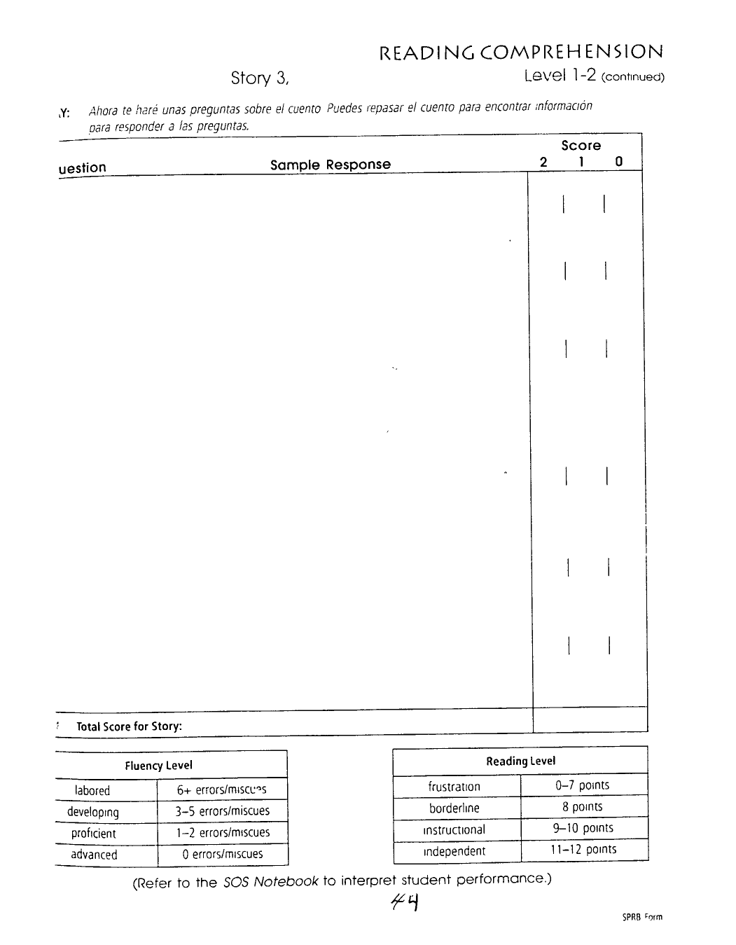

FIG. 1 illustrates a method of designing an assessment in accordance with one embodiment of the present invention. FIG. 2 illustrates a method of administering an assessment in accordance with one embodiment of the present invention. FIG. 3 illustrates a method of processing and using the results of an assessment in accordance with one embodiment of the present invention.

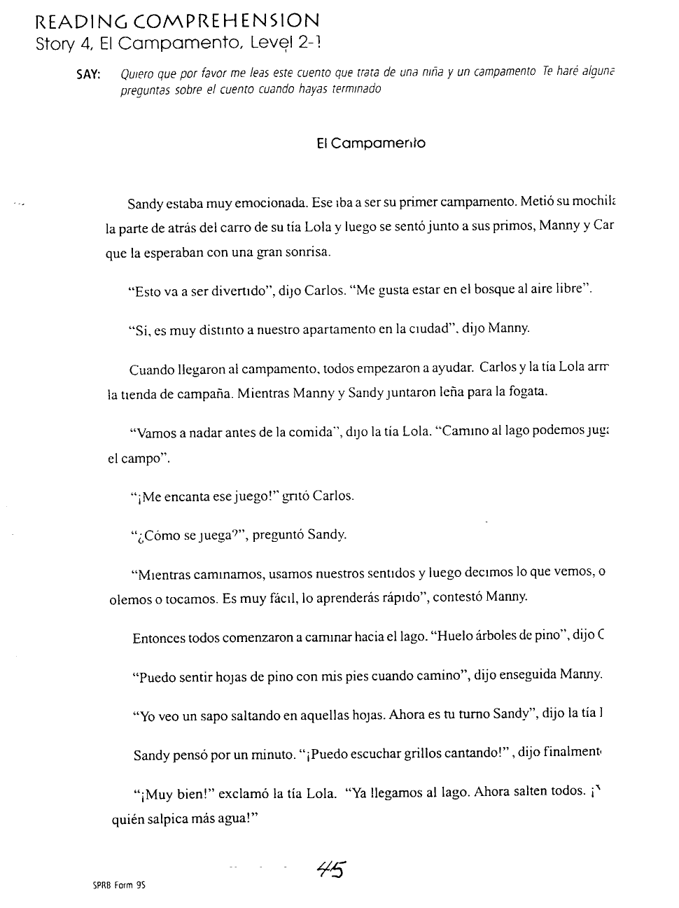

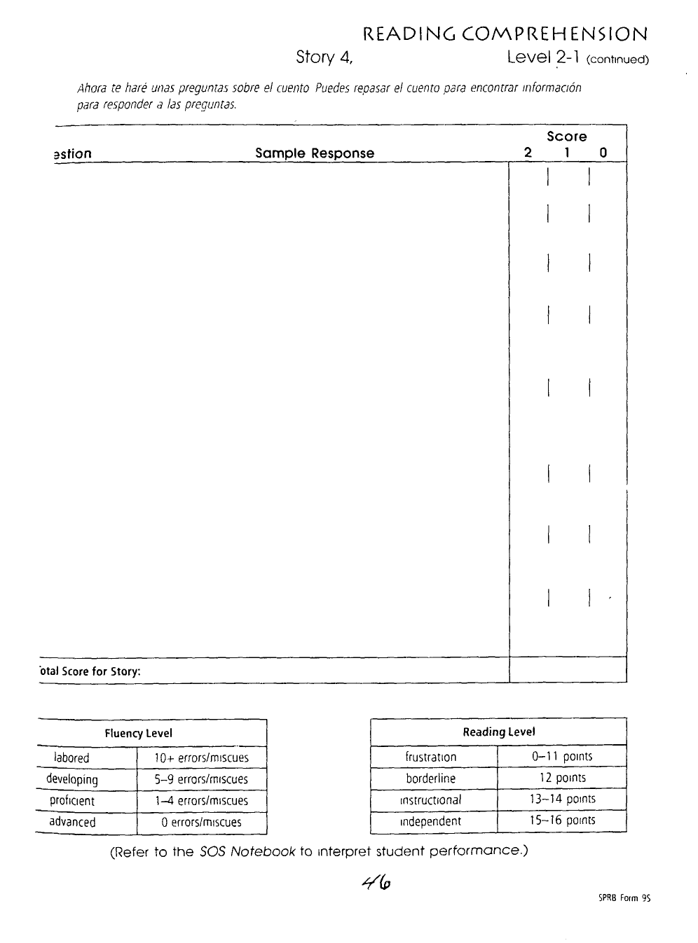

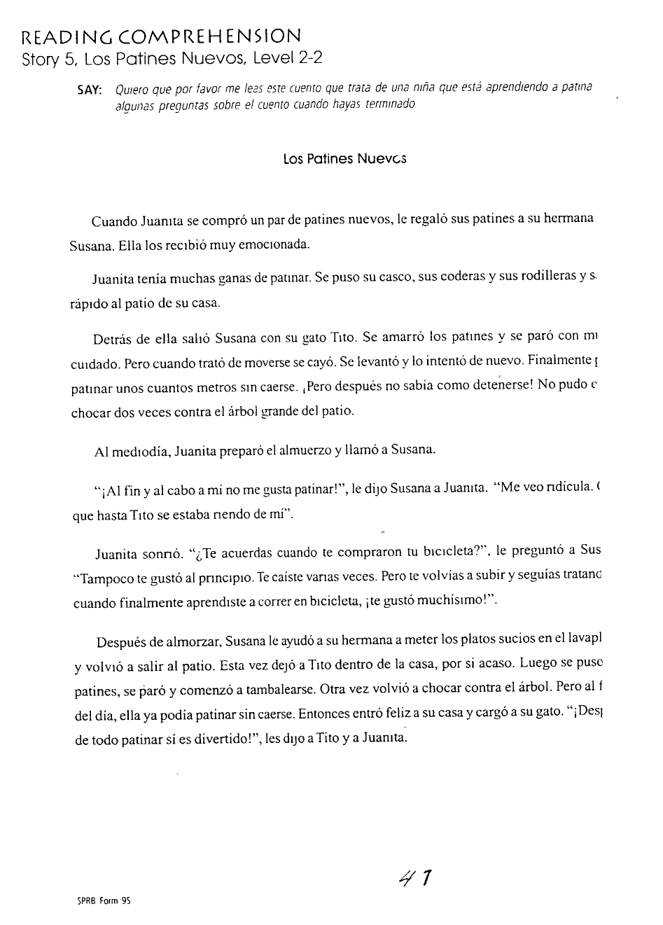

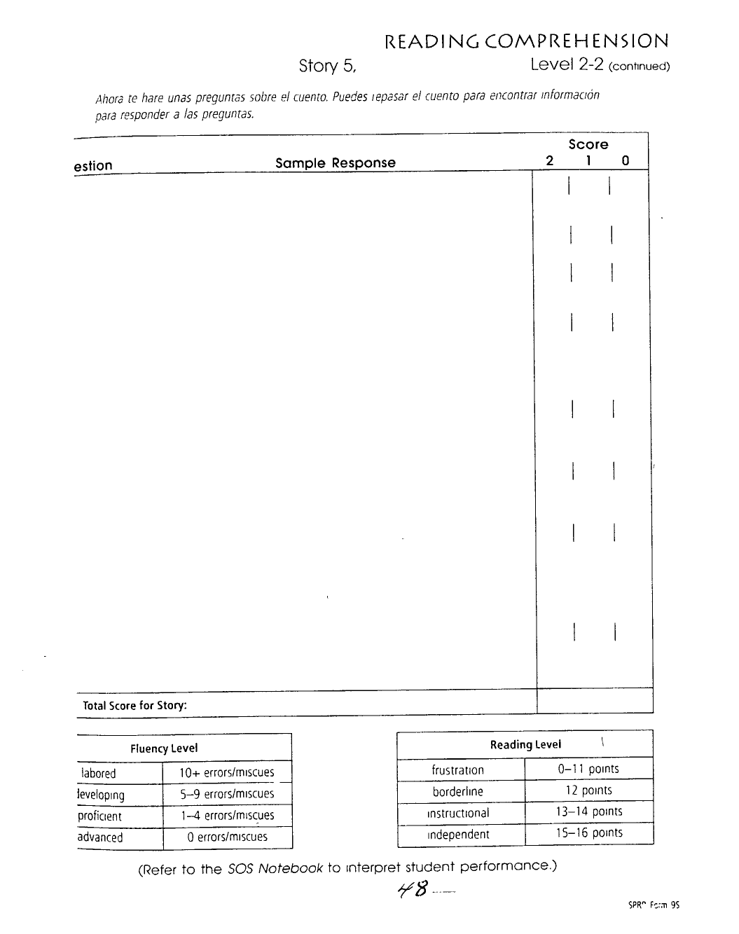

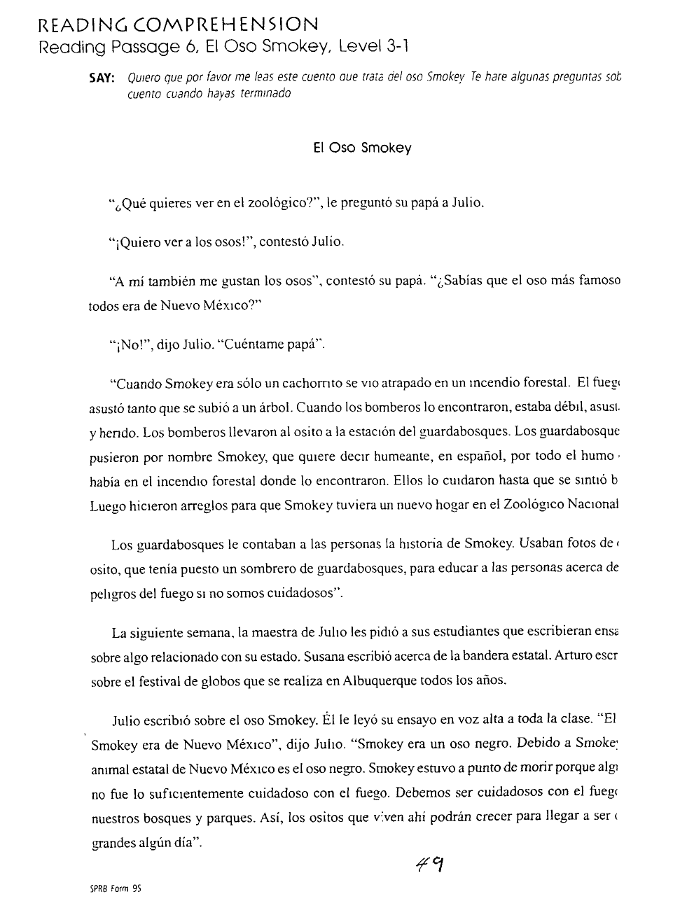

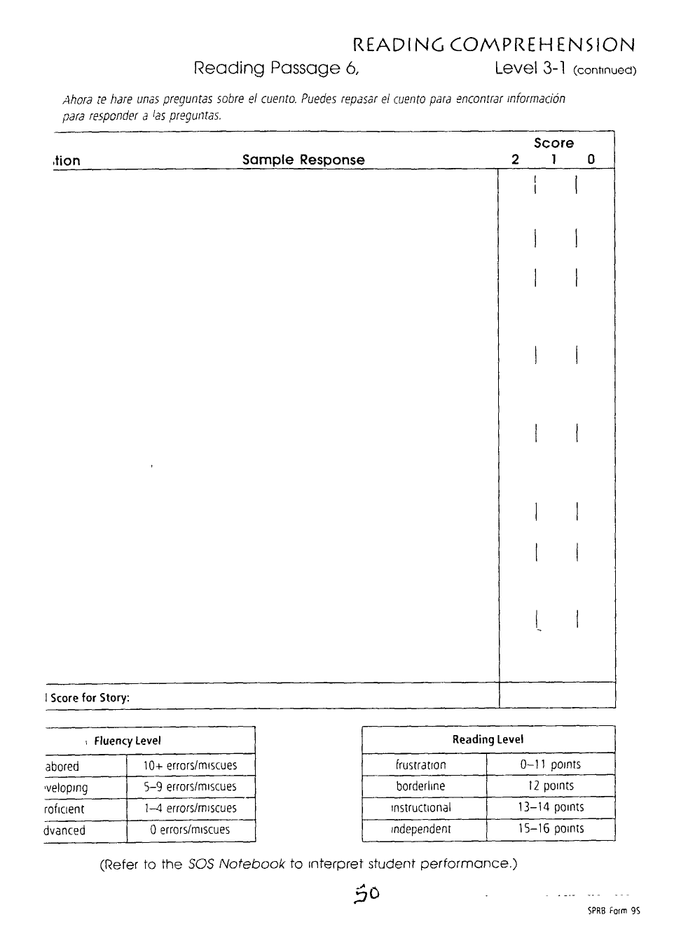

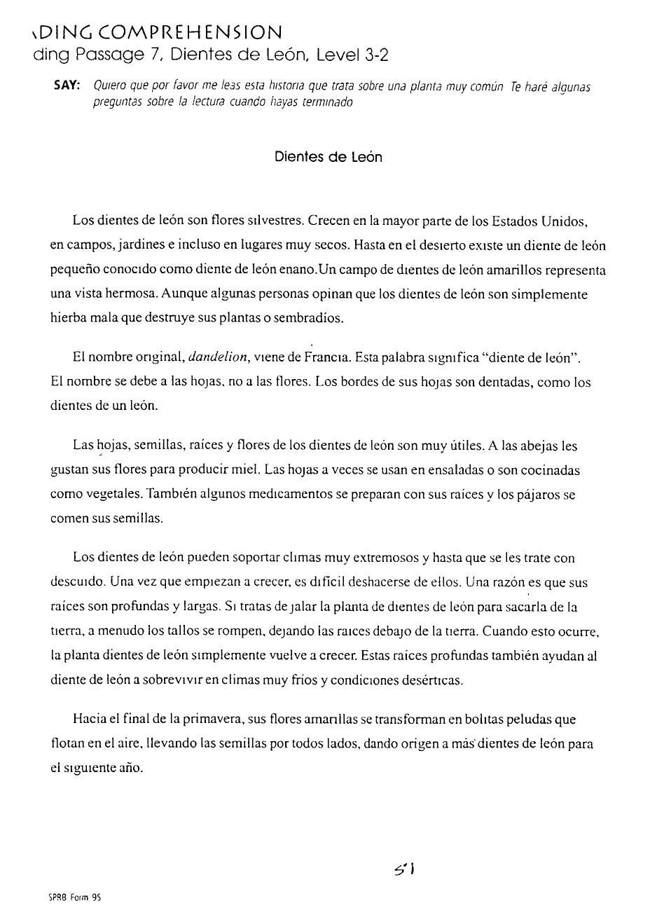

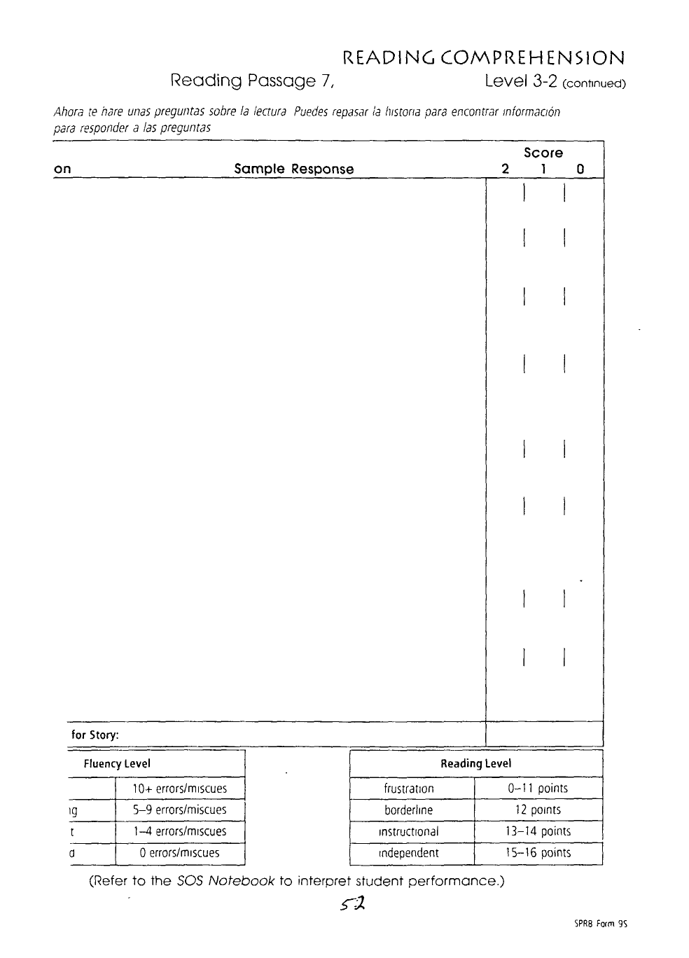

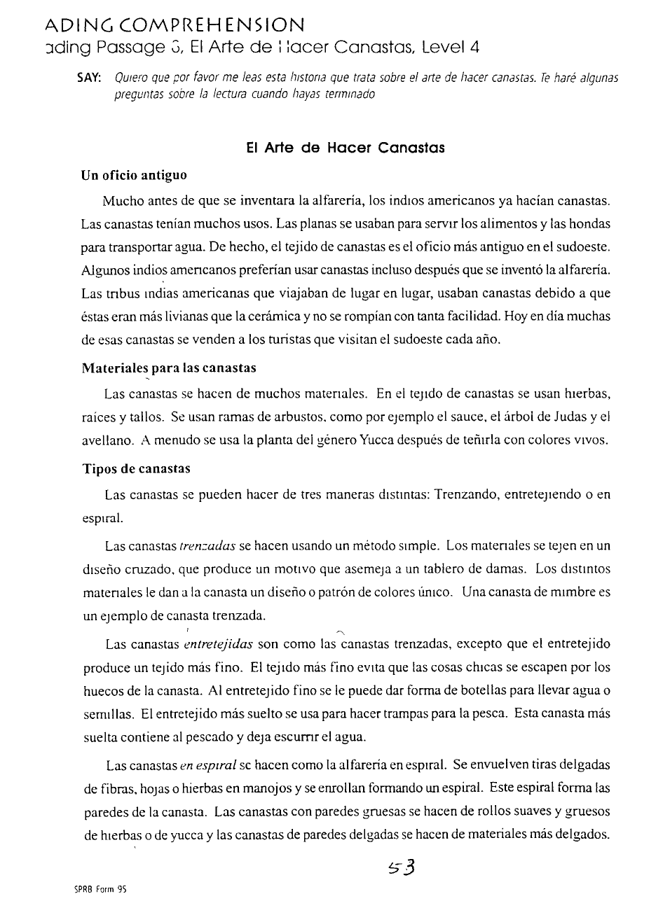

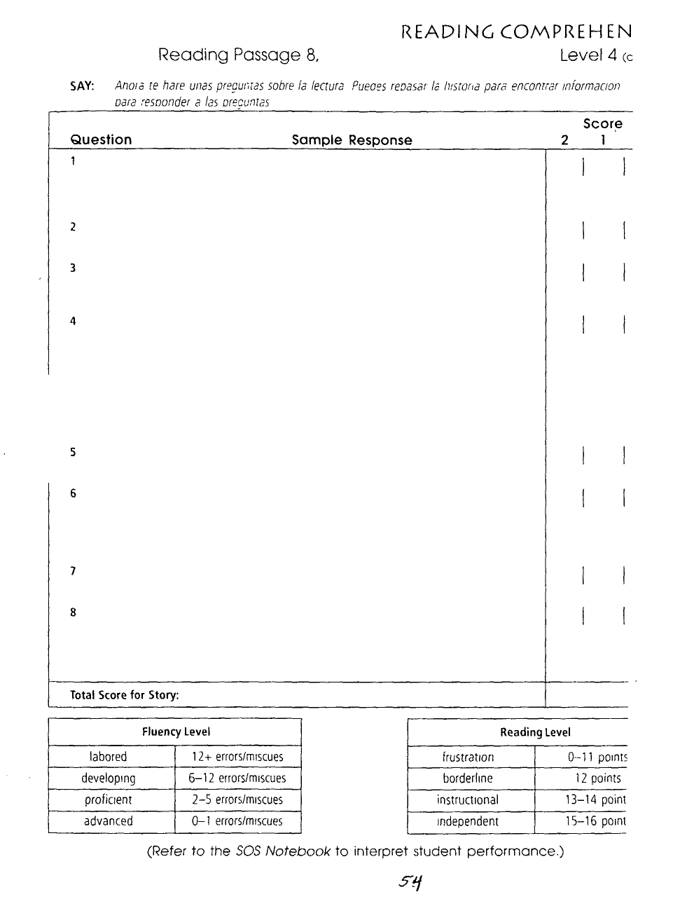

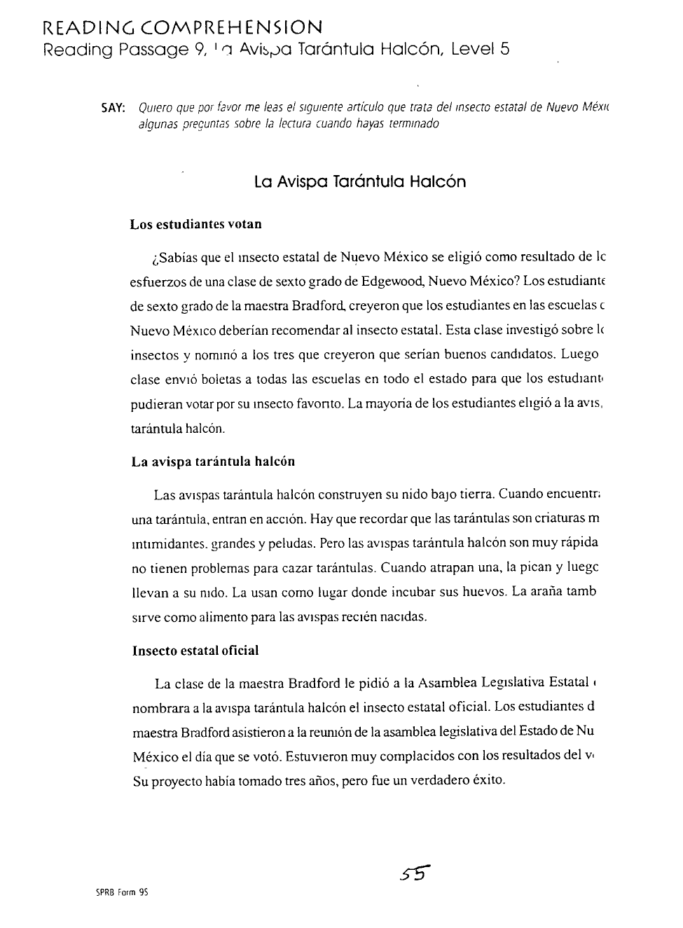

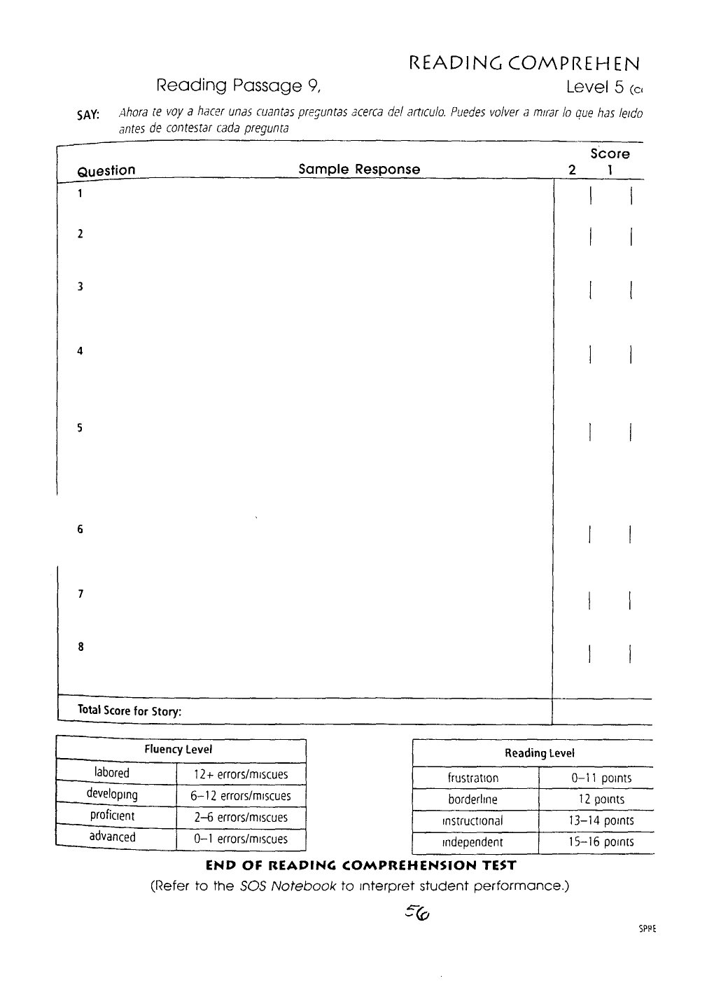

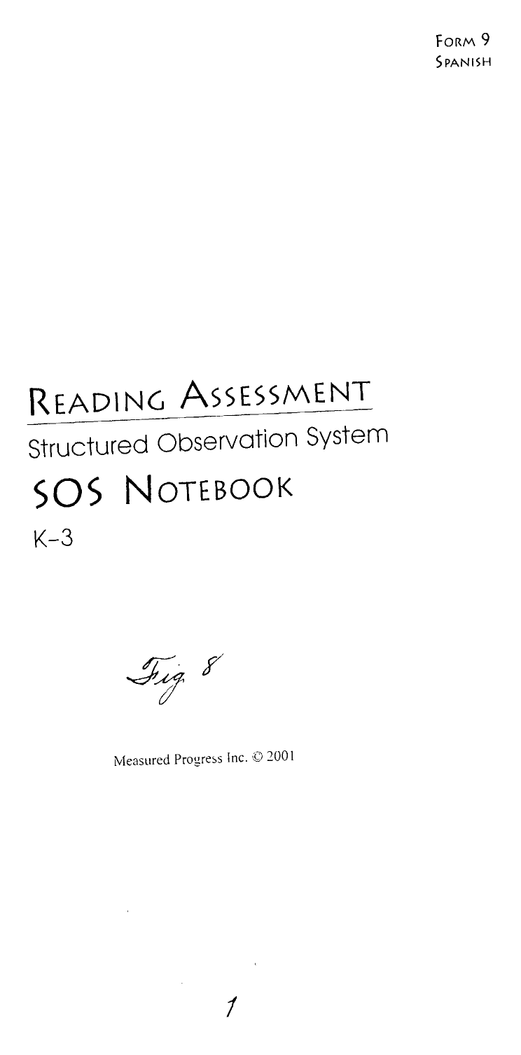

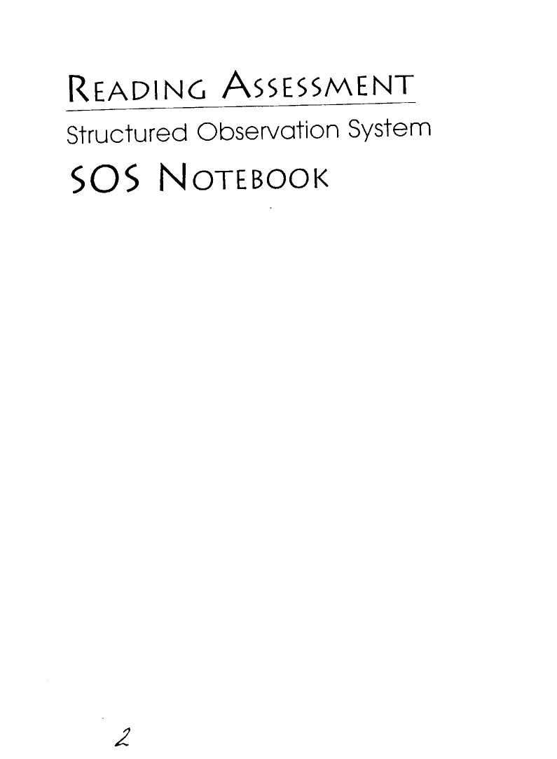

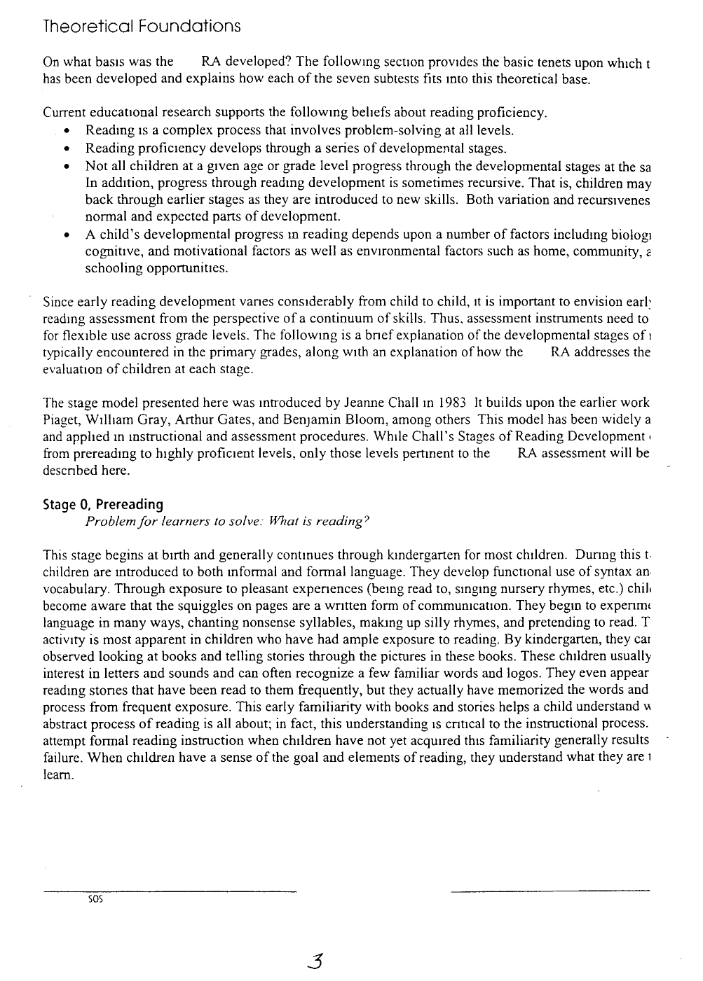

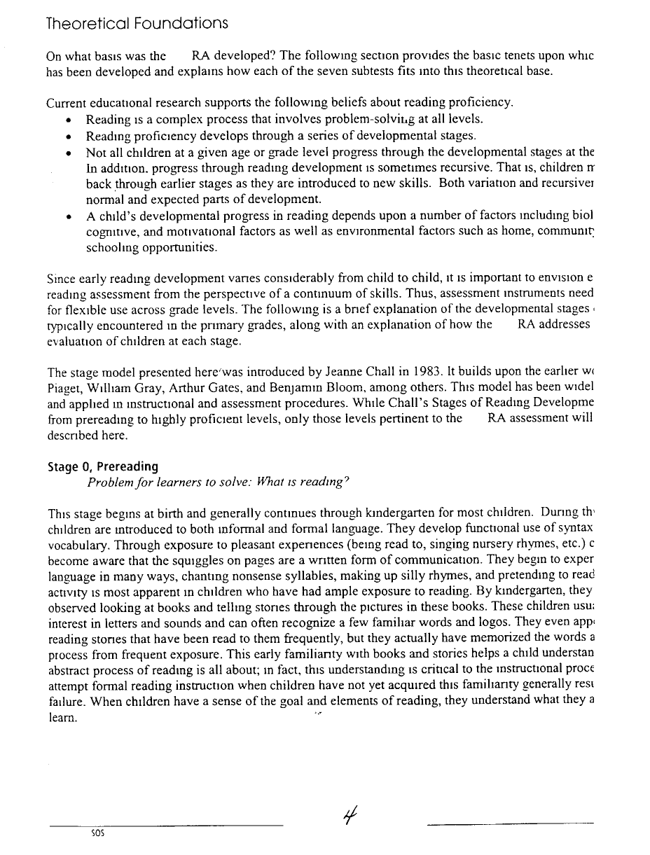

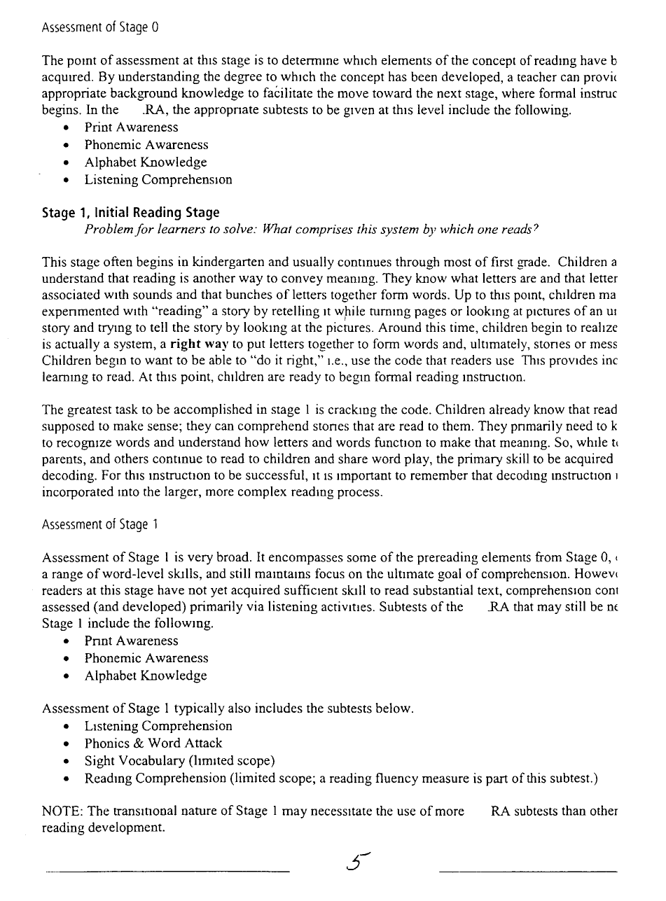

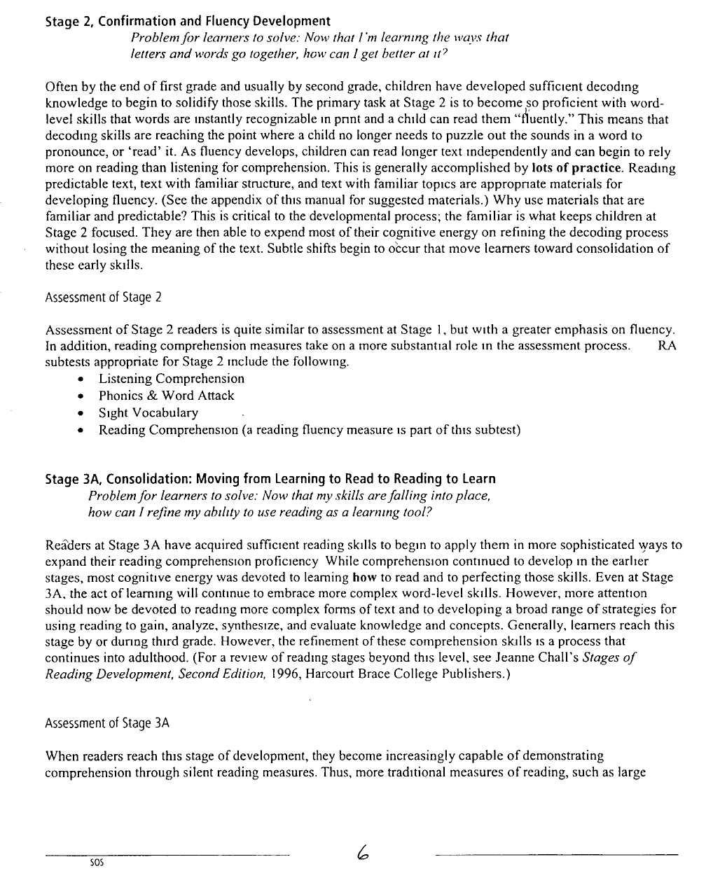

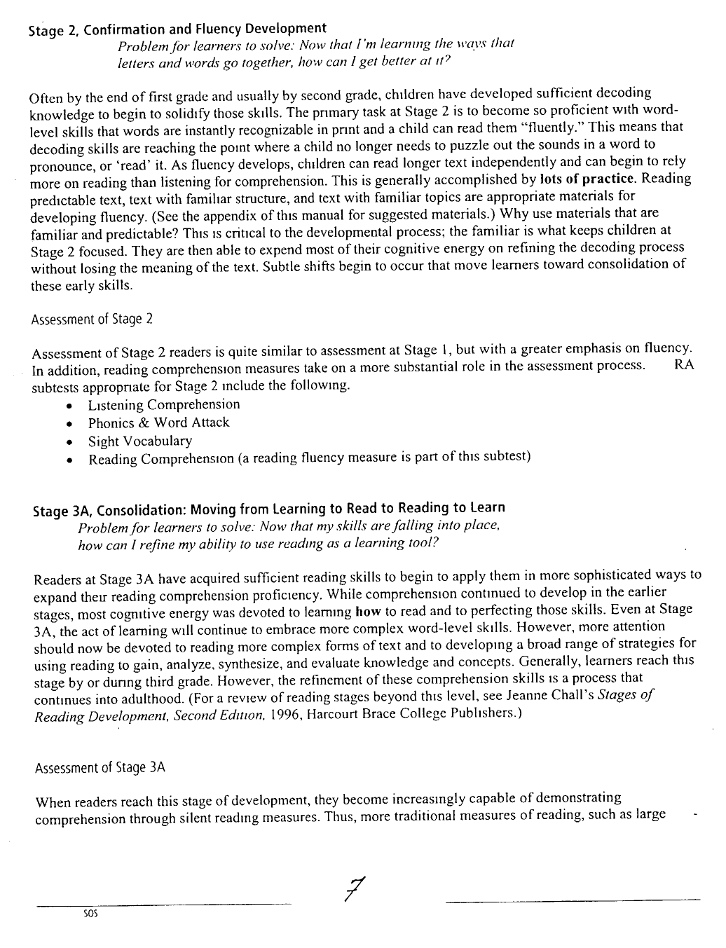

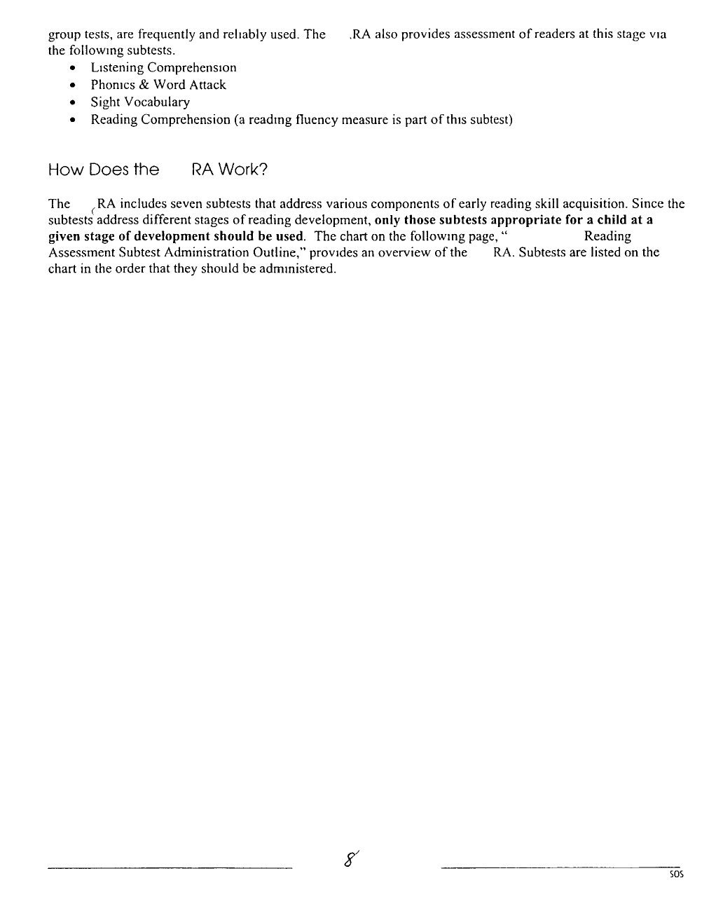

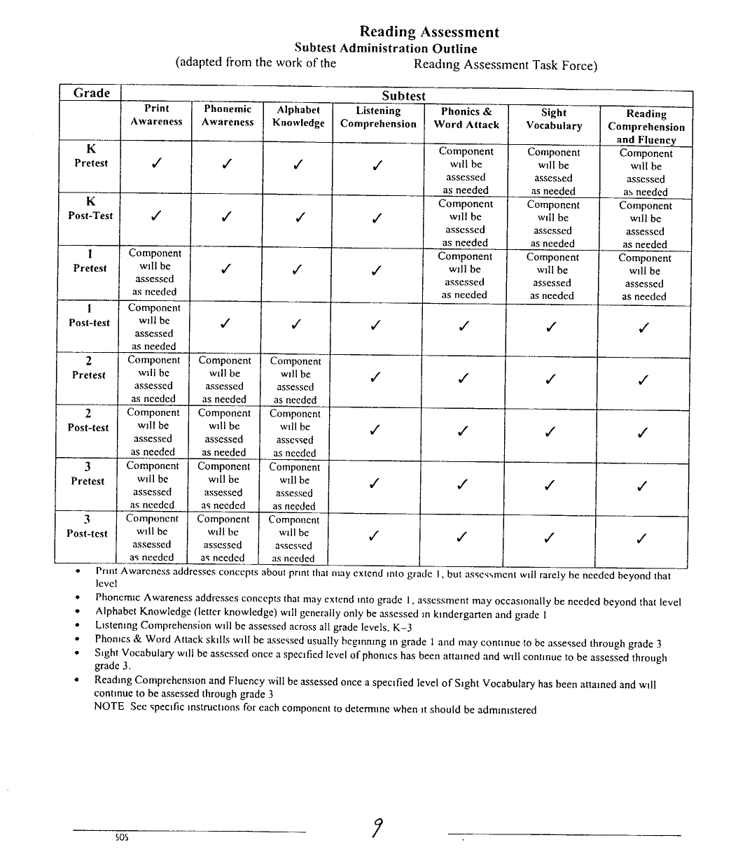

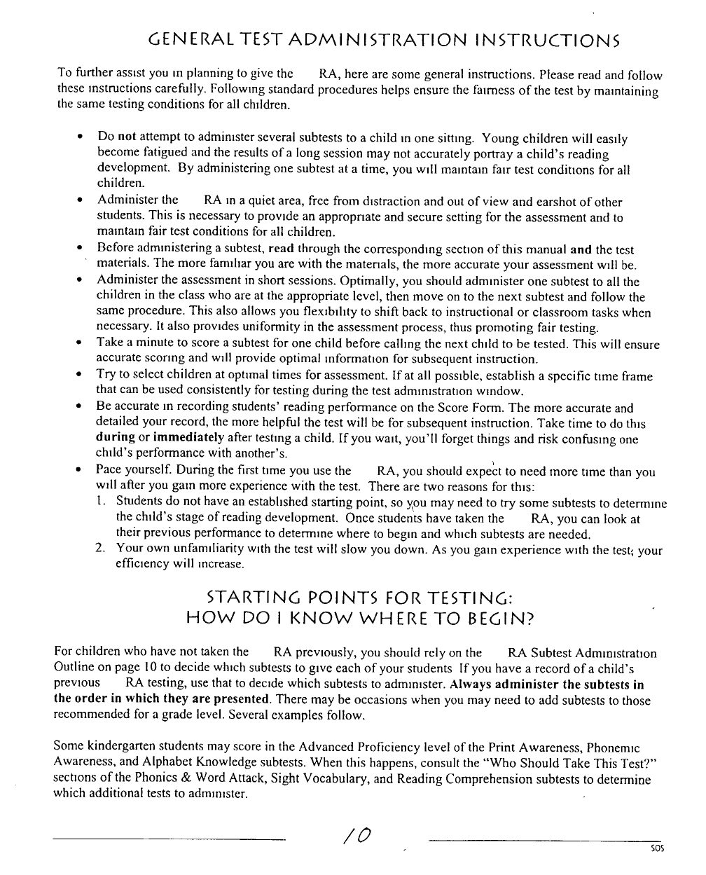

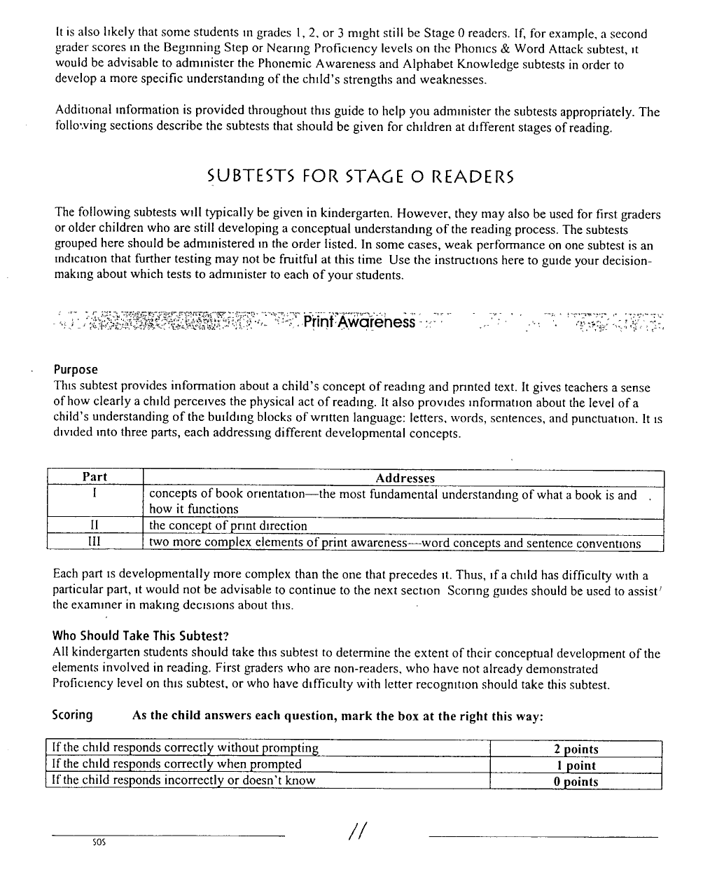

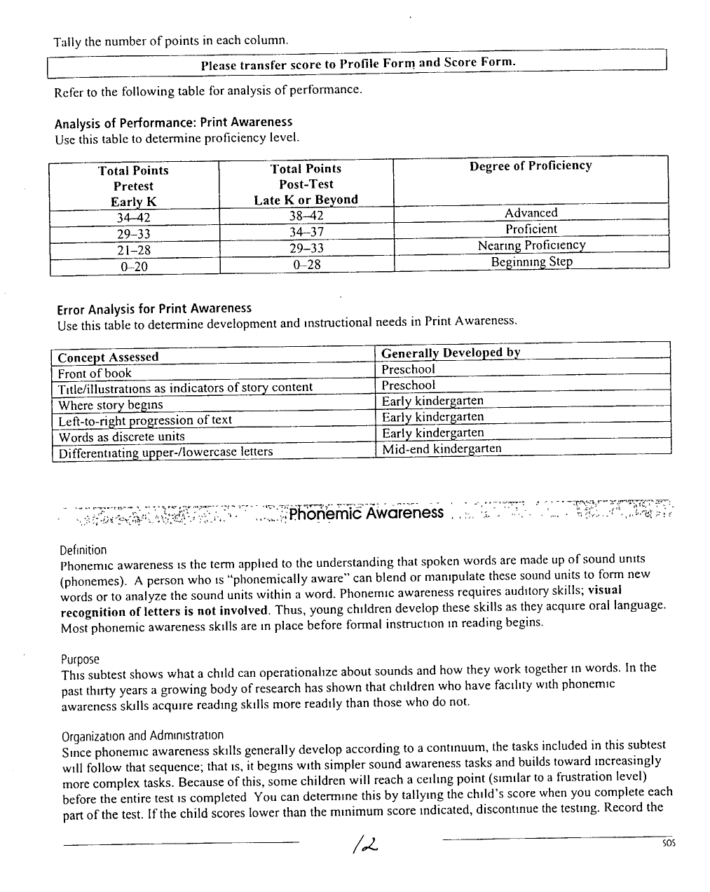

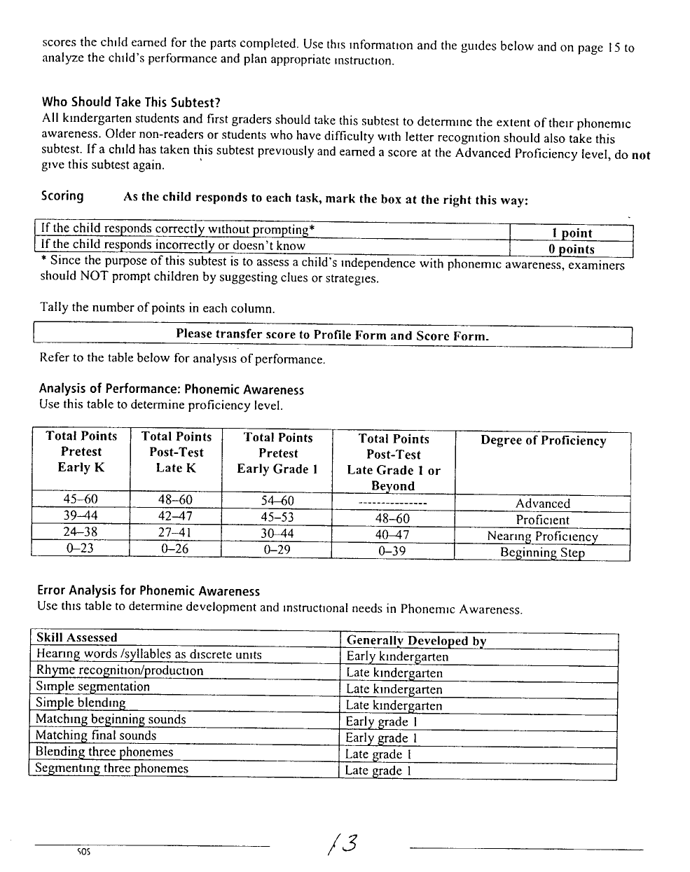

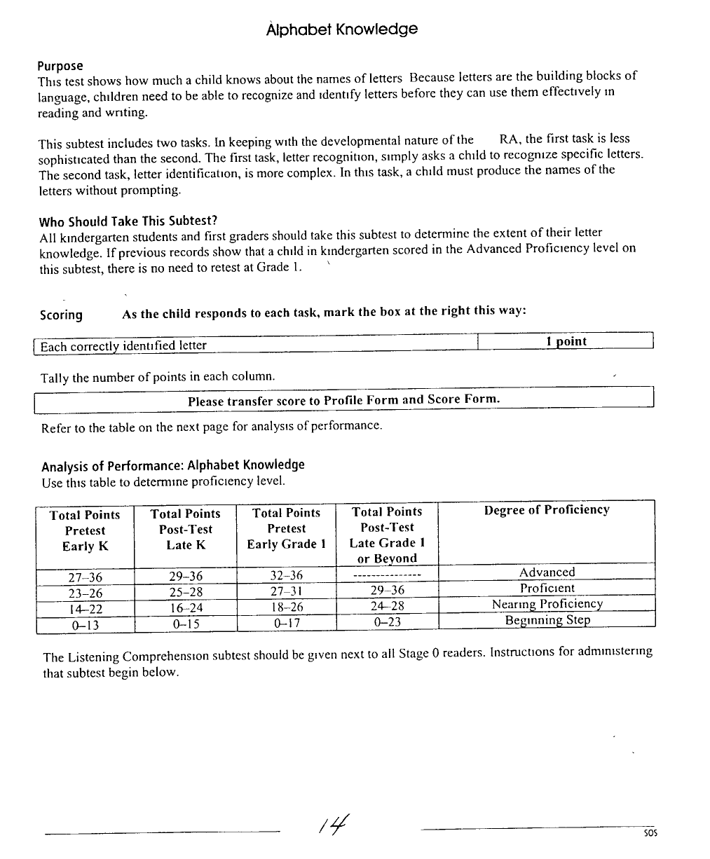

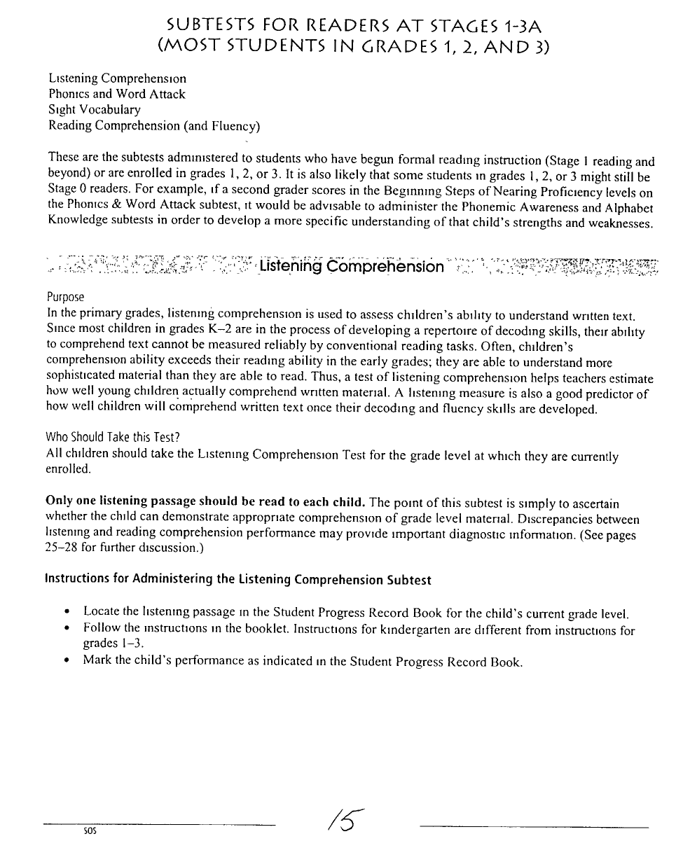

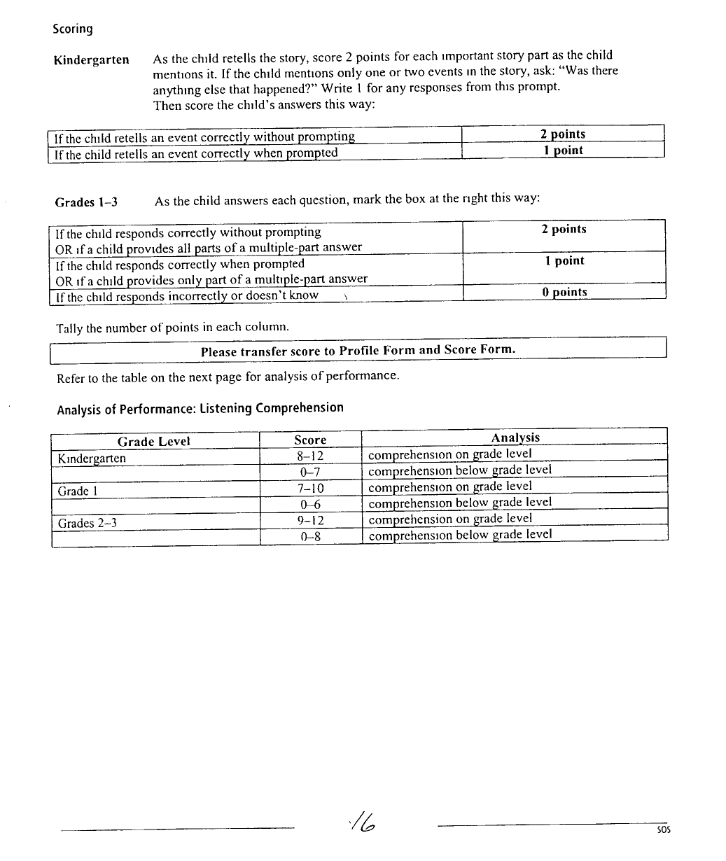

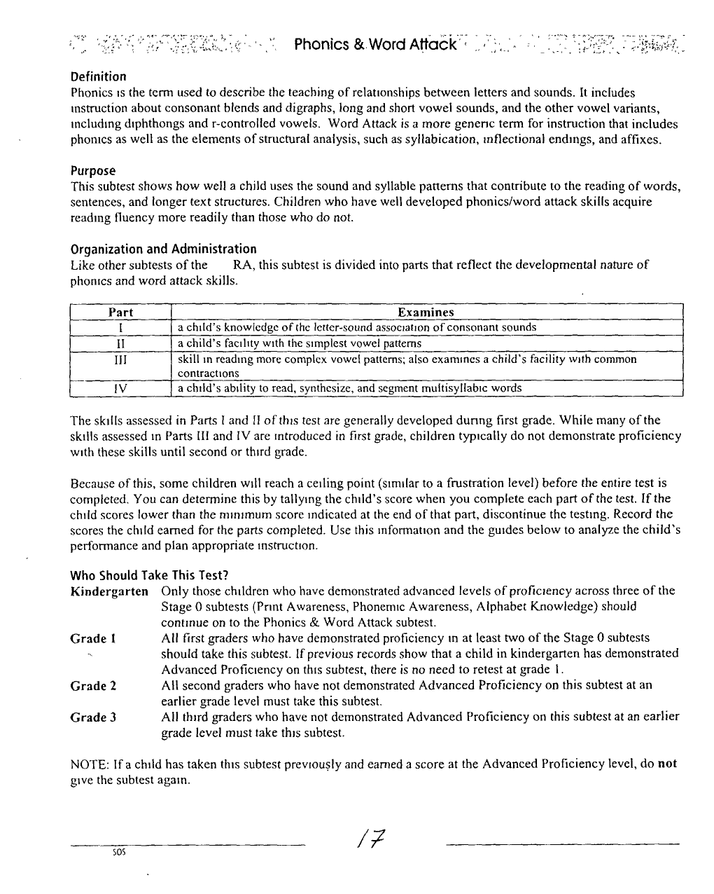

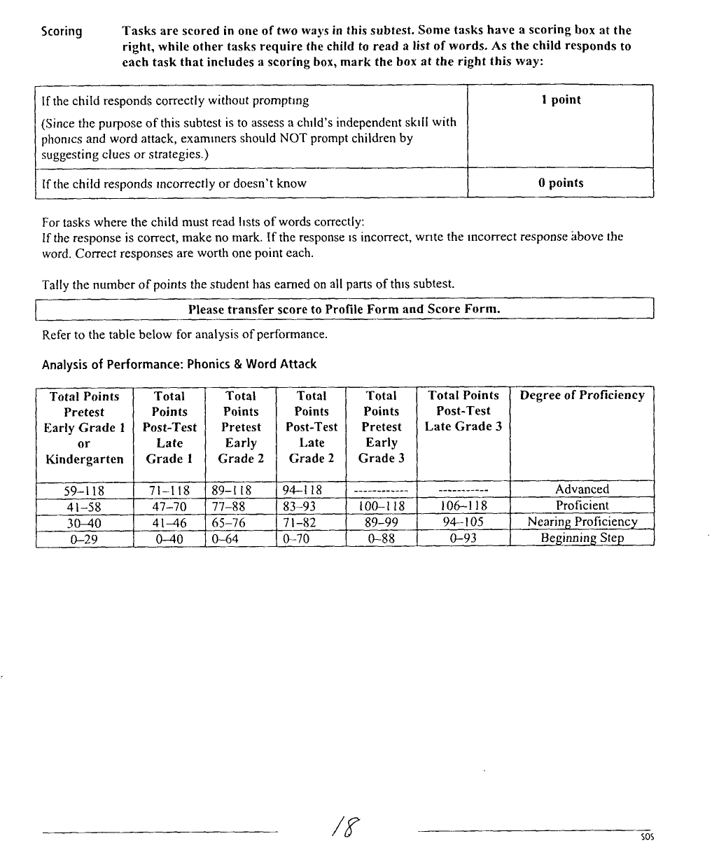

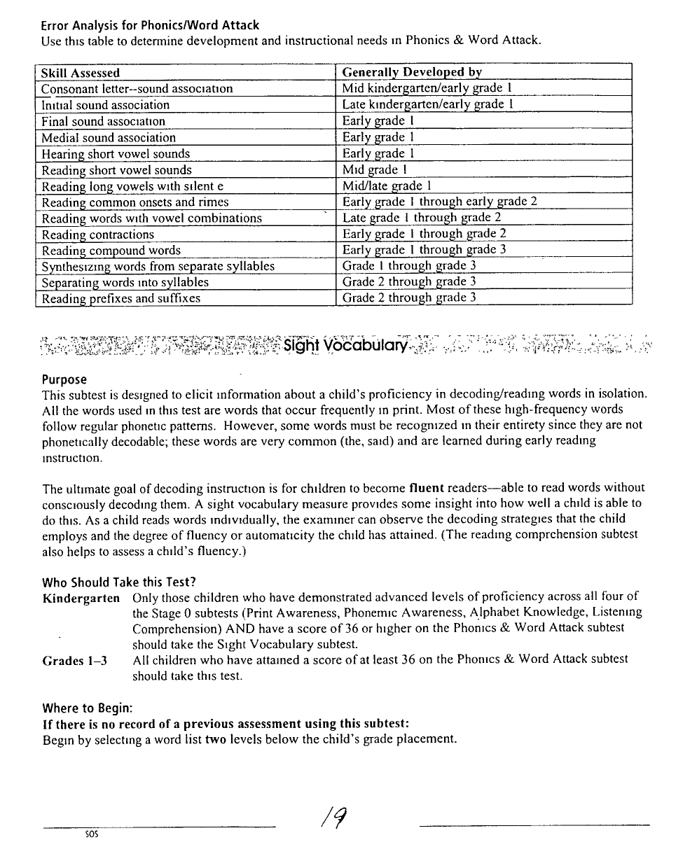

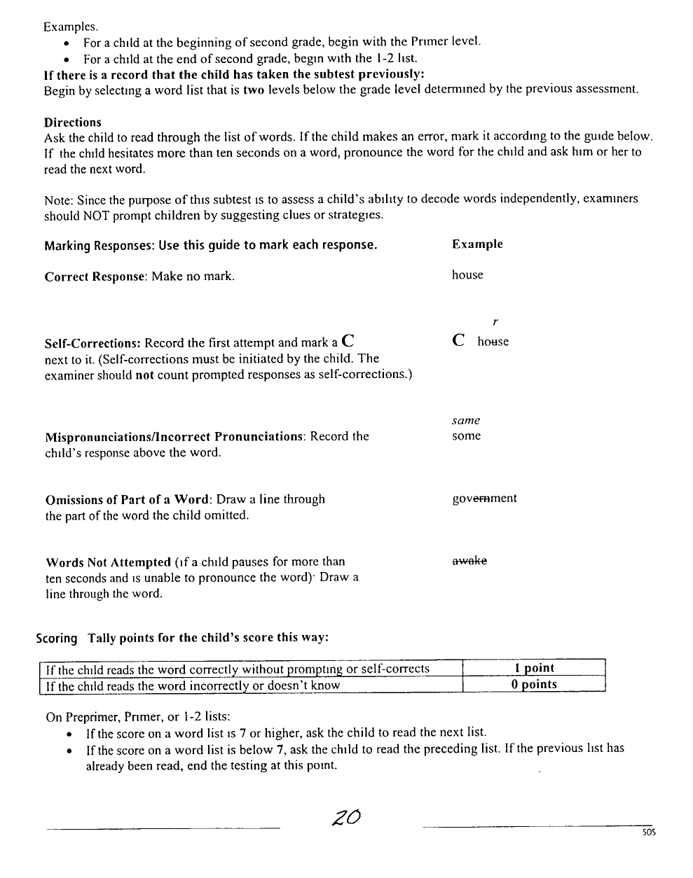

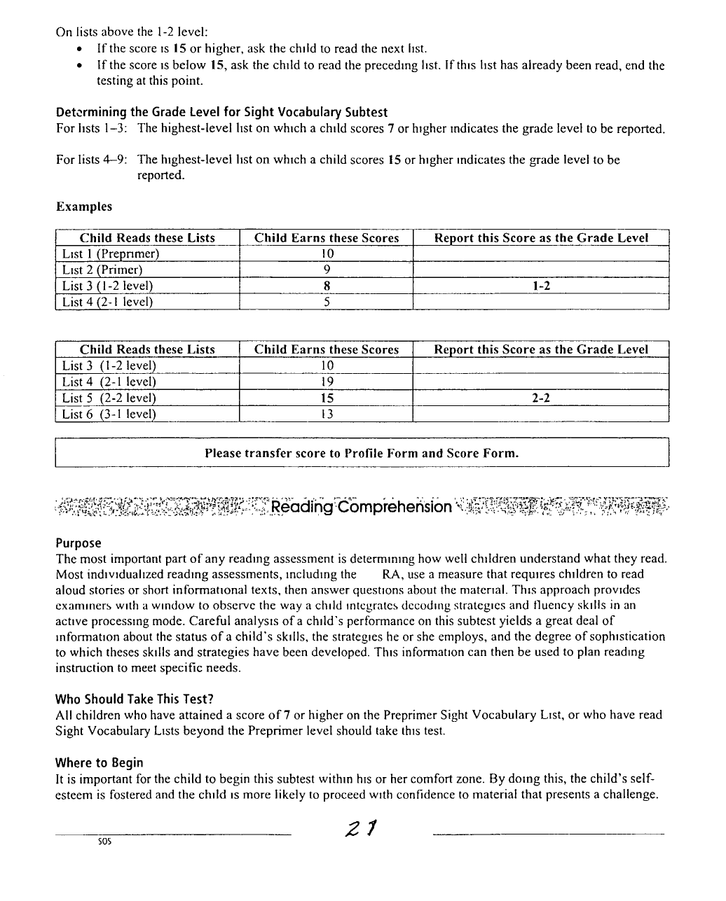

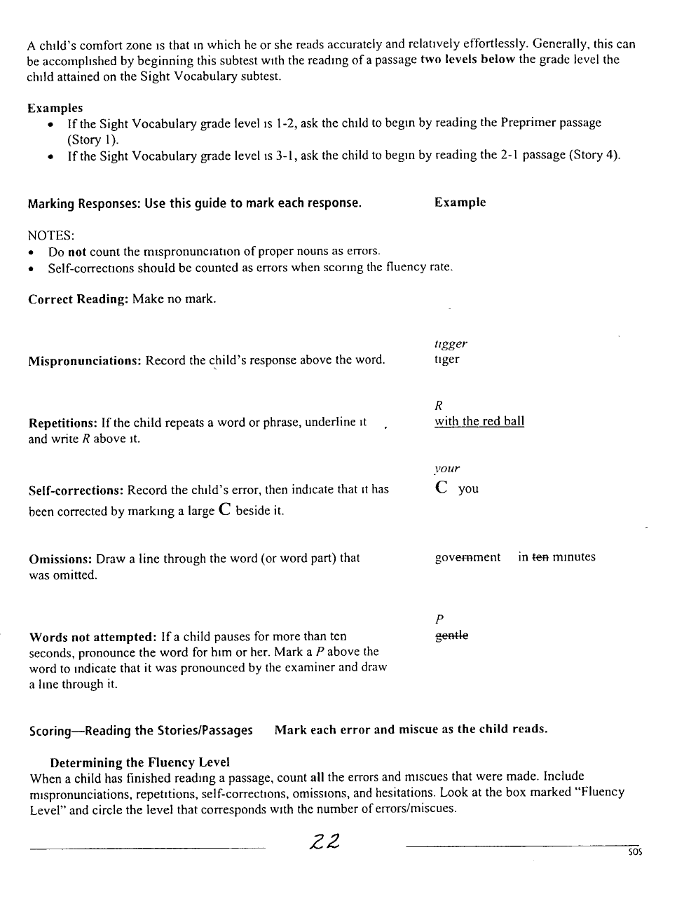

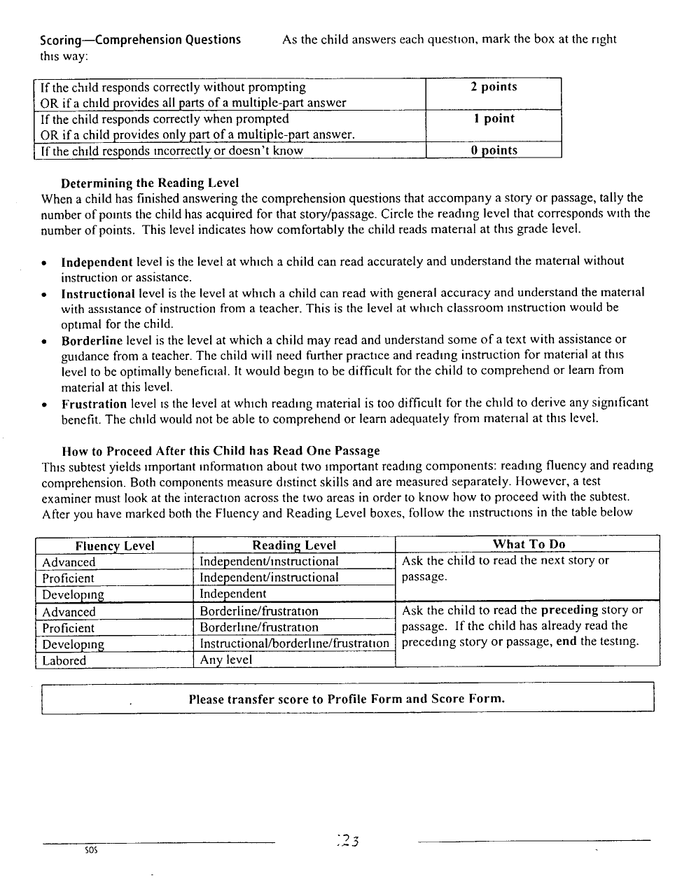

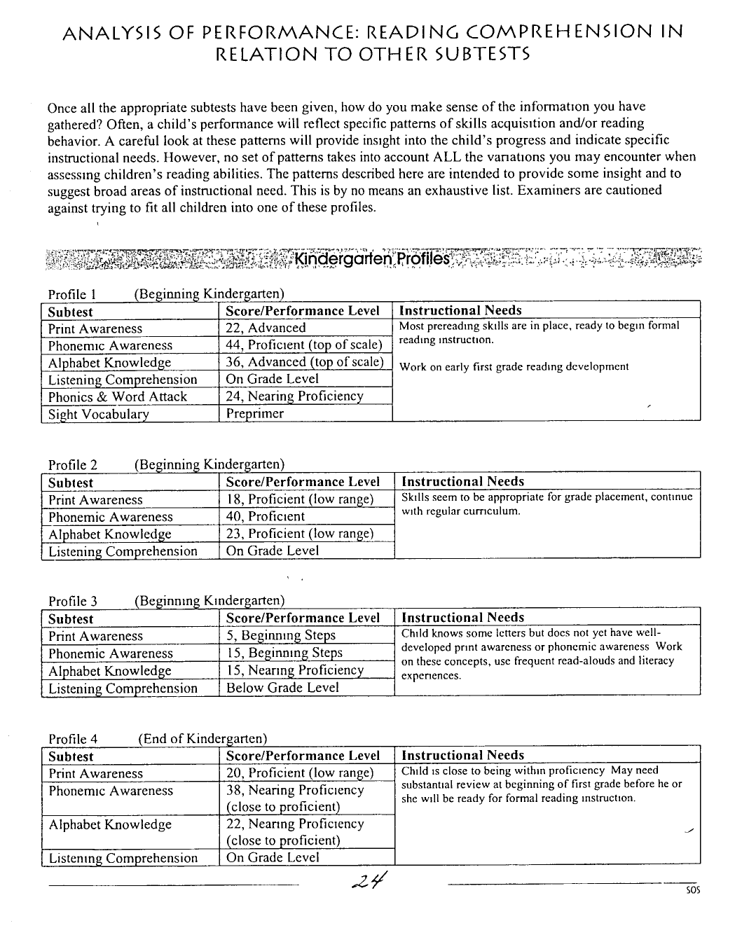

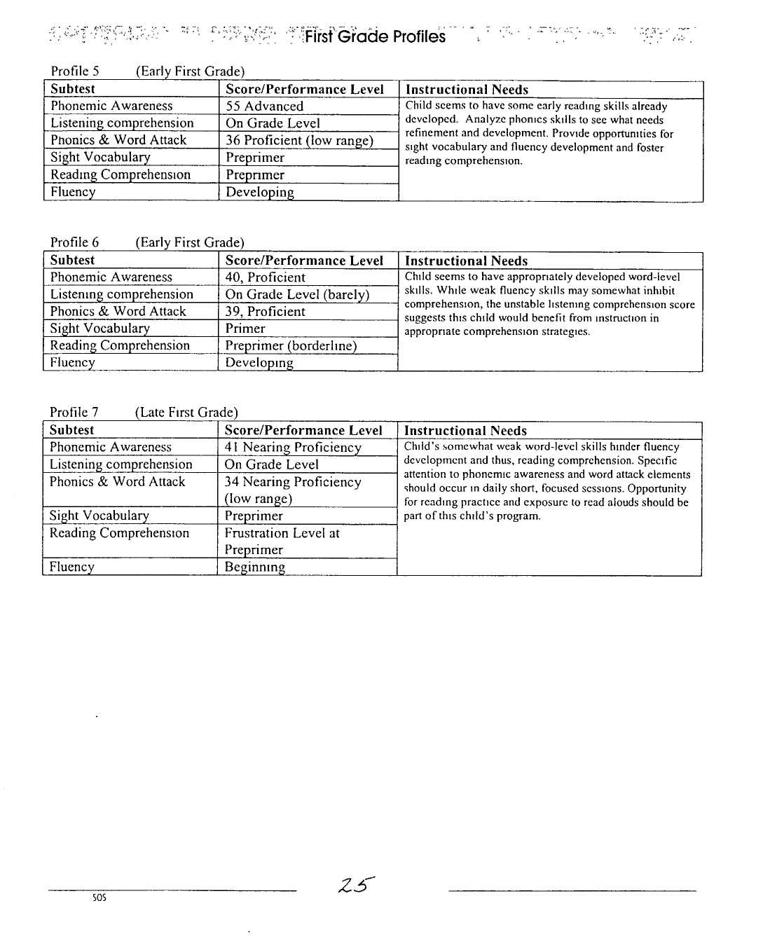

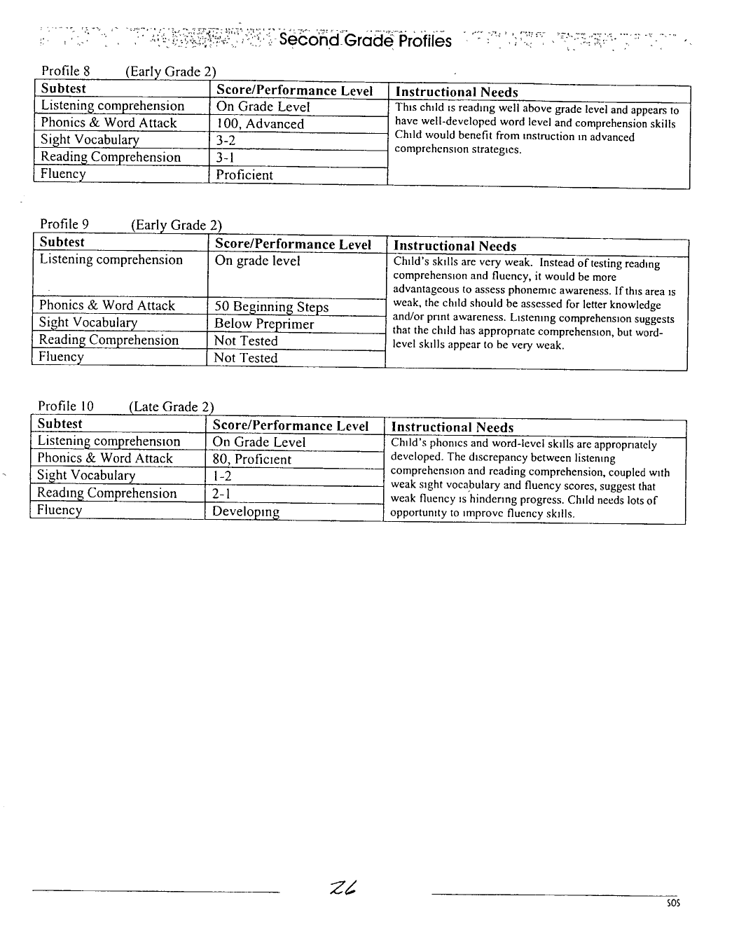

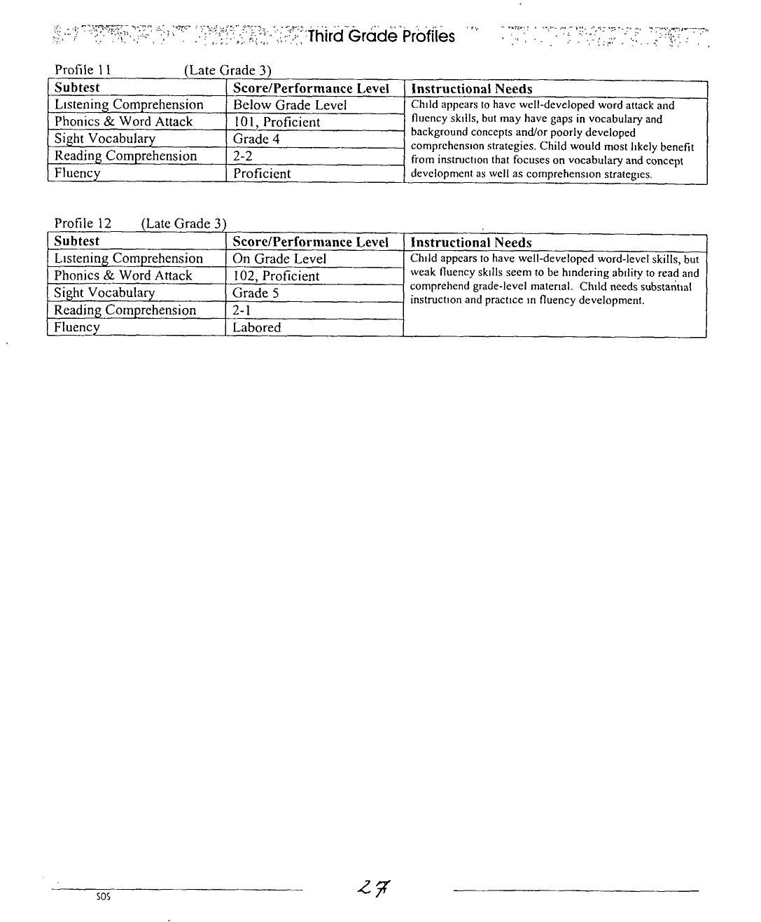

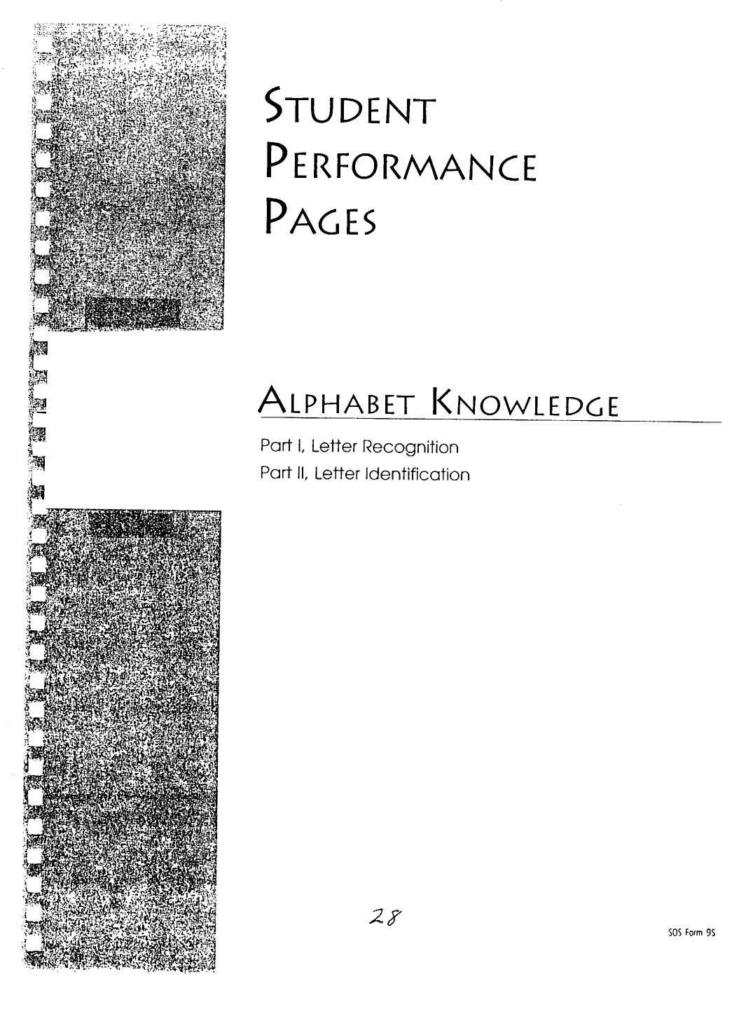

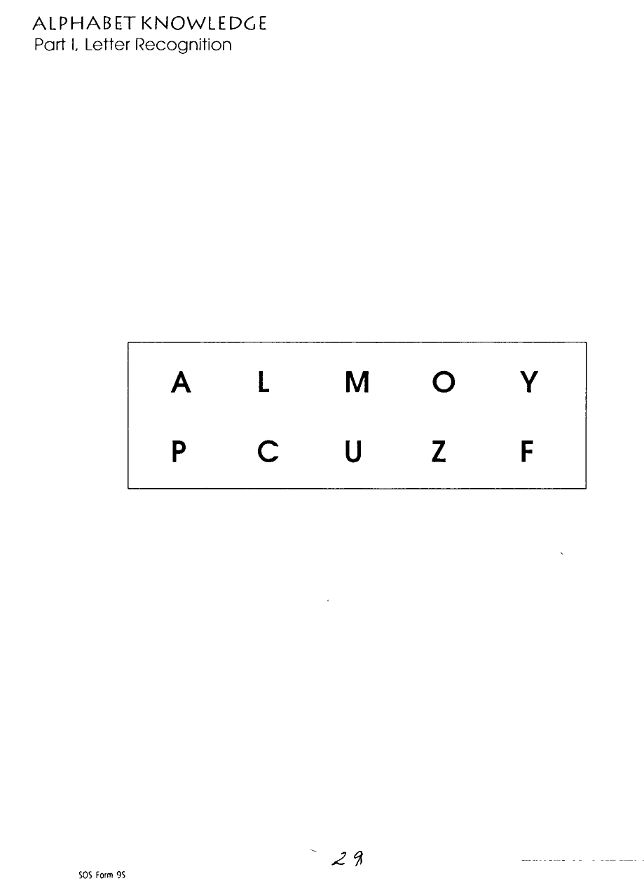

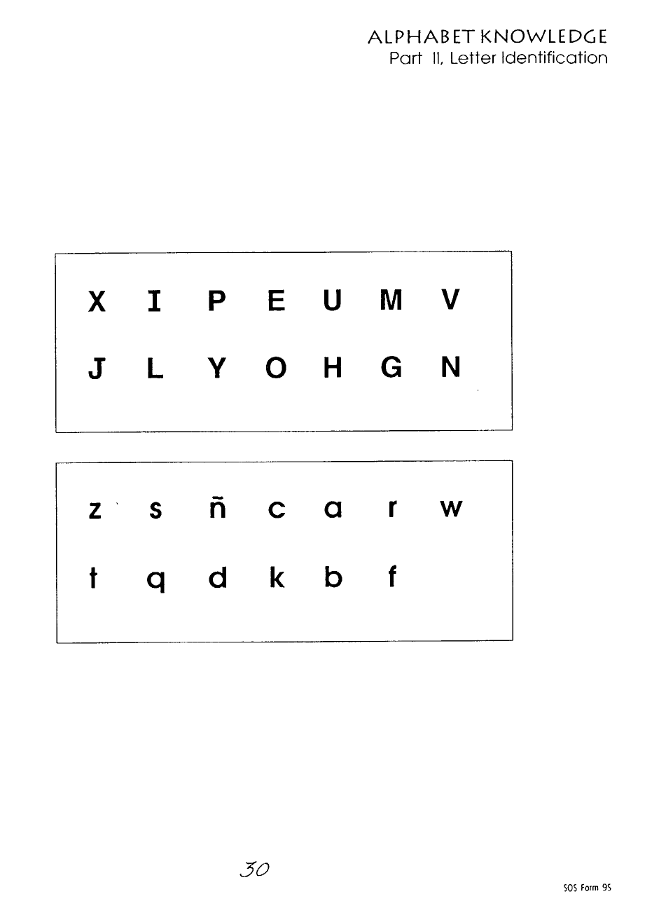

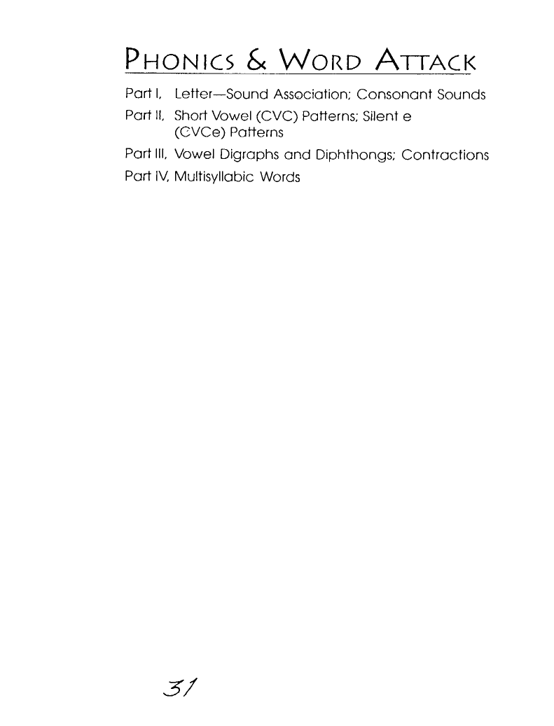

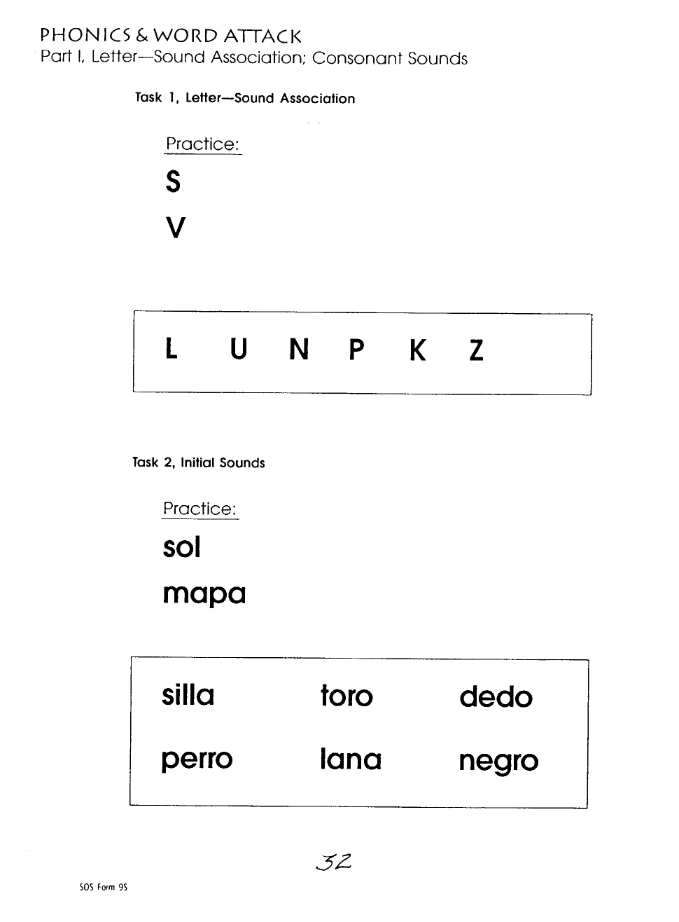

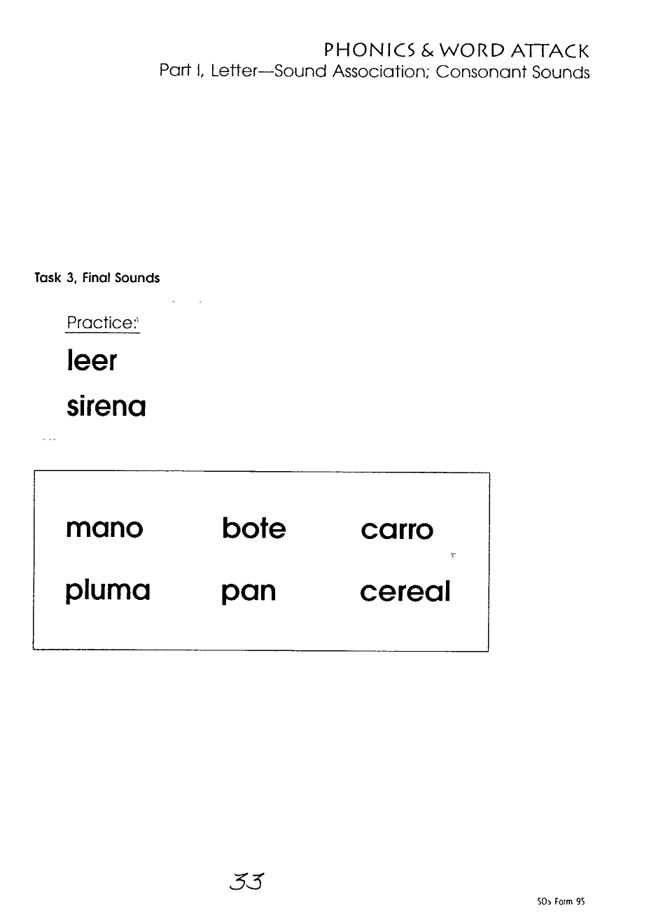

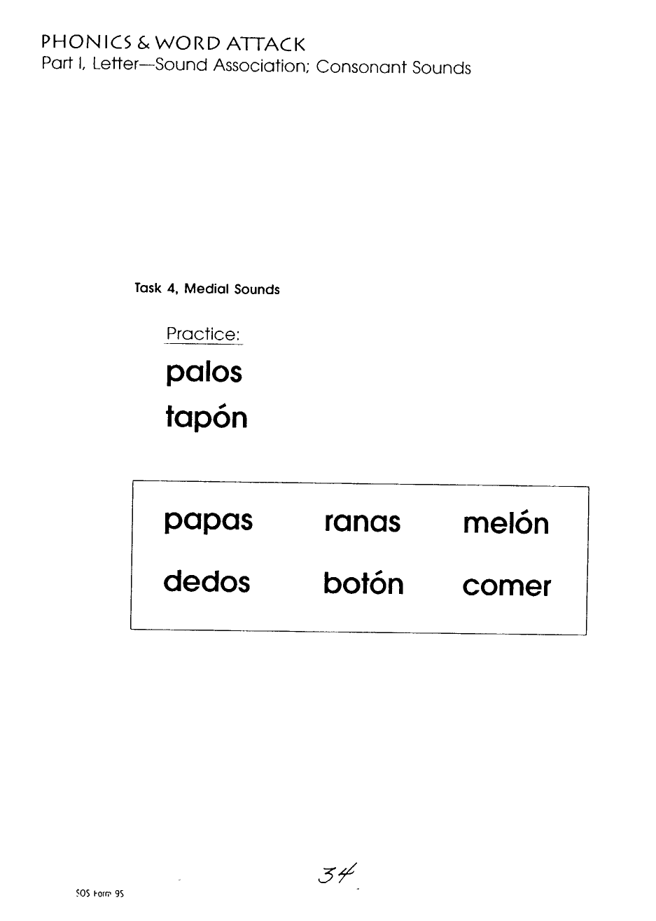

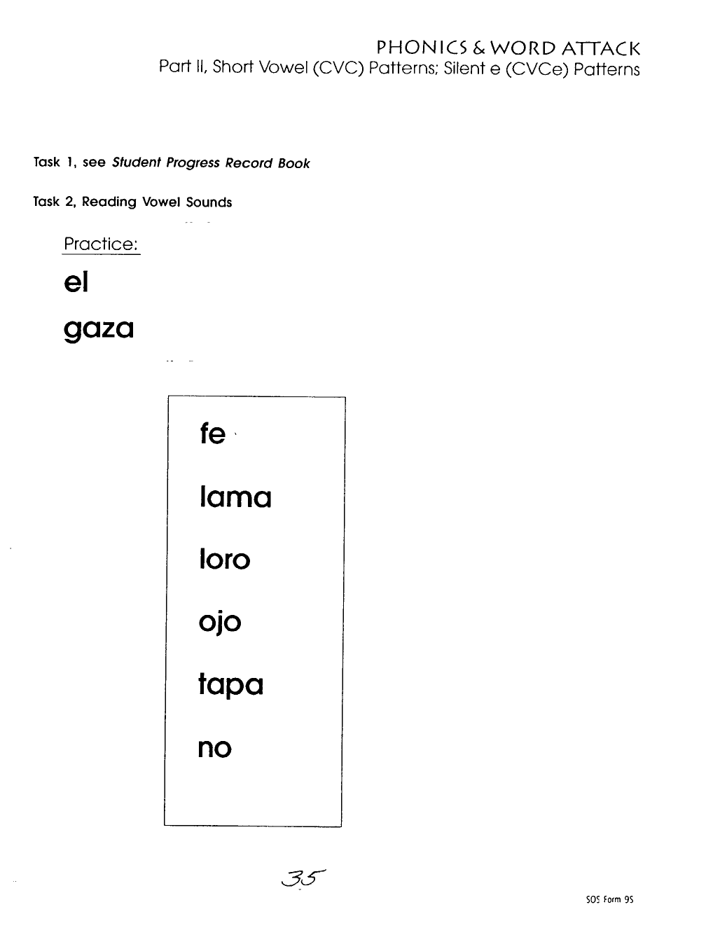

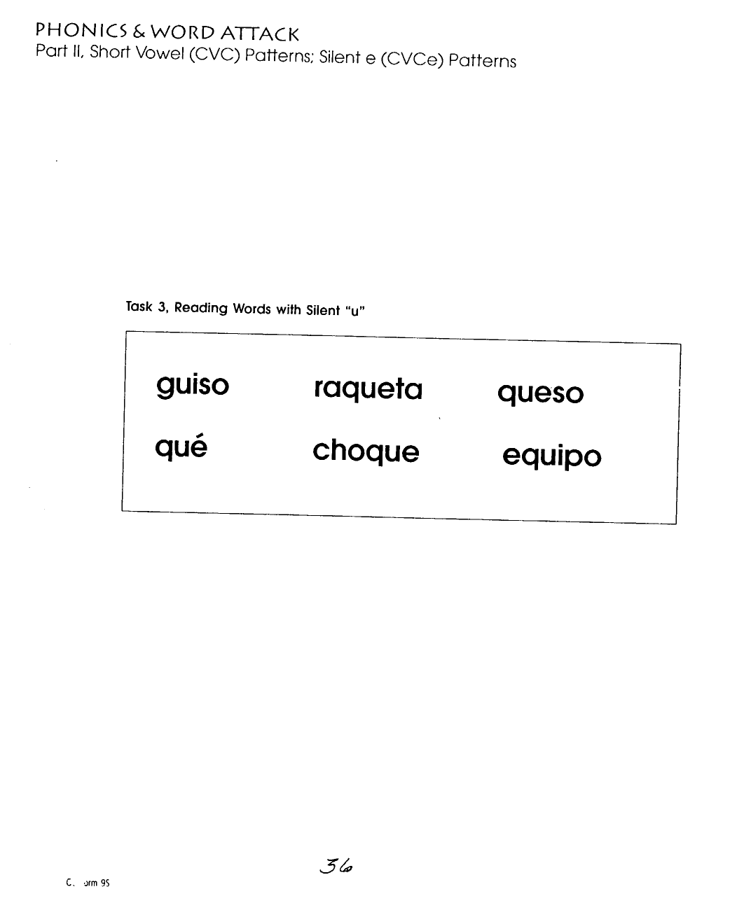

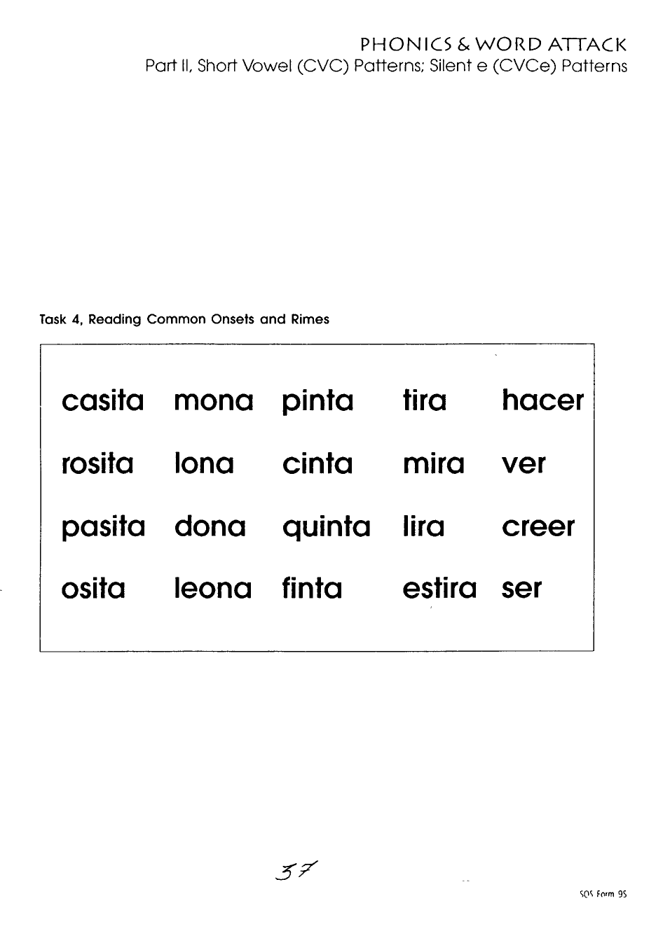

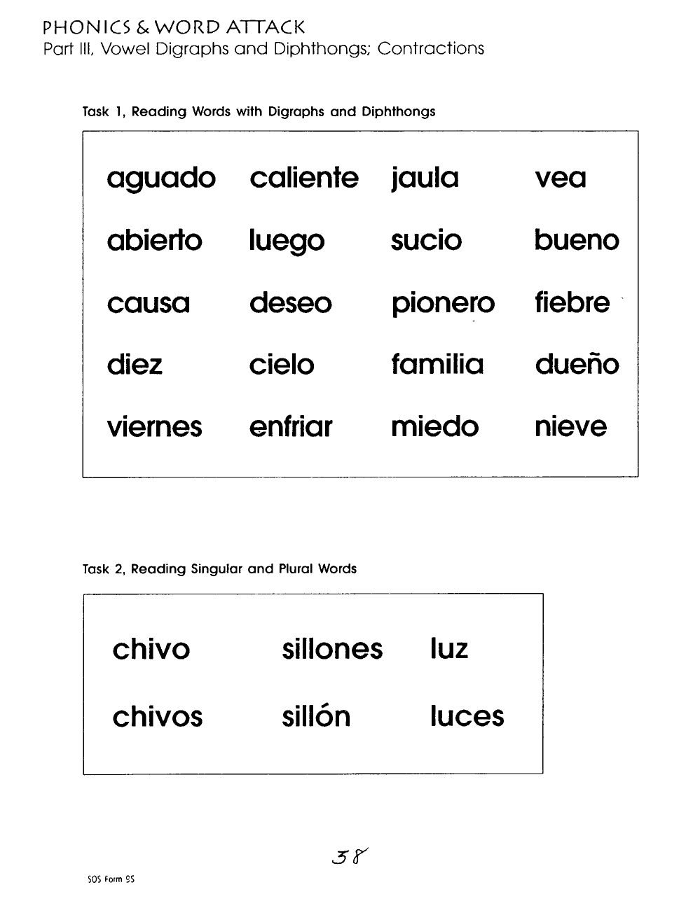

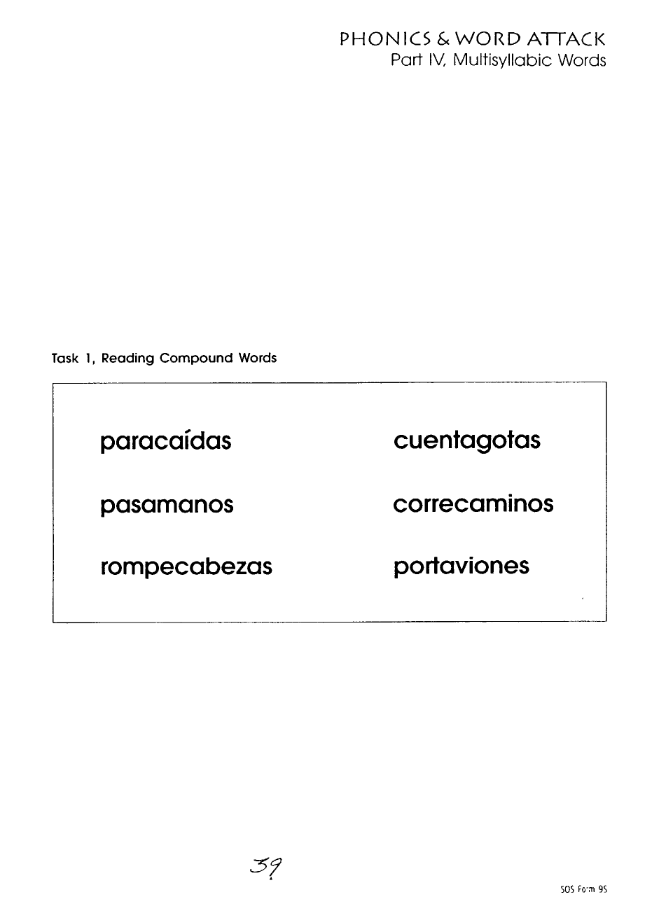

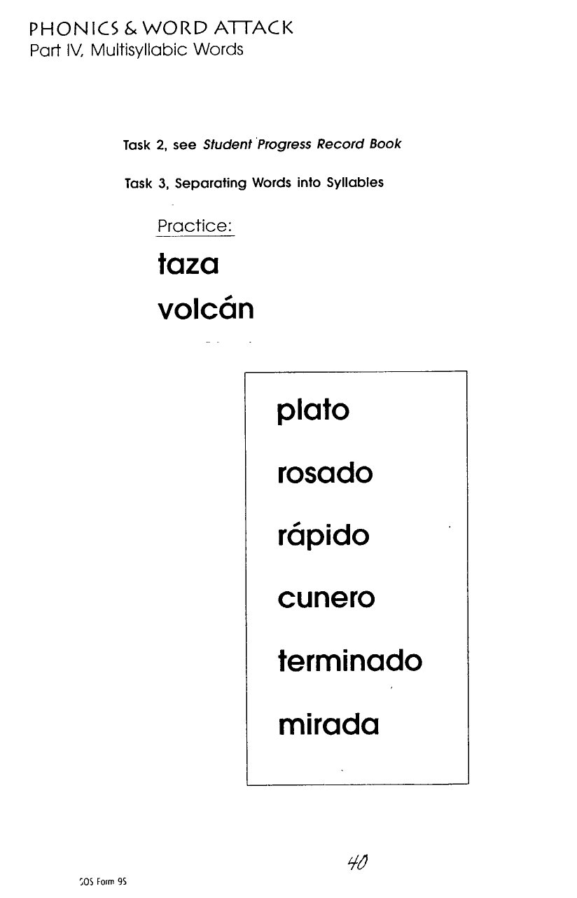

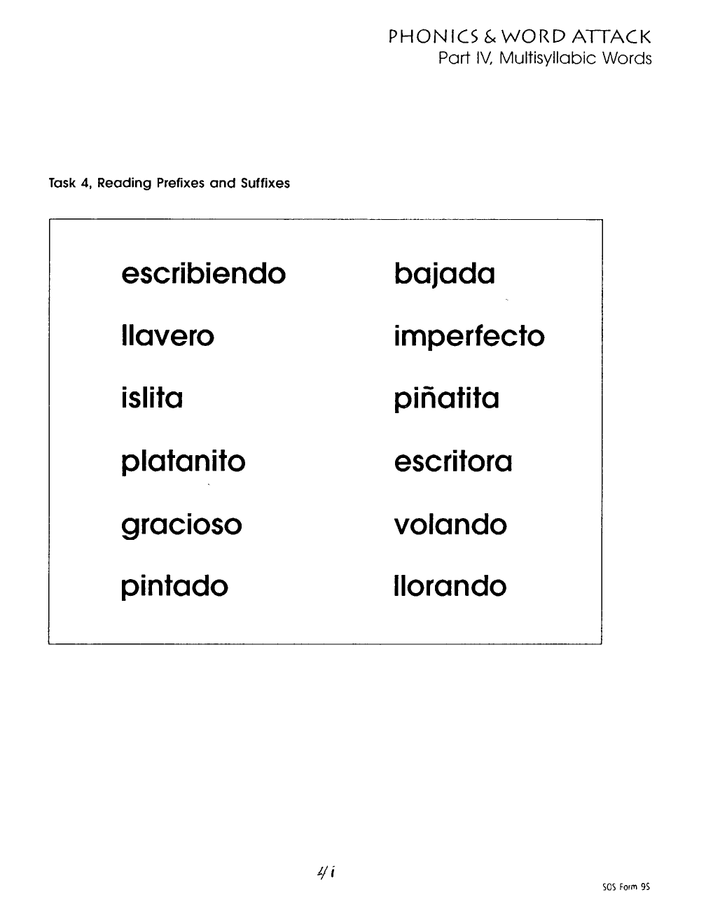

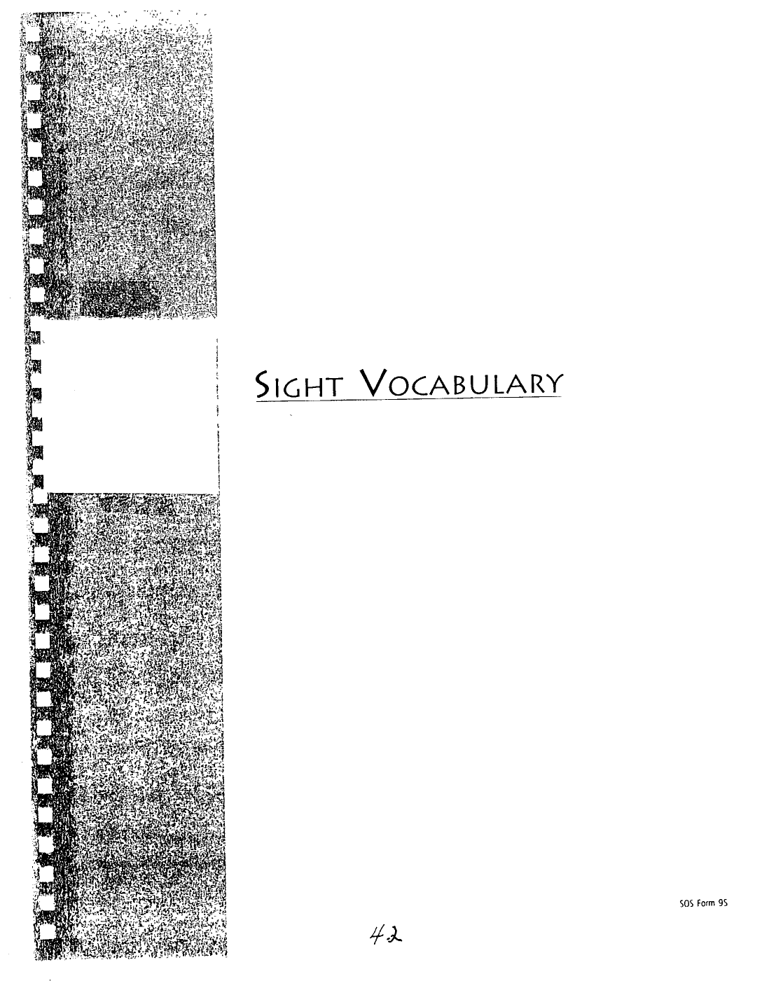

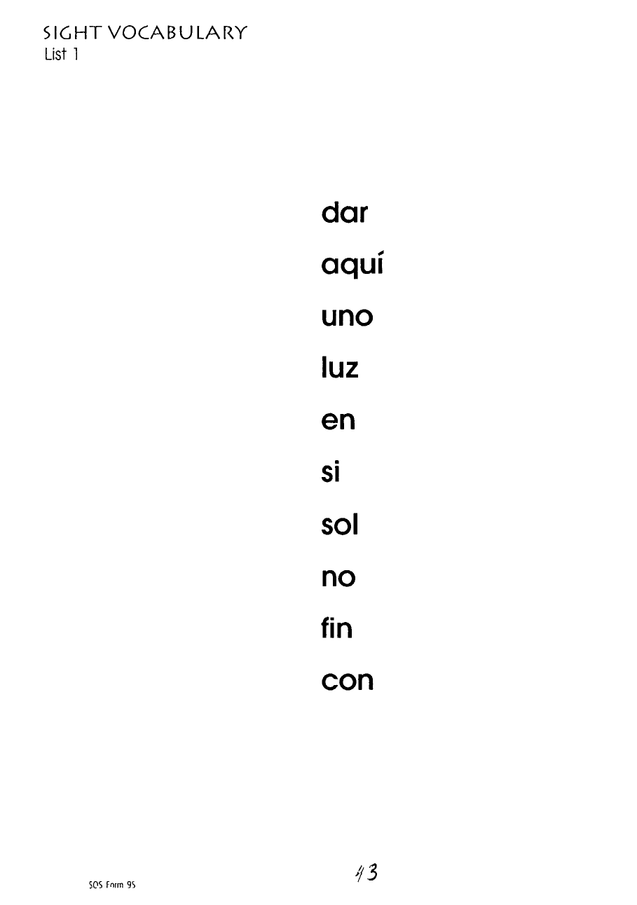

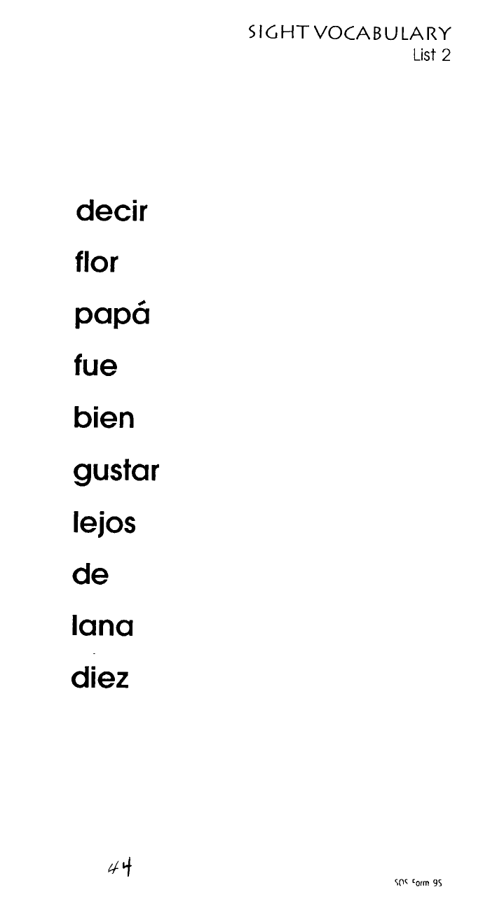

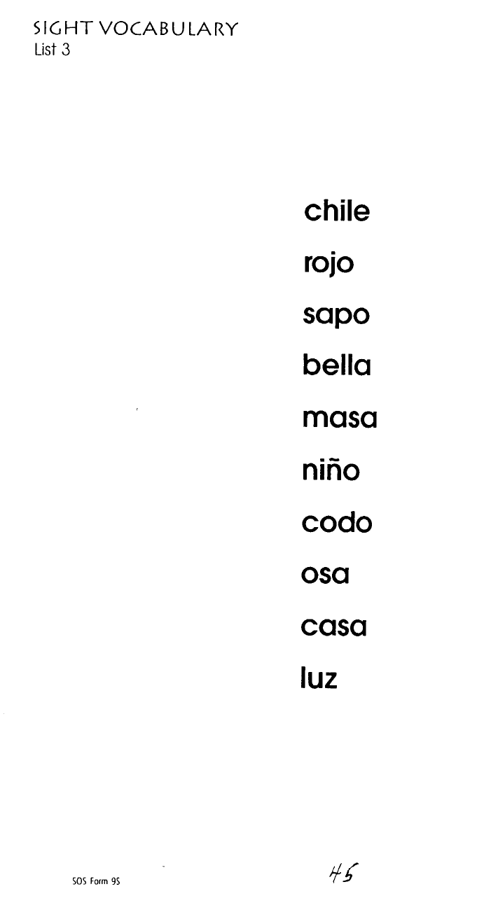

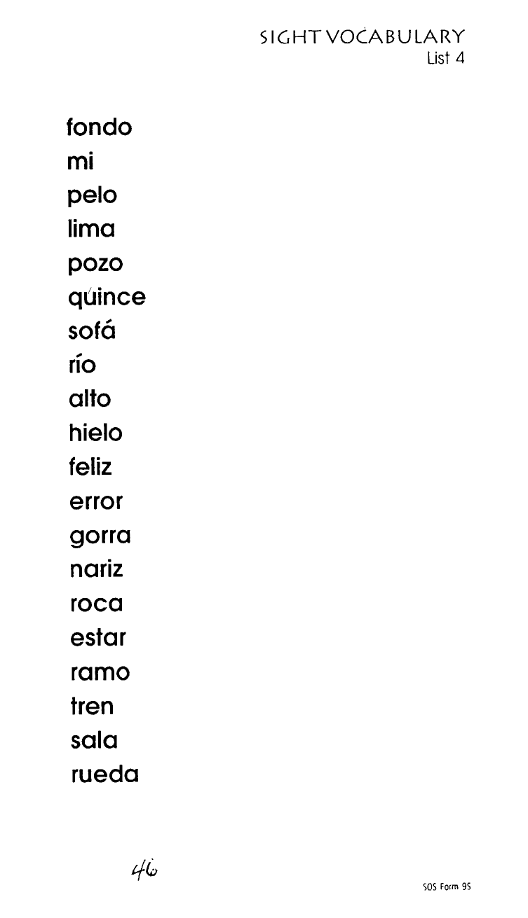

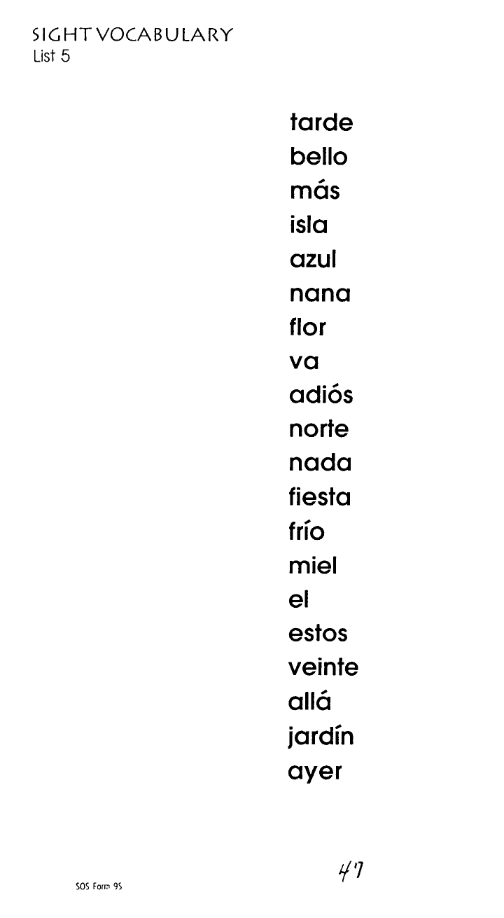

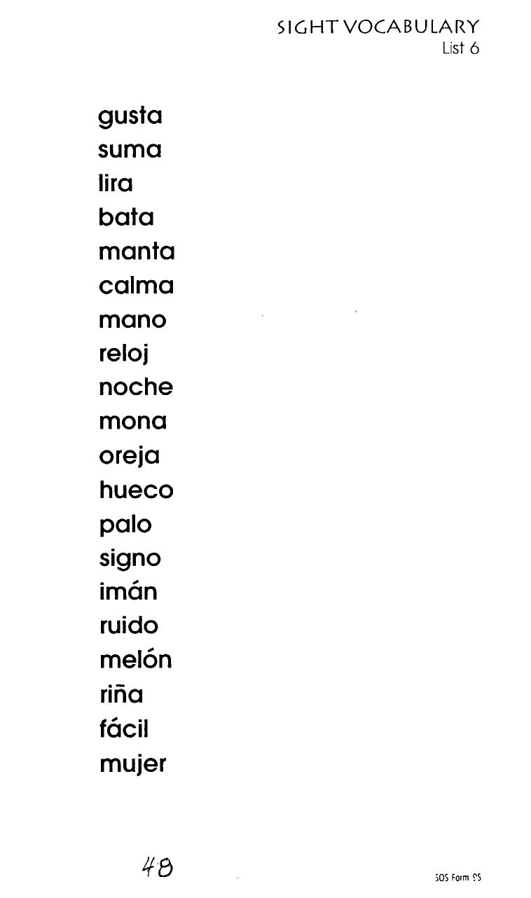

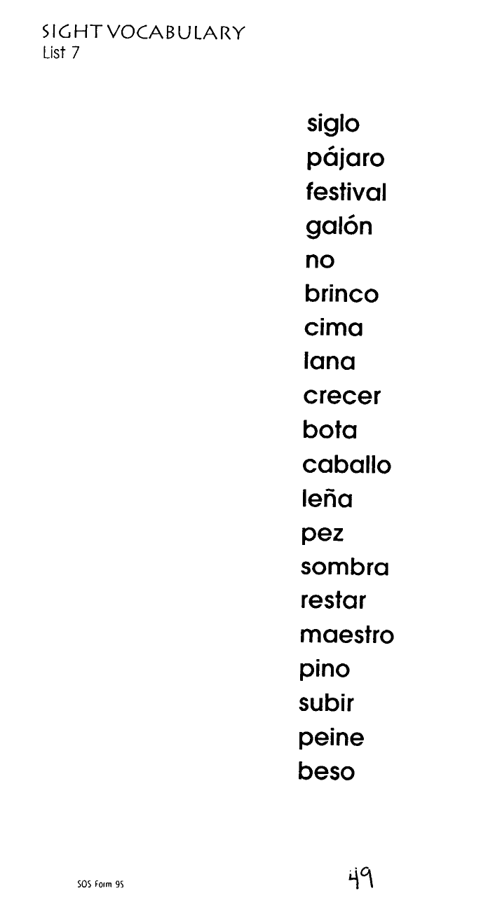

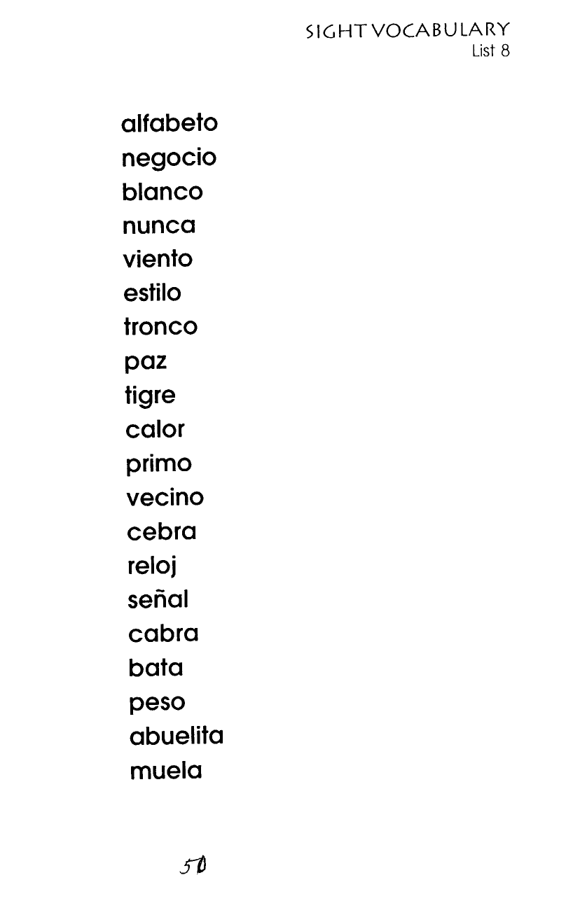

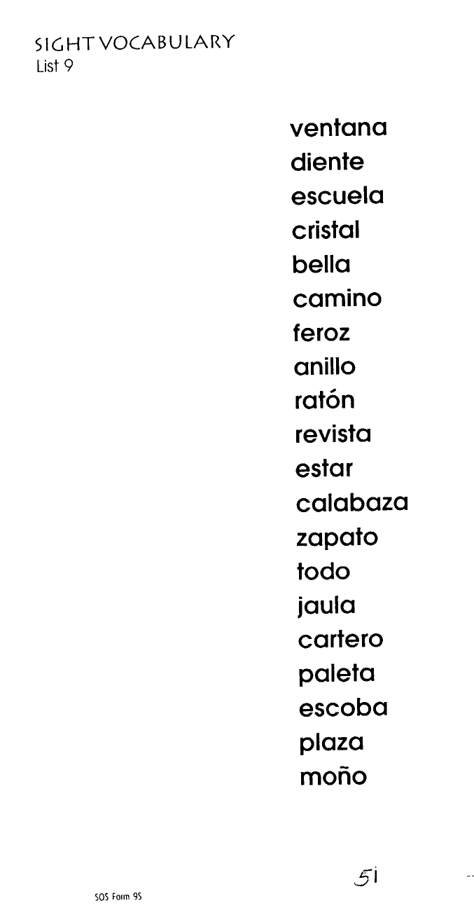

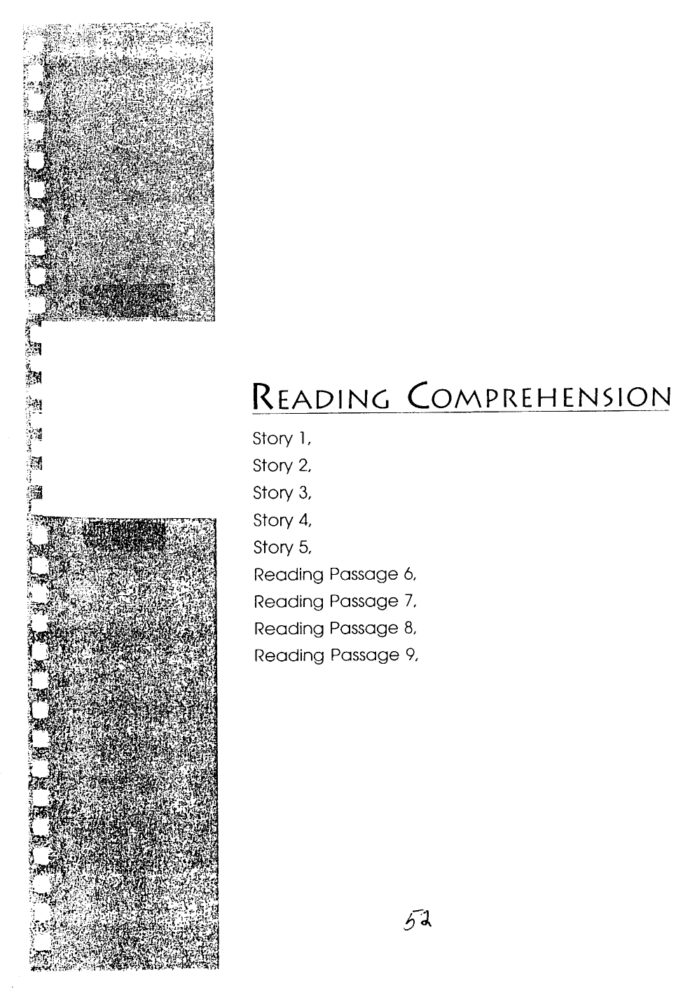

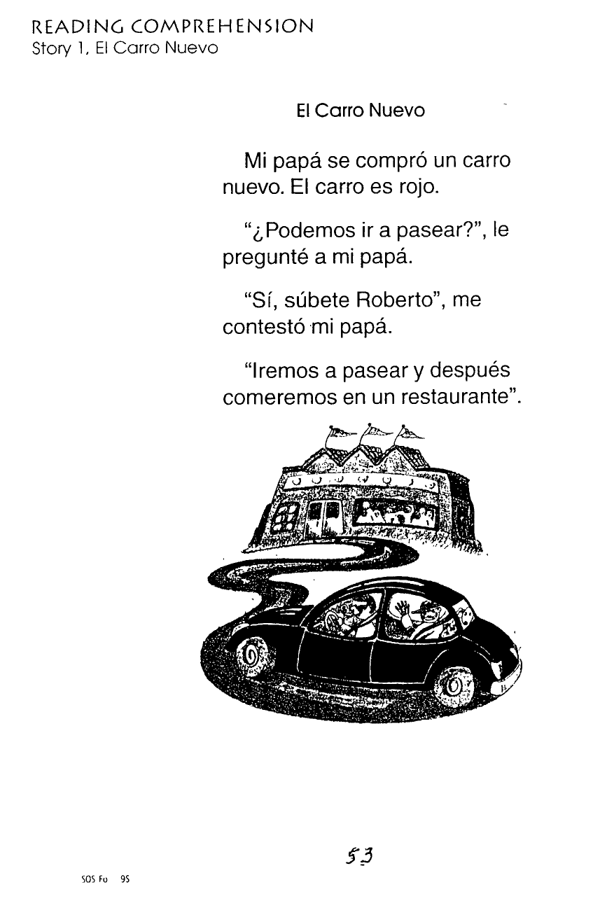

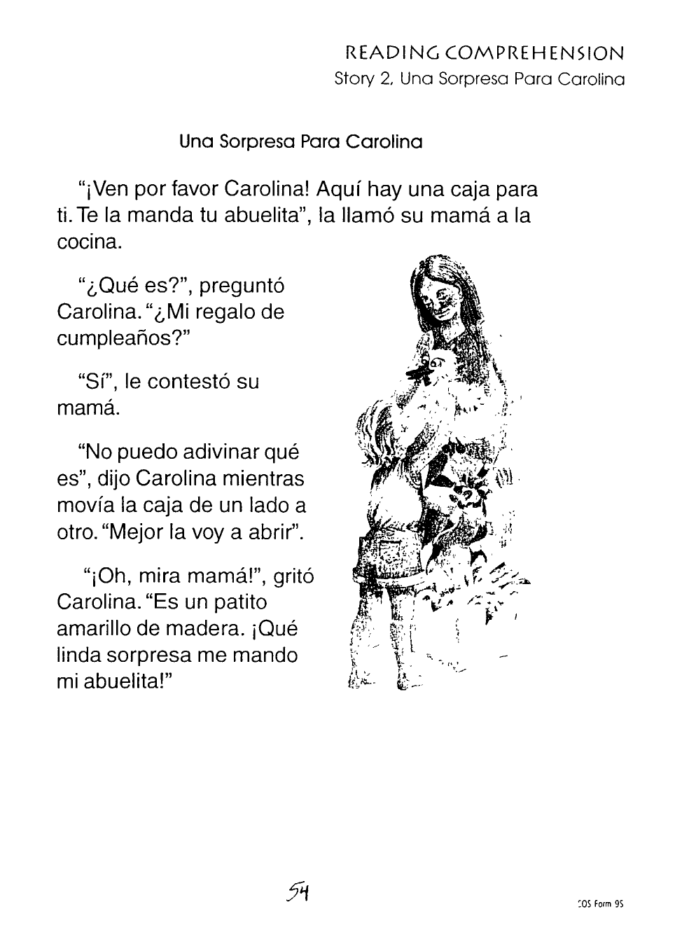

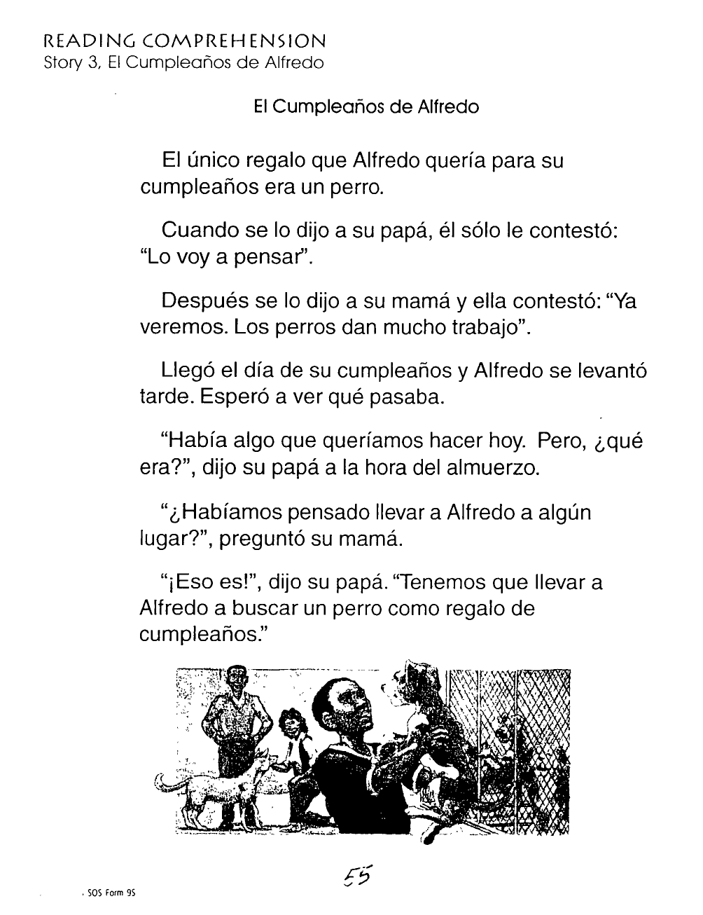

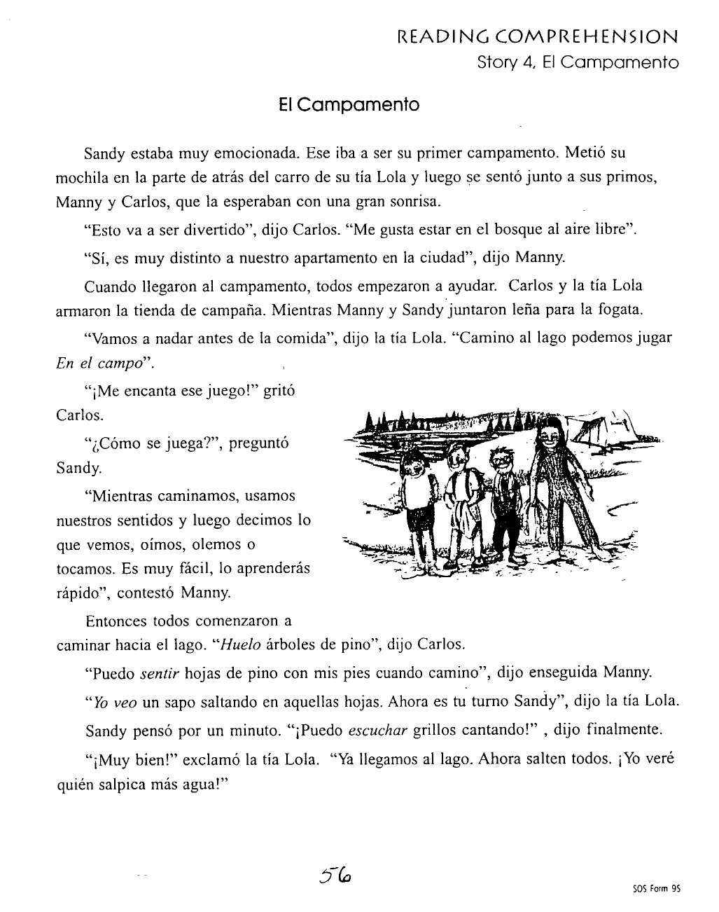

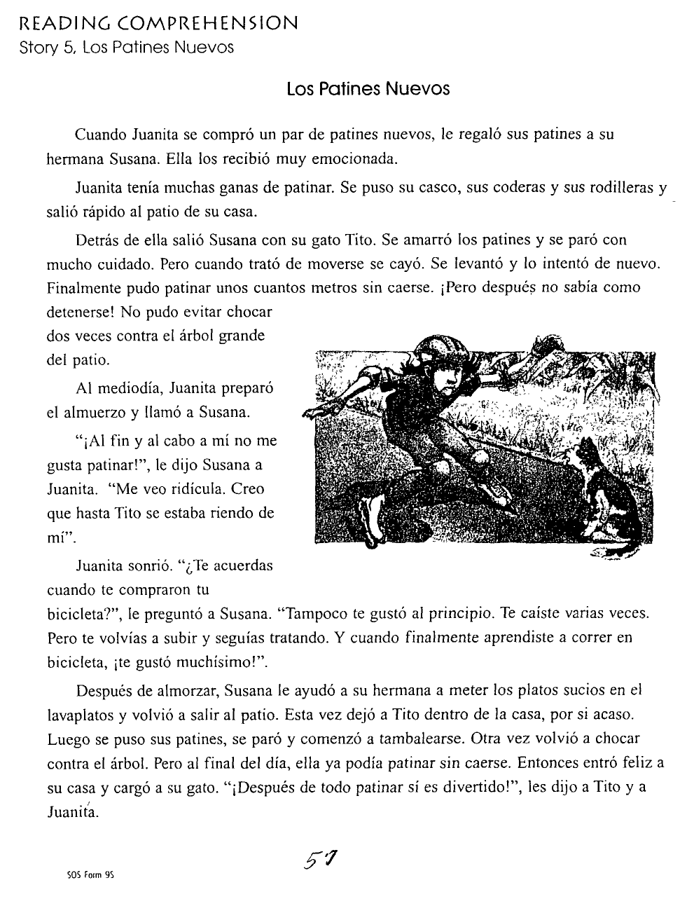

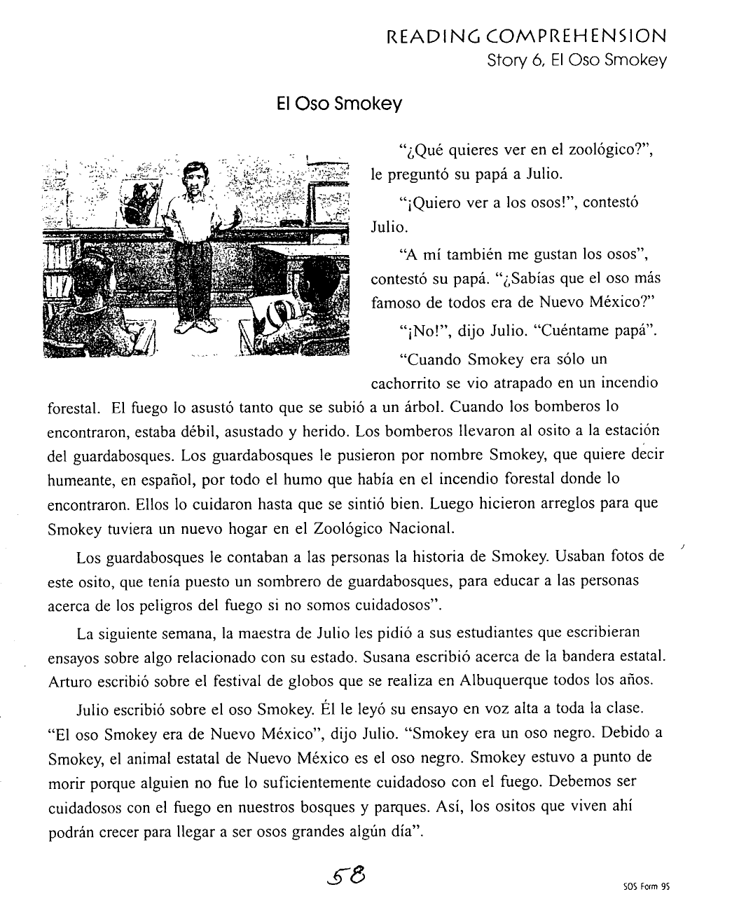

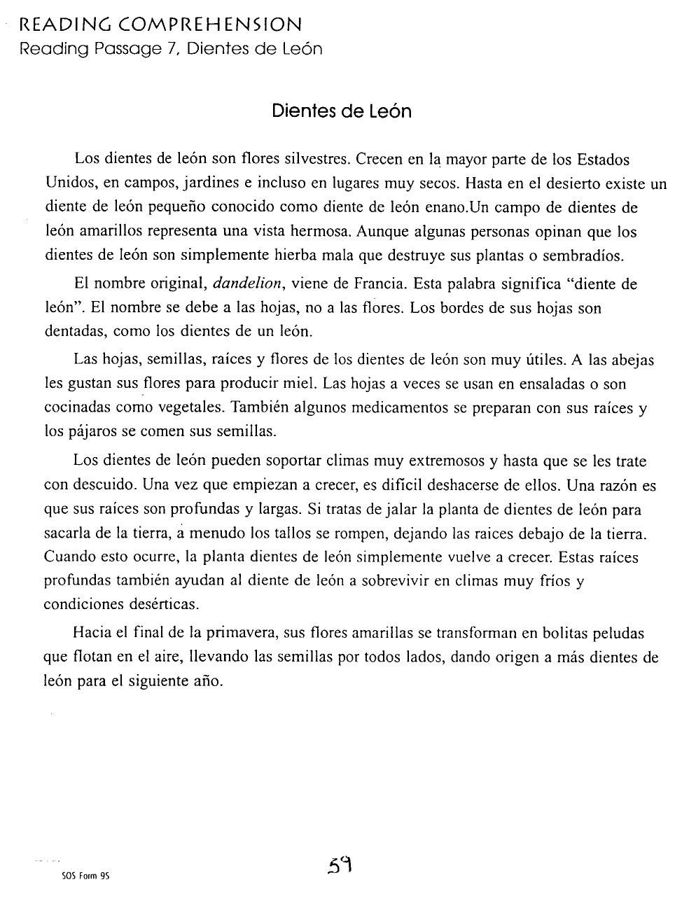

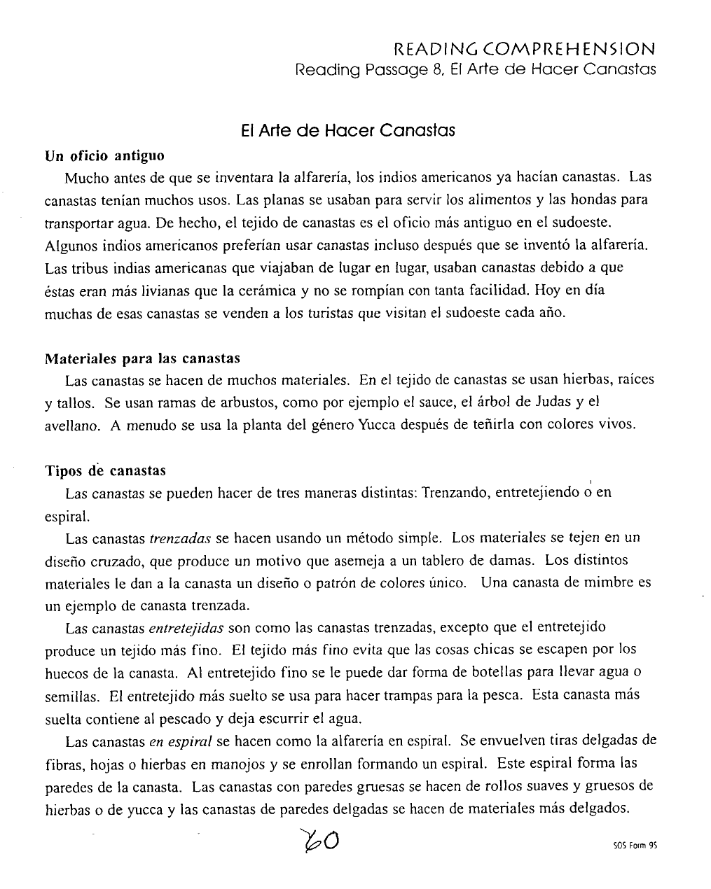

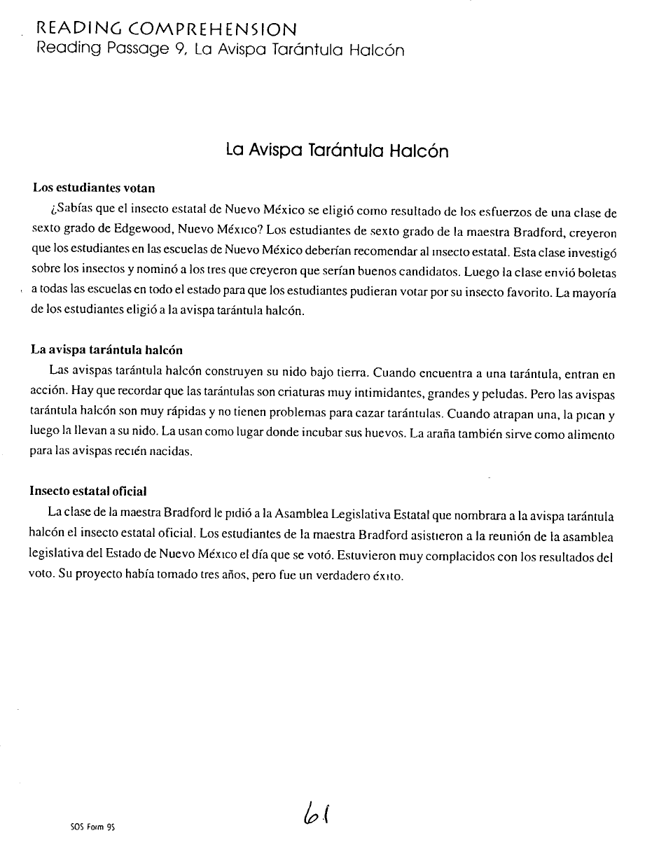

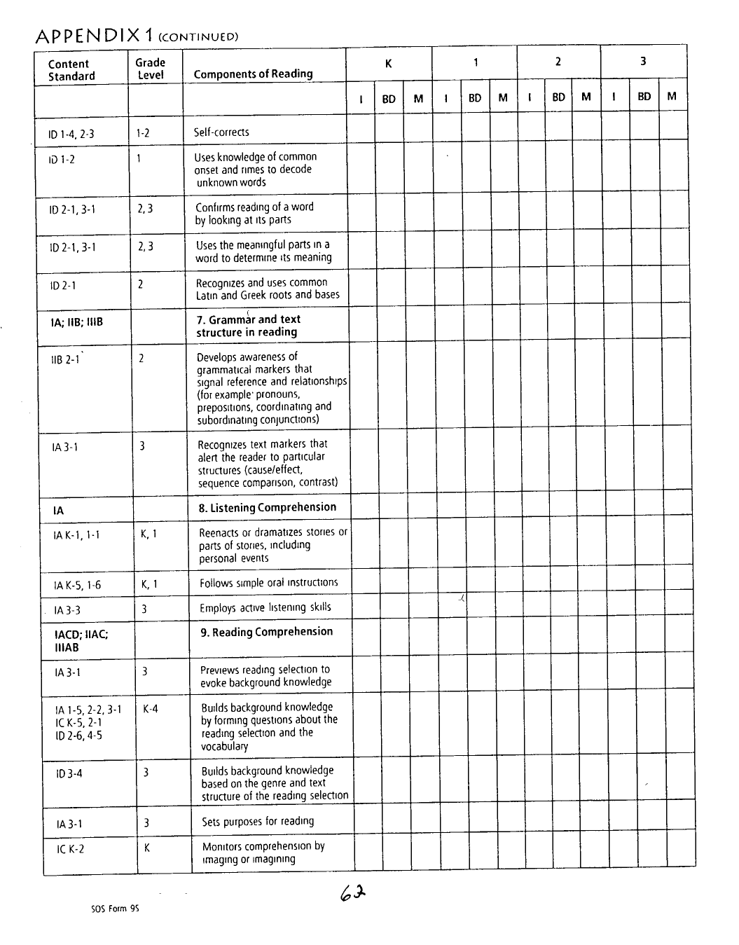

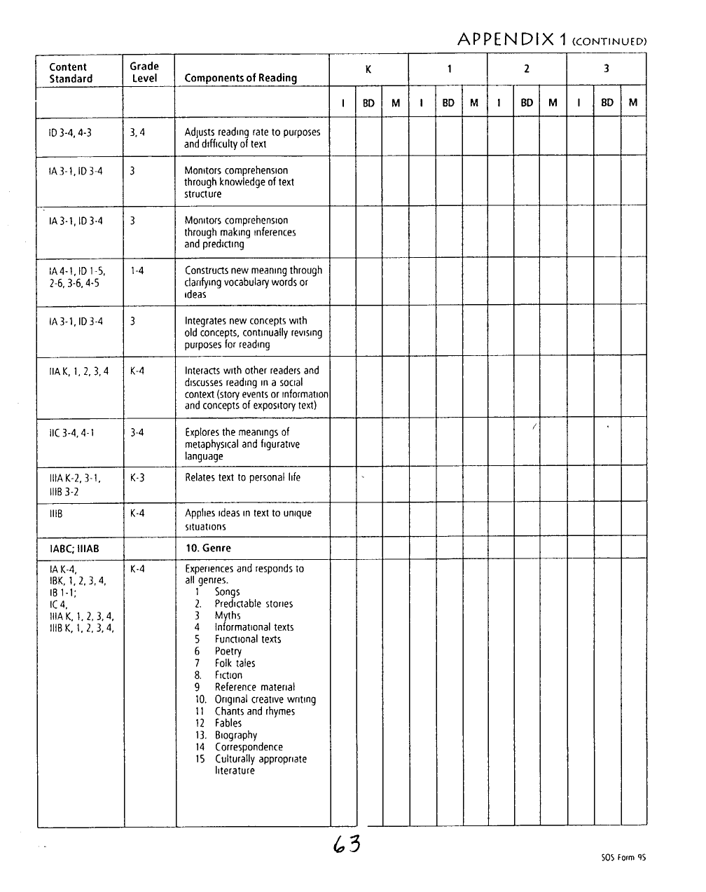

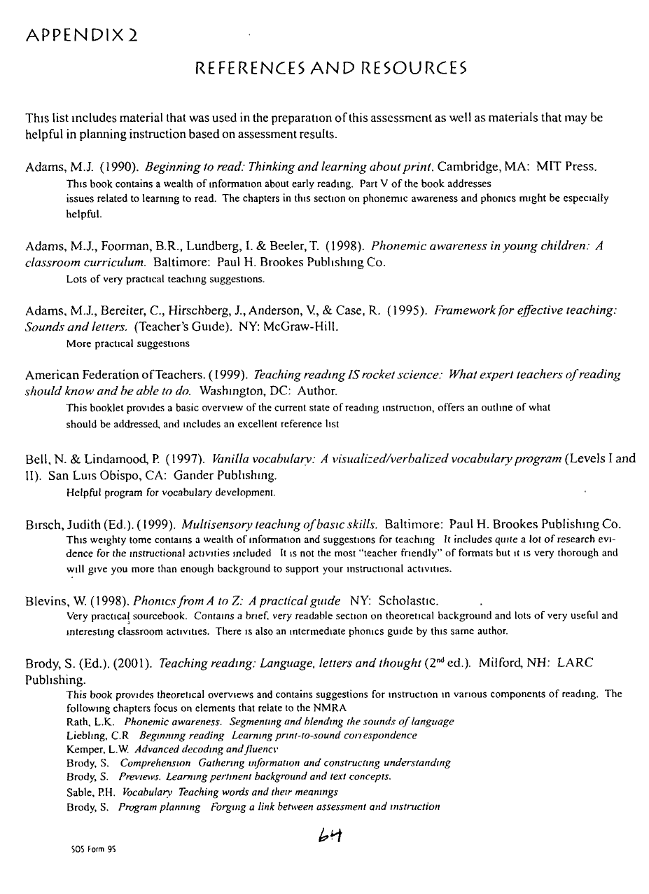

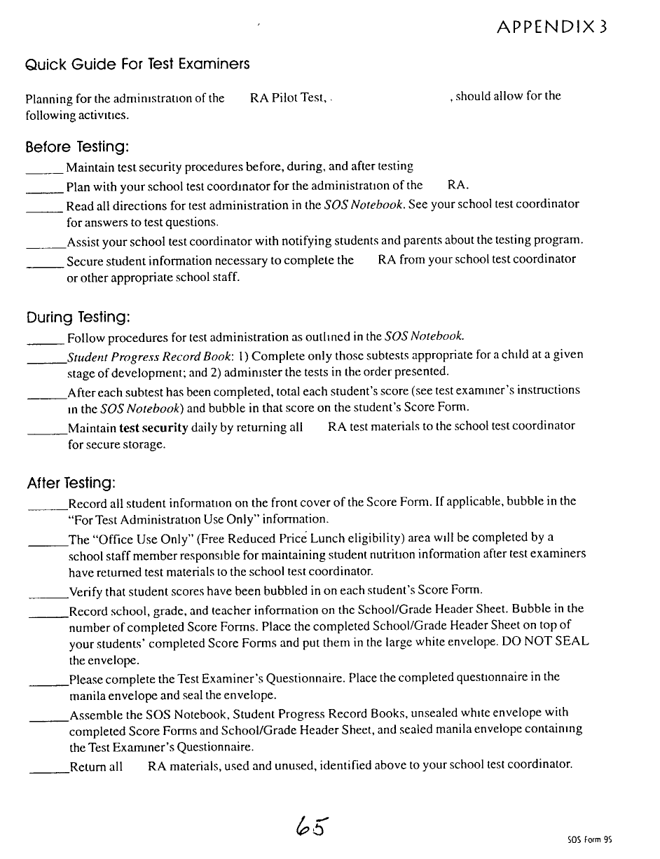

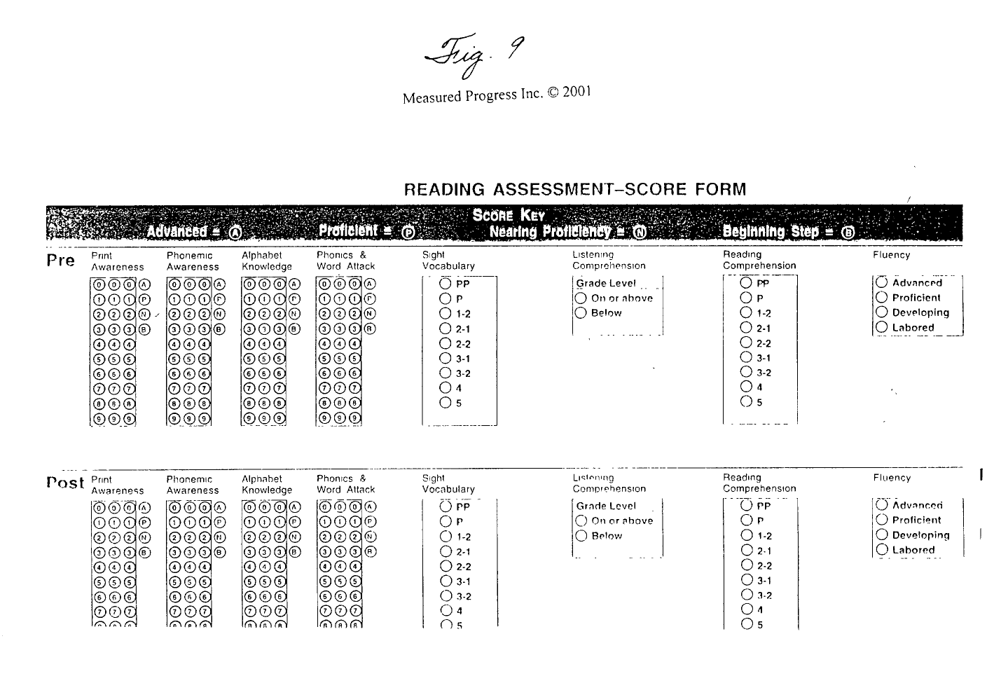

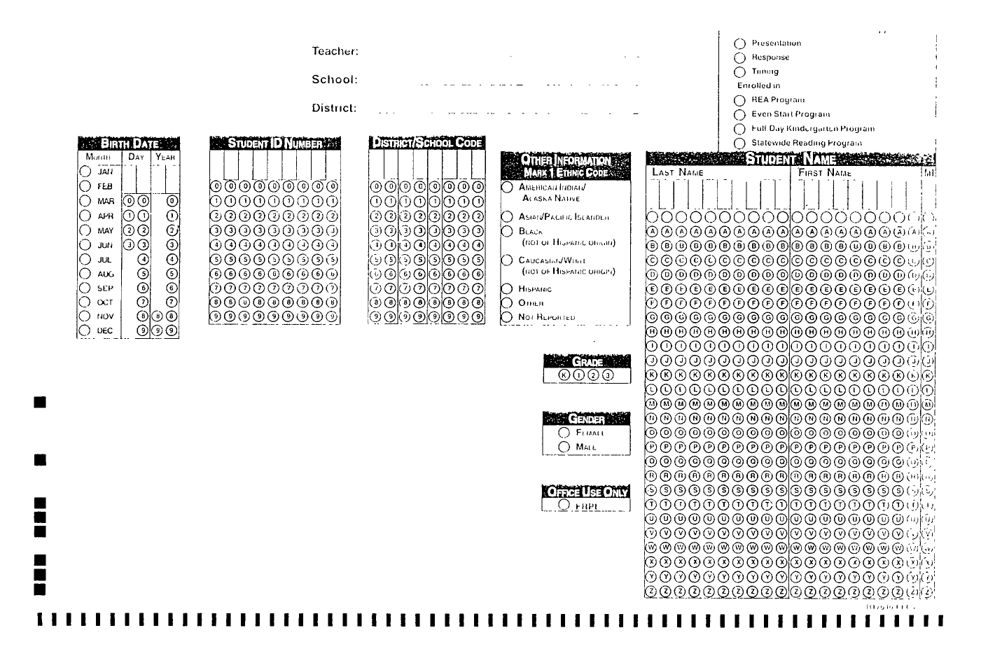

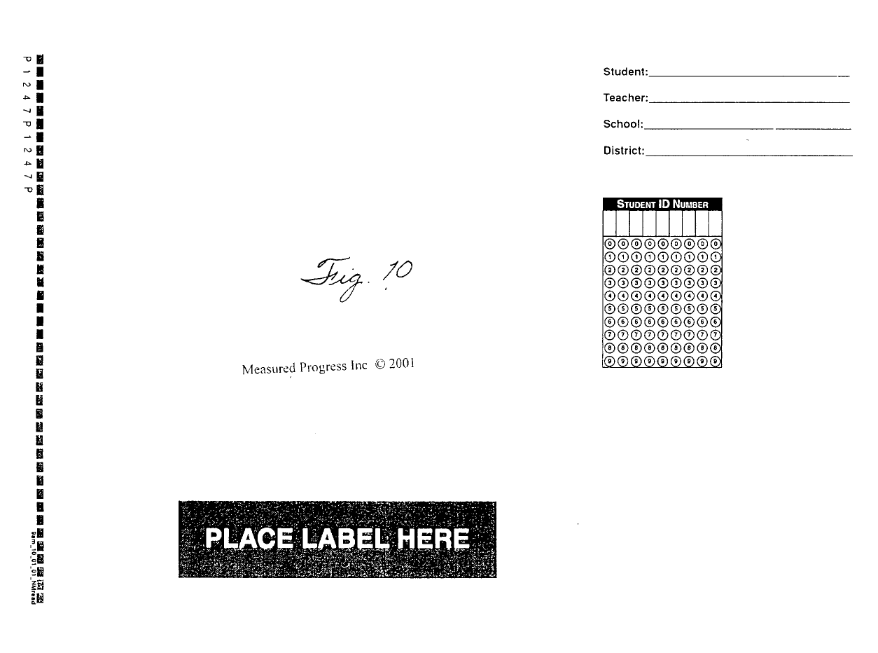

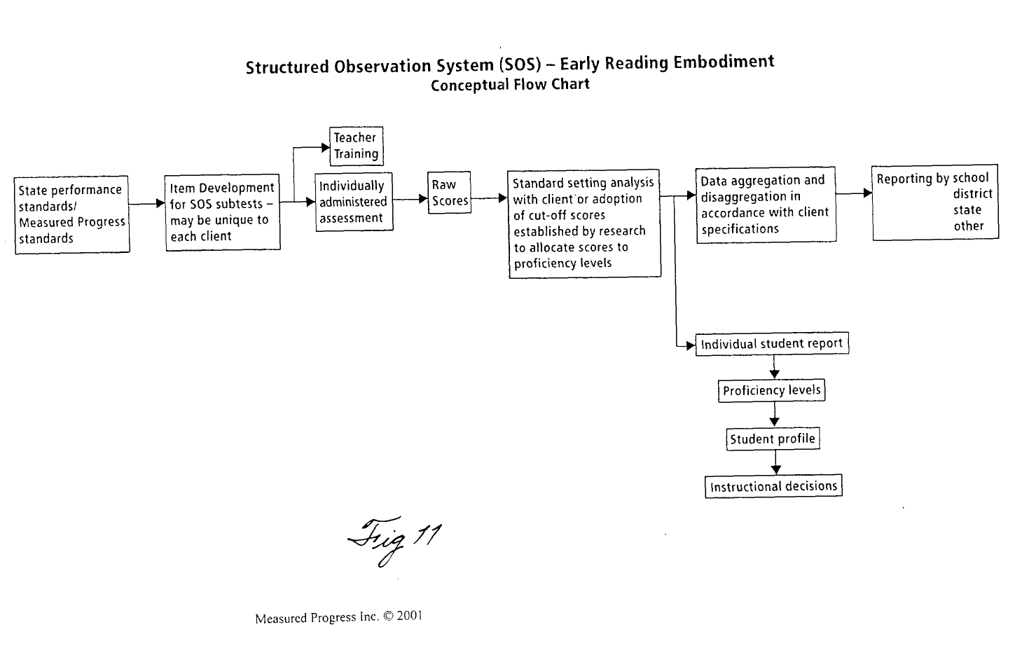

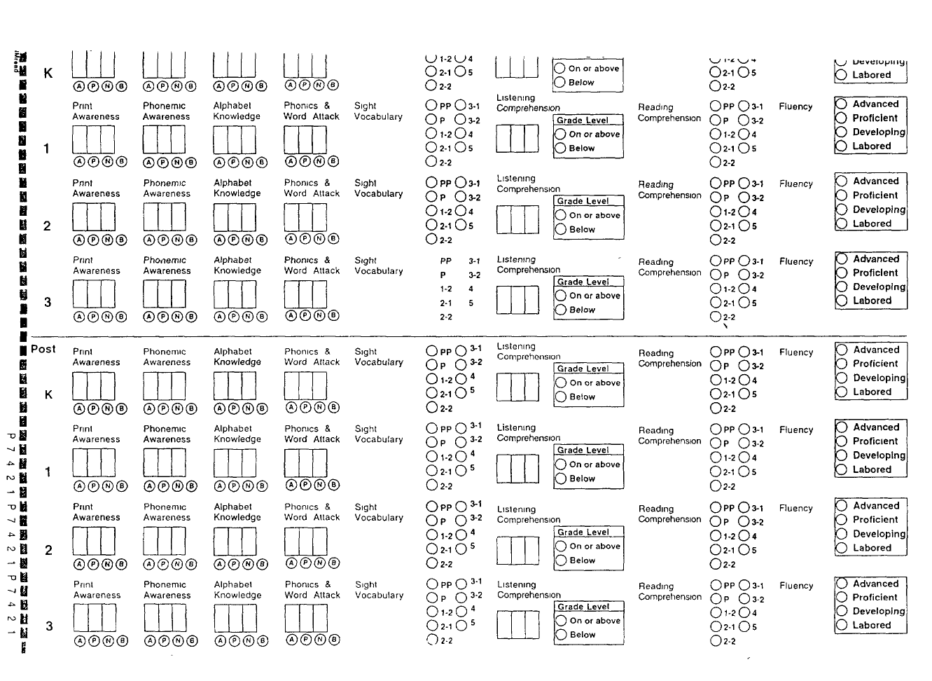

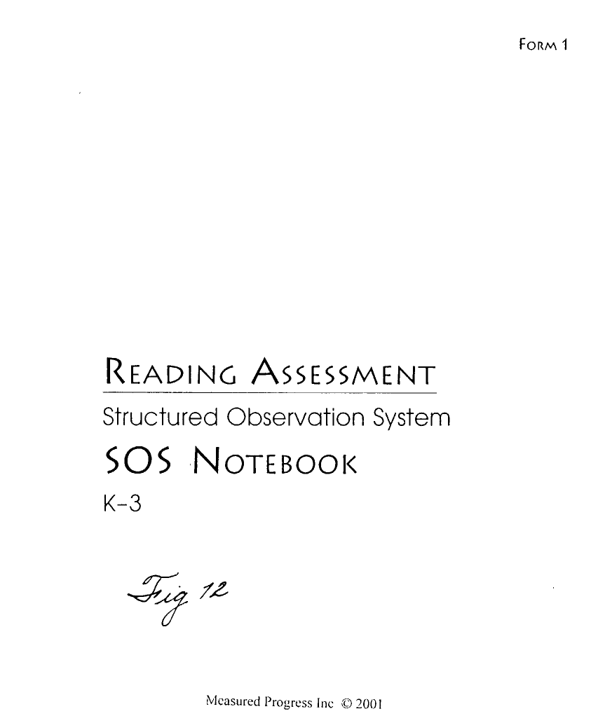

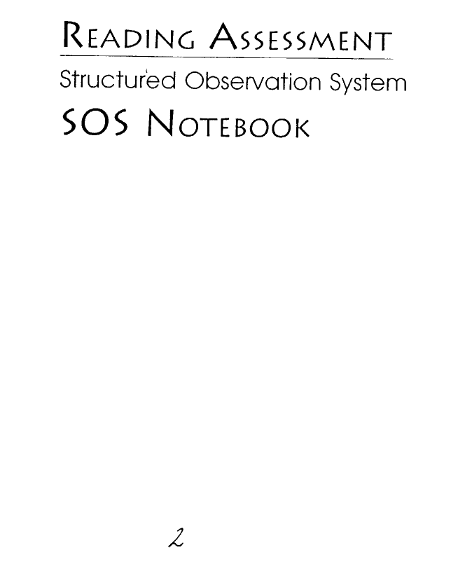

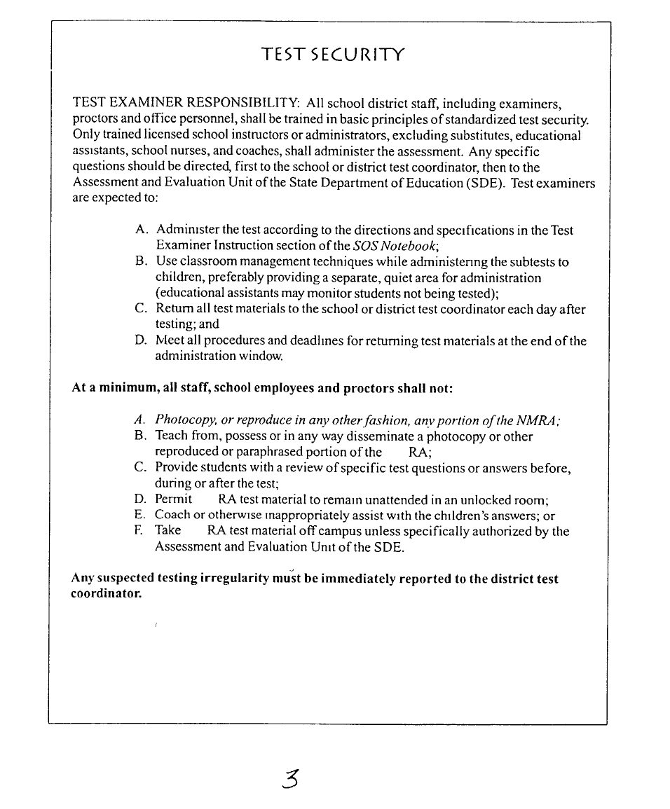

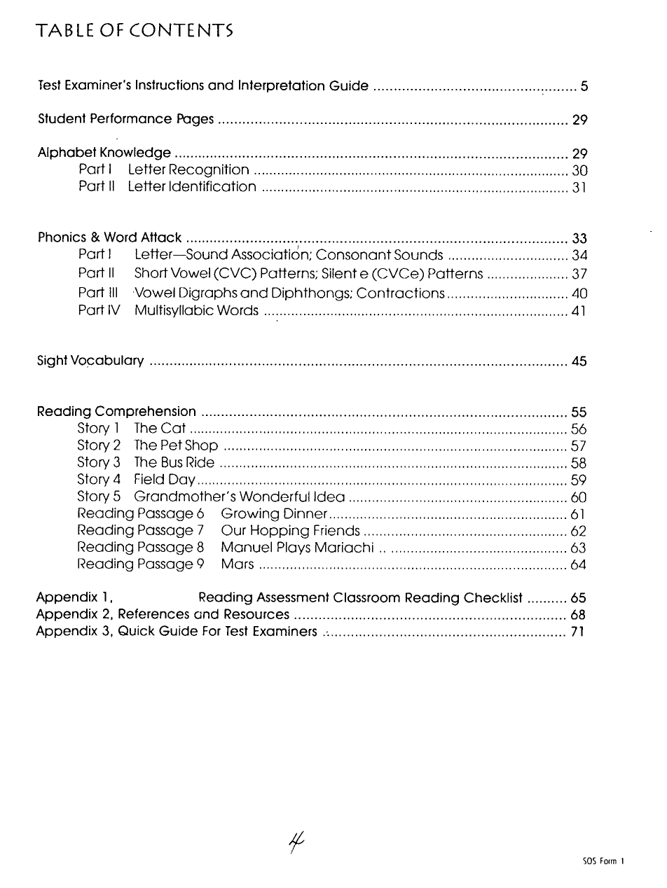

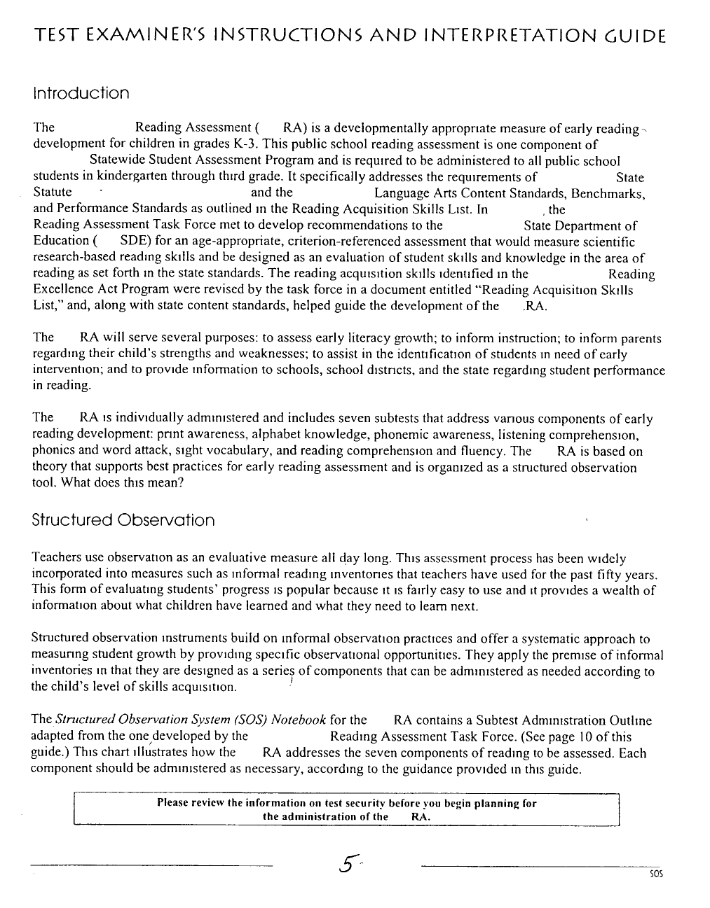

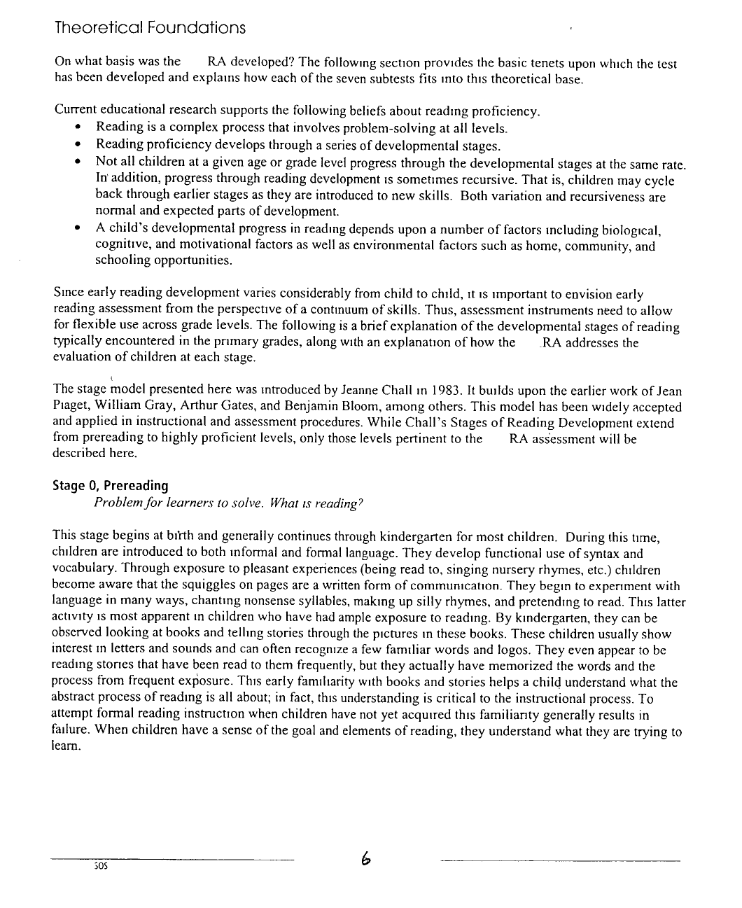

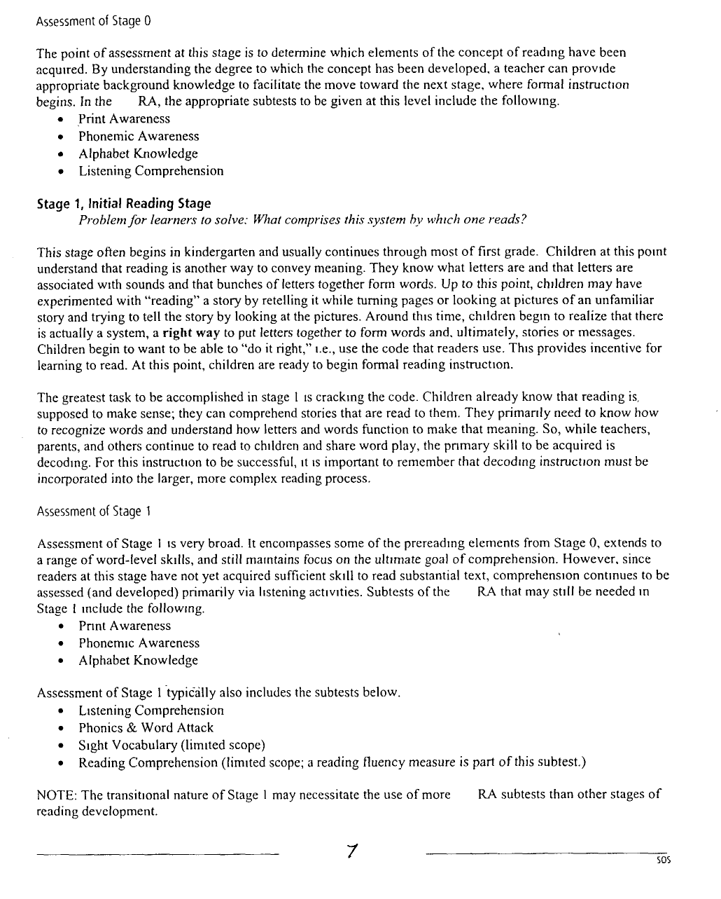

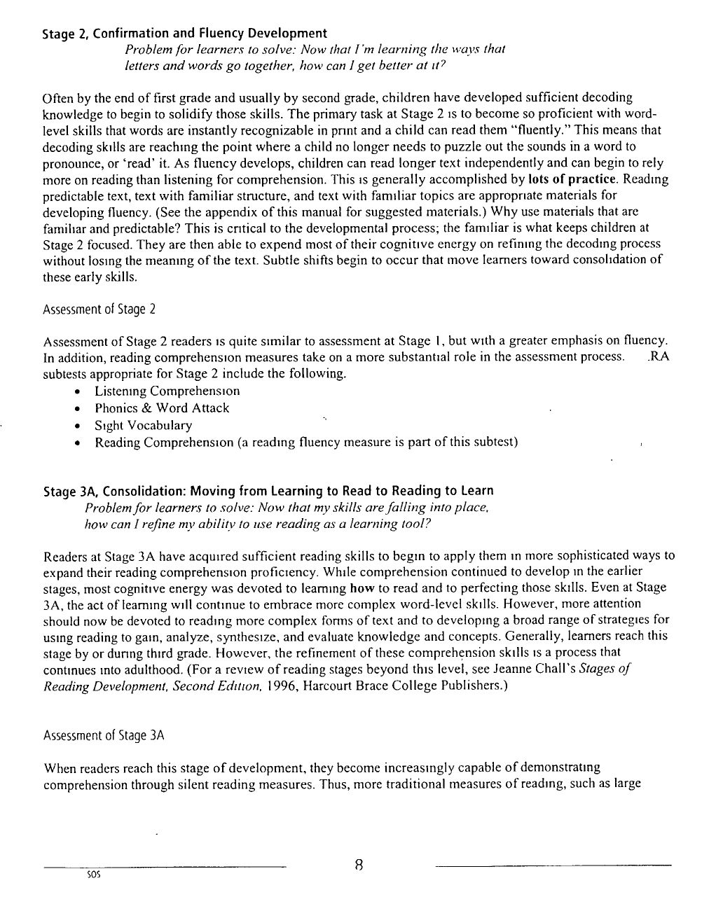

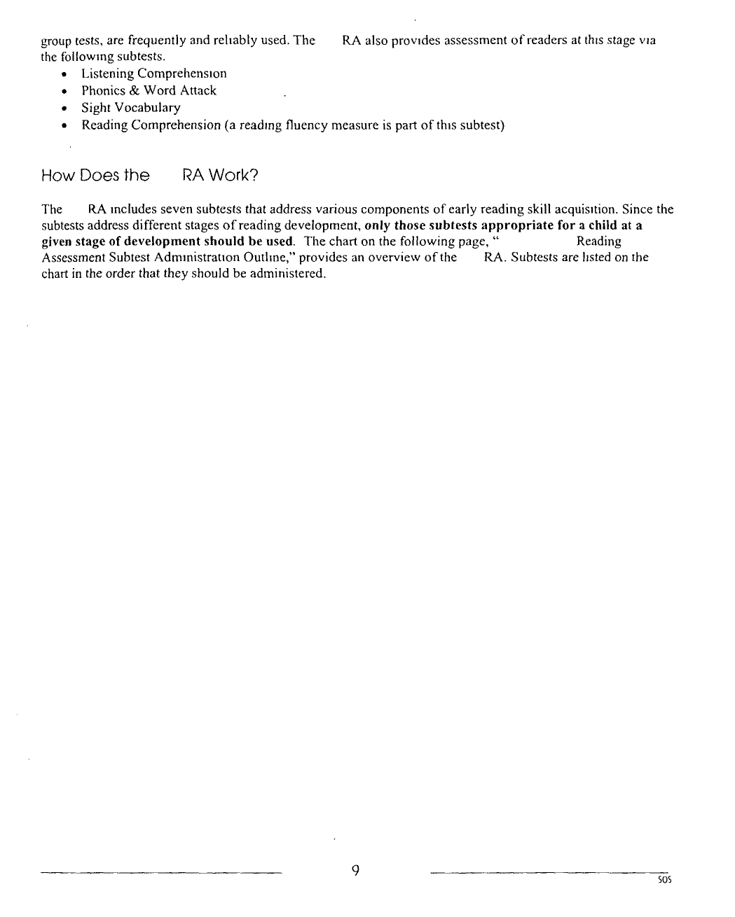

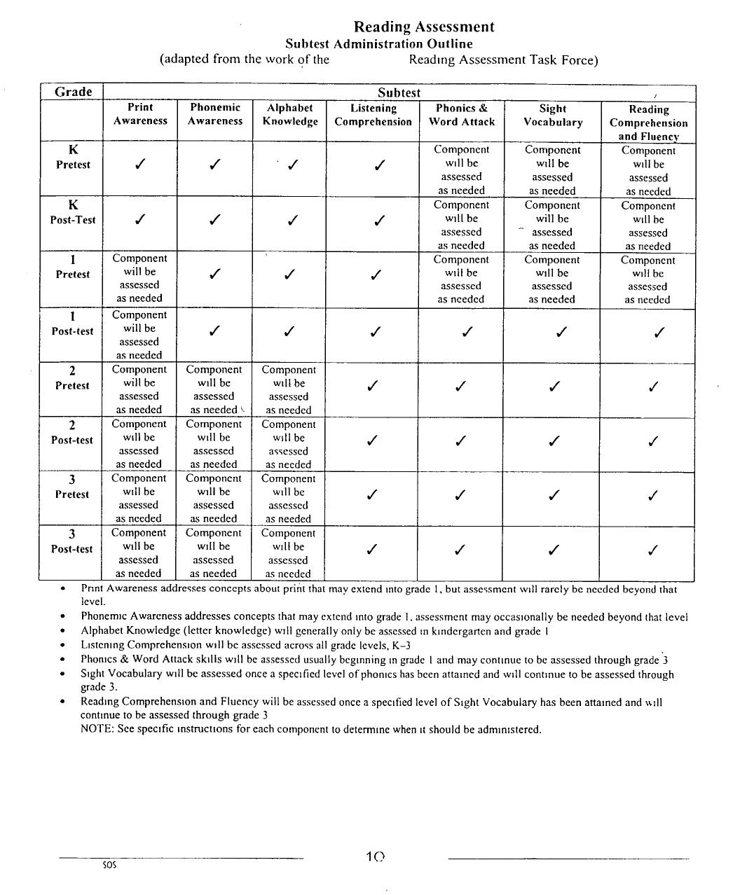

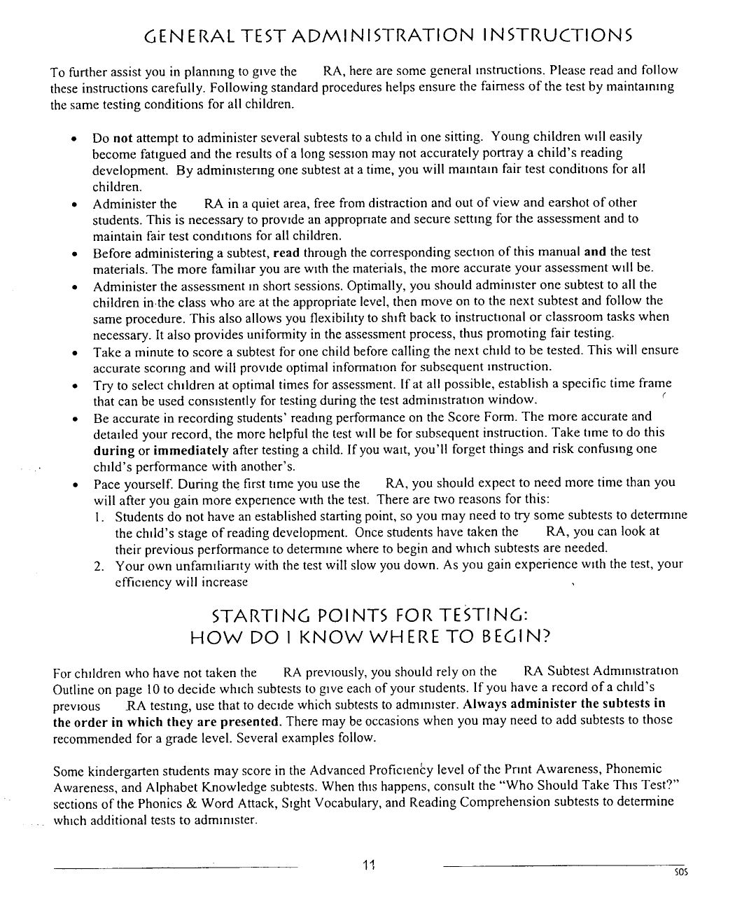

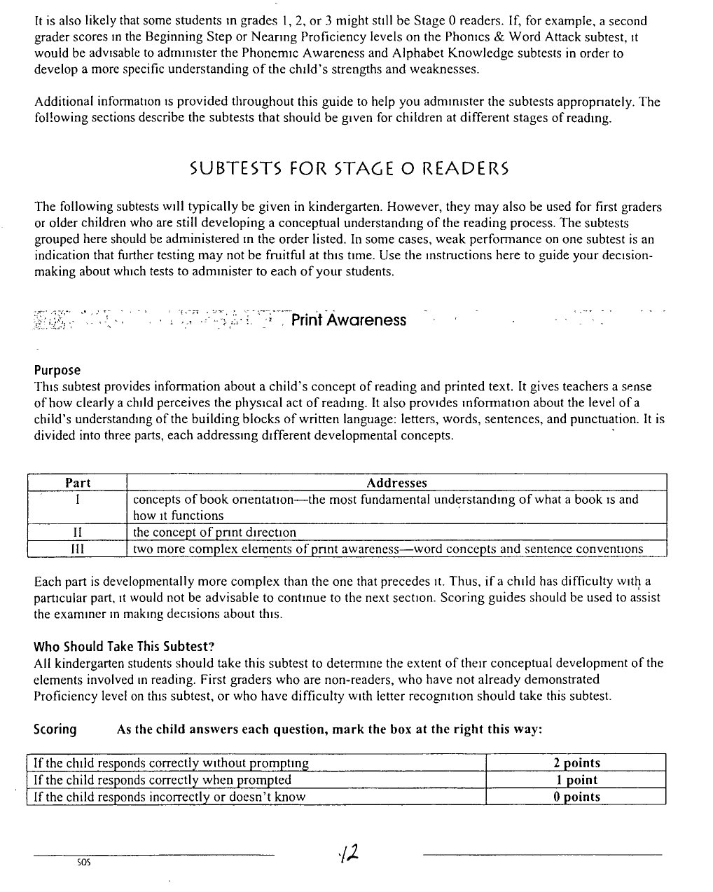

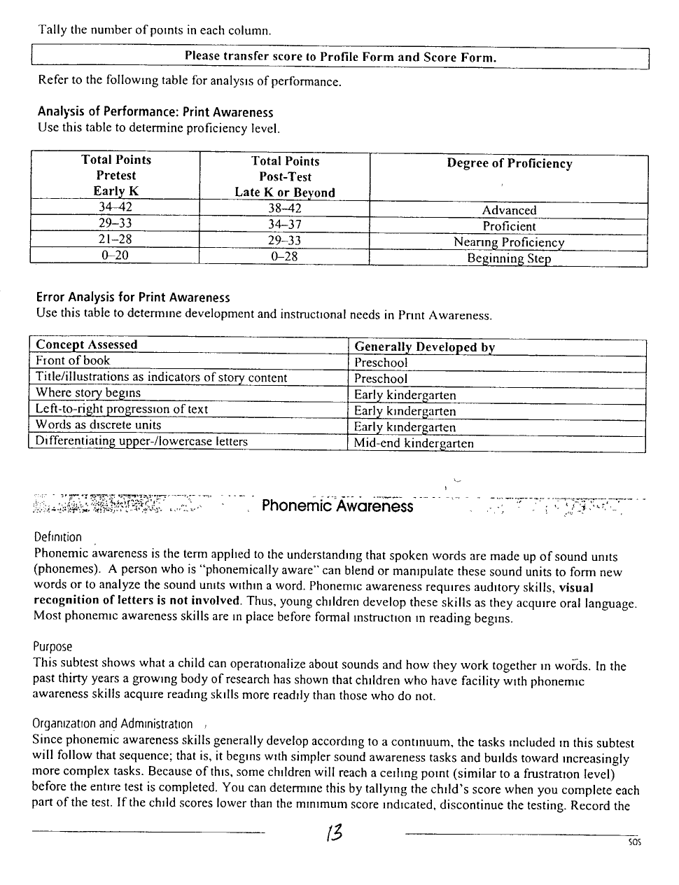

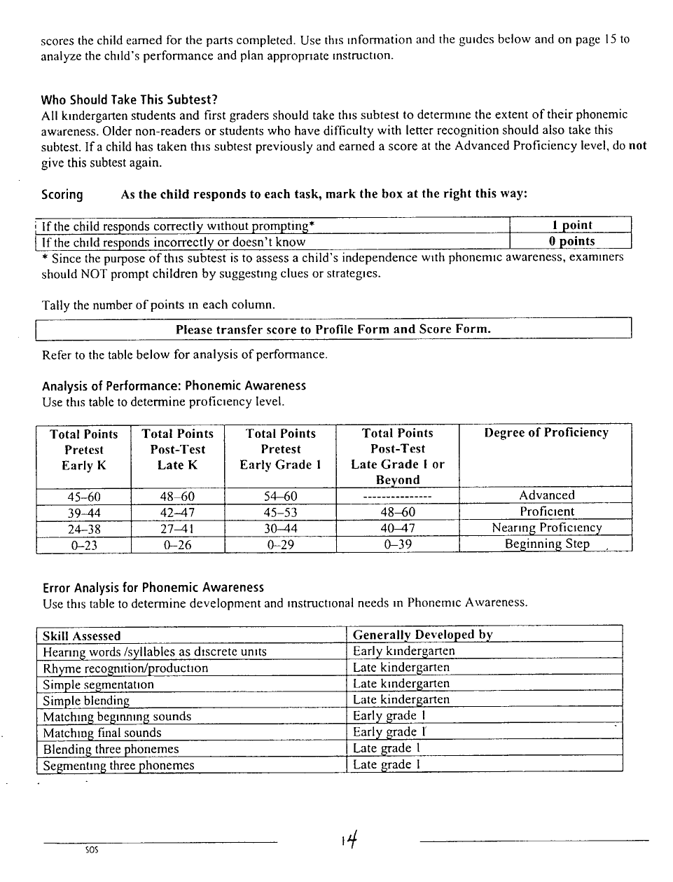

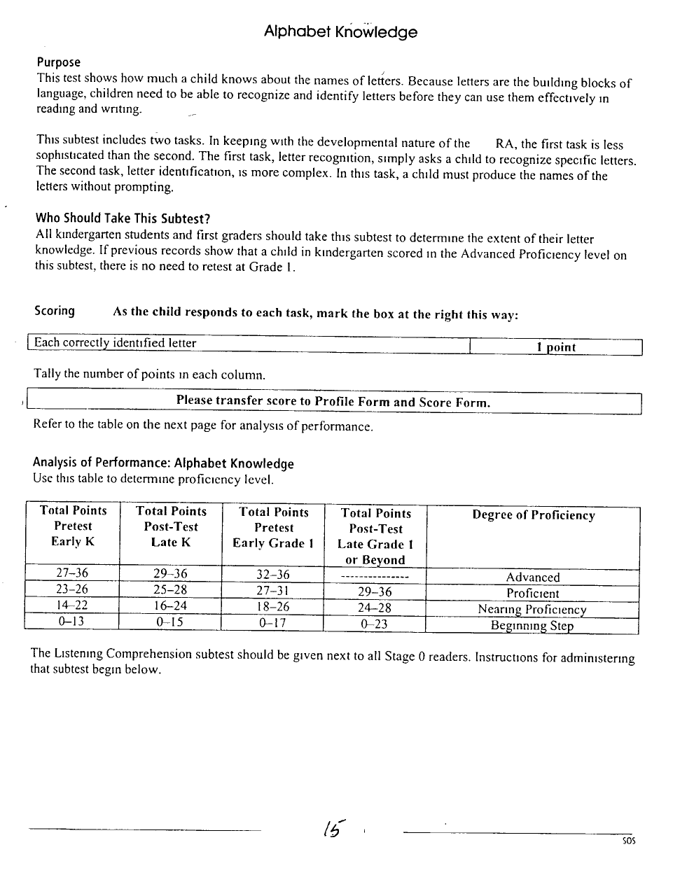

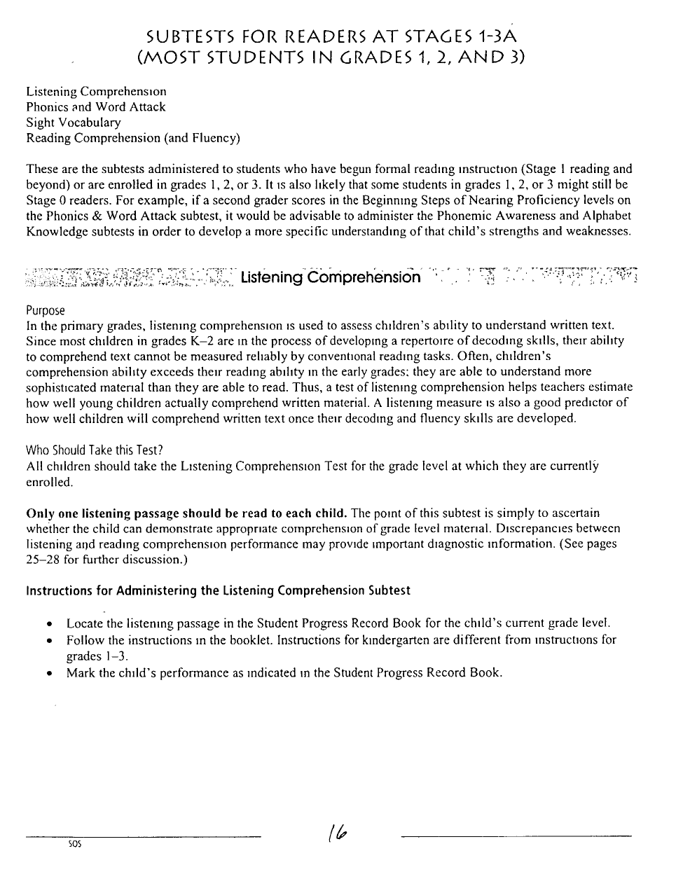

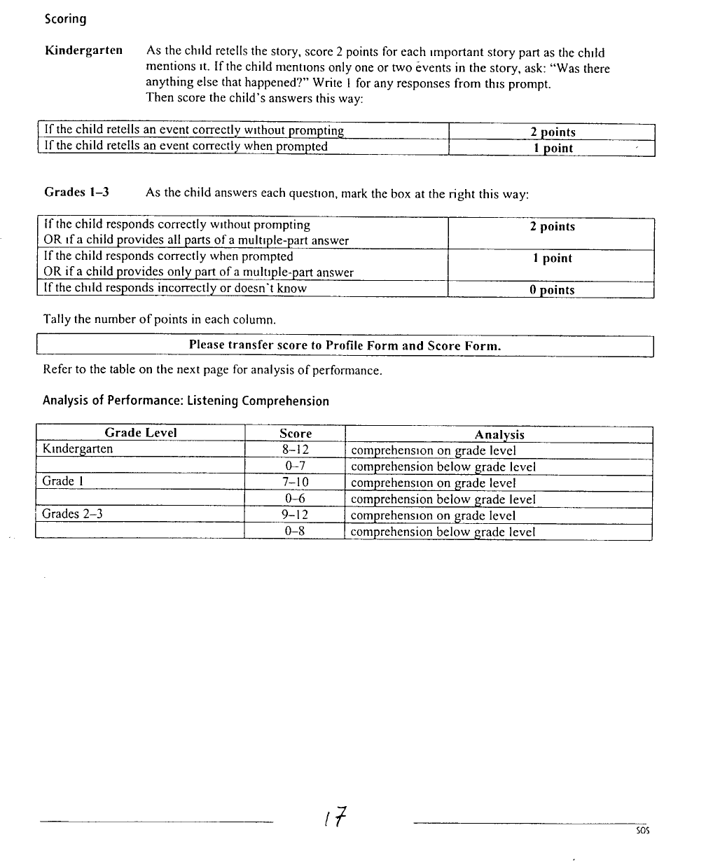

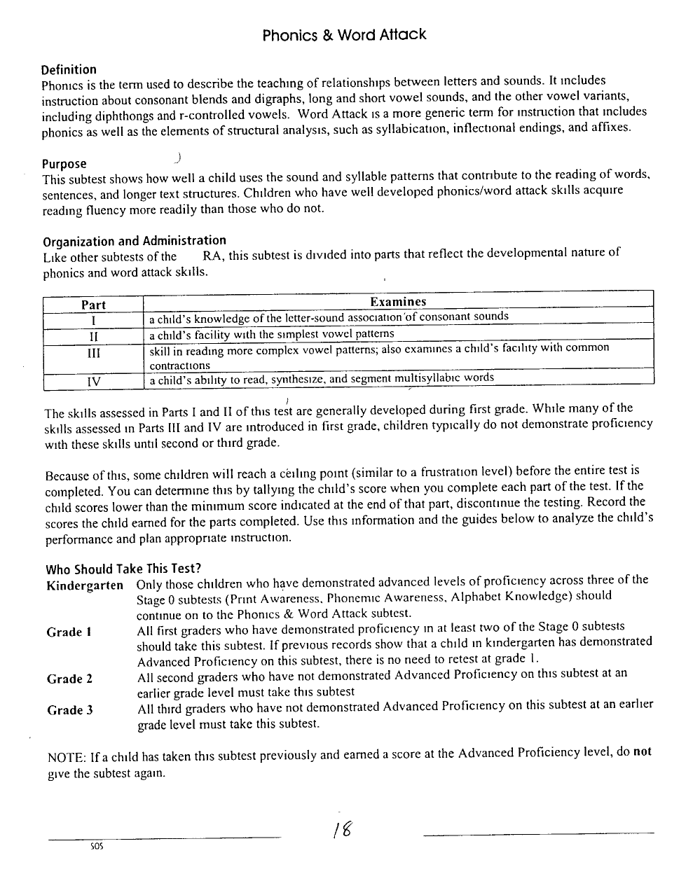

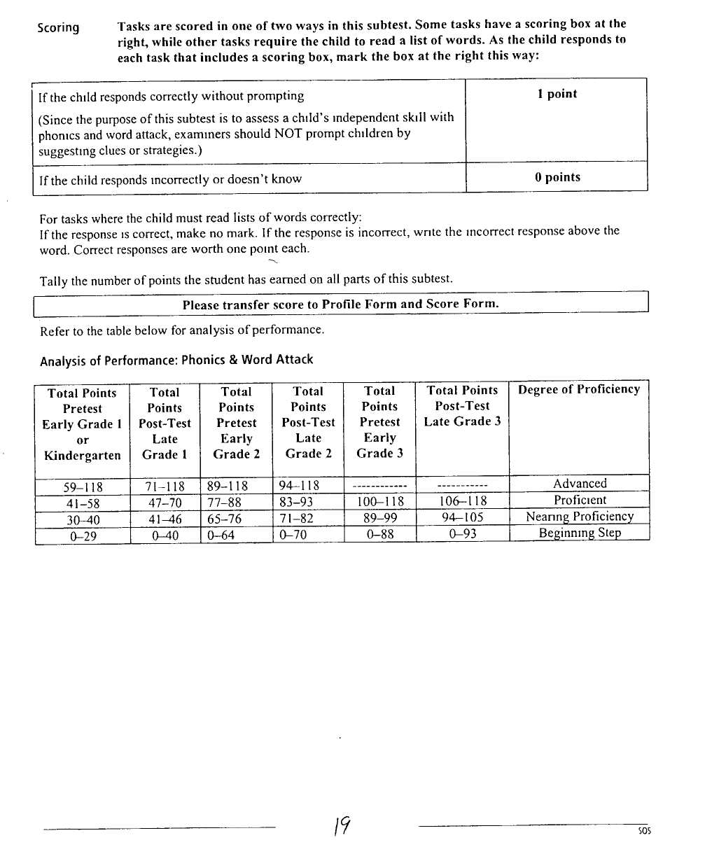

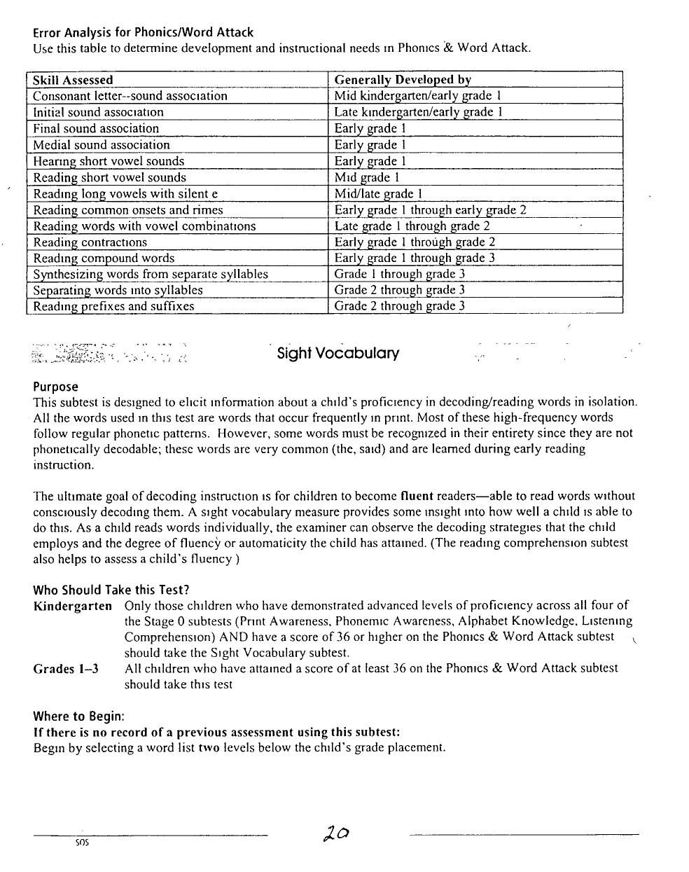

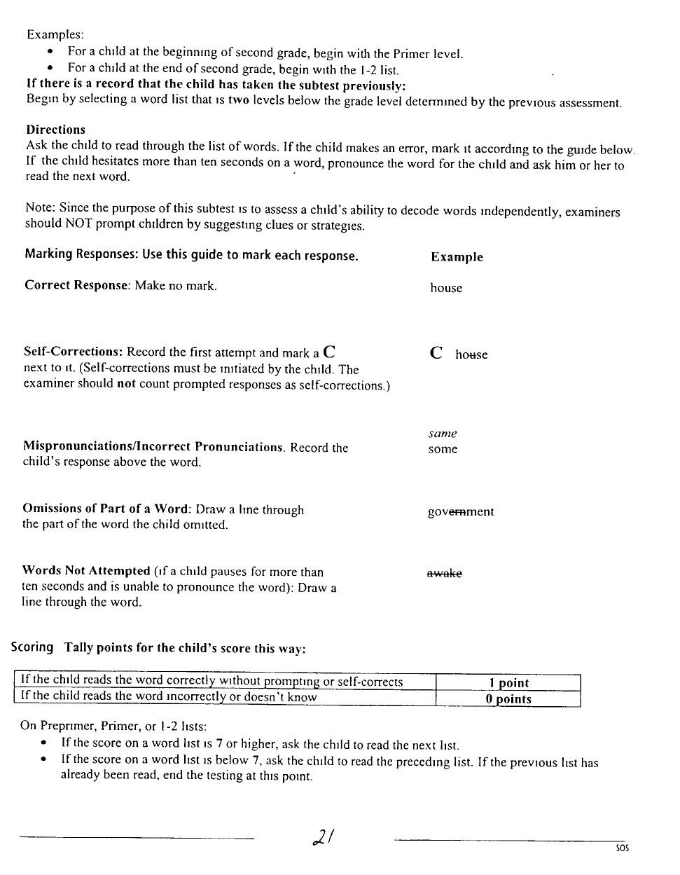

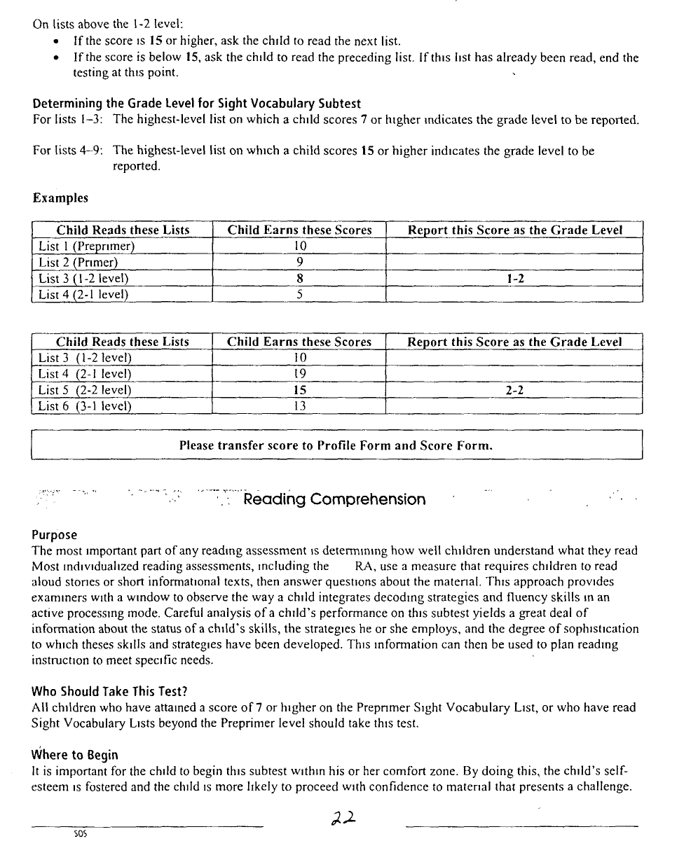

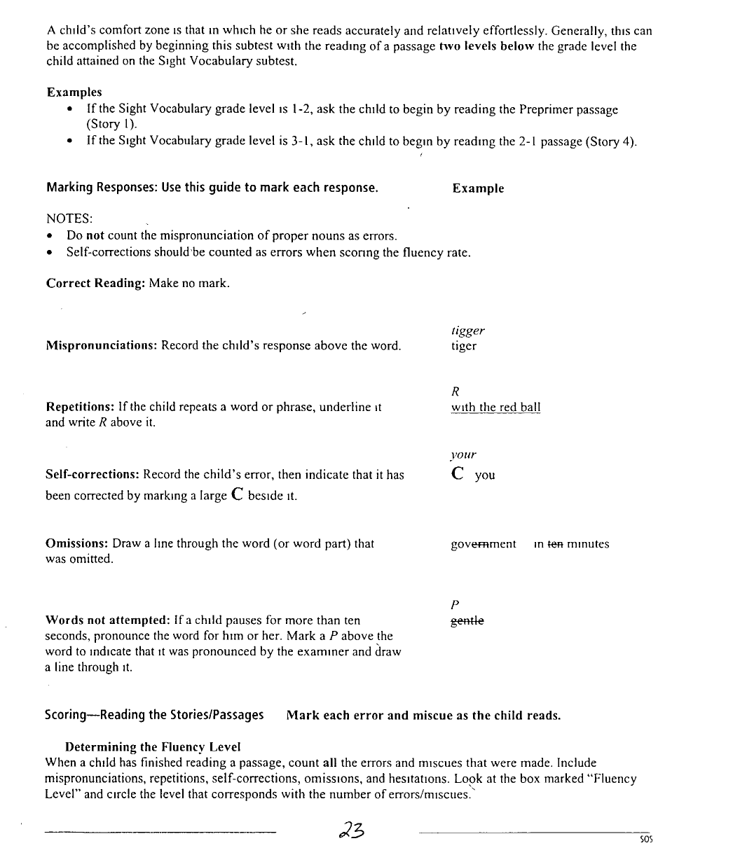

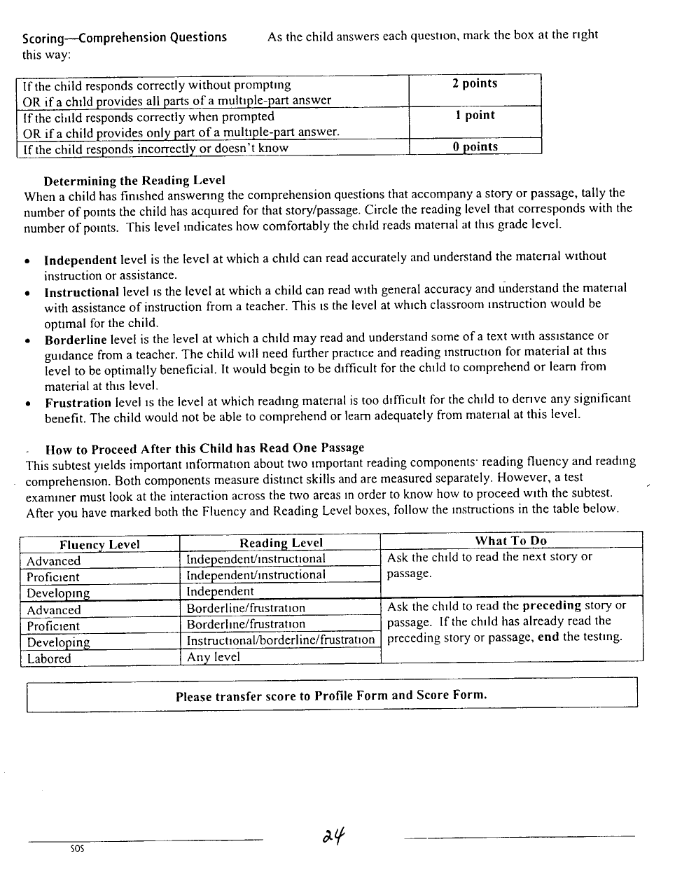

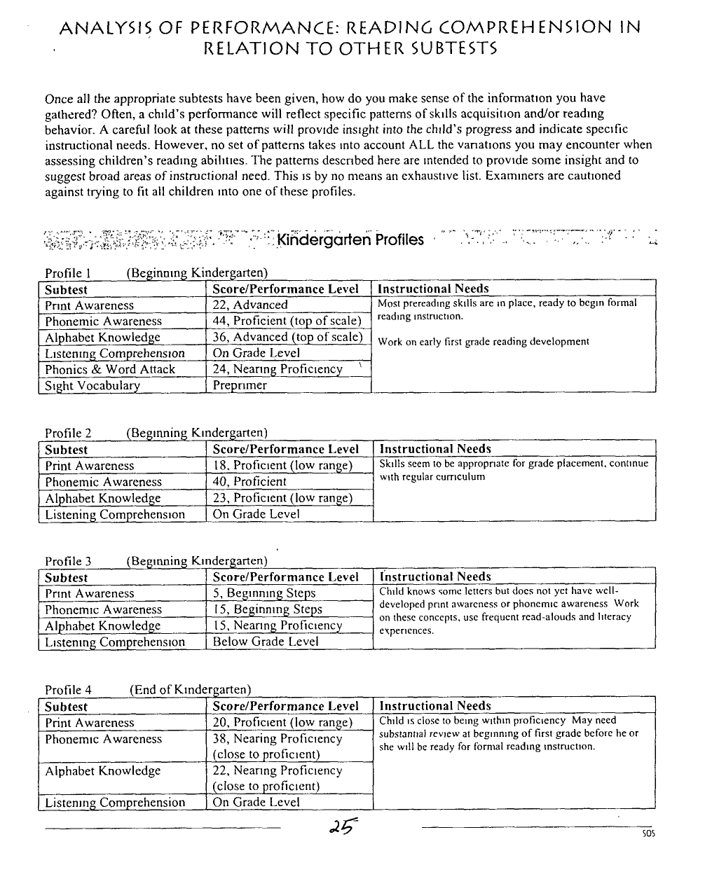

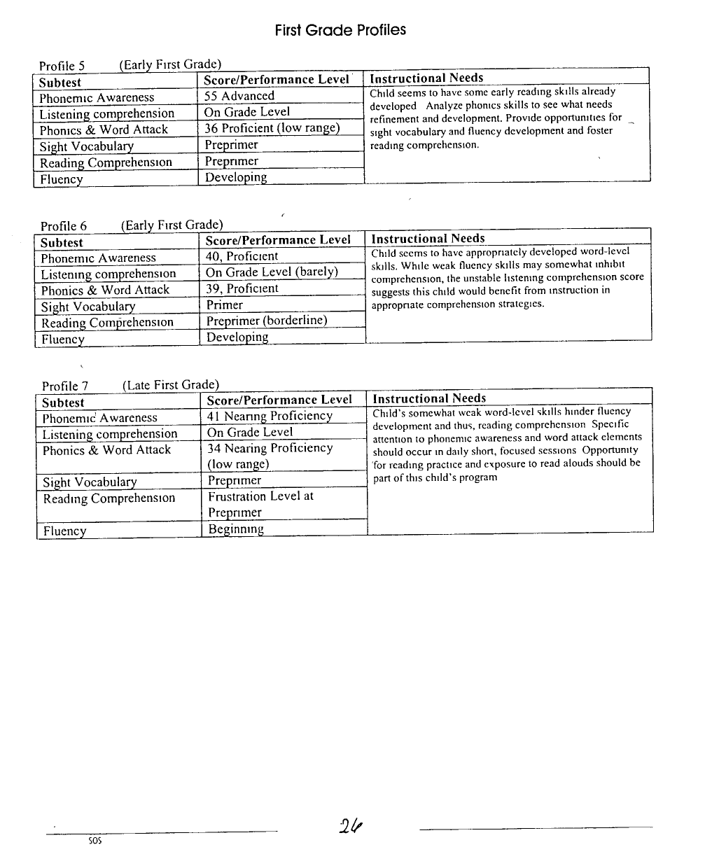

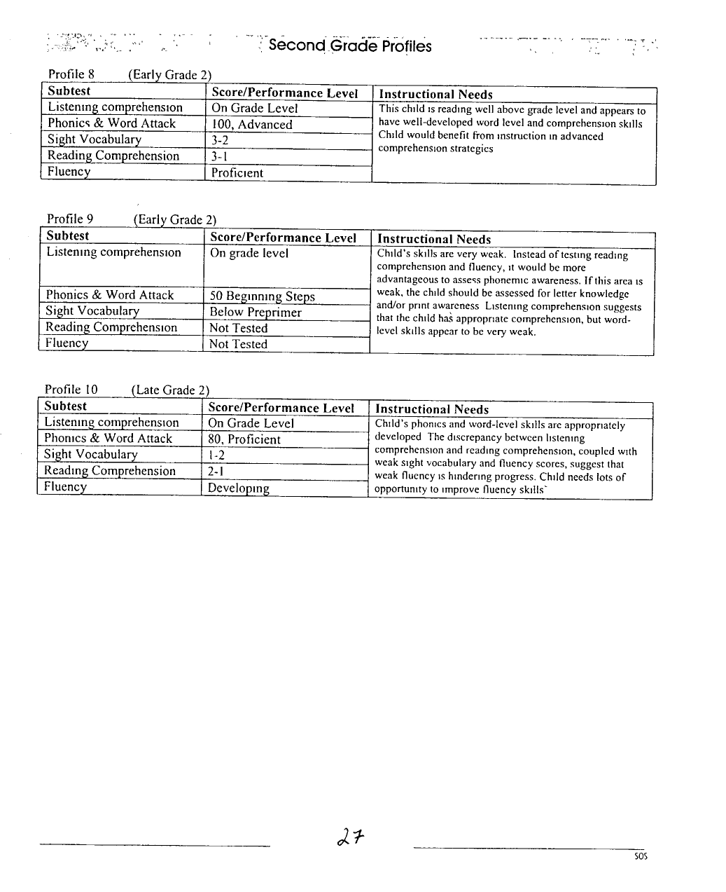

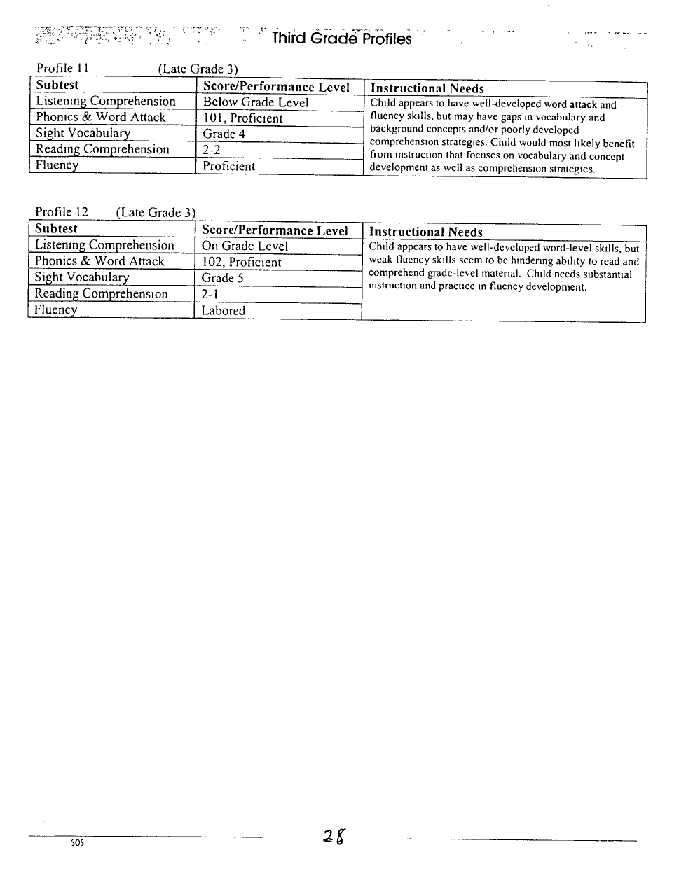

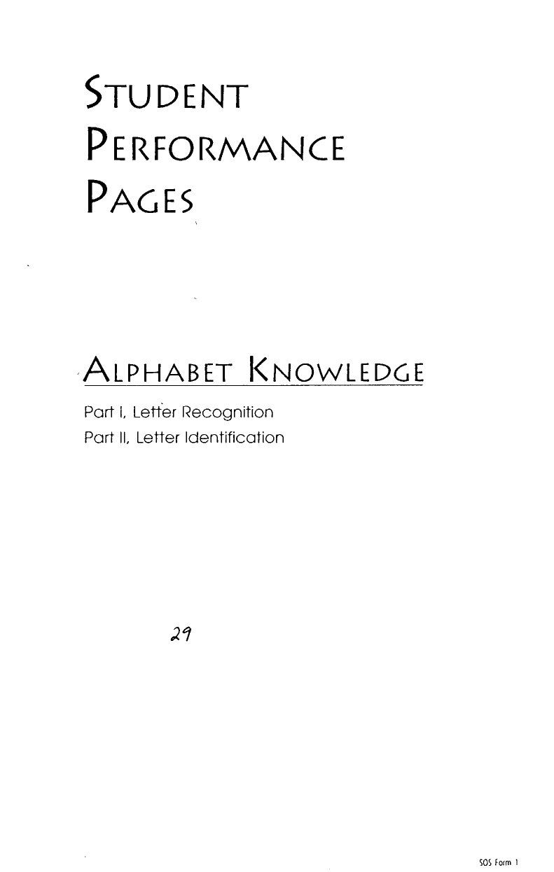

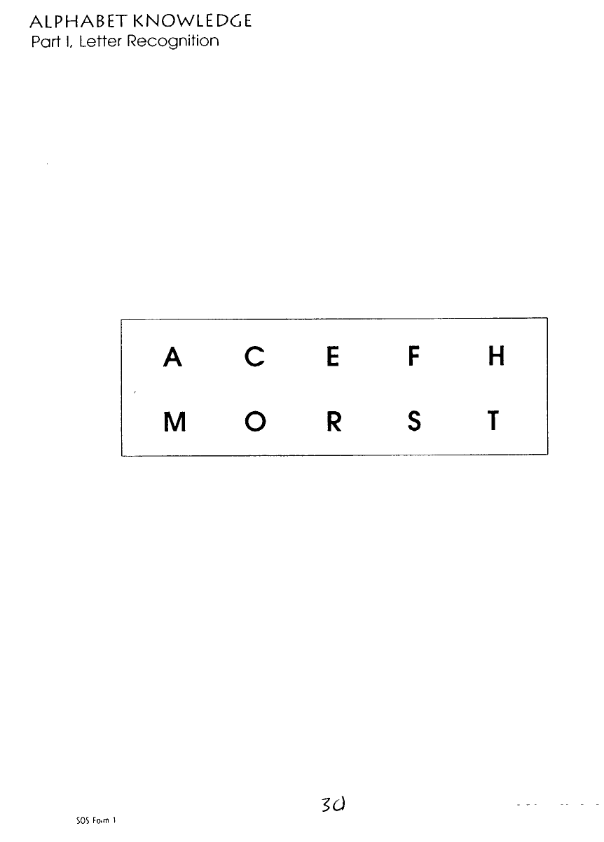

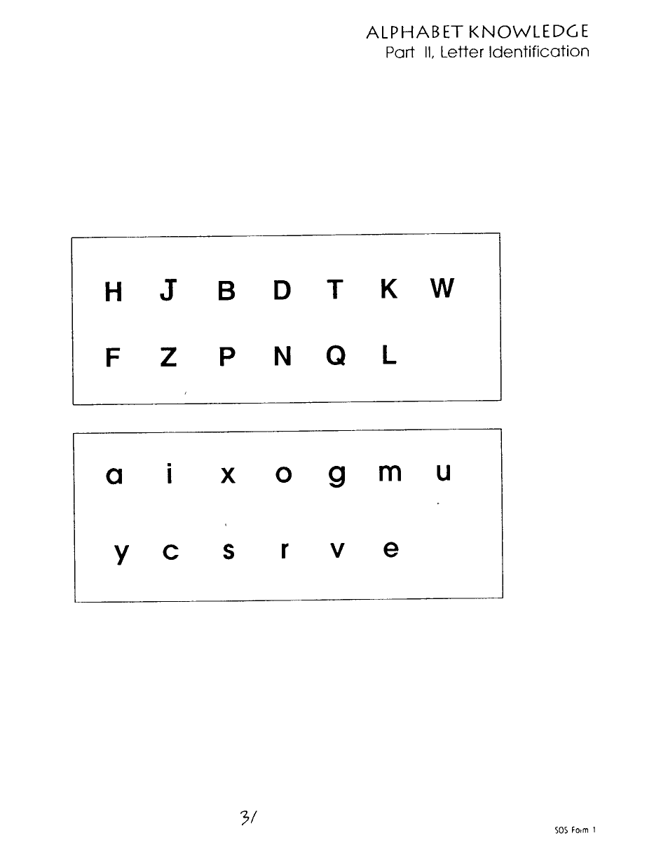

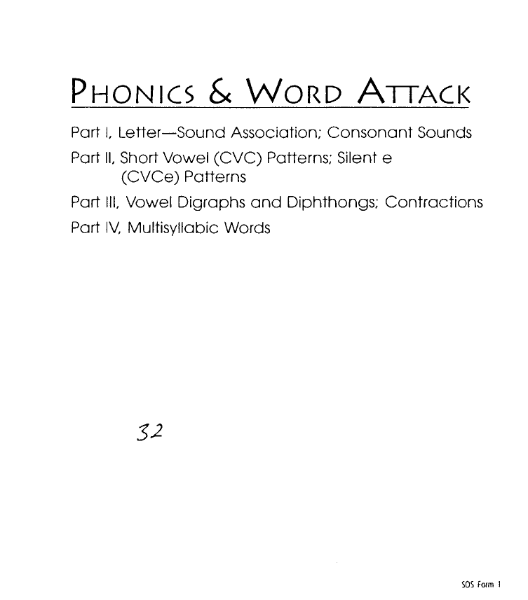

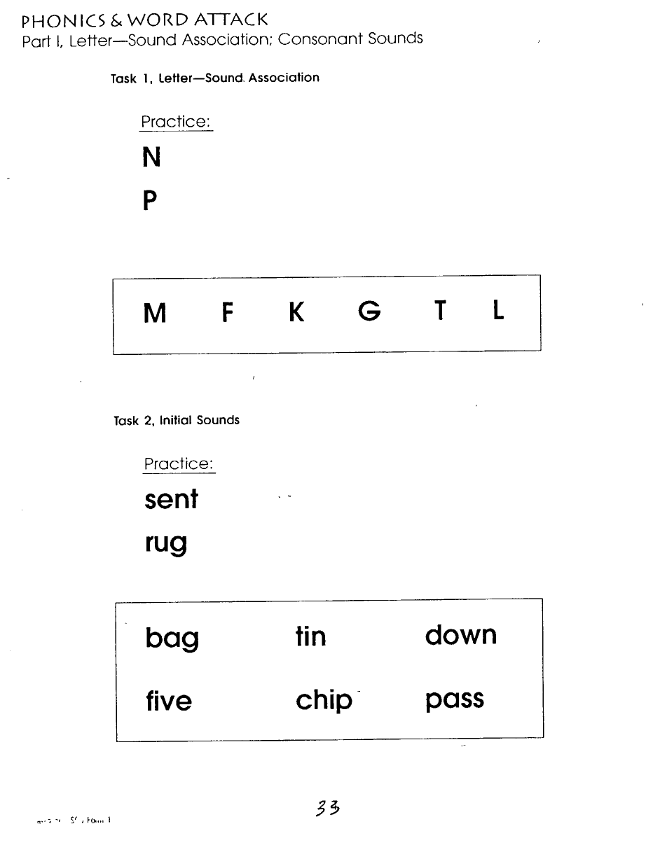

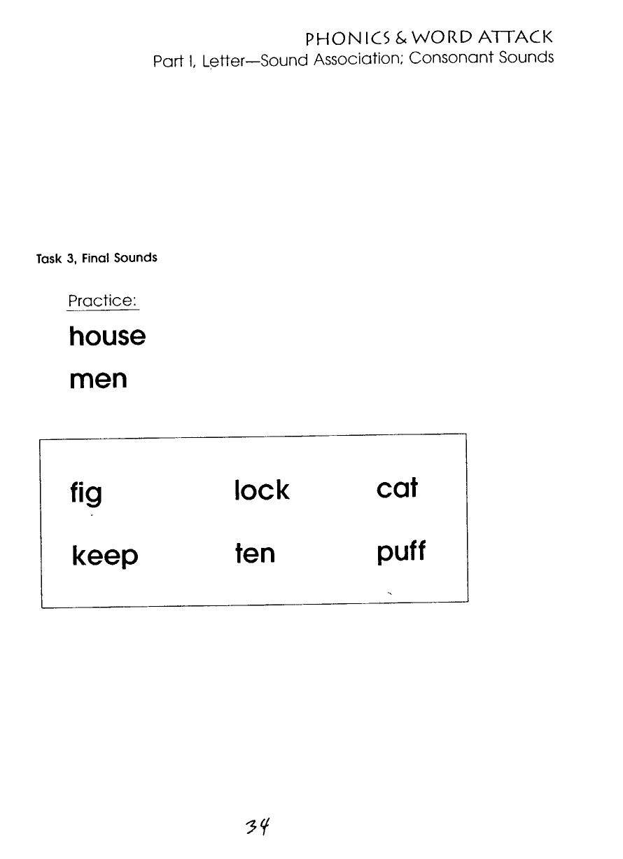

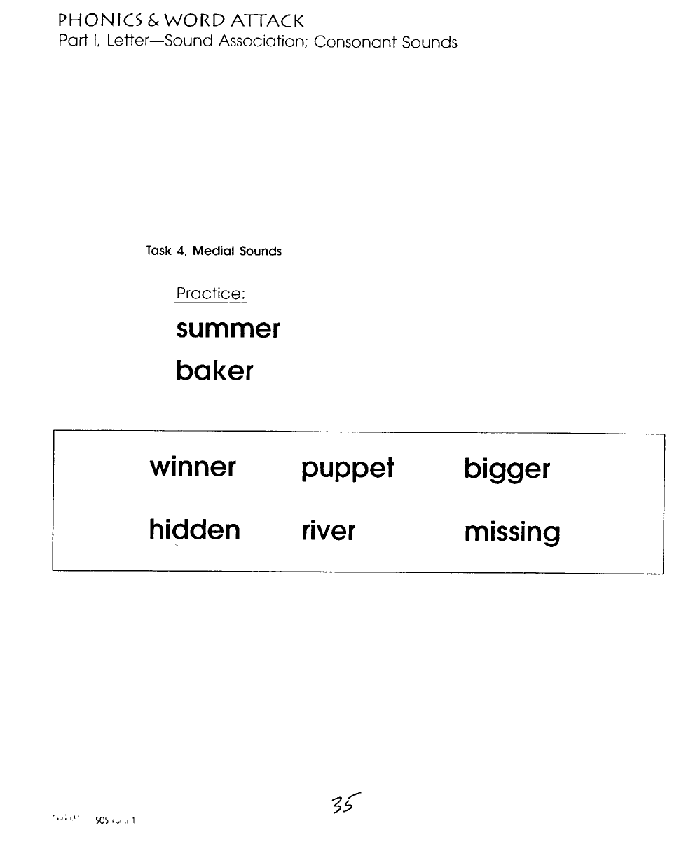

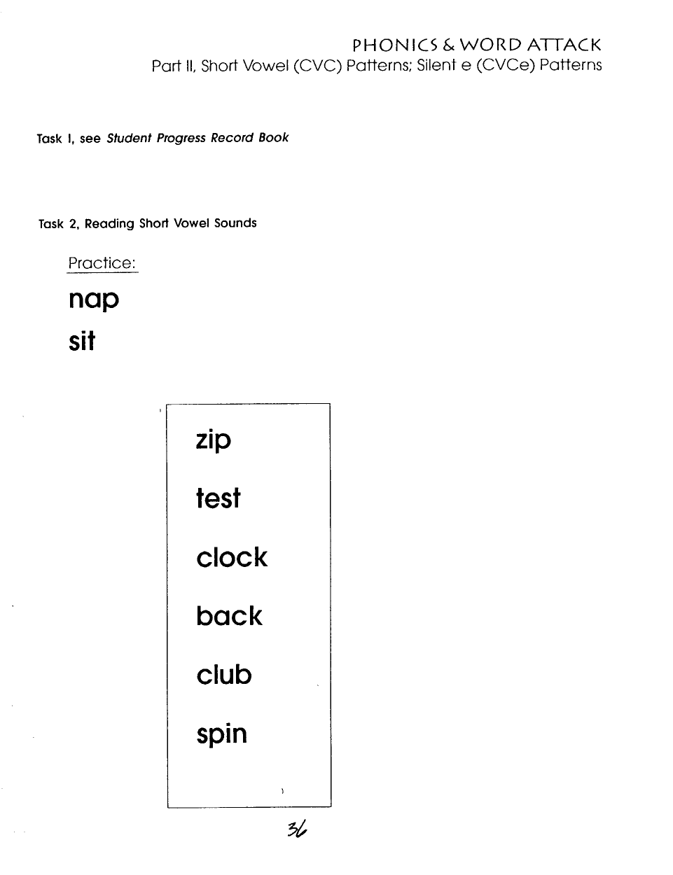

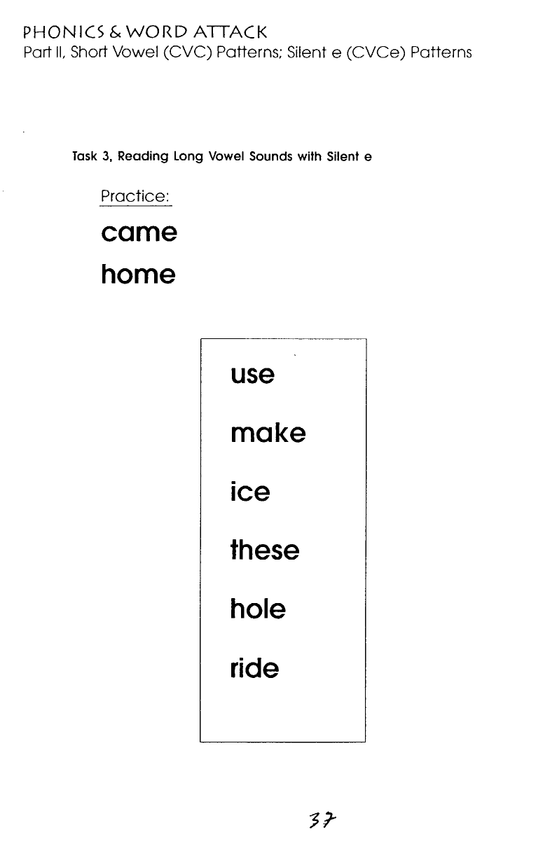

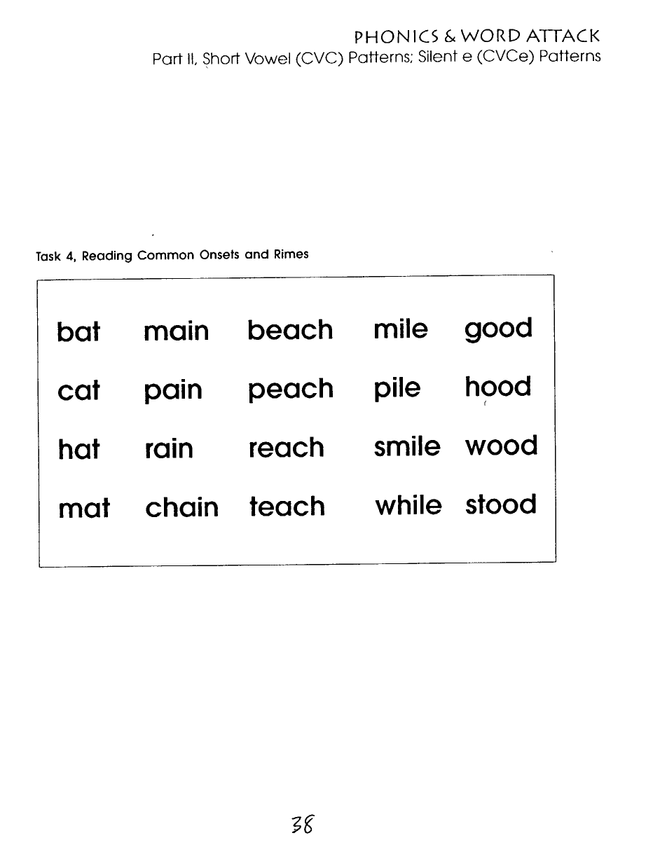

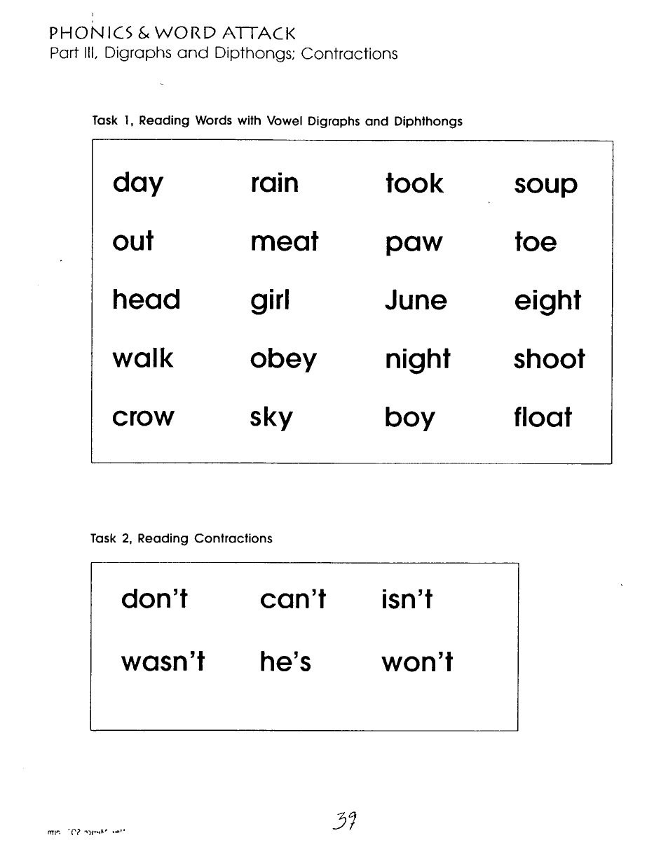

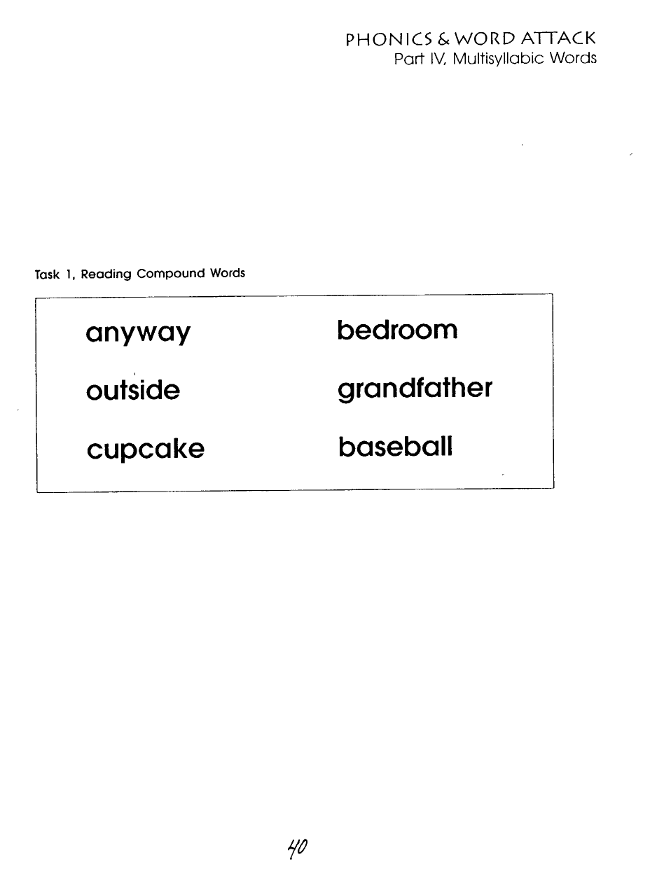

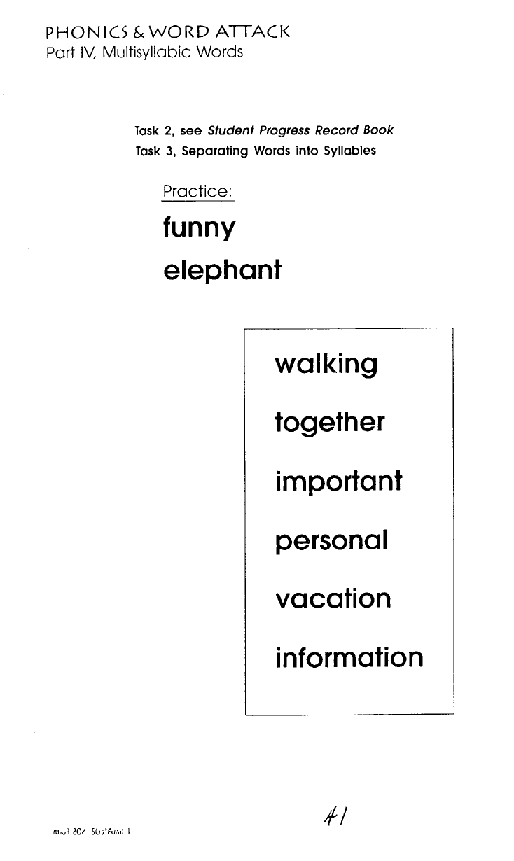

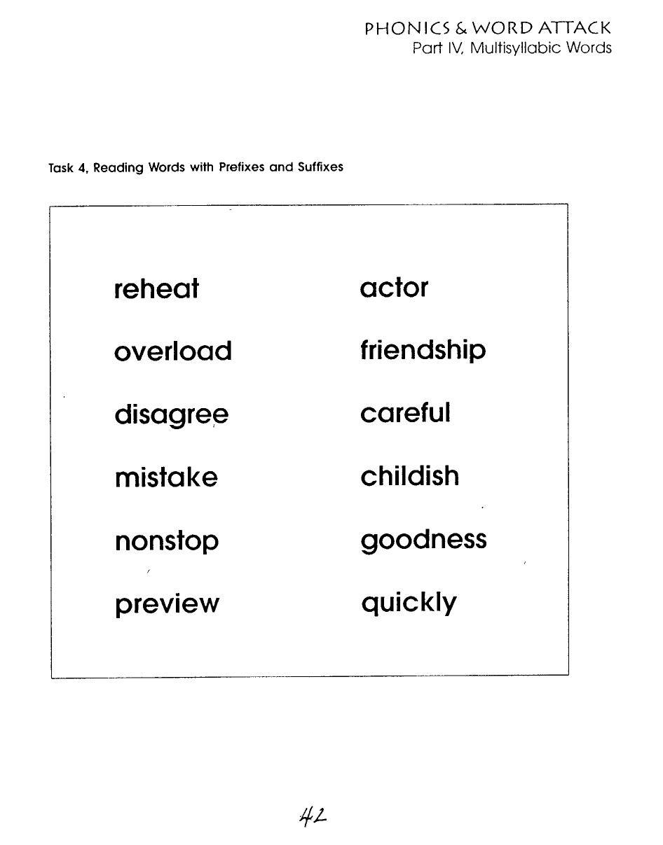

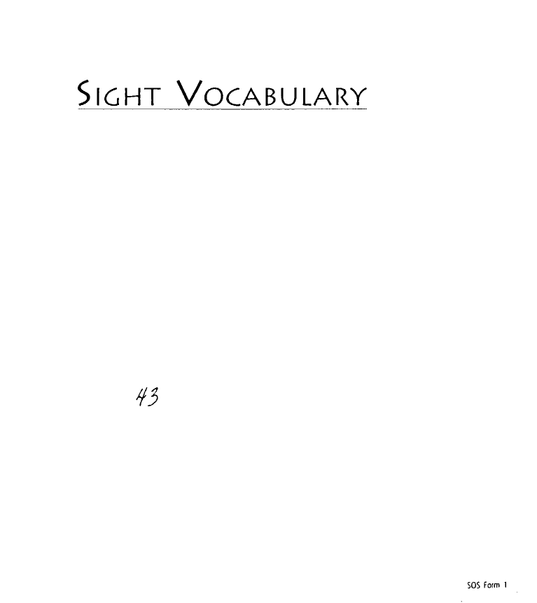

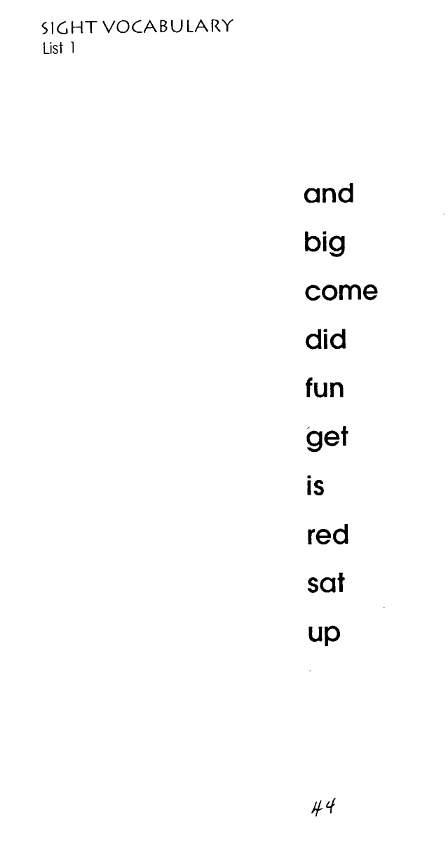

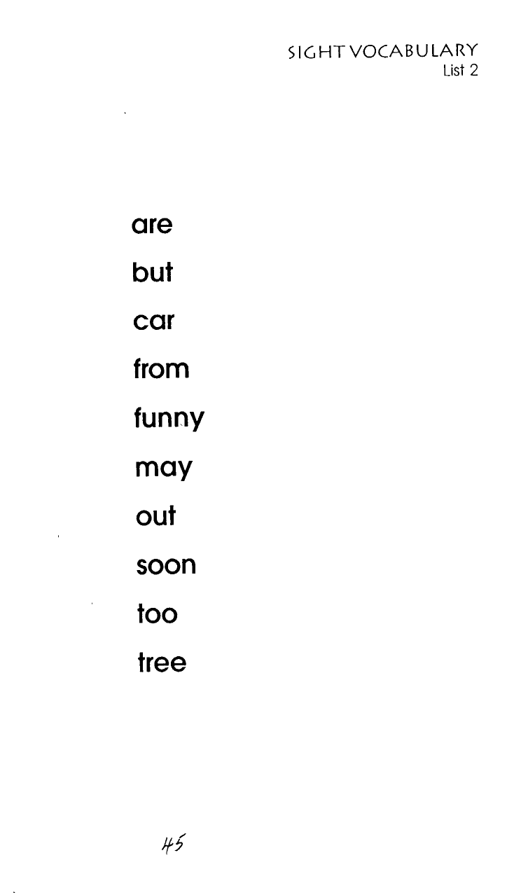

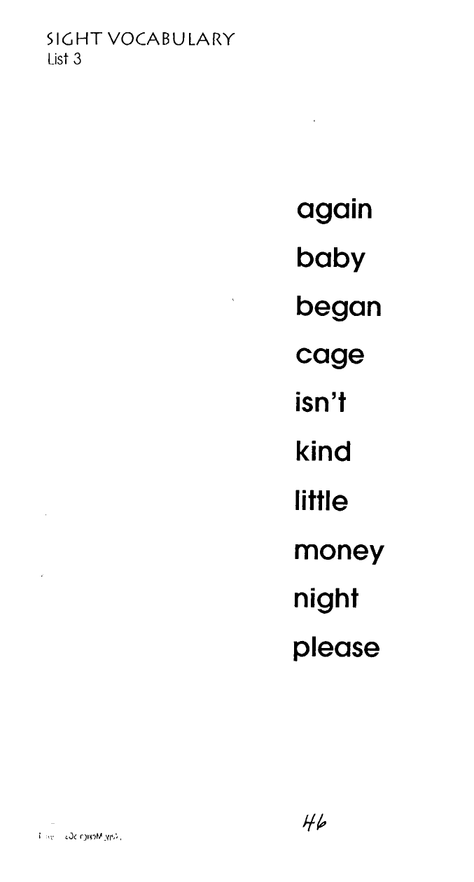

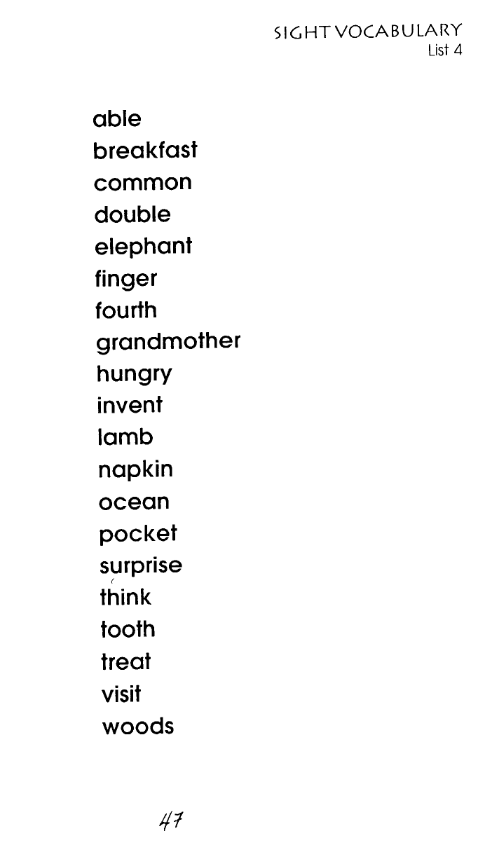

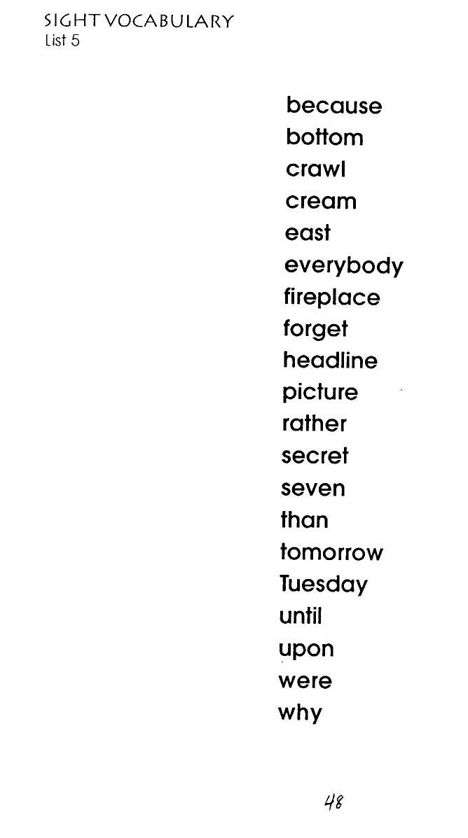

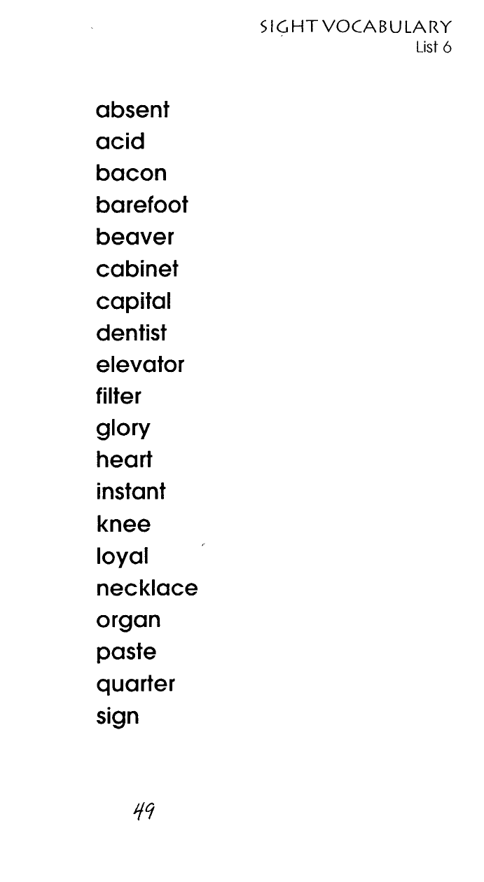

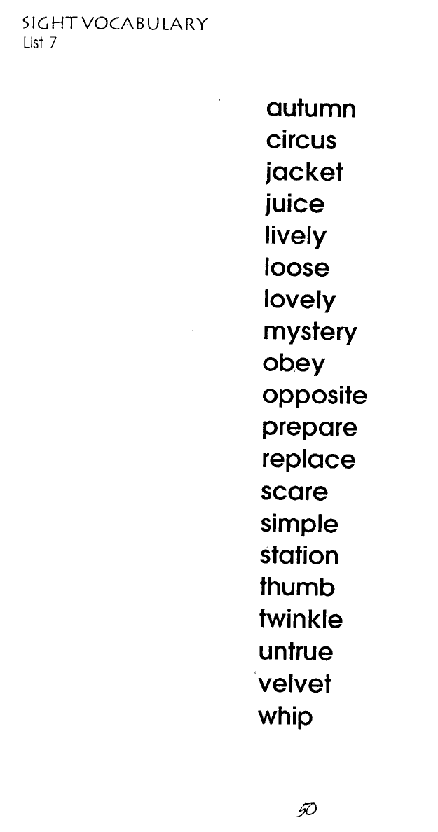

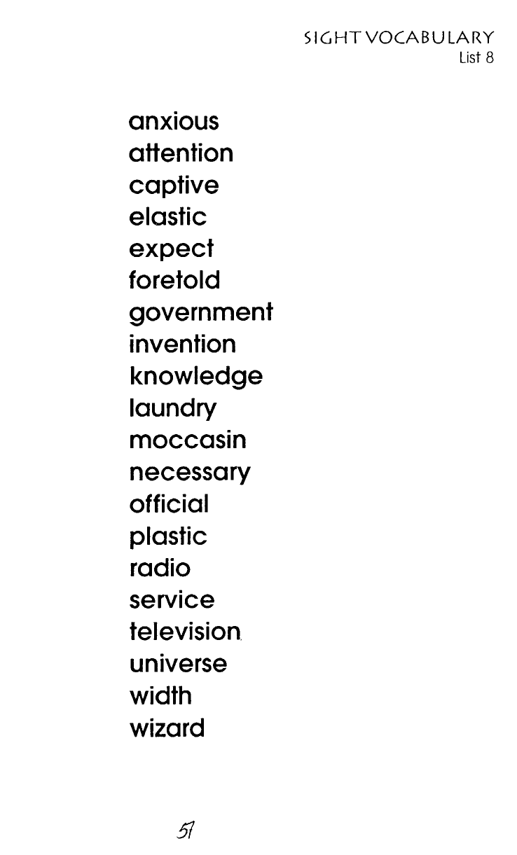

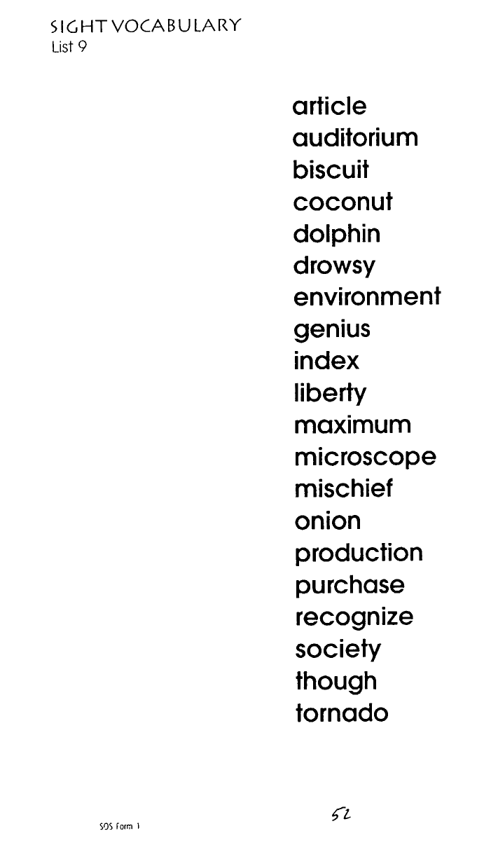

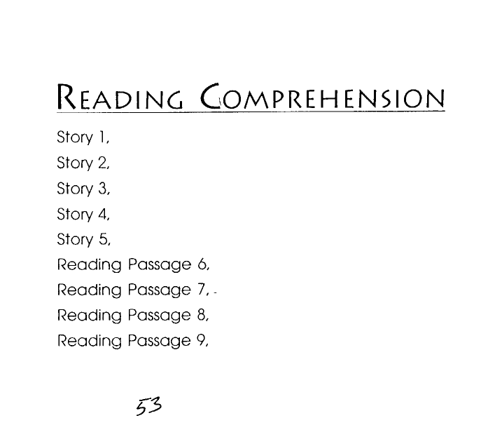

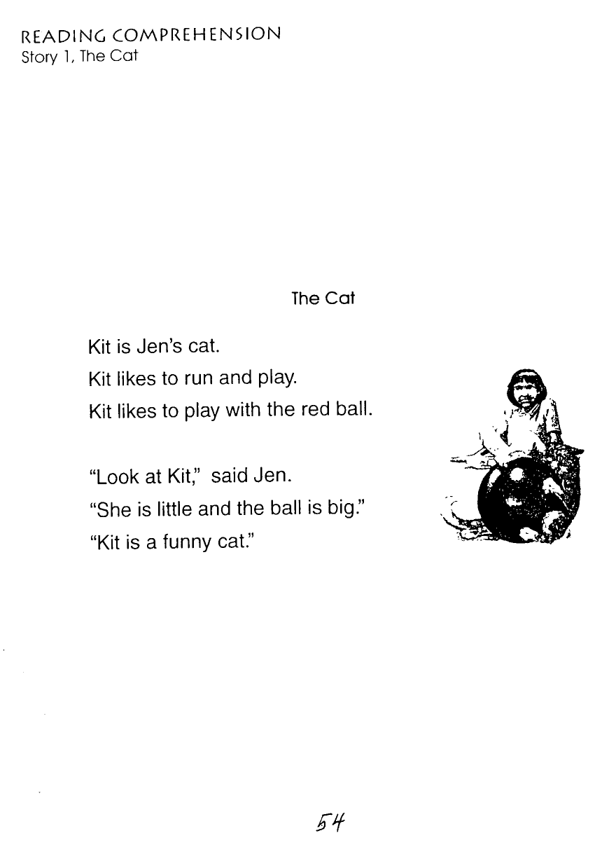

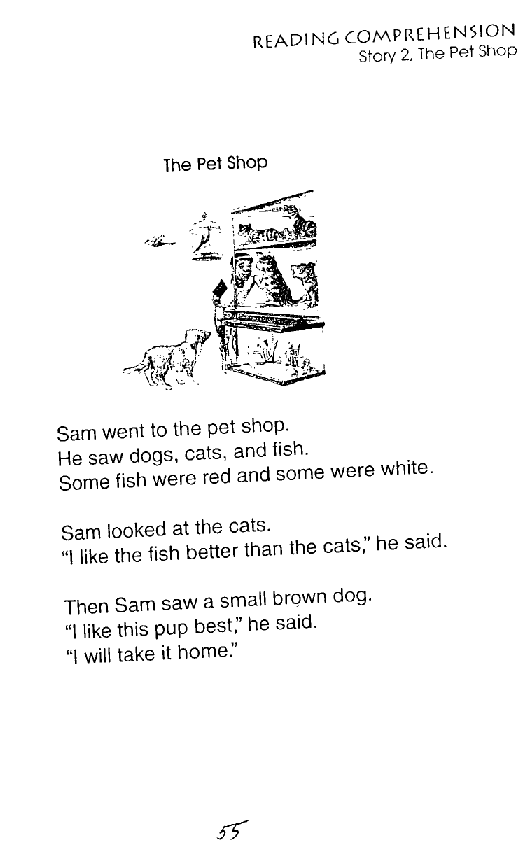

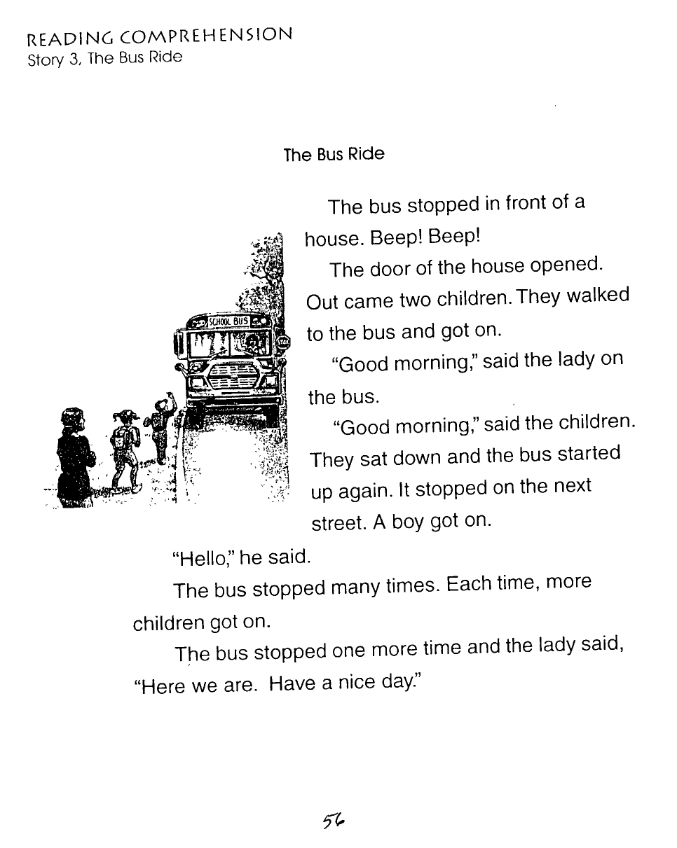

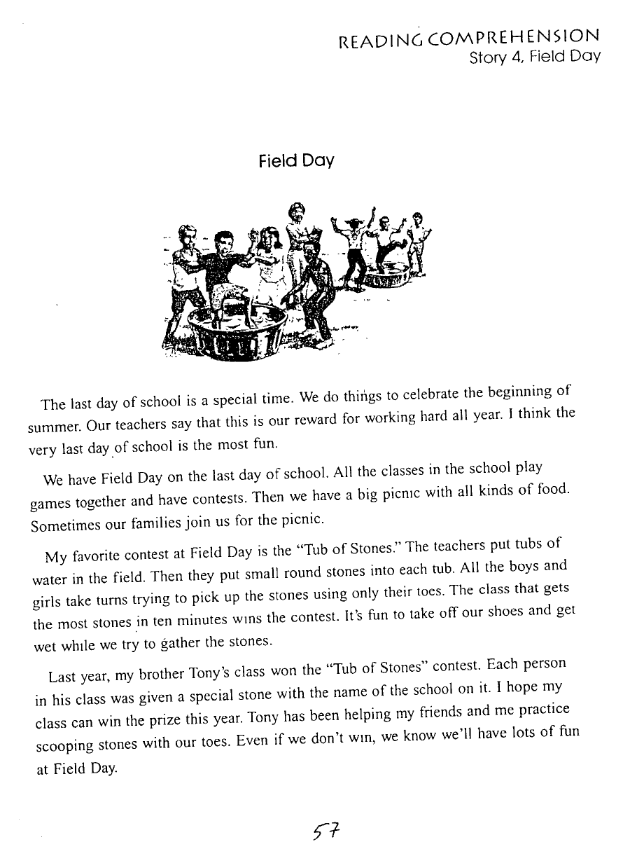

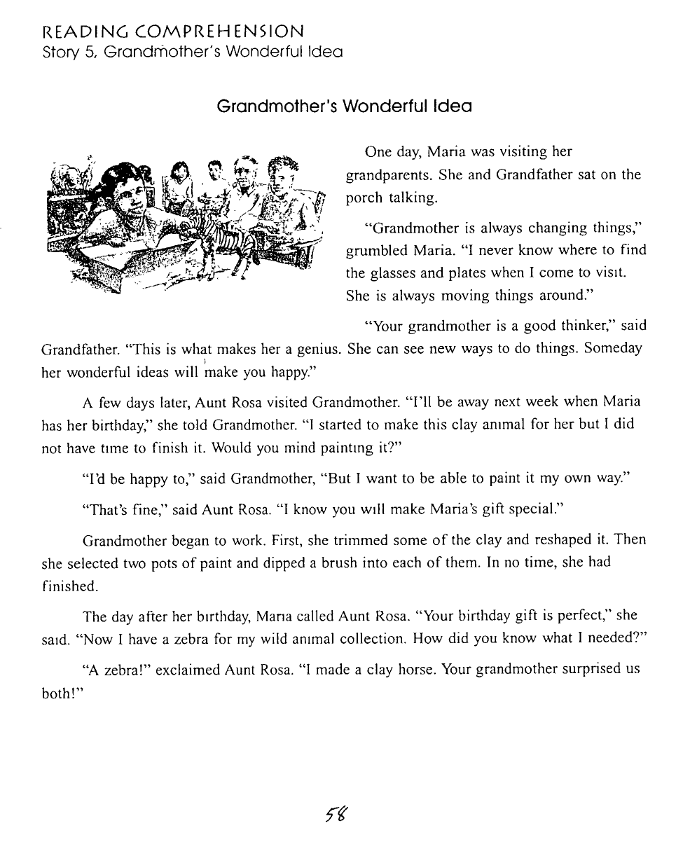

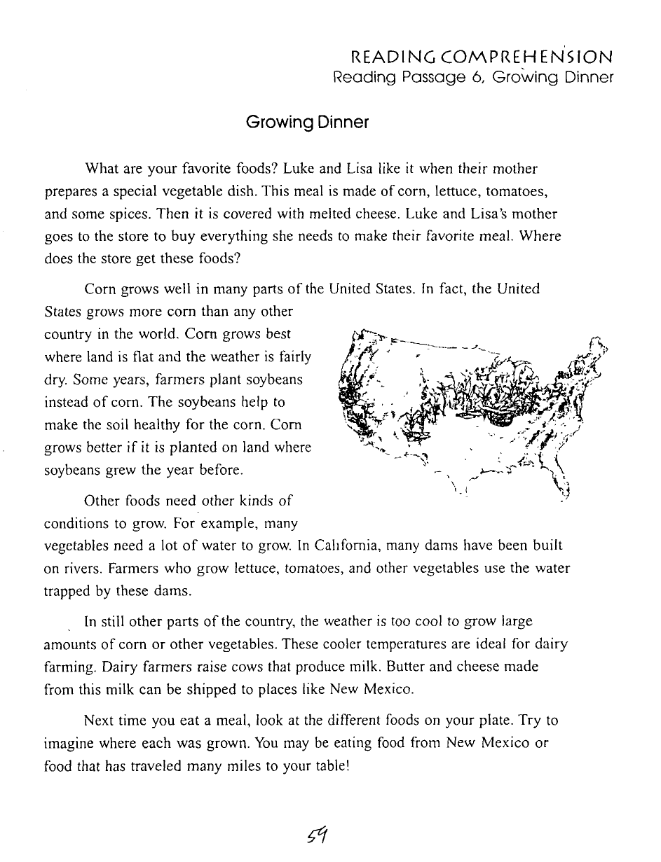

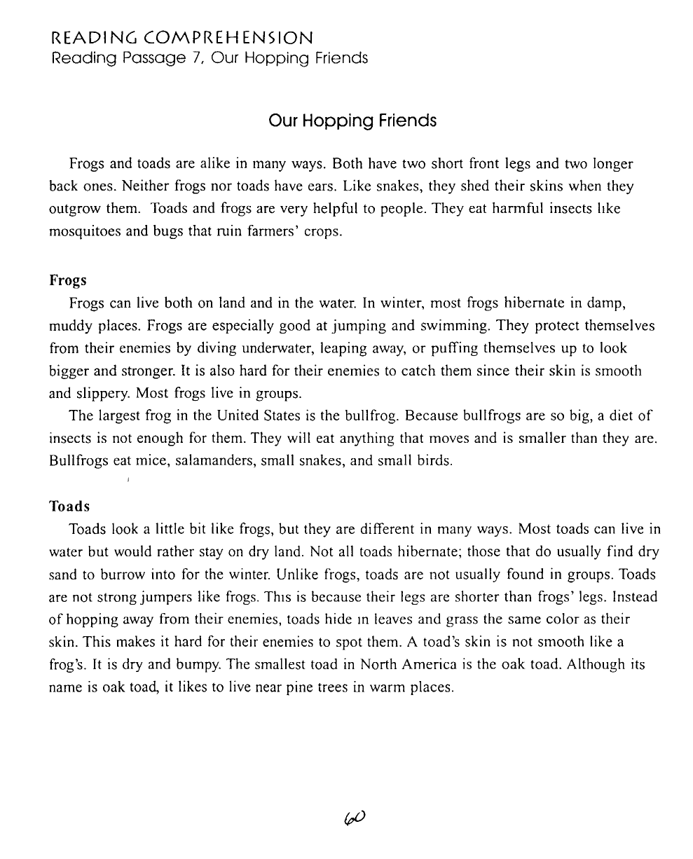

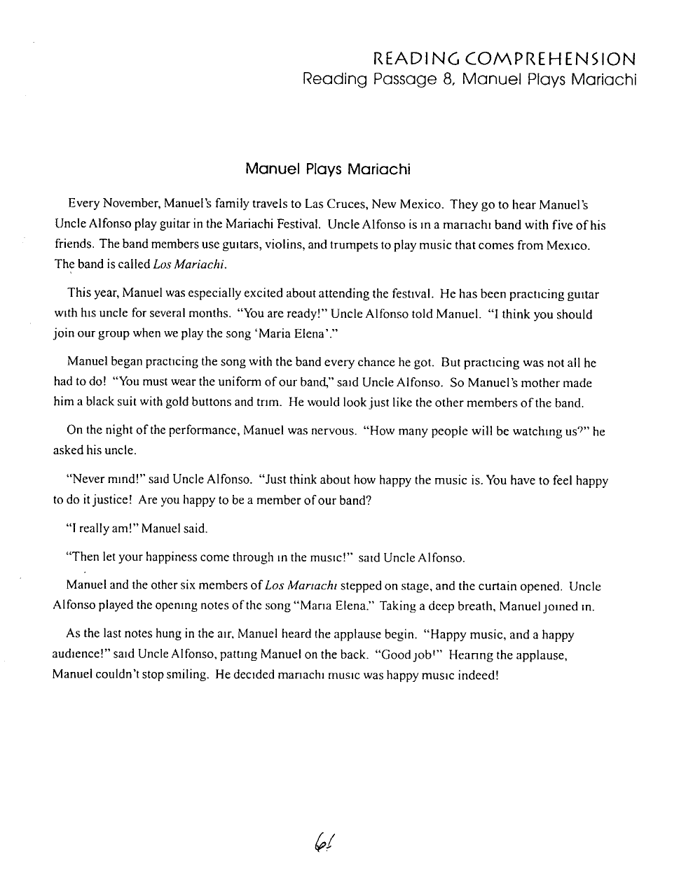

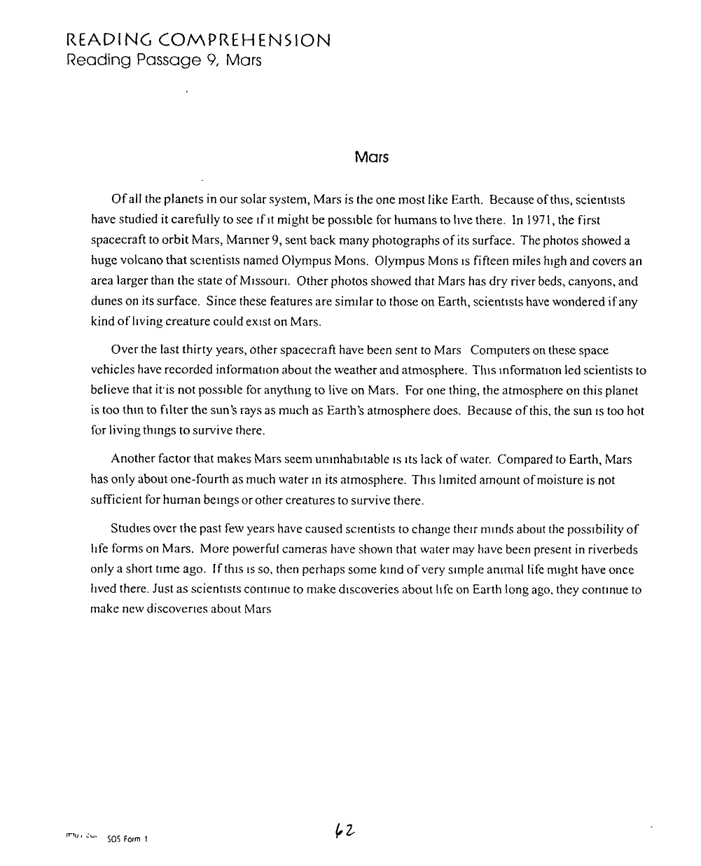

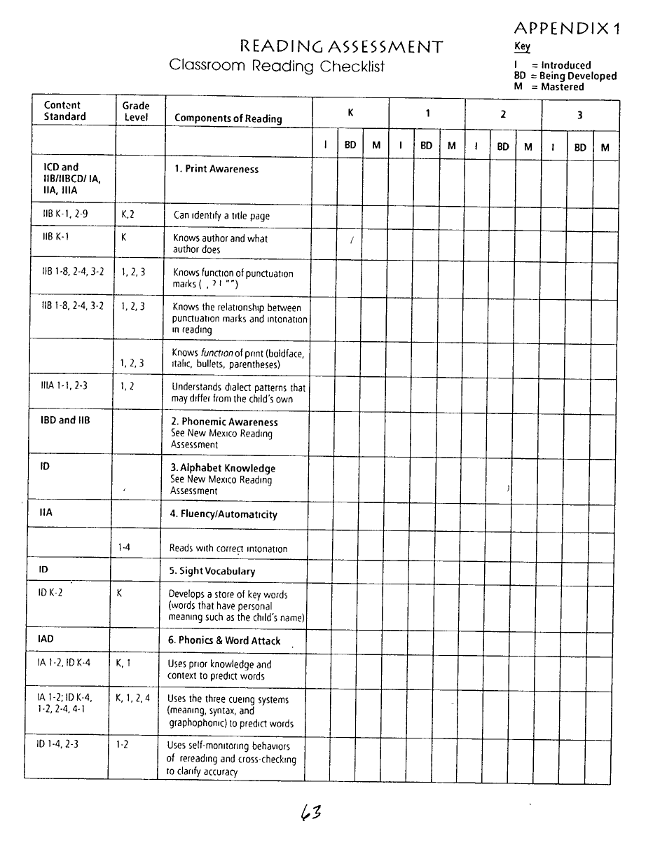

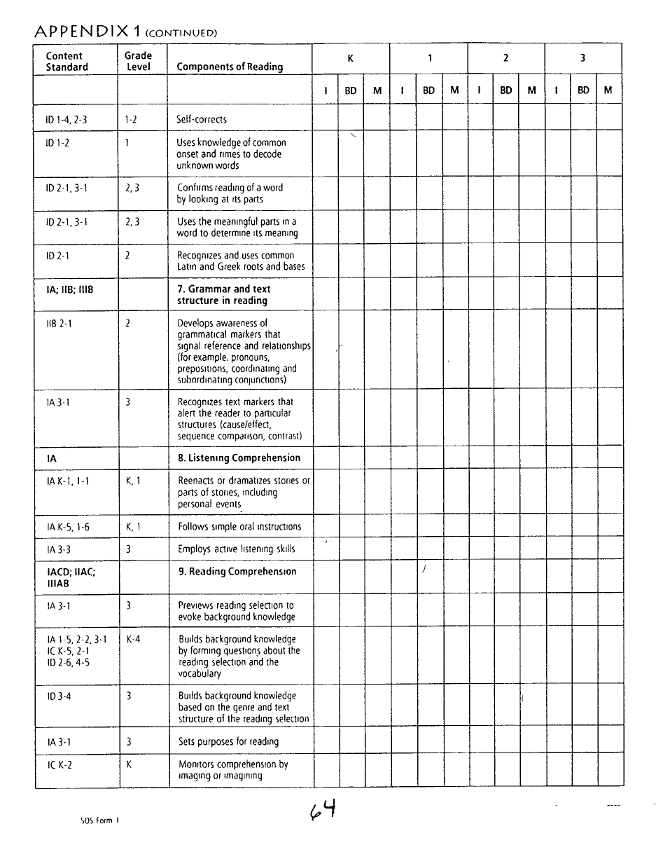

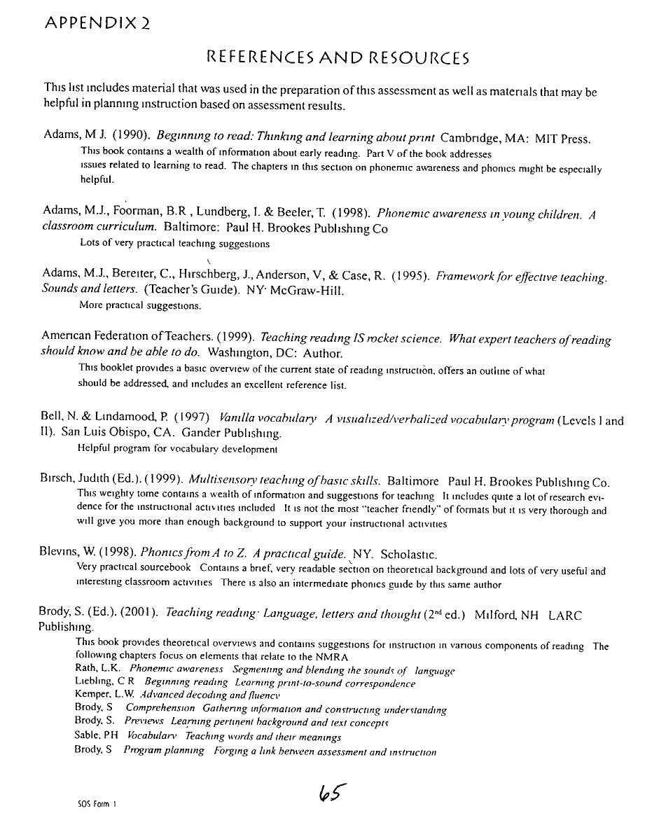

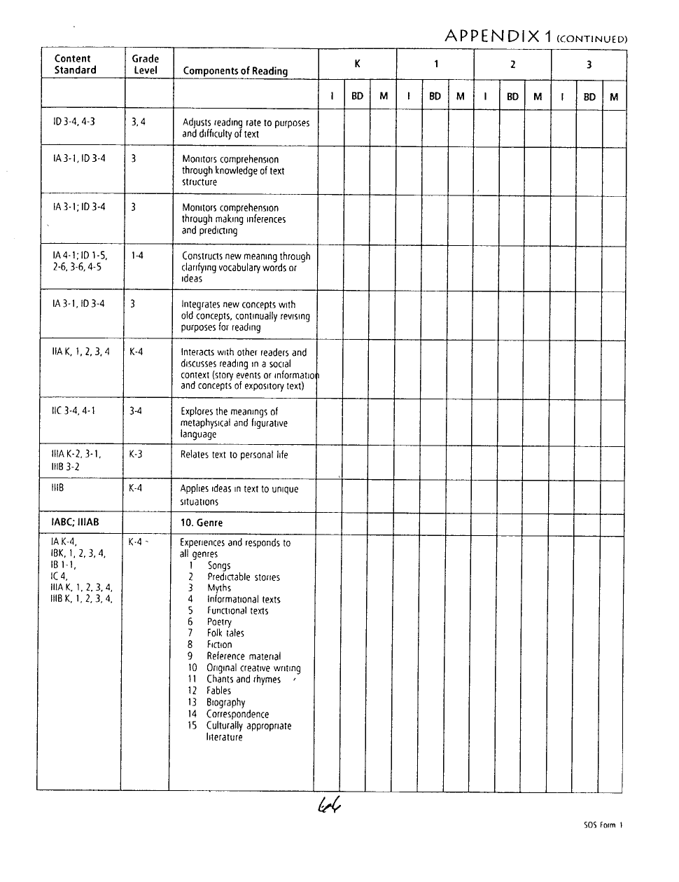

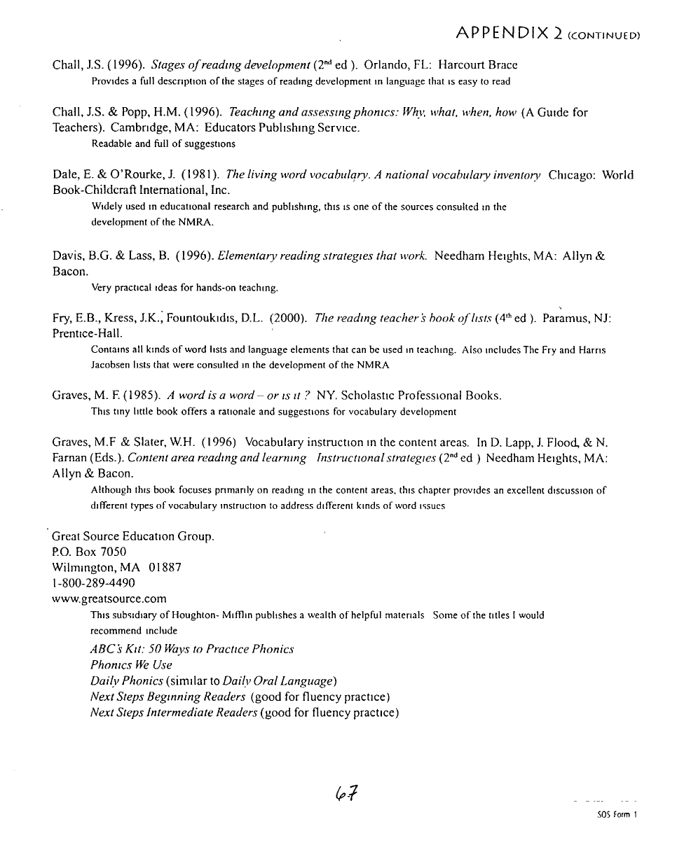

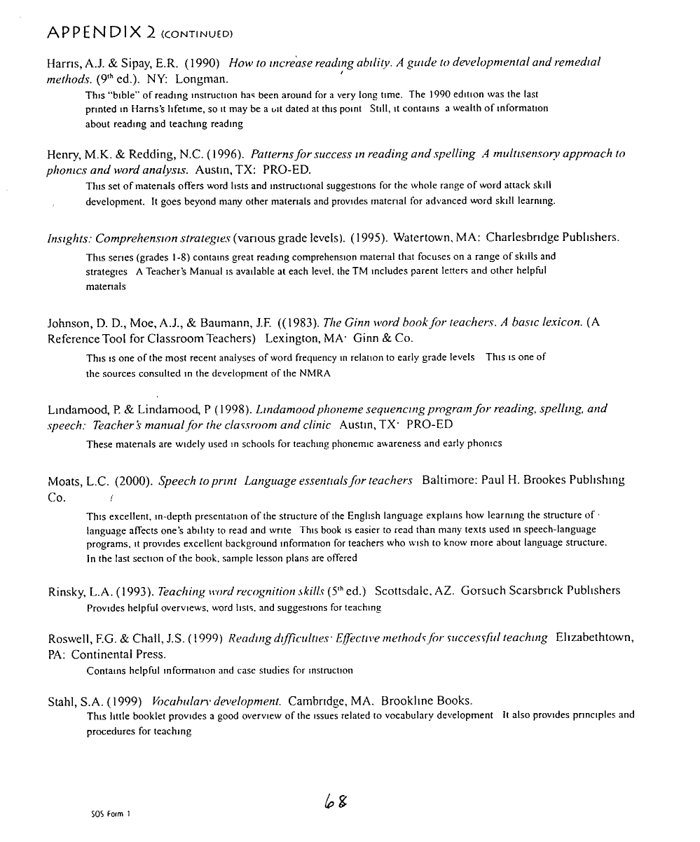

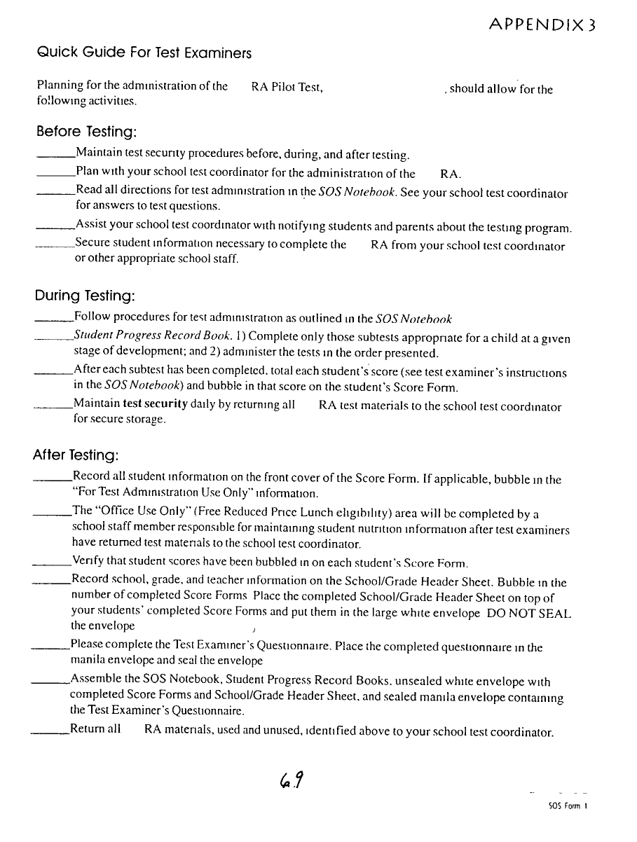

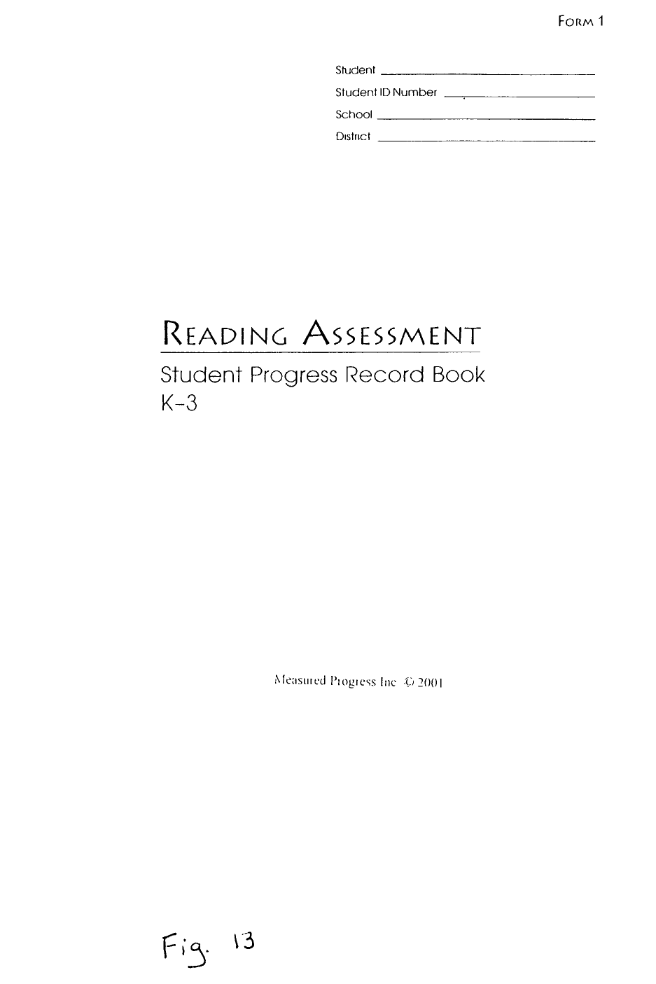

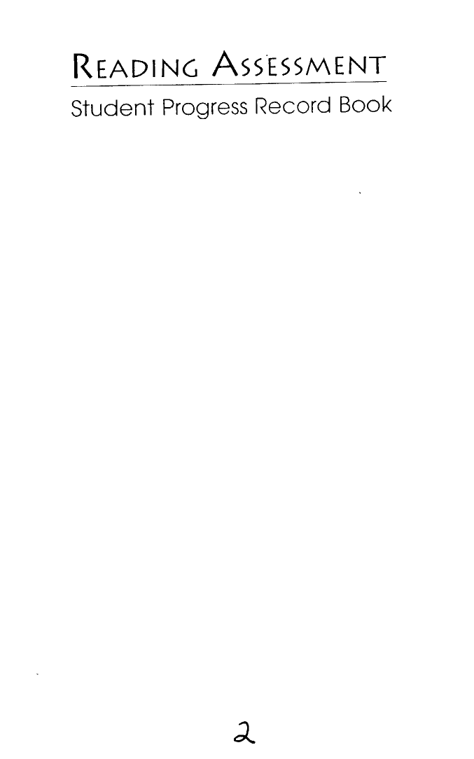

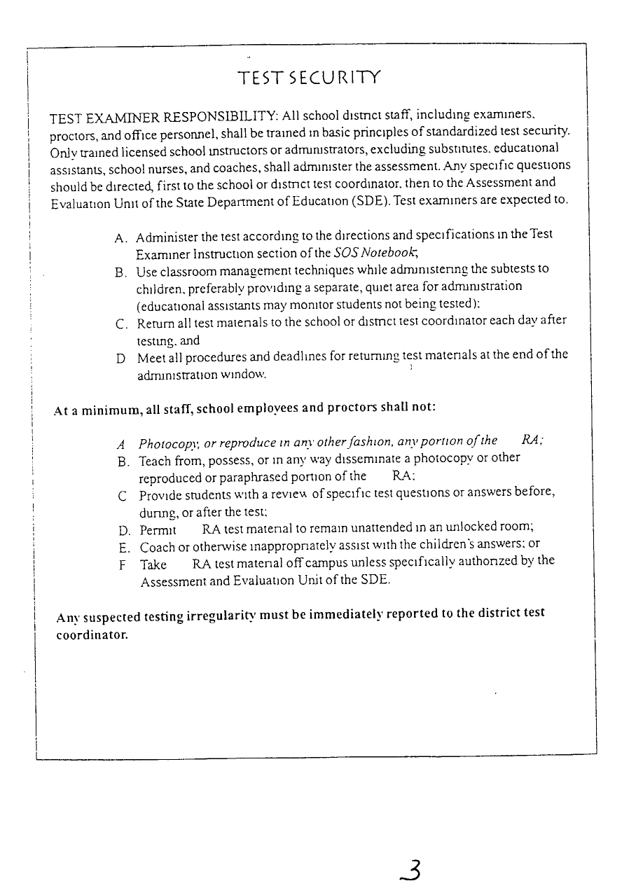

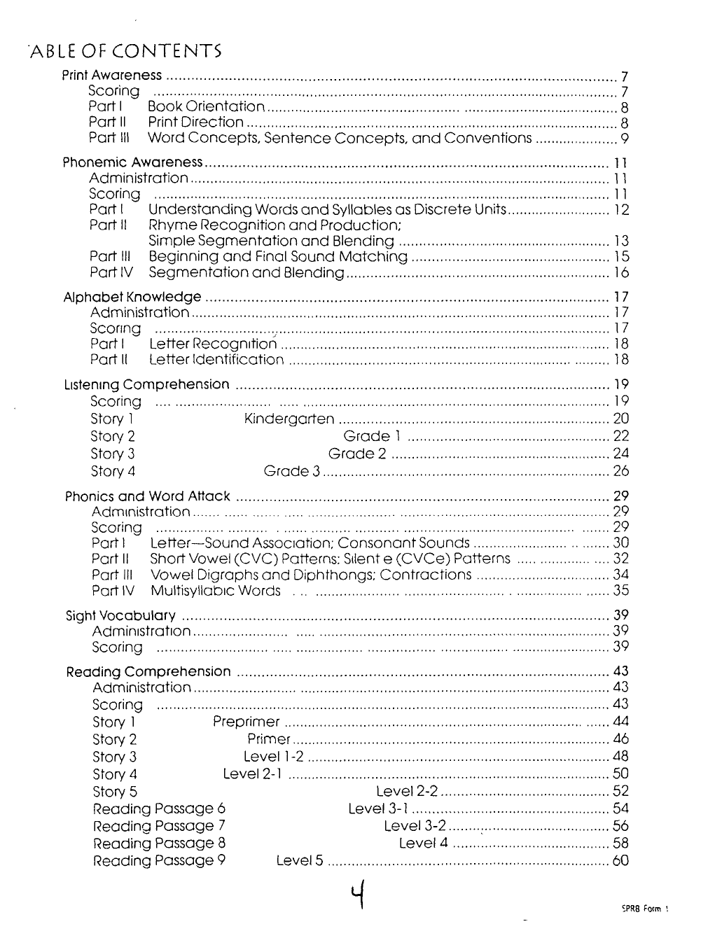

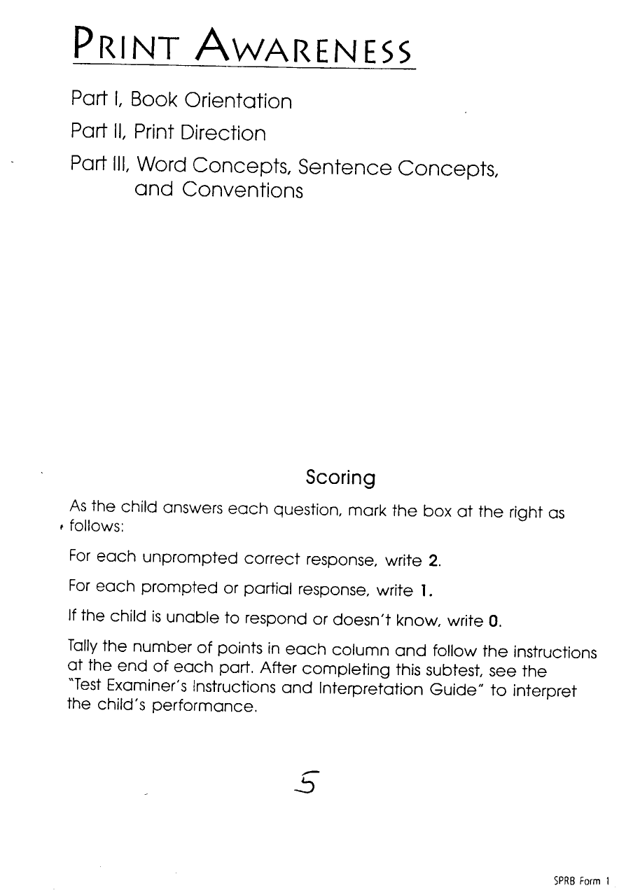

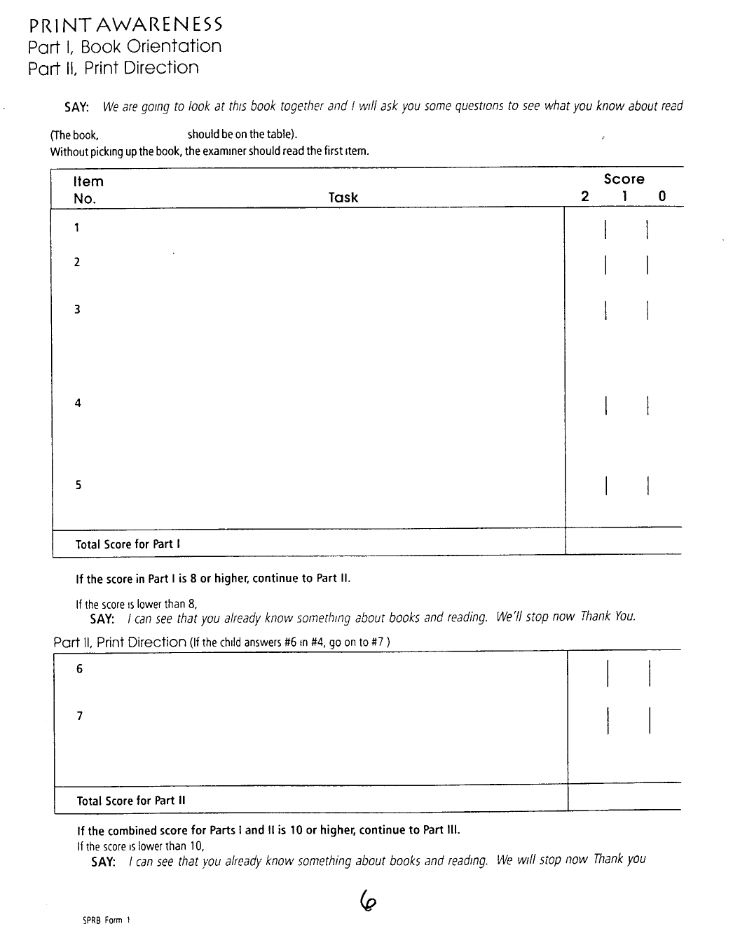

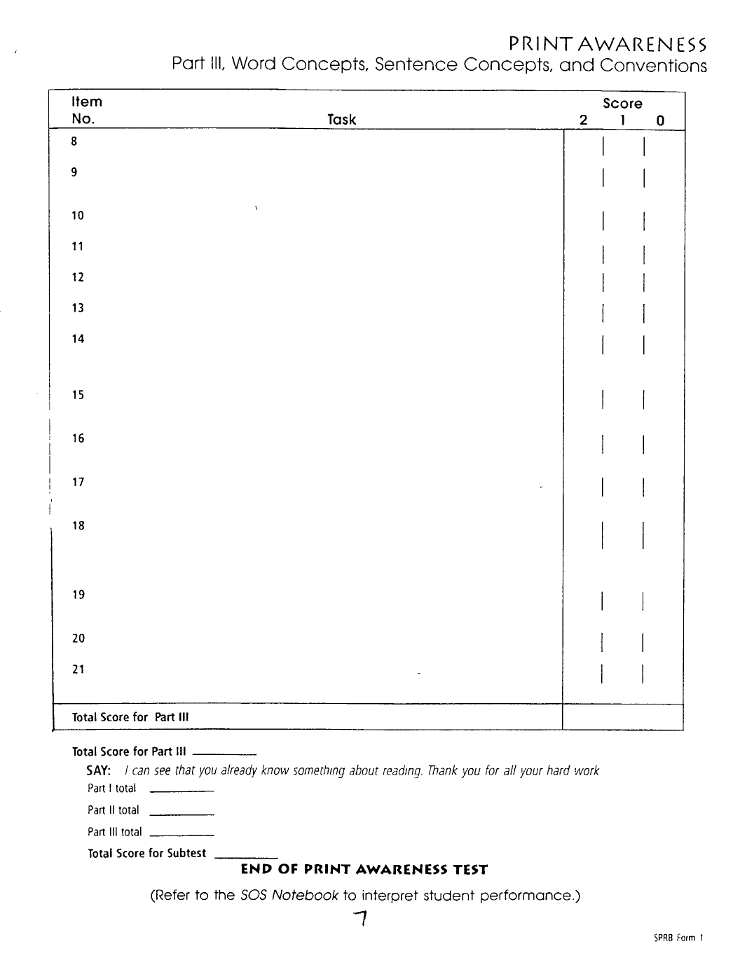

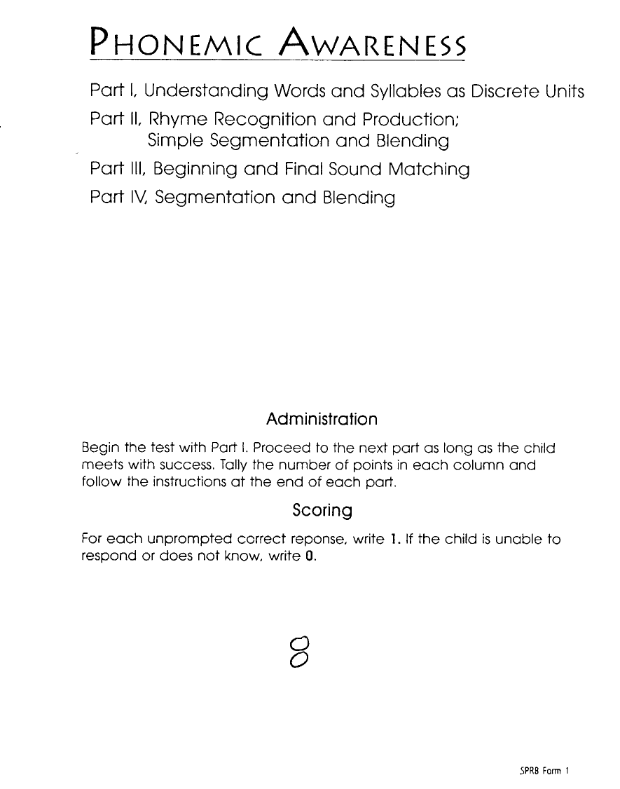

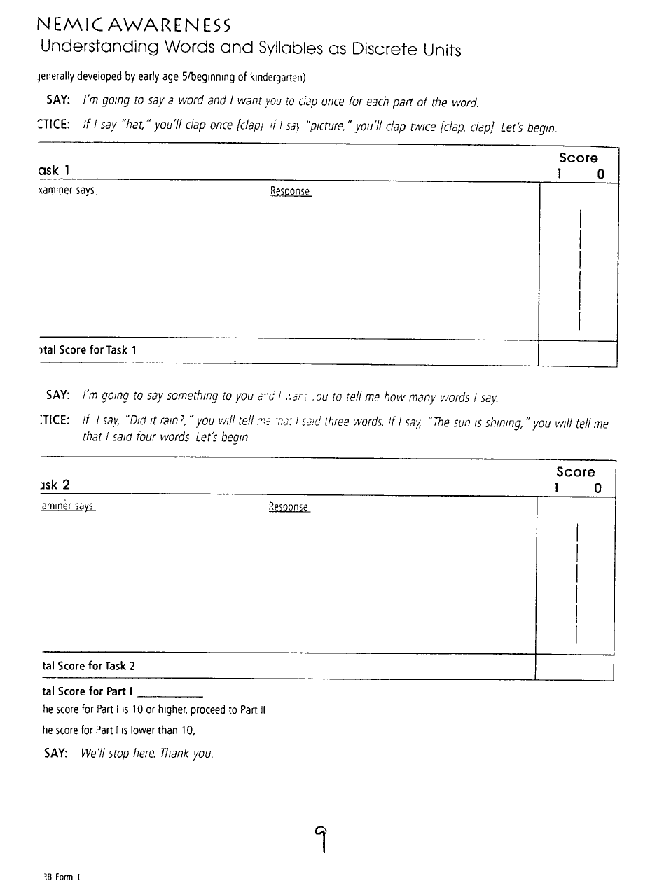

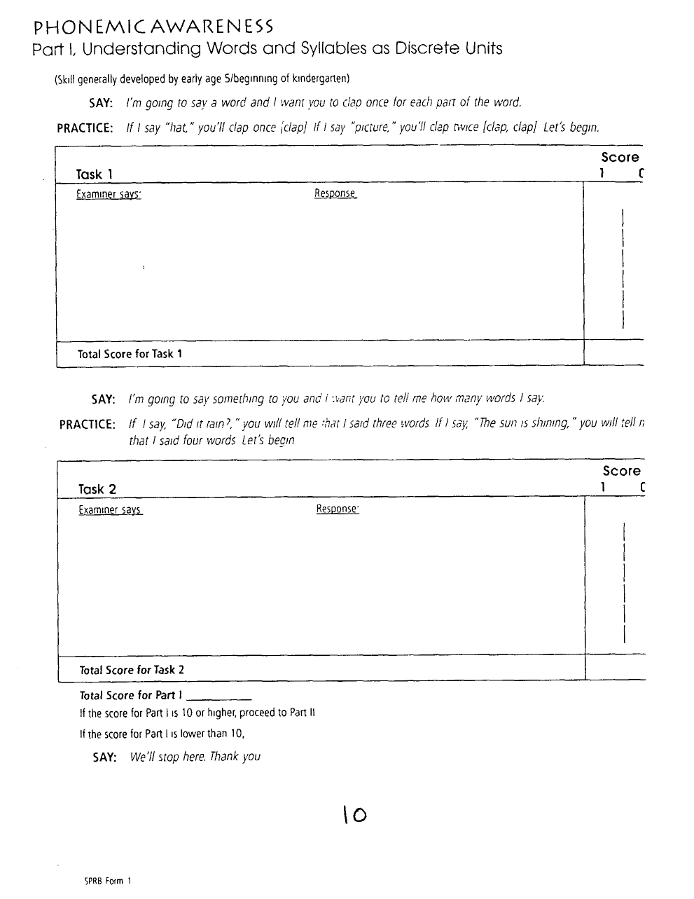

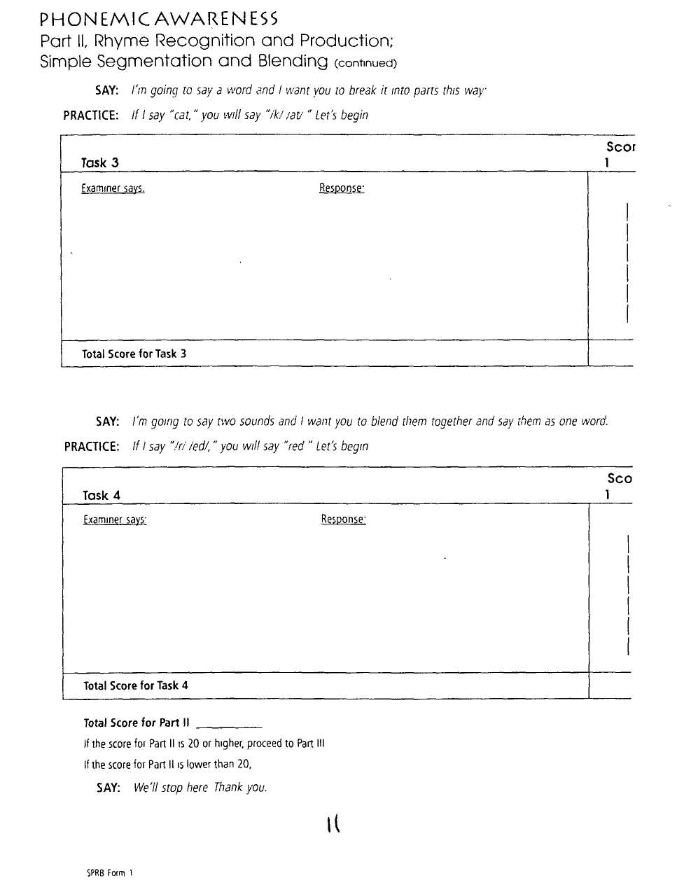

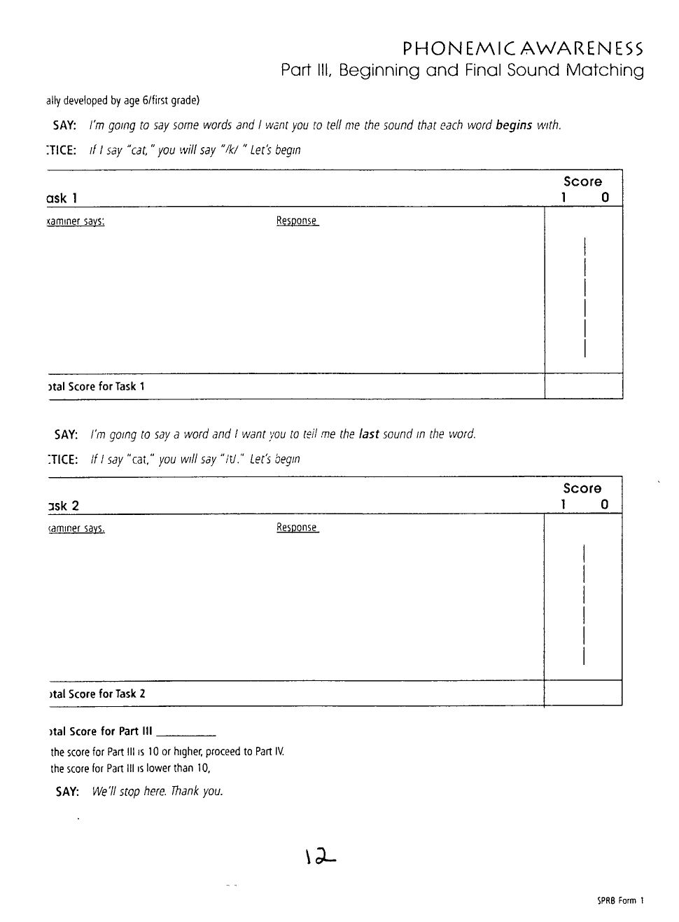

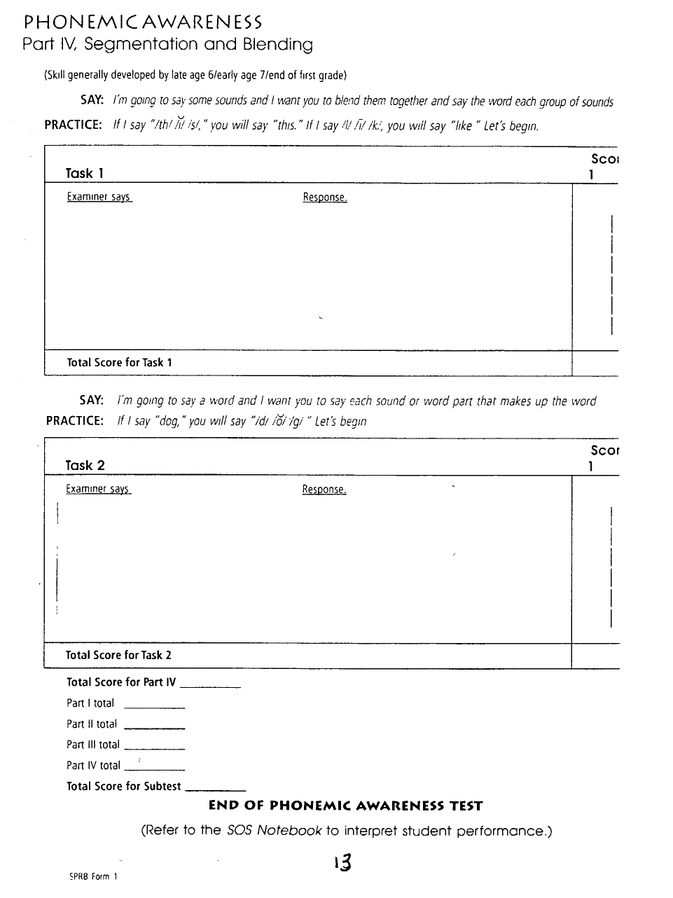

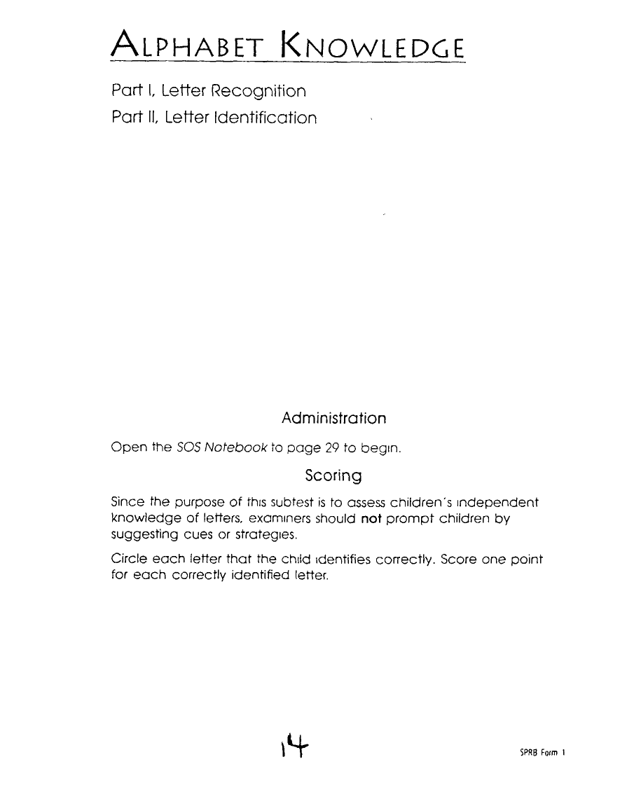

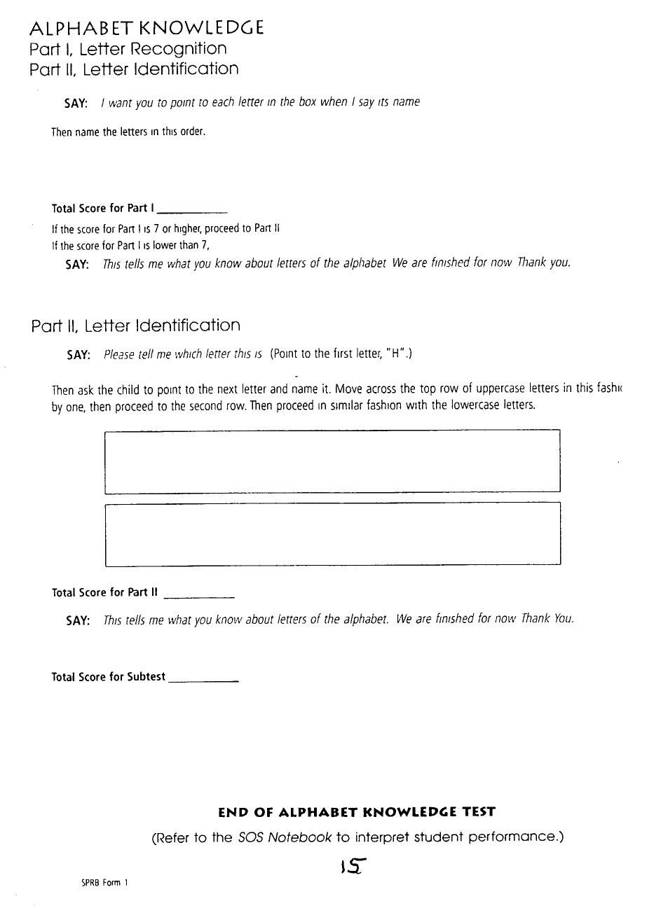

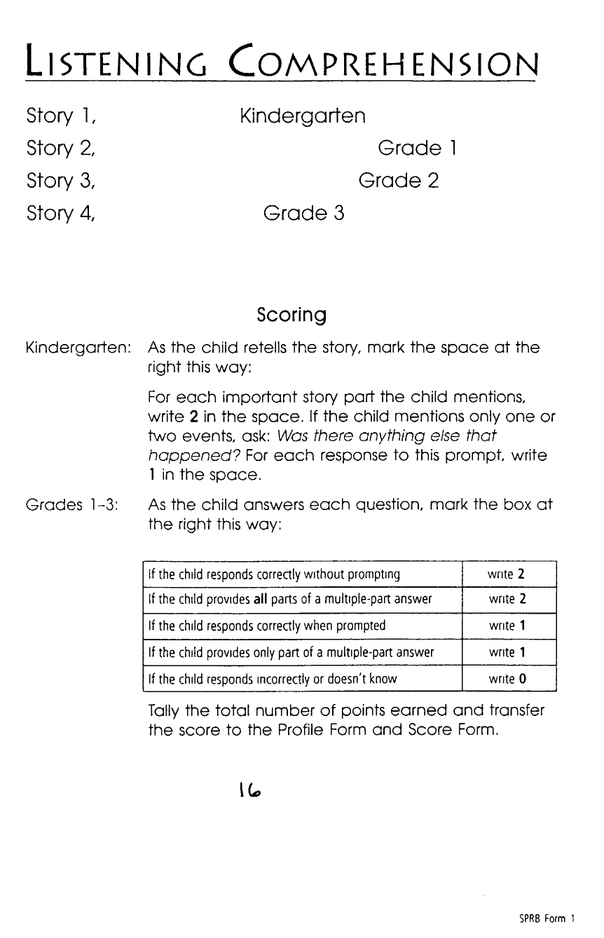

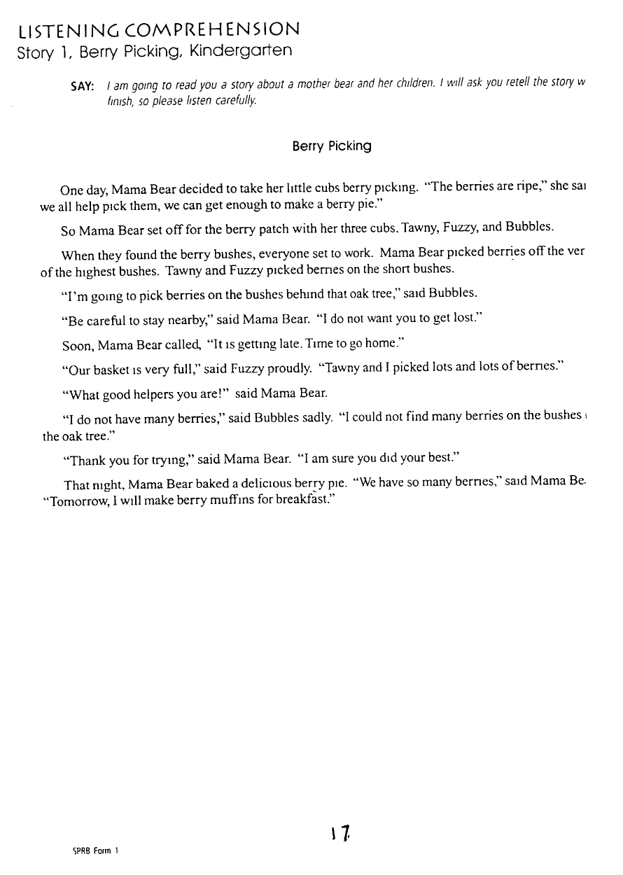

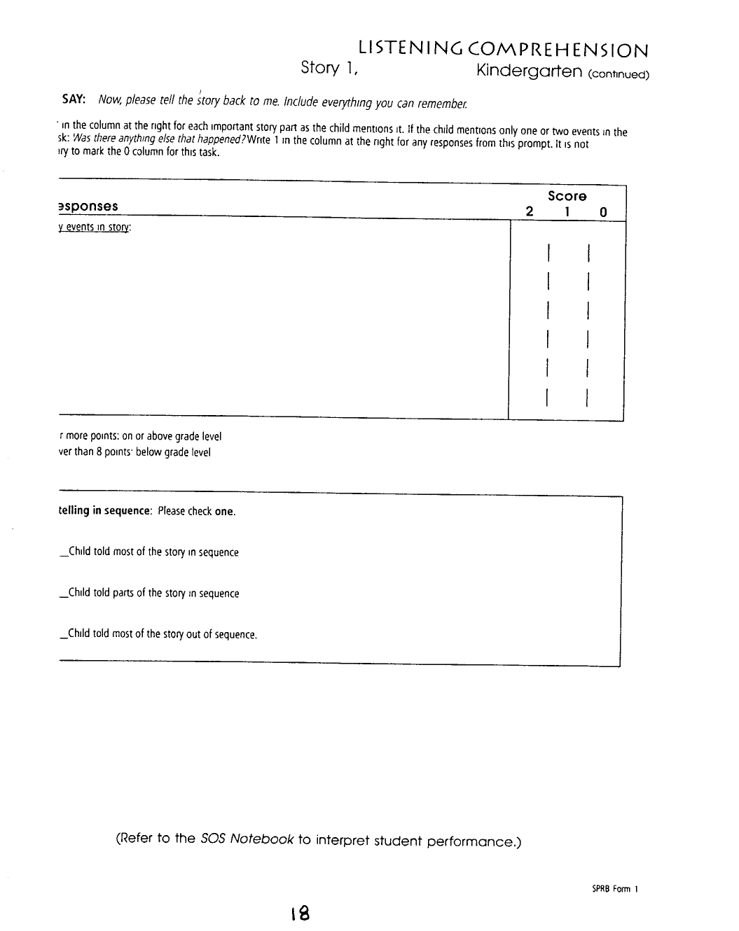

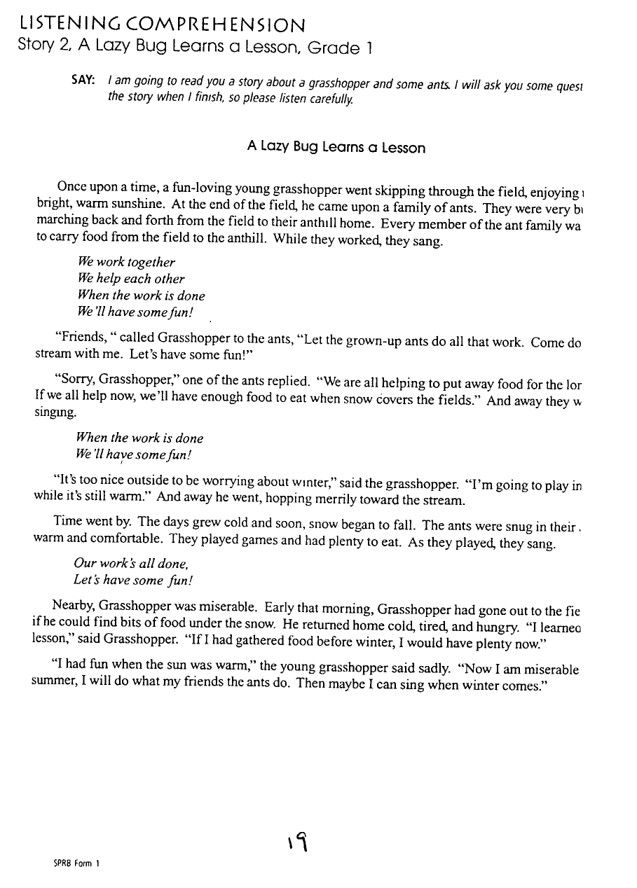

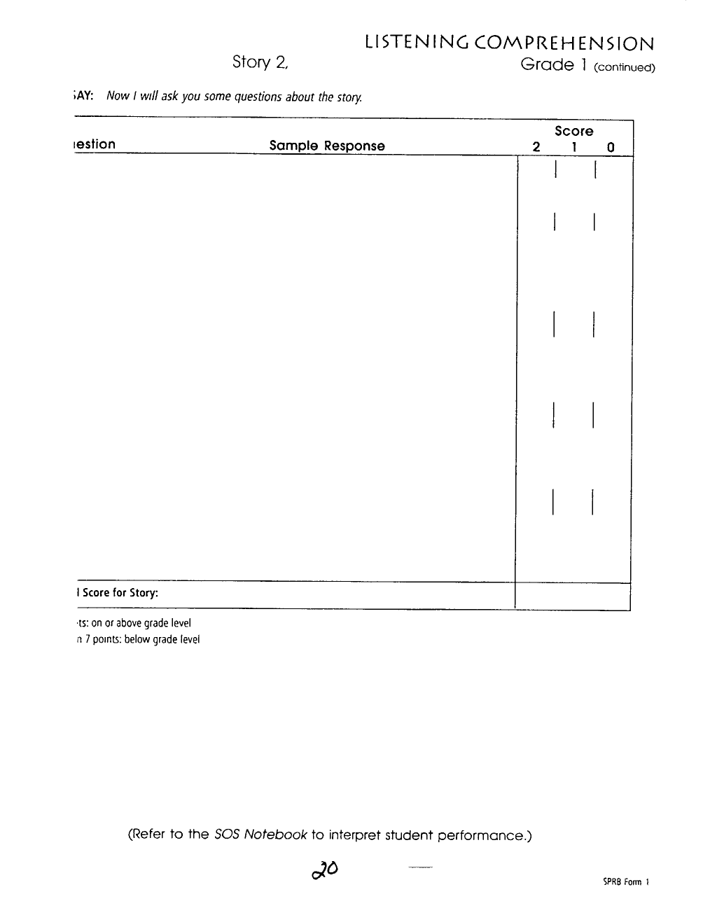

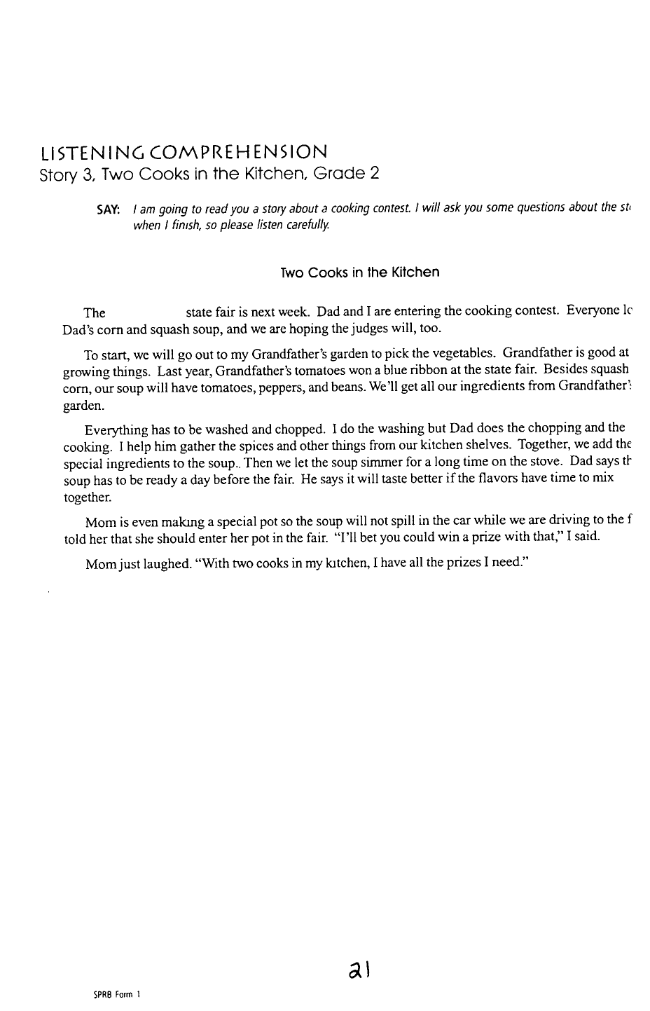

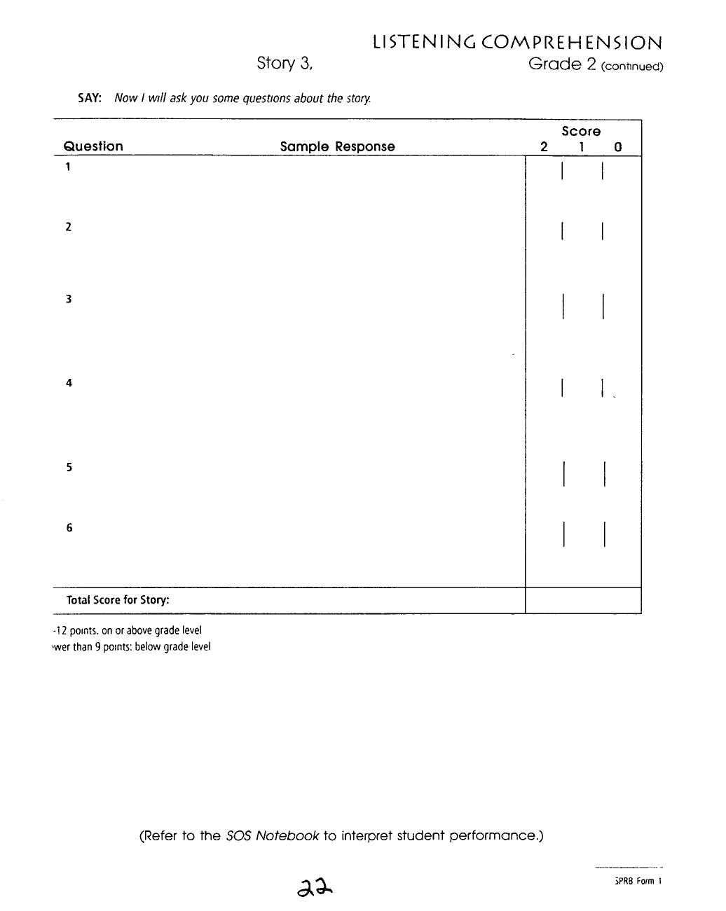

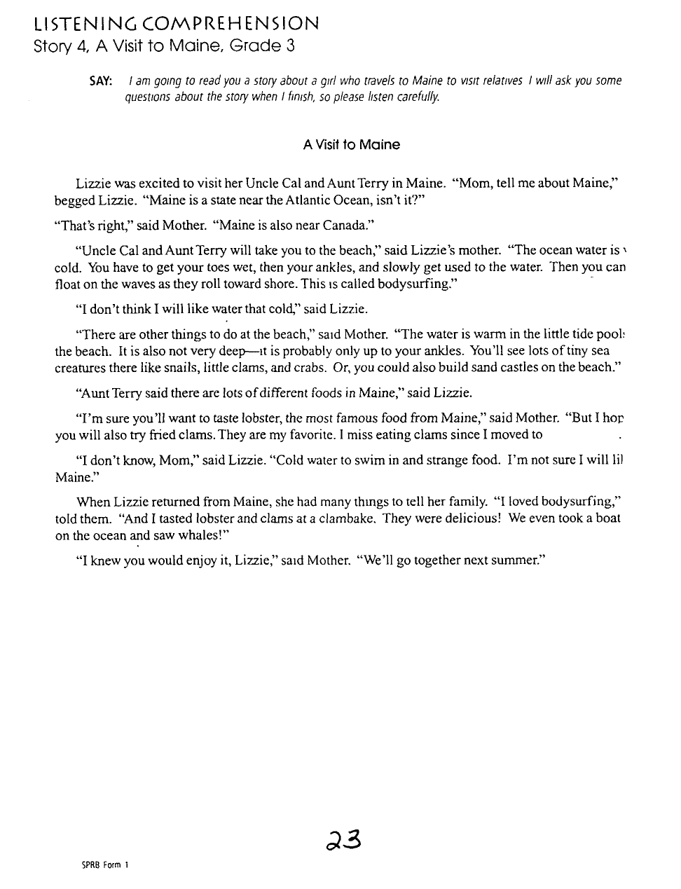

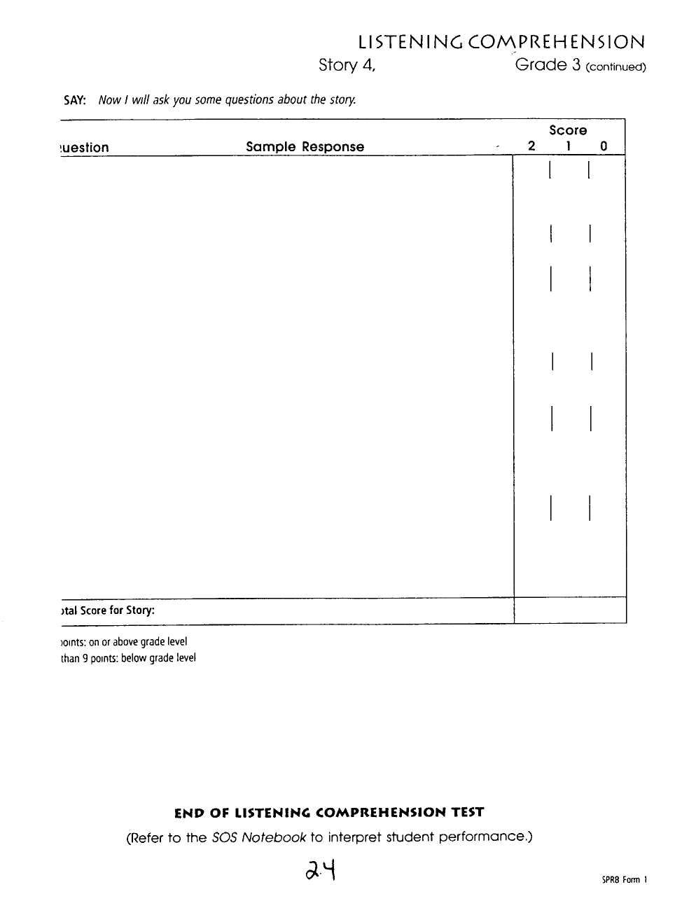

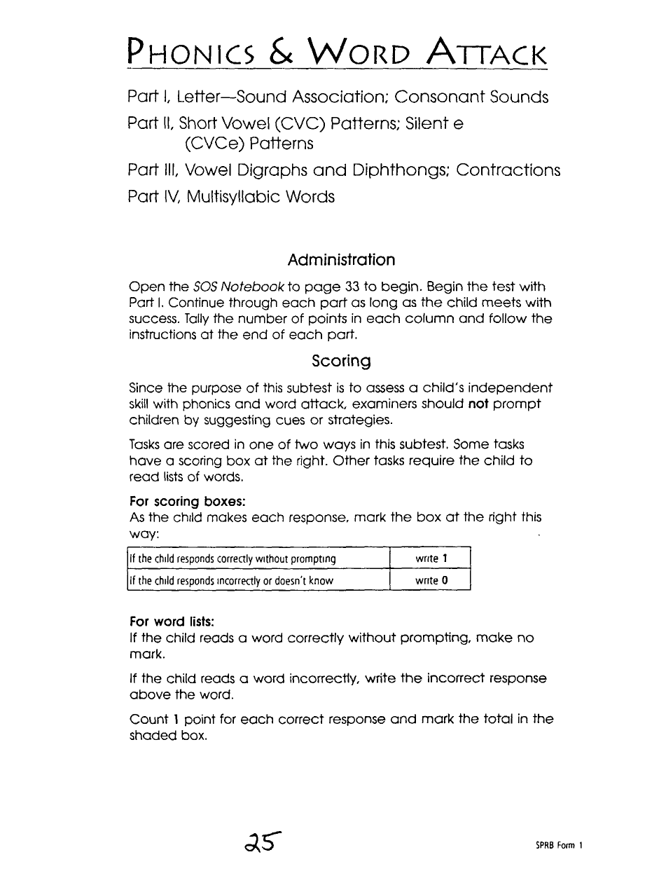

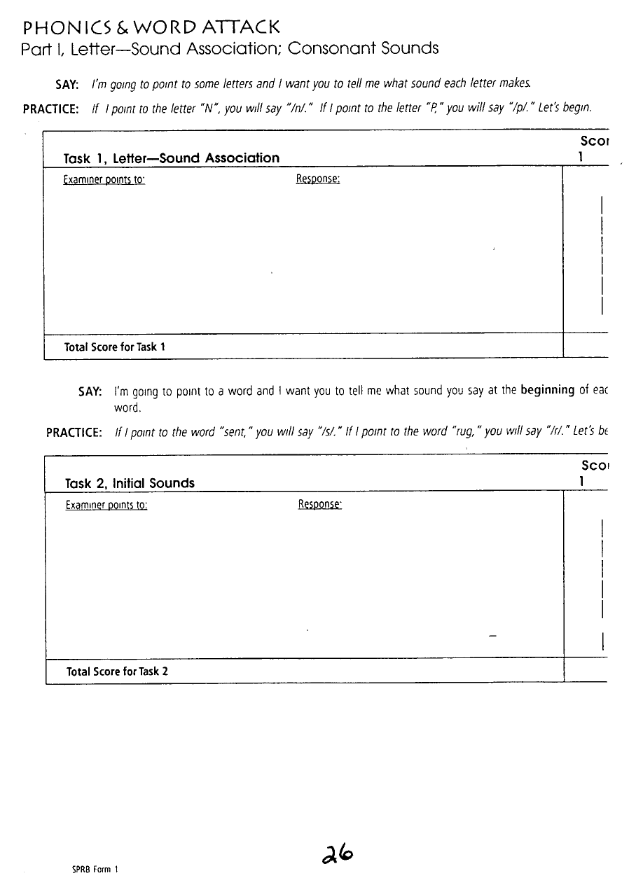

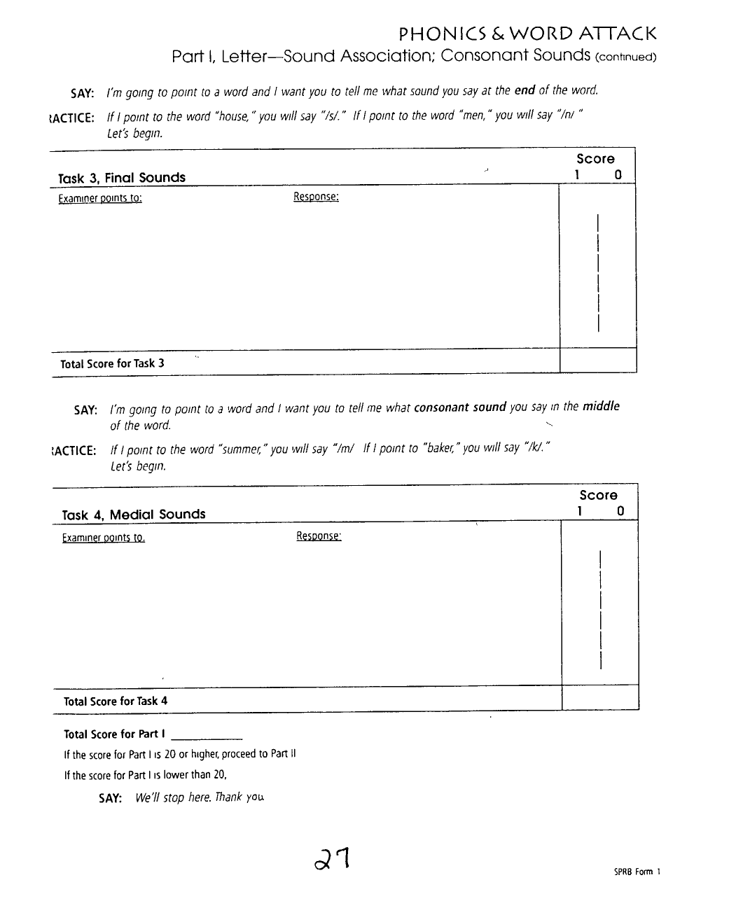

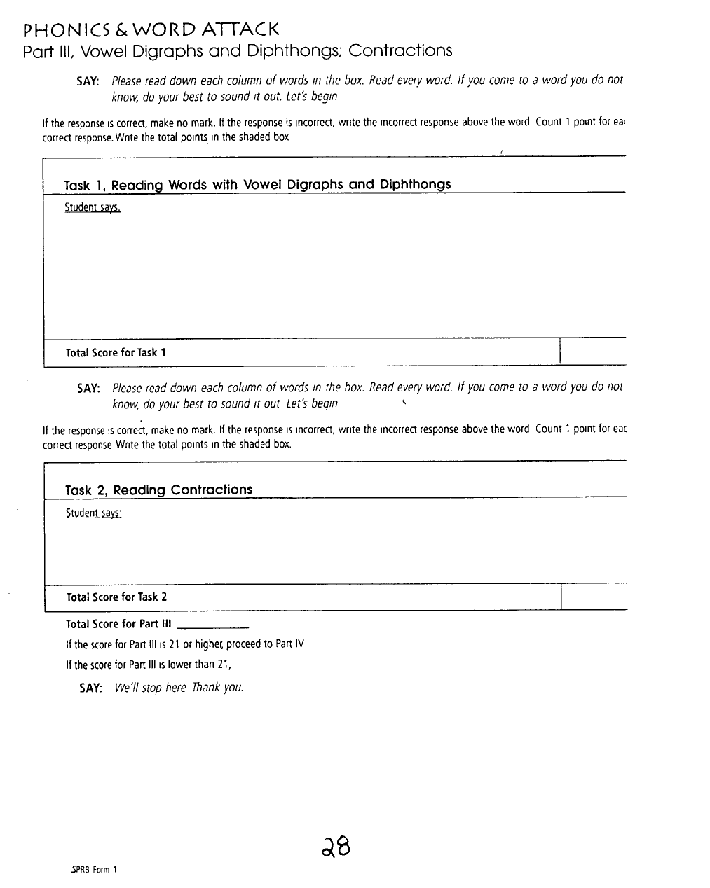

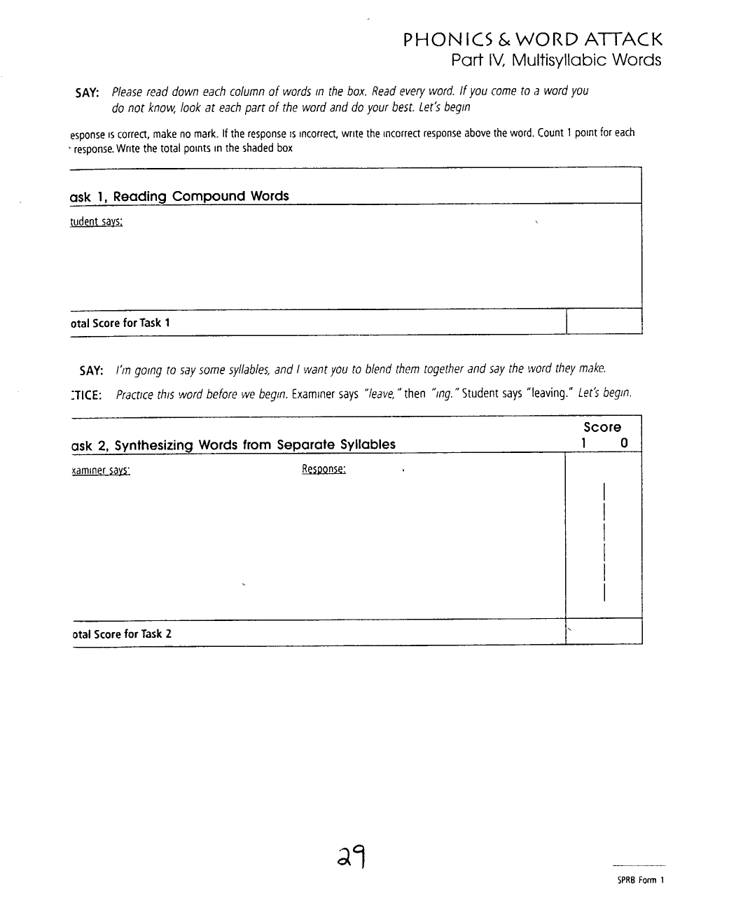

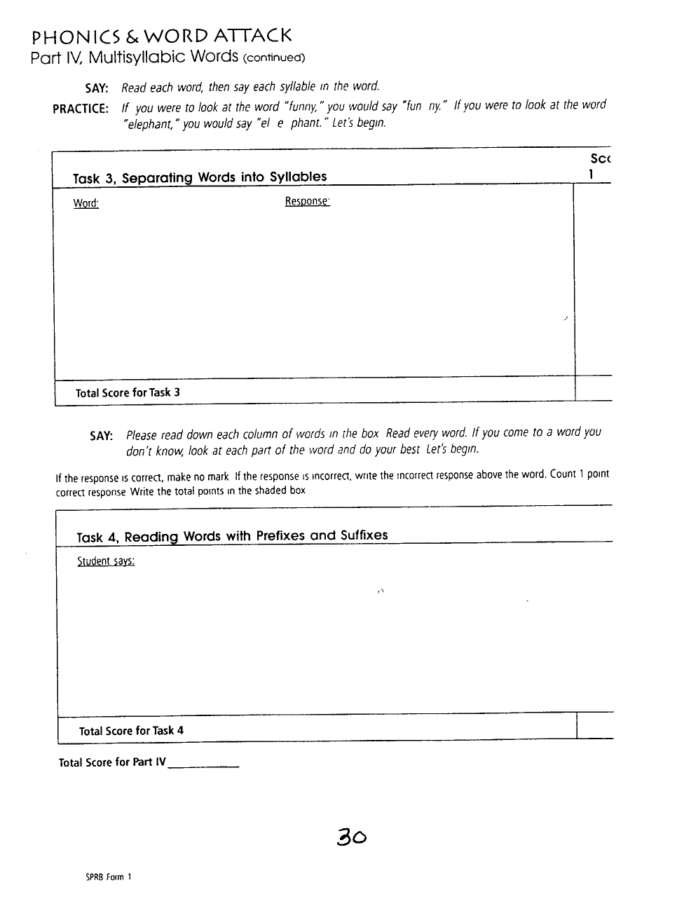

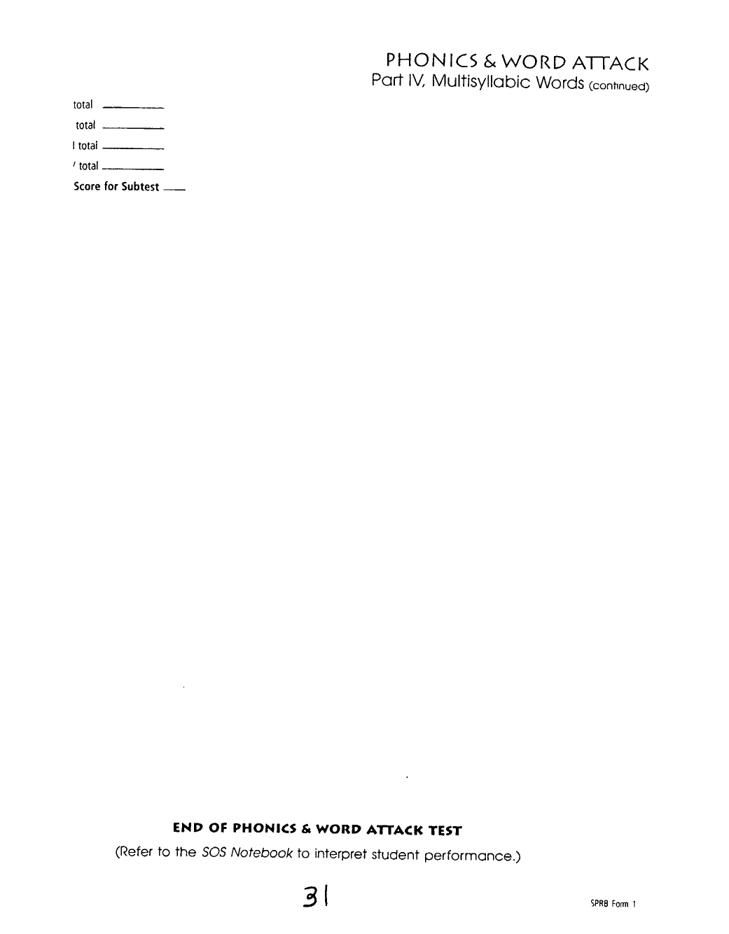

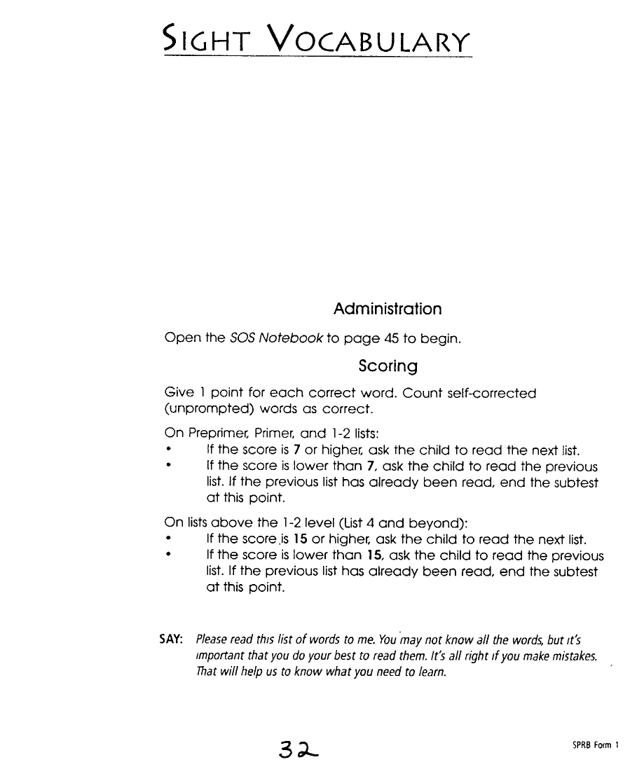

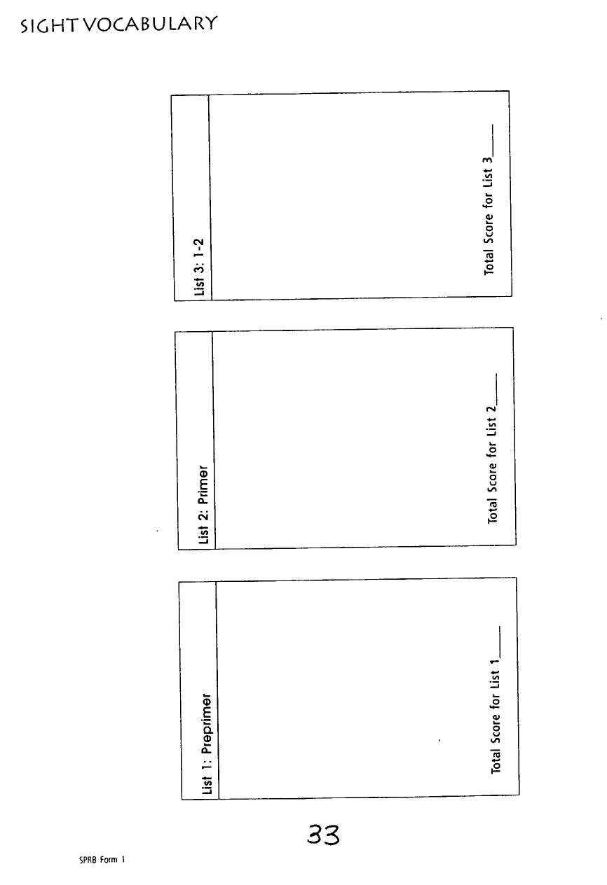

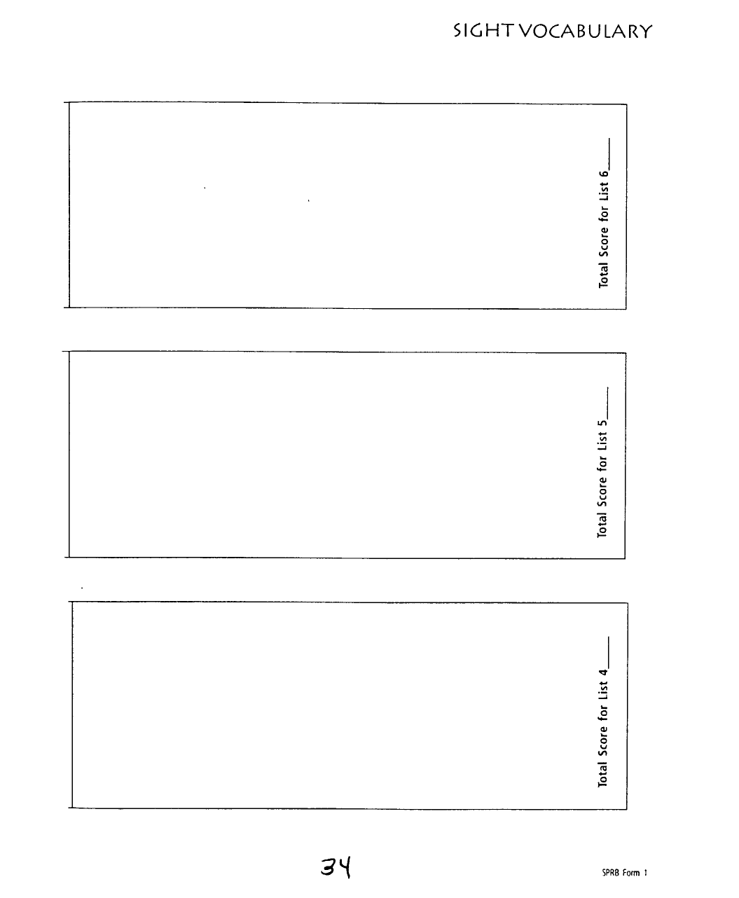

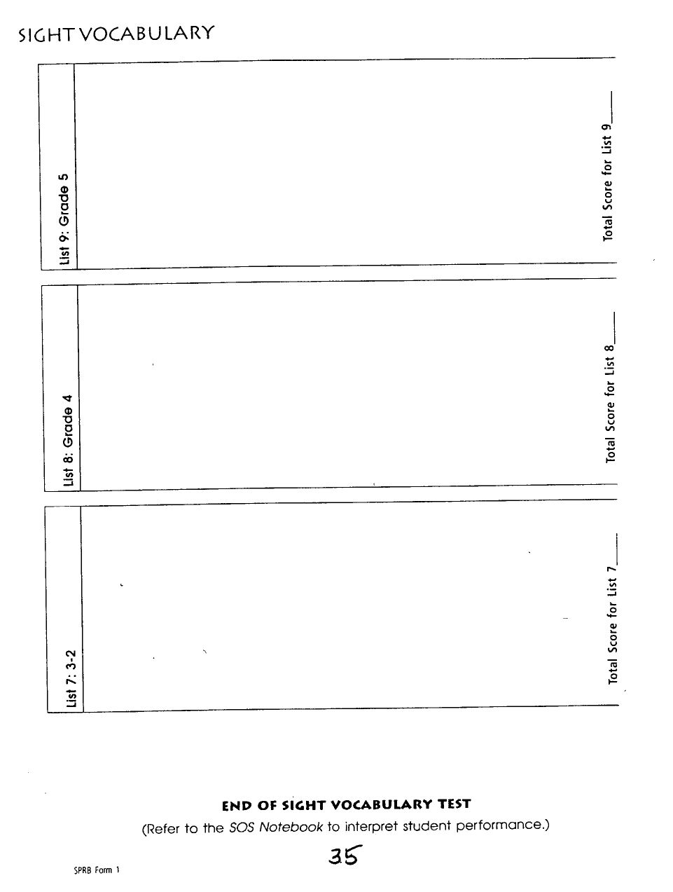

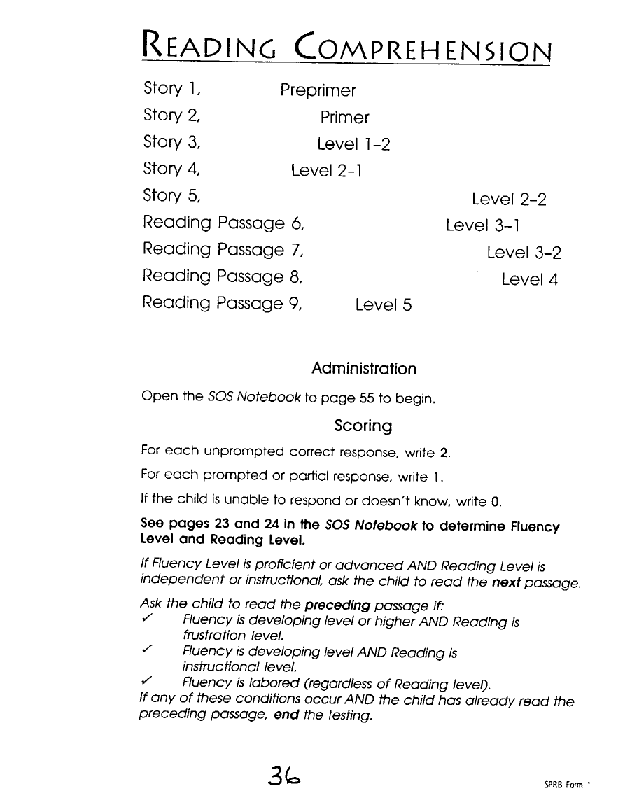

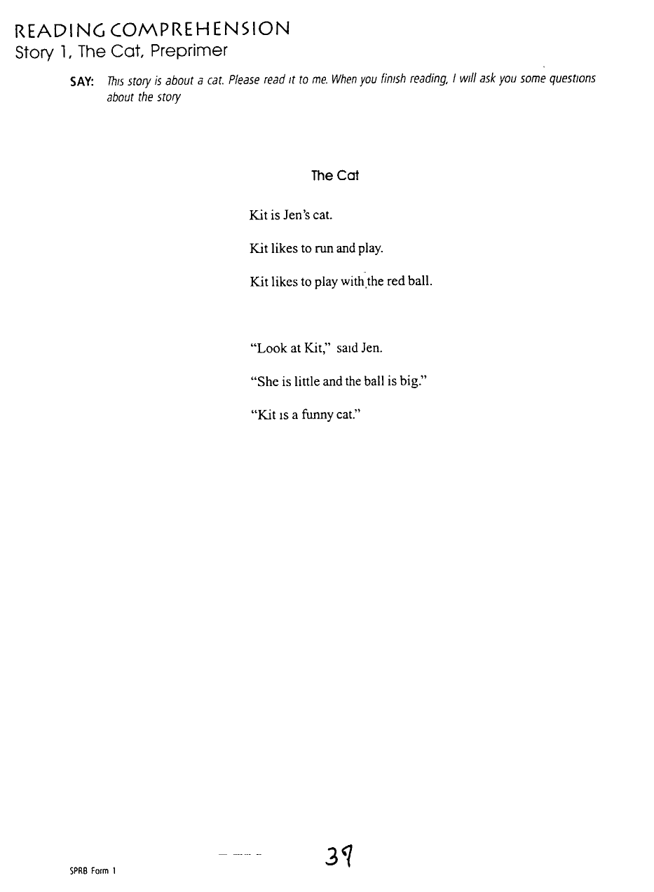

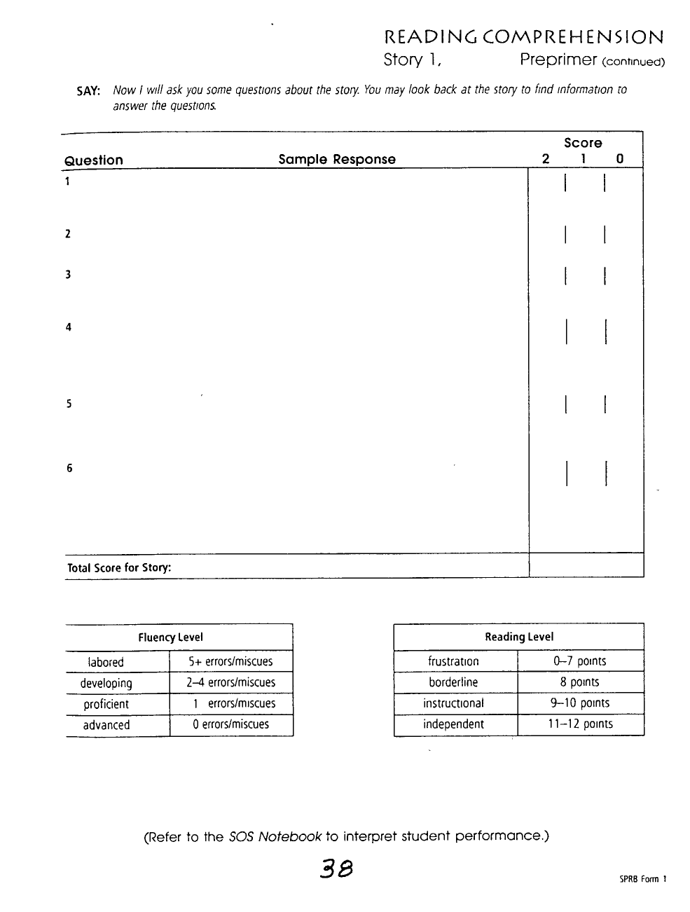

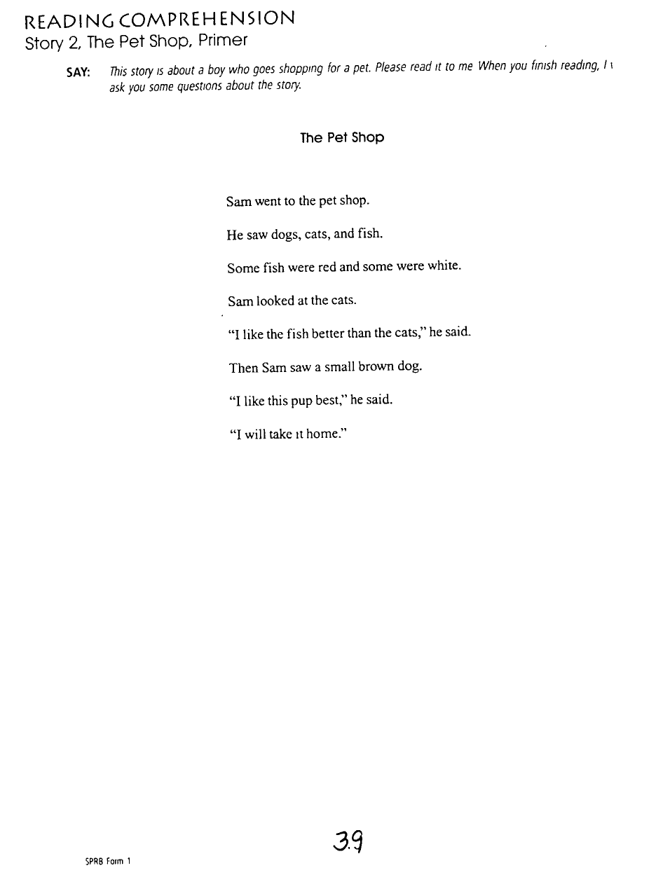

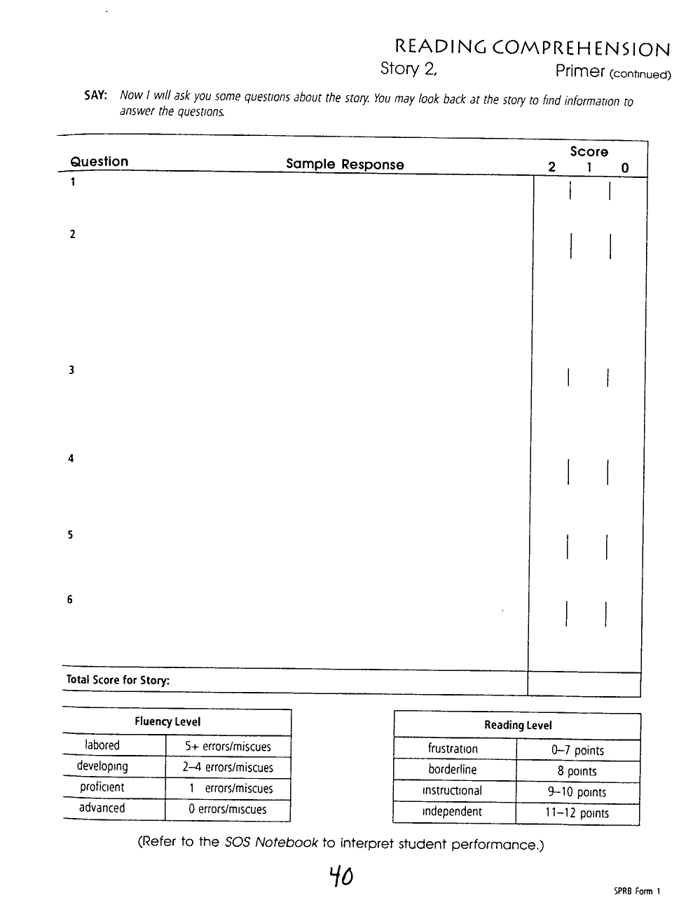

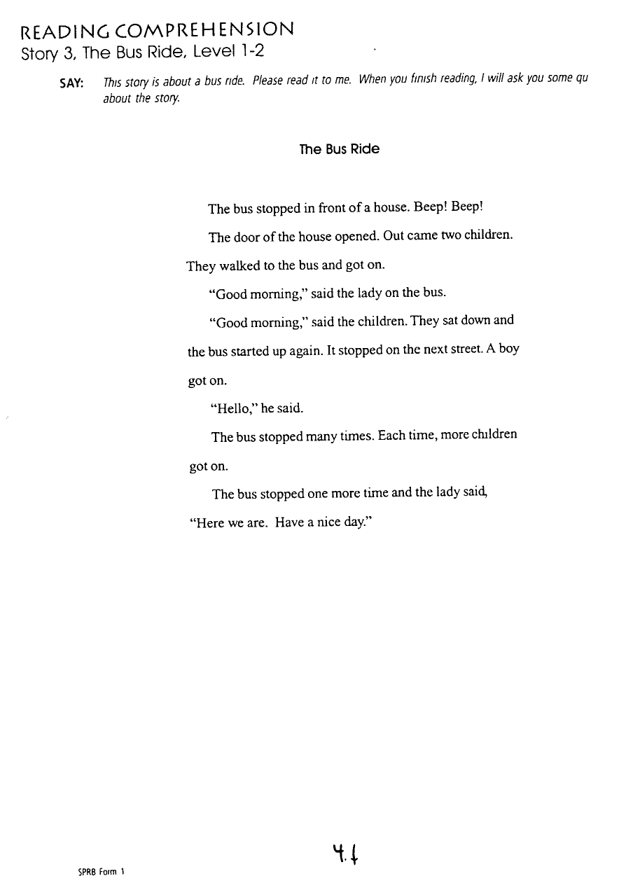

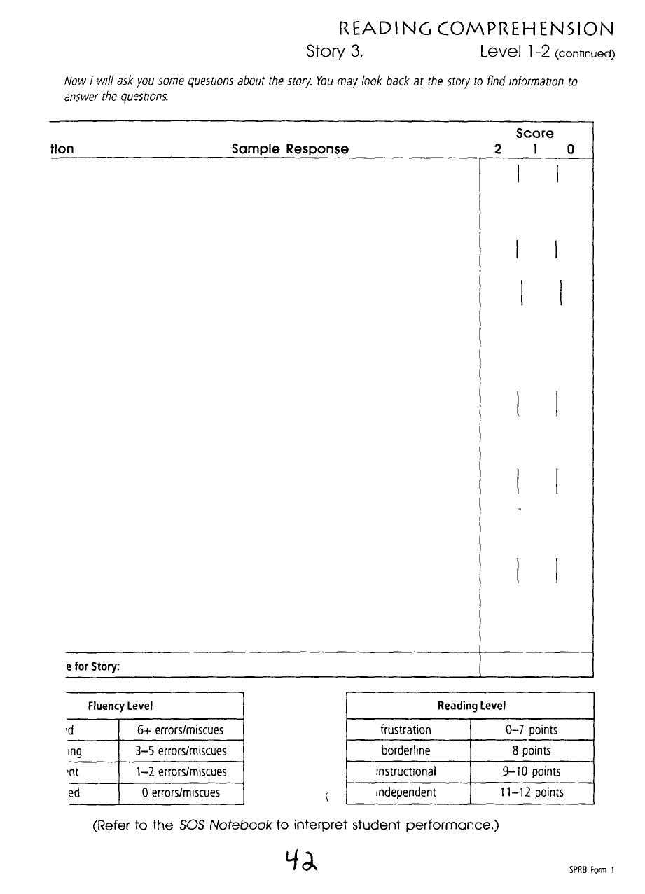

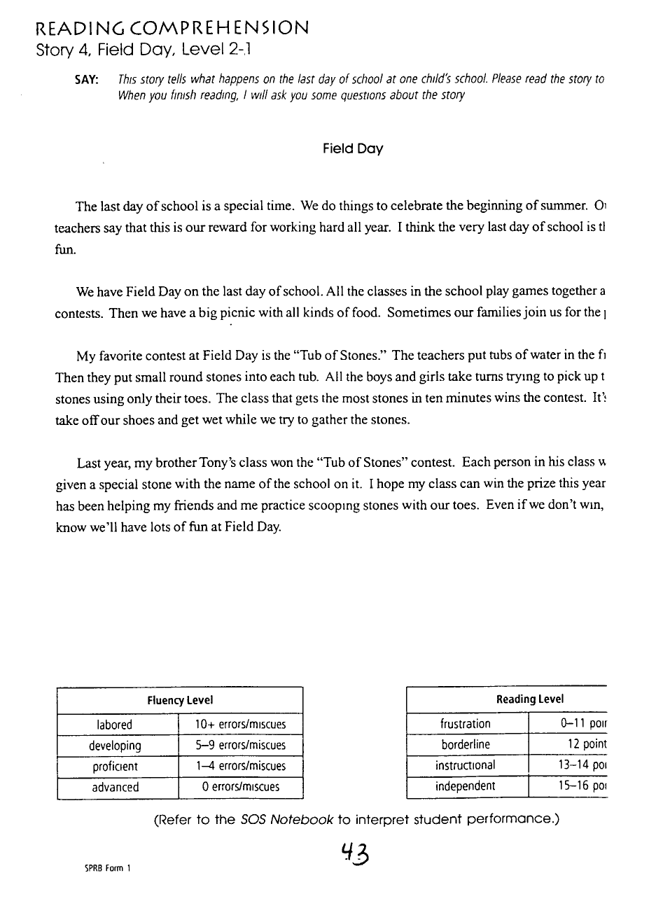

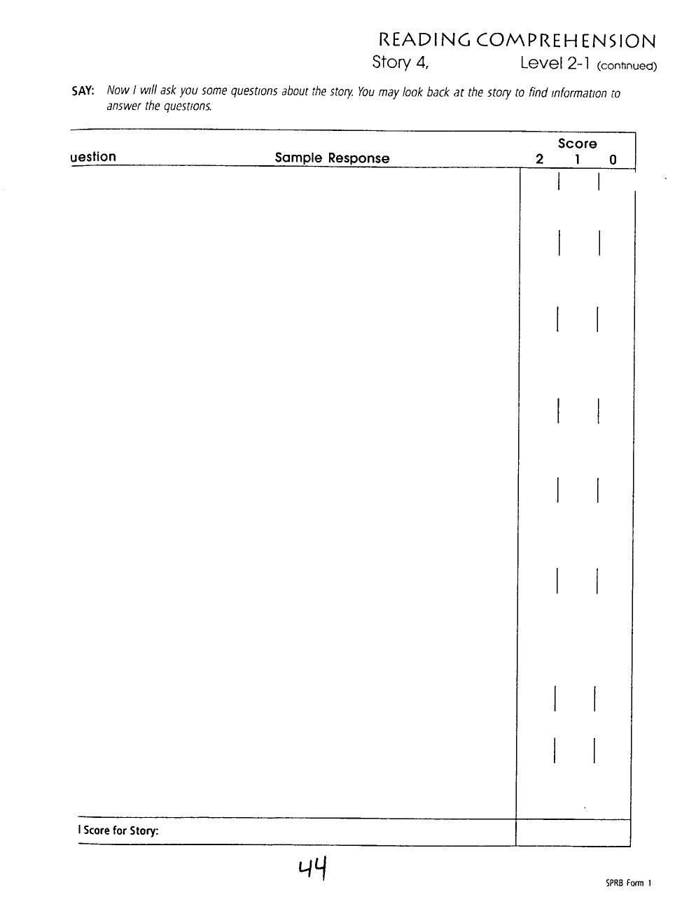

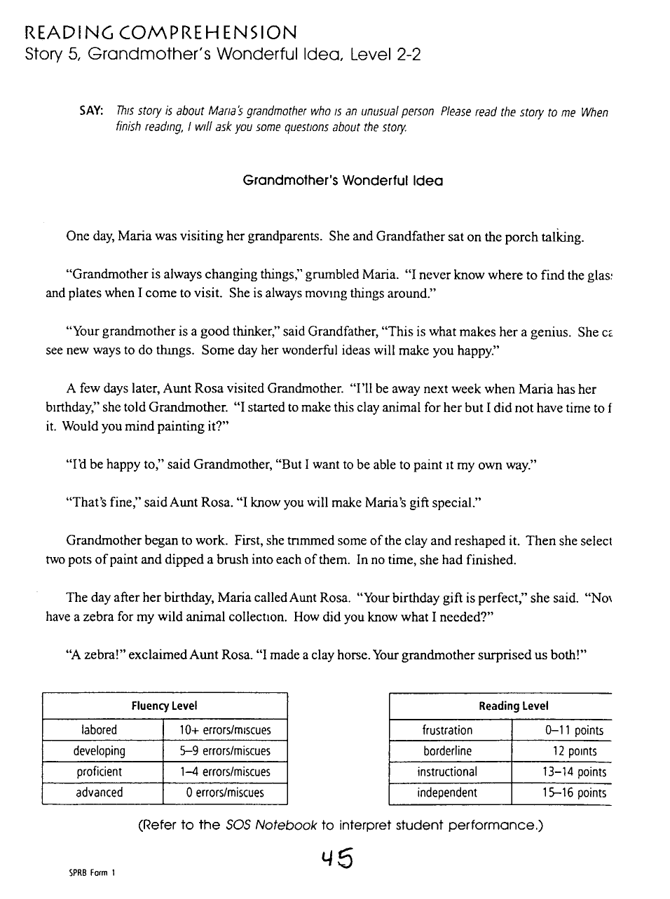

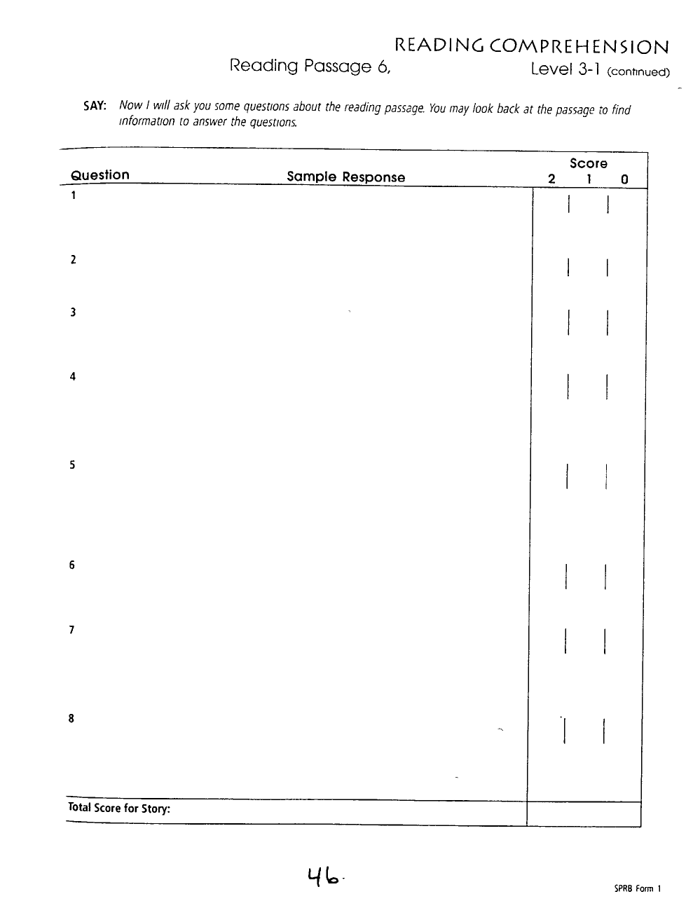

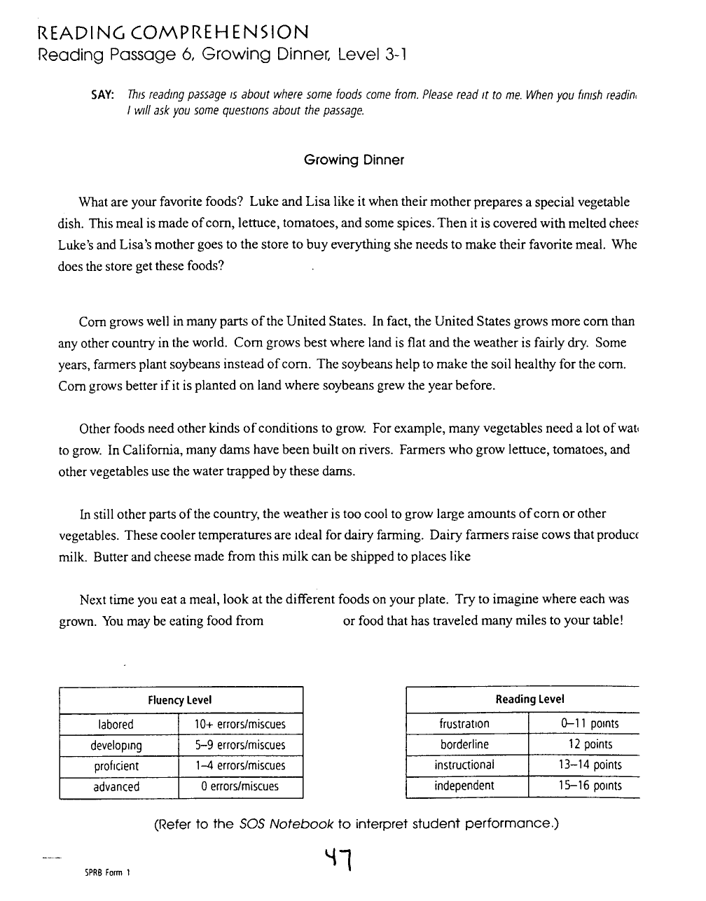

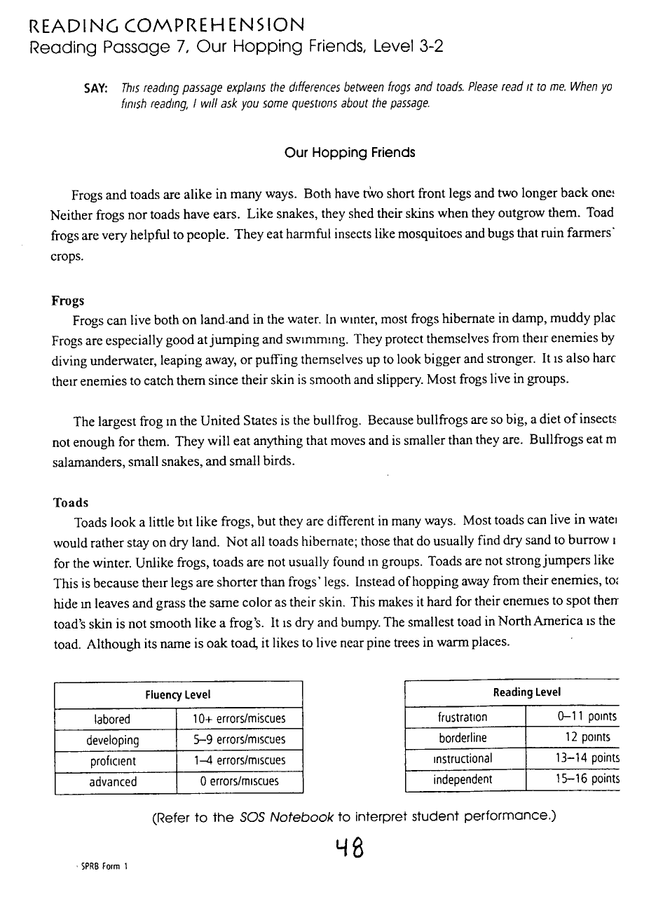

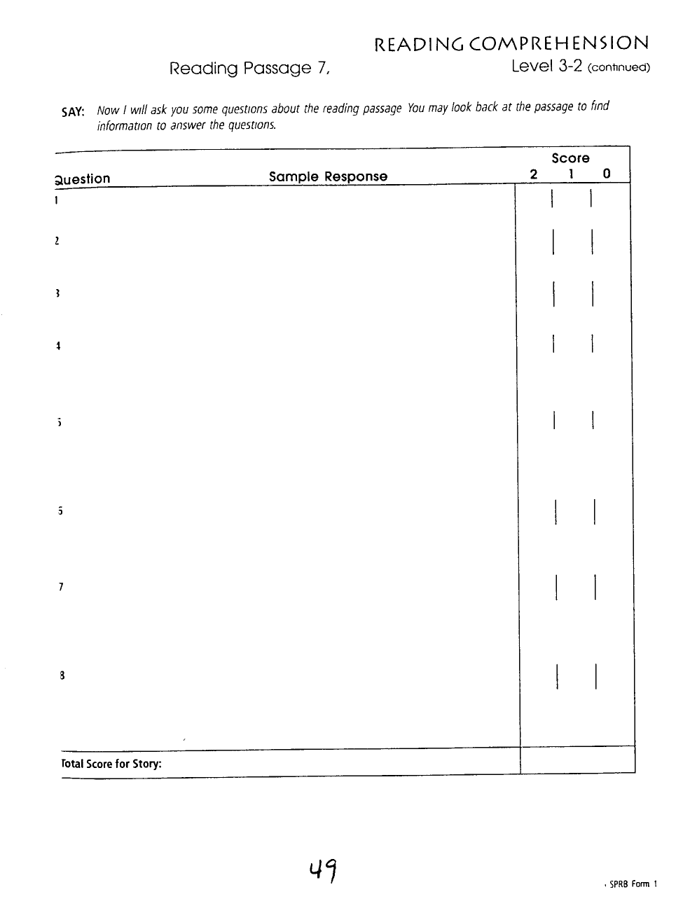

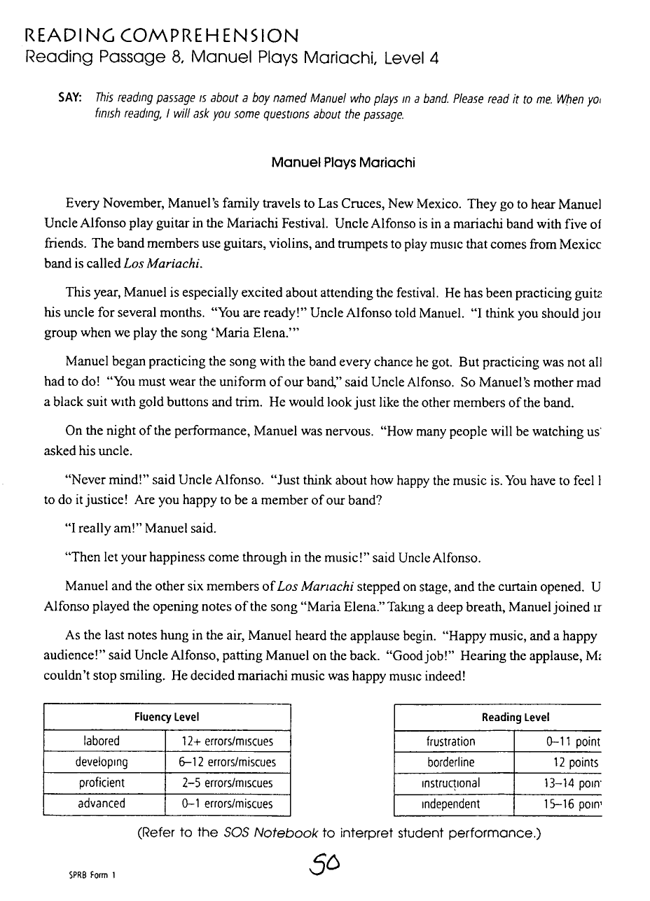

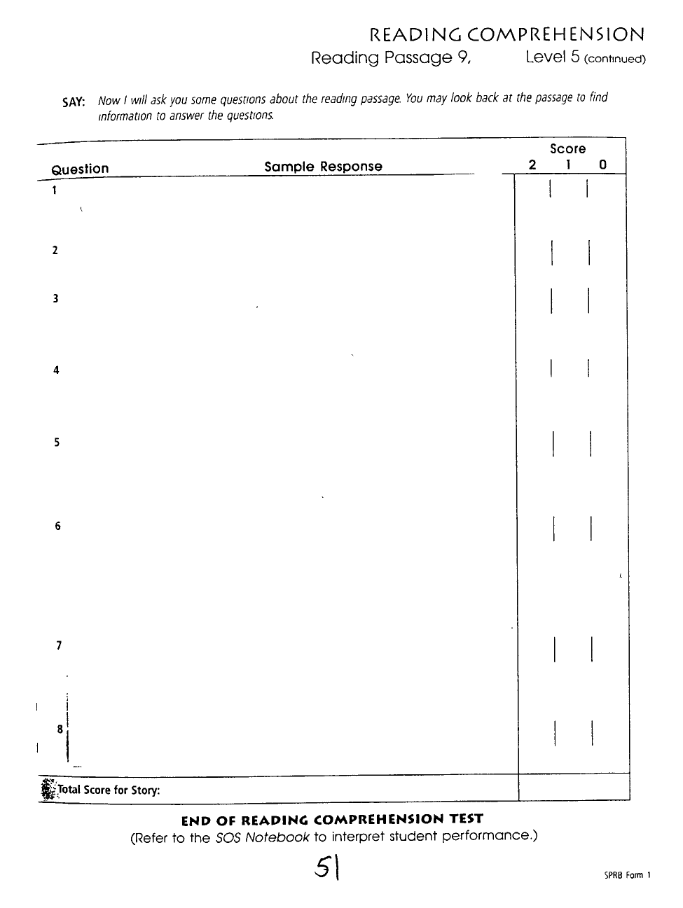

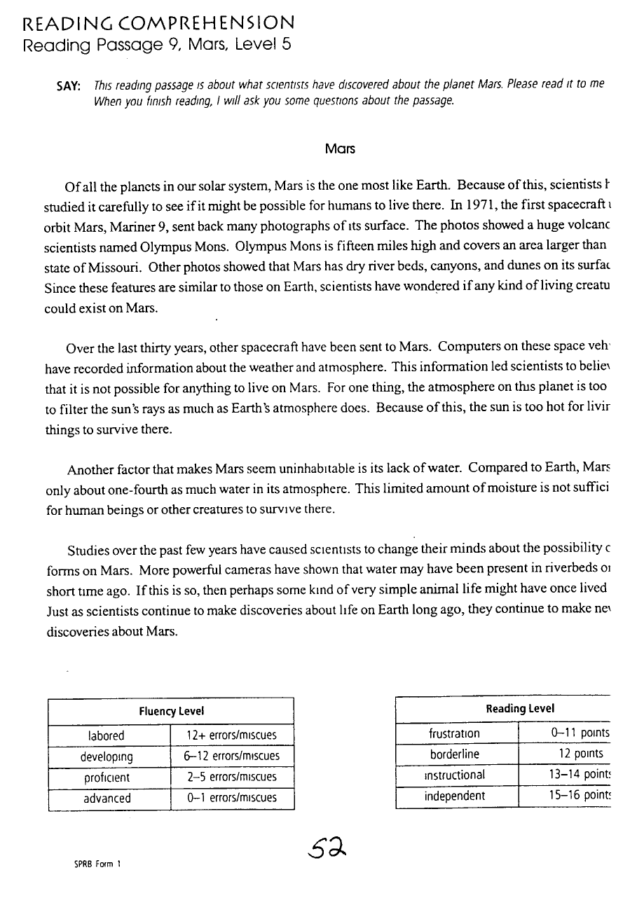

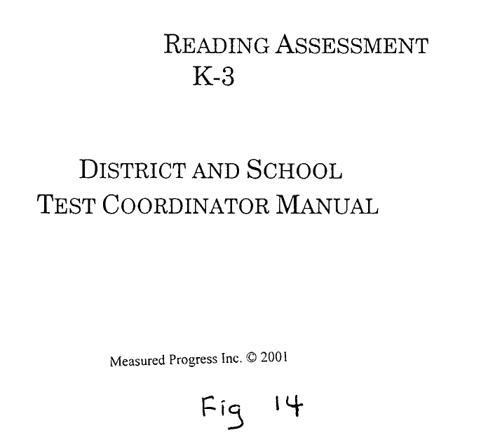

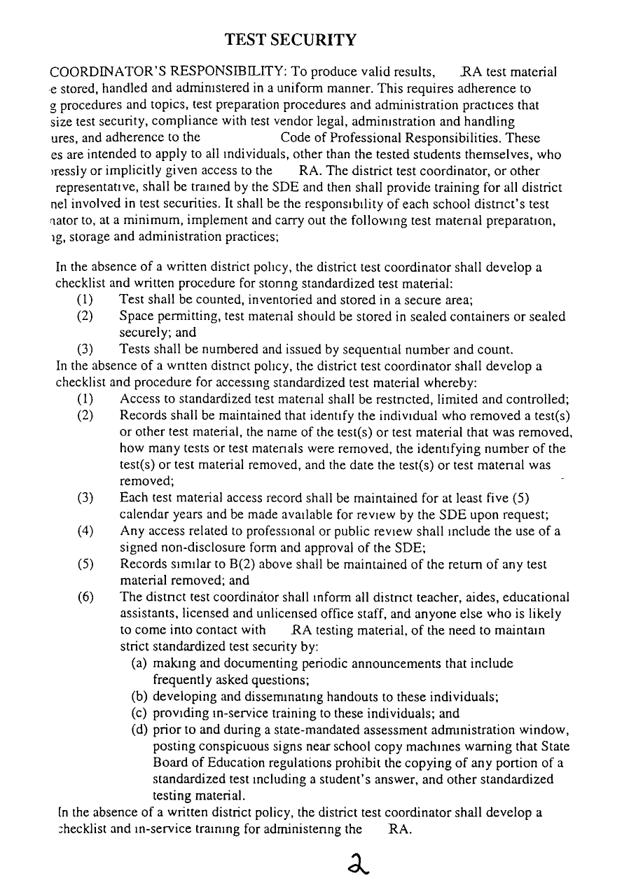

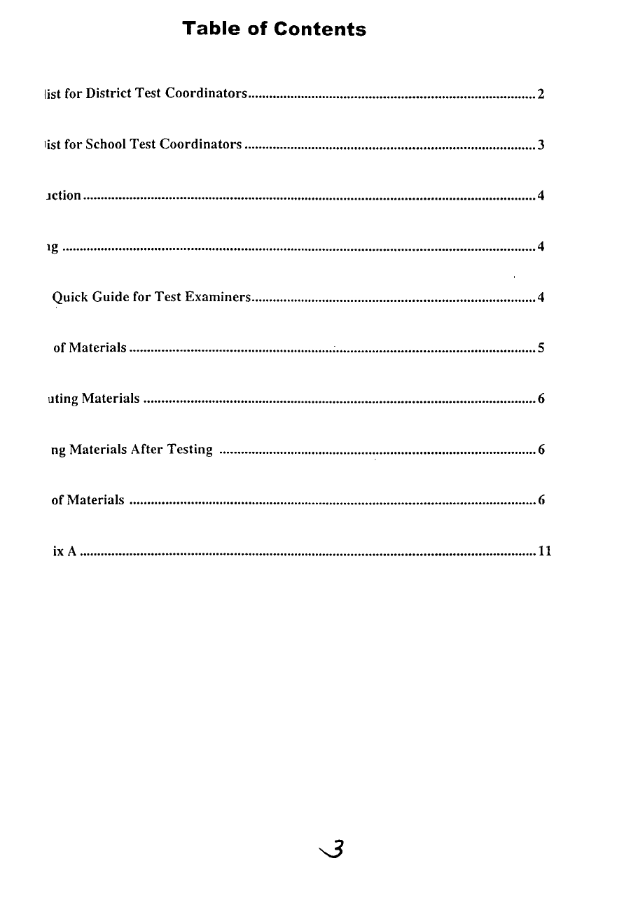

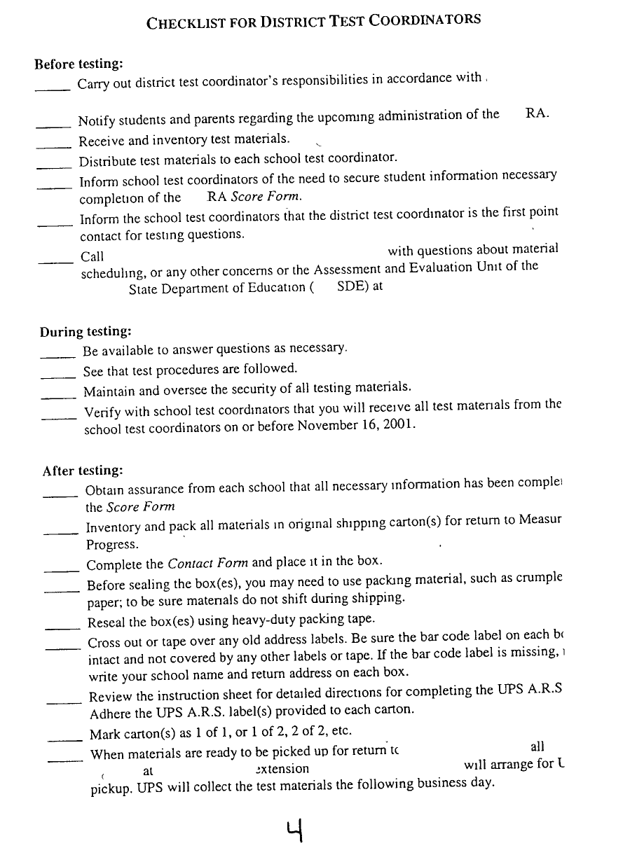

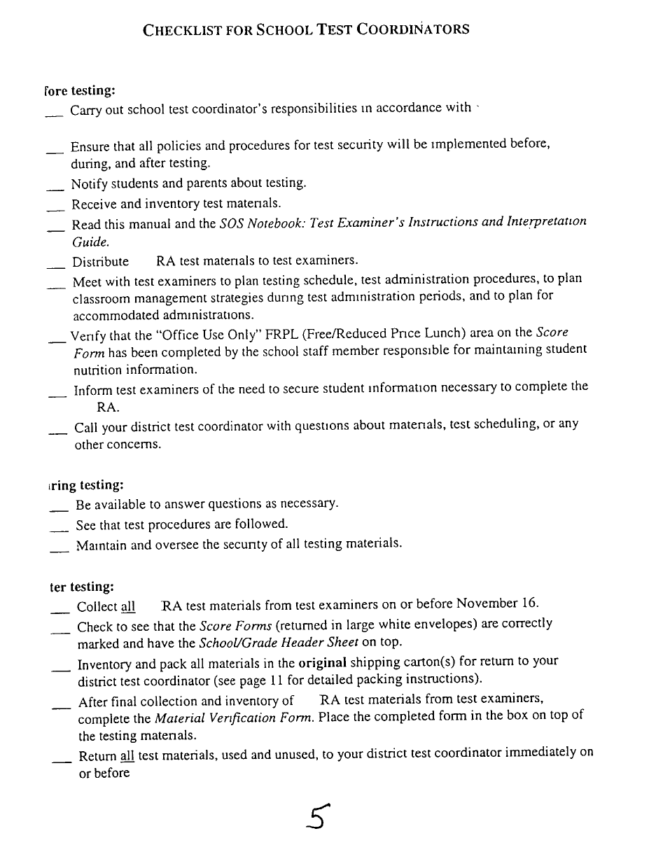

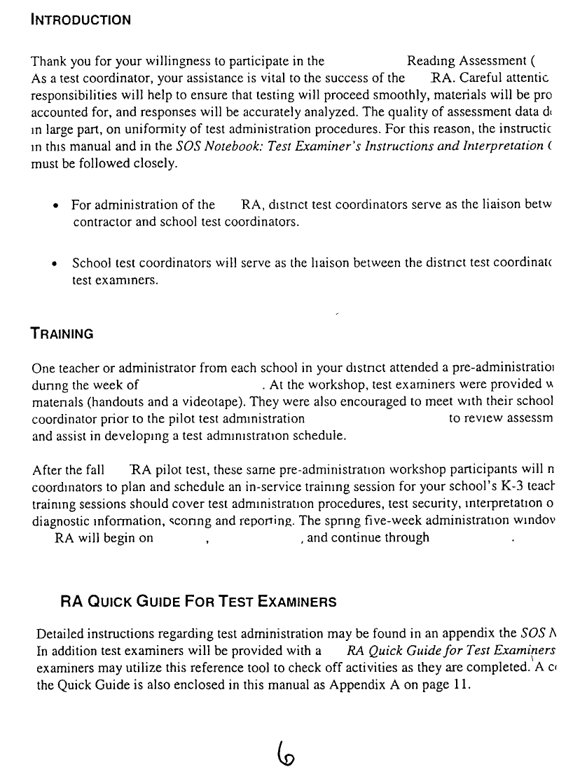

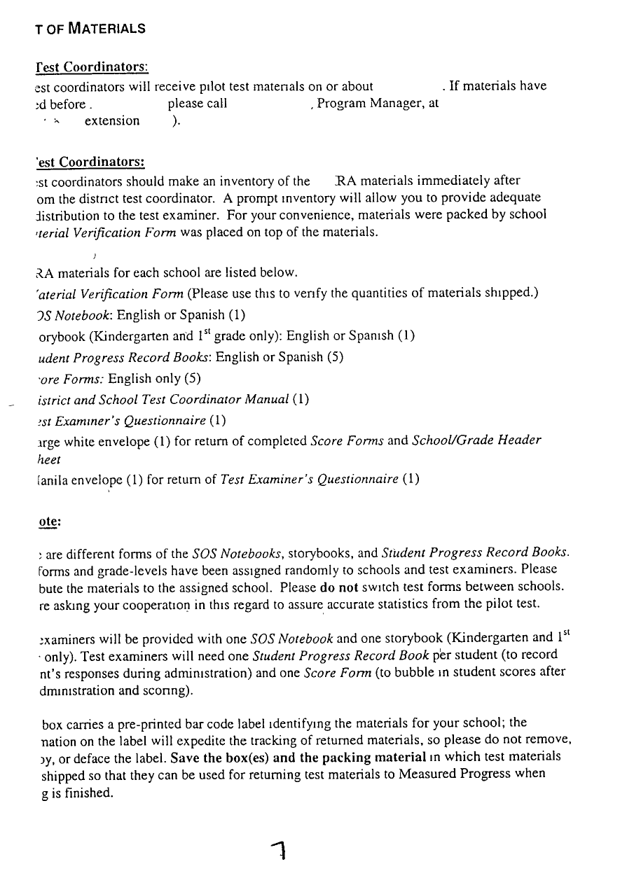

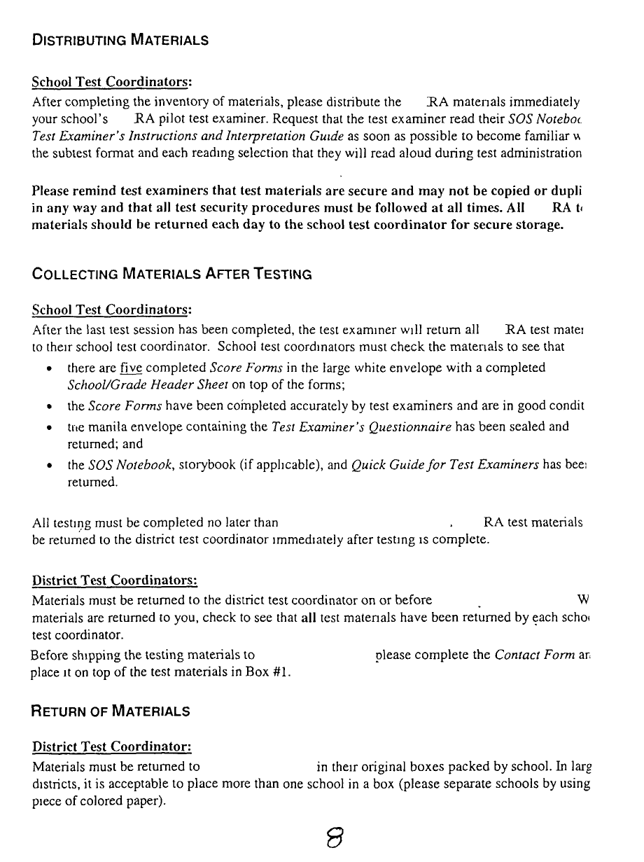

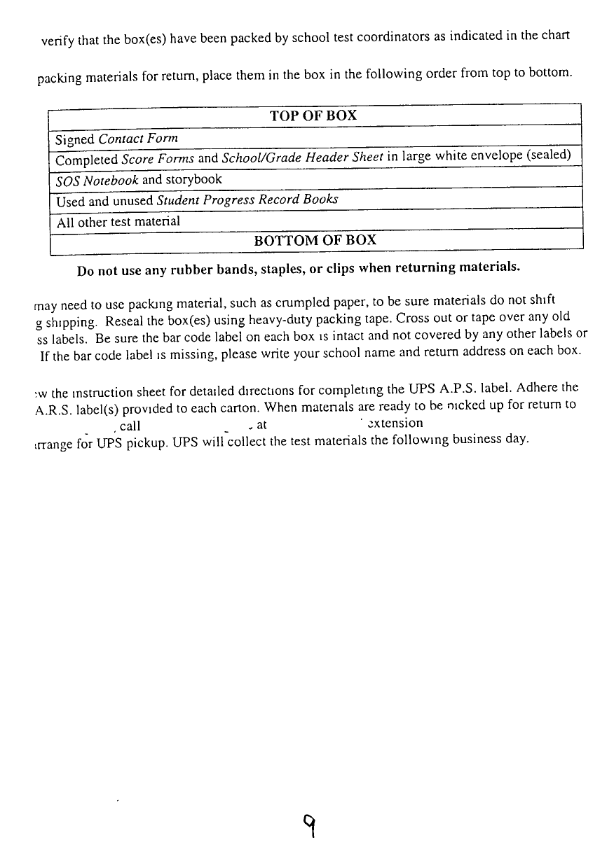

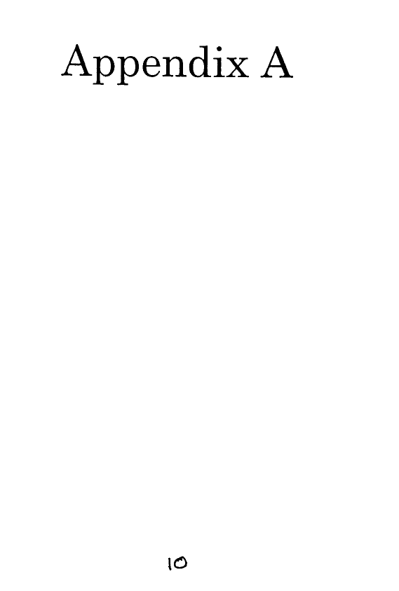

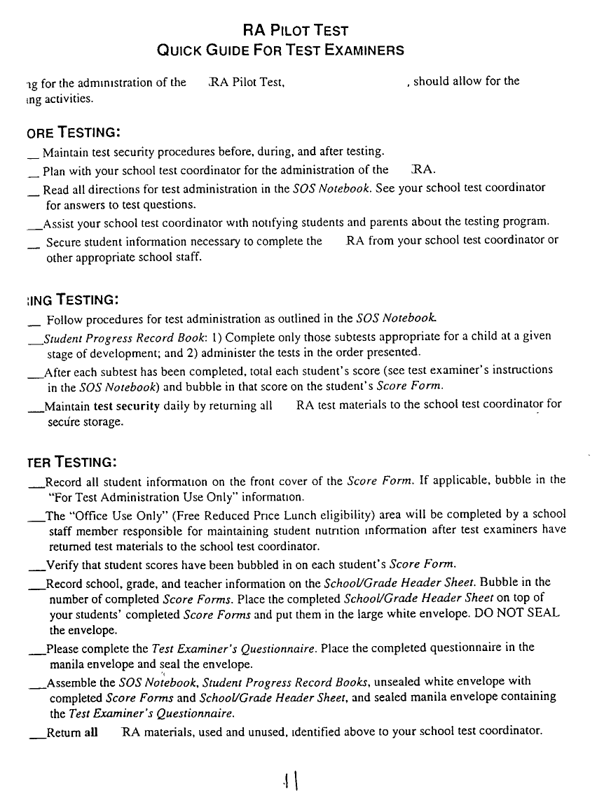

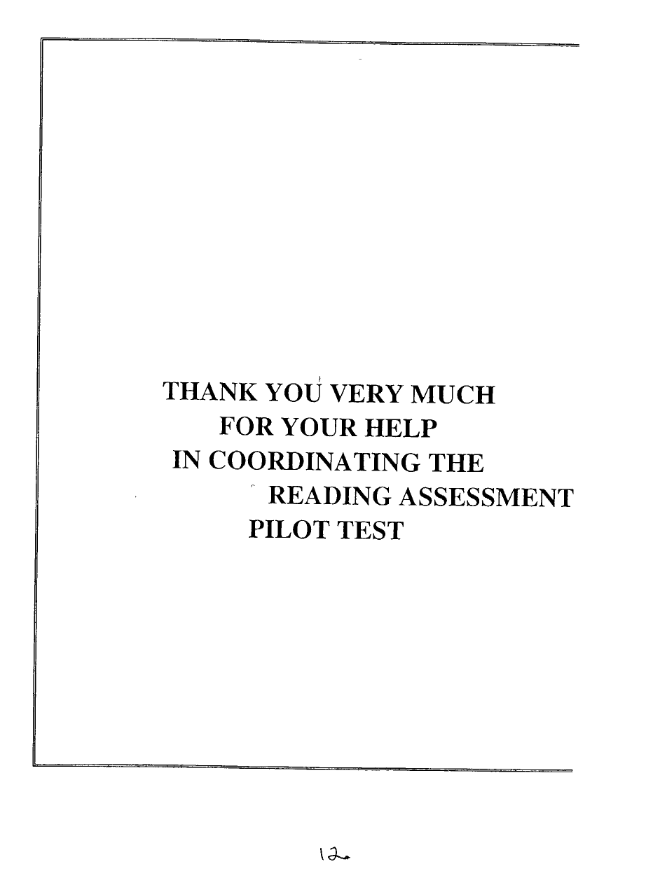

FIGS. 4-14 illustrate various exemplary components that may be included either individually or in various combinations in some embodiments of the present invention. FIG. 4 is a Quick Guide For Test Examiners in accordance with one embodiment of the present invention. FIG. 5 is an English language storybook for use in an assessment in accordance with one embodiment of the present invention. FIG. 6 is a Spanish language storybook for use in an assessment in accordance with one embodiment of the present invention. FIG. 7 is a student progress record book for use in an assessment in accordance with one embodiment of the present invention. FIG. 8 is a Spanish Language Structured Observation System Notebook for use in an assessment in accordance with one embodiment of the present invention. FIG. 9 is a reading assessment score form for use in an assessment in accordance with one embodiment of the present invention. FIG. 10 is a Reading Assessment Profile Form for use in an assessment in accordance with one embodiment of the present invention. FIG. 11 is a flow chart illustrating the development of an assessment in accordance with one embodiment of the present invention. FIG. 12 is an English Language Structured Observation System Notebook for use in an assessment in accordance with one embodiment of the present invention. FIG. 13 is a Student Progress Record Book for use in an assessment in accordance with one embodiment of the present invention. FIG. 14 is a District and School Test Coordinator Manual for use in an assessment in accordance with one embodiment of the present invention.

One embodiment of the present invention provides a system for assessing early literacy development in children, the system being formulated by the method comprising: gathering and reviewing early reading standards from a plurality of states and national professional organizations and scientifically based research related to developmental stages involved in acquiring reading skills; determining subtests required for a comprehensive diagnostic early reading assessment covering the early reading standards and the scientifically based research related to developmental stages; comparing existing early reading instruments to the comprehensive diagnostic early reading assessment; developing subtests using standard psychometric practice; developing a blueprint for each the subtest; and developing at least one form of the assessment, including items for all subtests and supporting materials.

Another embodiment of the present invention provides a method for administering an assessment of early literacy development in a student, the method comprising: obtaining assessment documents, including at least one form containing instructions and items for all subtests in the assessment, an answer document, and supporting materials; noting extent of prior reading skills of the student and selecting one or more subtests to be administered; instructing the student, and verifying the student's understanding of instructions; presenting the subtest to the student and recording the student's responses and reaction to each item of the subtest in the answer document; and submitting the answer document for scoring.

Yet another embodiment of the present invention provides a method for processing an assessment of early literacy development in students, the method comprising: confirming analytical and reporting tasks with a client; collecting and logging a plurality of answer documents; creating at least one file containing raw score data and student demographic data; analyzing the file using scientifically based research relating to developmental skills required for reading to diagnose student strengths and/or weaknesses in reading development; preparing reports including results obtained from the step of analyzing and recommendations for the amelioration of developmental deficits; and communicating the reports to the client.

The foregoing description of the embodiments of the invention has been presented for the purposes of illustration and description. It is not intended to be exhaustive or to limit invention to the precise form disclosed. Many modifications and variations are possible in light of this disclosure. It is intended that the scope of the invention be limited not by this detailed description, but rather by the claims appended hereto.

What is claimed is:

1. A system for assessing early literacy development in children, the system being formulated by the method comprising:
gathering and reviewing early reading standards from a plurality of states and national professional organizations and scientifically based research related to developmental stages involved in acquiring reading skills;
determining subtests required for a comprehensive diagnostic early reading assessment covering said early reading standards and said scientifically based research related to developmental stages;
comparing existing early reading instruments to said comprehensive diagnostic early reading assessment;
developing subtests using standard psychometric practice;
developing a blueprint for each said subtest; and
developing at least one form of said assessment, including items for all subtests and supporting materials.

2. The system of claim 1 wherein said method further comprises the step of determining areas to be covered by each said subtest.

3. The system of claim 1 wherein said method further comprises the step of determining that each said subtest will be individually administered.

4. A method for administering an assessment of early literacy development in a student, the method comprising:
Obtaining assessment documents, including at least one form containing instructions and items for all subtests in the assessment, an answer document, and supporting materials;
noting extent of prior reading skills of said student and selecting one or more subtests to be administered;
instructing said student, and verifying said student's understanding of instructions;
presenting said subtest to said student and recording said student's responses and reaction to each item of said subtest in said answer document;
submitting said answer document for scoring.

5. The method of claim 4 further comprising the step of retaining said assessment booklet in a secure location

6. A method for processing of an assessment of early literacy development in students, the method comprising:
confirming analytical and reporting tasks with a client;
collecting and logging a plurality of answer documents;
creating at least one file containing raw score data and student demographic data;
analyzing said file using scientifically based research relating to developmental skills required for reading to diagnose student strengths and/or weaknesses in reading development;
preparing reports including results obtained from said step of analyzing and recommendations for the amelioration of developmental deficits; and
communicating said reports to said client.
